(19) United States
(12) Patent Application Publication
(10) Pub. No.: US 2023/0384860 A1
(43) Pub. Date: Nov. 30, 2023

(54) DEVICES, METHODS, AND GRAPHICAL USER INTERFACES FOR GENERATING AND DISPLAYING A REPRESENTATION OF A USER

(71) Applicant: Apple Inc., Cupertino, CA (US)

(72) Inventors: Amy E. DEDONATO, San Francisco, CA (US); Kristi E. BAUERLY, Los Altos, CA (US); Wesley M. HOLDER, Union City, CA (US); Seung Wook KIM; Jay MOON, San Francisco, CA (US); Danielle M. PRICE, Los Gatos, CA (US); Jason D. RICKWALD, Santa Cruz, CA (US); William A. SORRENTINO, III, Mill Valley, CA (US); Alfred B. HUERGO WAGNER, Redwood City, CA (US); Giancarlo YERKES, San Carlos, CA (US)

(21) Appl. No.: 18/131,833

(22) Filed: Apr. 6, 2023

Related U.S. Application Data
(60) Provisional application No. 63/409,649, filed on Sep. 23, 2022.
(60) Provisional application No. 63/345,356, filed on May 24, 2022.

(51) Int. Cl. G06F 3/01; G06T 13/80; G06T 13/40; G06T 19/00; G09B 5/06

(52) U.S. Cl. CPC G06F 3/012; G06T 13/80; G06T 13/40; G06T 19/00; G09B 5/06; G06F 3/167

(57) ABSTRACT

In some examples, a computer system provides non-visual feedback based on a determination that information about a user has been captured. In some examples, a computer system displays different portions of a representation of a user as the user and/or the computer system move relative to one another. In some examples, a computer system displays different three-dimensional content associated with different steps of an enrollment process. In some examples, a computer system displays visual elements at different simulated depths that move with simulated parallax to facilitate alignment of the user and the computer system. In some examples, a computer system prompts a user to make facial expressions and displays a progress bar indicating an amount of progress toward making the facial expressions. In some examples, a computer system adjusts dynamic audio output to indicate an amount of progress toward completing a step of an enrollment process.

### CROSS-REFERENCE TO RELATED APPLICATIONS

This application claims priority to U.S. Provisional Patent Application Ser. No. 63/409,649, entitled “DEVICES, METHODS, AND GRAPHICAL USER INTERFACES FOR GENERATING AND DISPLAYING A REPRESENTATION OF A USER,” filed on Sep. 23, 2022, and U.S. Provisional Patent Application Ser. No. 63/345,356, entitled “DEVICES, METHODS, AND GRAPHICAL USER INTERFACES FOR GENERATING AND DISPLAYING A REPRESENTATION OF A USER,” filed on May 24, 2022, the contents of each of which are hereby incorporated by reference in their entireties.

### TECHNICAL FIELD

The present disclosure relates generally to computer systems that are in communication with one or more display generation components and, optionally, one or more audio output devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements, such as buttons and other graphics.

### SUMMARY

Some methods and interfaces for generating and/or displaying a representation of a user environments that include at least some virtual elements (e.g., applications, augmented reality environments, mixed reality environments, and virtual reality environments) are cumbersome, inefficient, and limited. For example, systems that provide insufficient feedback and/or guidance for performing actions associated with capturing information for generating a representation of a user and systems that do not provide an ability to preview and/or edit the representation of the user are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make generating a representation of a user with the computer systems more efficient and intuitive for a user. Such methods and interfaces optionally complement or replace conventional methods for generating a representation of a user. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for generating and/or displaying representations of users. Such methods and interfaces may complement or replace conventional methods for generating and/or displaying representations of users. Such methods and interfaces reduce the number, extent, and/or the nature of the inputs from a user and produce a more efficient human-machine interface. For battery-operated computing devices, such methods and interfaces conserve power and increase the time between battery charges. In addition, such methods and interfaces improve ergonomics of the device, provide more varied, detailed, and/or realistic user experiences, allow for the use of fewer and/or less precise sensors resulting in a more compact, lighter, and cheaper device, and/or reduce energy usage.

In accordance with some embodiments, a method is described. The method is performed at a computer system that is in communication with one or more display generation components. The method comprises: during an enrollment process for generating a representation of a user, where the enrollment process includes capturing information about one or more physical characteristics of a user of the computer system using a first sensor that is positioned on a same side of the computer system as a first display generation component of the one or more display generation components, prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, outputting a non-visual indication confirming that the threshold amount of information about the first physical characteristic has been captured.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer system using a first sensor that is positioned on a same side of the computer system as a first display generation component of the one or more display generation components, prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, outputting a non-visual indication confirming that the threshold amount of information about the first physical characteristic has been captured.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer system using a first sensor that is positioned on a same side of the computer system as a first display generation component of the one or more display generation components, prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, outputting a non-visual indication confirming that the threshold amount of information about the first physical characteristic has been captured.

In accordance with some embodiments, a computer system is described. The computer system is in communication with one or more display generation components. The computer system comprises: one or more processors; and memory storing one or more programs configured to be executed by the one or more processors, the one or more programs including instructions for: during an enrollment process for generating a representation of a user, where the enrollment process includes capturing information about one or more physical characteristics of a user of the computer system using a first sensor that is positioned on a same side of the computer system as a first display generation component of the one or more display generation components, prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, outputting a non-visual indication confirming that the threshold amount of information about the first physical characteristic has been captured.

In accordance with some embodiments, a computer system is described. The computer system is in communication with one or more display generation components. The computer system comprises: during an enrollment process for generating a representation of a user, where the enrollment process includes capturing information about one or more physical characteristics of a user of the computer system using a first sensor that is positioned on a same side of the computer system as a first display generation component of the one or more display generation components, means for prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, means for outputting a non-visual indication confirming that the threshold amount of information about the first physical characteristic has been captured.

In accordance with some embodiments, a computer program product is described. The computer program product includes one or more programs configured to be executed by one or more processors of a computer system that is in communication with one or more display generation components, the one or more programs include instructions for: during an enrollment process for generating a representation of a user, where the enrollment process includes capturing information about one or more physical characteristics of a user of the computer system using a first sensor that is positioned on a same side of the computer system as a first display generation component of the one or more display generation components, prompting the user of the computer system to move a position of a head of the user relative to the computer system; and after prompting the user of the computer system to move the position of the head of the user relative to the orientation of the computer system: in accordance with a determination that a threshold amount of information about a first physical characteristic of the one or more physical characteristics has been captured using the first sensor and based on the position of the head of the user moving relative to the orientation of the computer system, outputting a non-visual indication confirming that the threshold amount of information about the first physical characteristic has been captured.

In accordance with some embodiments, a method is described. The method is performed at a computer system that is in communication with one or more display generation components. The method comprises: capturing information about one or more physical characteristics of a user of the computer system; after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; while displaying, via the first display generation component, the first portion of the representation of the user without displaying the second portion of the representation of the user, detecting a change in an orientation of the computer system relative to the user of the computer system; and in response to detecting the change in the orientation of the computer system relative to the user of the computer system, displaying, via the first display generation component of the one or more display generation components, the second portion of the representation of the user, different from the first portion of the representation of the user.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: capturing information about one or more physical characteristics of a user of the computer system; after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; while displaying, via the first display generation component, the first portion of the representation of the user without displaying the second portion of the representation of the user, detecting a change in an orientation of the computer system relative to the user of the computer system; and in response to detecting the change in the orientation of the computer system relative to the user of the computer system, displaying, via the first display generation component of the one or more display generation components, the second portion of the representation of the user, different from the first portion of the representation of the user.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: capturing information about one or more physical characteristics of a user of the computer system; after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; while displaying, via the first display generation component, the first portion of the representation of the user without displaying the second portion of the representation of the user, detecting a change in an orientation of the computer system relative to the user of the computer system; and in response to detecting the change in the orientation of the computer system relative to the user of the computer system, displaying, via the first display generation component of the one or more display generation components, the second portion of the representation of the user, different from the first portion of the representation of the user.

In accordance with some embodiments, a computer system is described. The computer system is in communication with one or more display generation components. The computer system comprises: one or more processors; and memory storing one or more programs configured to be executed by the one or more processors, the one or more programs including instructions for: capturing information about one or more physical characteristics of a user of the computer system; after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; while displaying, via the first display generation component, the first portion of the representation of the user without displaying the second portion of the representation of the user, detecting a change in an orientation of the computer system relative to the user of the computer system; and in response to detecting the change in the orientation of the computer system relative to the user of the computer system, displaying, via the first display generation component of the one or more display generation components, the second portion of the representation of the user, different from the first portion of the representation of the user.

In accordance with some embodiments, a computer system is described. The computer system is in communication with one or more display generation components. The computer system comprises: means for capturing information about one or more physical characteristics of a user of the computer system; means for, after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; means for, while displaying, via the first display generation component, the first portion of the representation of the user without displaying the second portion of the representation of the user, detecting a change in an orientation of the computer system relative to the user of the computer system; and means for, in response to detecting the change in the orientation of the computer system relative to the user of the computer system, displaying, via the first display generation component of the one or more display generation components, the second portion of the representation of the user, different from the first portion of the representation of the user.

In accordance with some embodiments, a computer program product is described. The computer program product includes one or more programs configured to be executed by one or more processors of a computer system that is in communication with one or more display generation components, the one or more programs include instructions for: capturing information about one or more physical characteristics of a user of the computer system; after capturing information about the one or more physical characteristics of the user of the computer system, displaying, via a first display generation component of the one or more display generation components, a first portion of a representation of the user without displaying a second portion of the representation of the user, where one or more physical characteristics of the representation of the user are based on the information about the one or more physical characteristics of the user; while displaying, via the first display generation component, the first portion of the representation of the user without displaying the second portion of the representation of the user, detecting a change in an orientation of the computer system relative to the user of the computer system; and in response to detecting the change in the orientation of the computer system relative to the user of the computer system, displaying, via the first display generation component of the one or more display generation components, the second portion of the representation of the user, different from the first portion of the representation of the user.

In accordance with some embodiments, a method is described. The method is performed at a computer system that is in communication with one or more display generation components. The method comprises: prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a computer system is described. The computer system is in communication with one or more display generation components. The computer system comprises: one or more processors; and memory storing one or more programs configured to be executed by the one or more processors, the one or more programs including instructions for: prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a computer system is described. The computer system is in communication with one or more display generation components. The computer system comprises: means for, prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a computer program product is described. The computer program product includes one or more programs configured to be executed by one or more processors of a computer system that is in communication with one or more display generation components, the one or more programs include instructions for: prior to an enrollment process for generating a representation of a user, where the enrollment process includes capturing information about one or more physical characteristics of a user of the computer system, outputting a plurality of indications that provides guidance to the user of the computer system for capturing information about one or more physical characteristics of the user of the computer system, where outputting the plurality of indications includes: outputting a first indication corresponding to a first step of a process that includes capturing the information about the one or more physical characteristics of the user of the computer system, where the first indication includes displaying, via a first display generation component of the one or more display generation components, first three-dimensional content associated with the first step; and after outputting the first indication, outputting a second indication corresponding to a second step, different from the first step, of the process for capturing the information about the one or more physical characteristics of the user of the computer system, where the second indication includes displaying, via the first display generation component of the one or more display generation components, second three-dimensional content associated with the second step, where the second step occurs after the first step in the enrollment process.

In accordance with some embodiments, a method is described. The method is performed at a computer system that is in communication with one or more display generation components. The method comprises: during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; a second visual indication indicative of the orientation of the body part of the user with respect to the computer system, where the second visual indication has a second simulated depth different from the first simulated depth; while displaying the first visual indication and the second visual indication, receiving an indication of a change in pose of the body part of the user with respect to the one or more sensors; and in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; a second visual indication indicative of the orientation of the body part of the user with respect to the computer system, where the second visual indication has a second simulated depth different from the first simulated depth; while displaying the first visual indication and the second visual indication, receiving an indication of a change in pose of the body part of the user with respect to the one or more sensors; and in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; a second visual indication indicative of the orientation of the body part of the user with respect to the computer system, where the second visual indication has a second simulated depth different from the first simulated depth; while displaying the first visual indication and the second visual indication, receiving an indication of a change in pose of the body part of the user with respect to the one or more sensors; and in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a computer system is described. The computer system is in communication with one or more display generation components. The computer system comprises: one or more processors; and memory storing one or more programs configured to be executed by the one or more processors, the one or more programs including instructions for: during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; a second visual indication indicative of the orientation of the body part of the user with respect to the computer system, where the second visual indication has a second simulated depth different from the first simulated depth; while displaying the first visual indication and the second visual indication, receiving an indication of a change in pose of the body part of the user with respect to the one or more sensors; and in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a computer system is described. The computer system is in communication with one or more display generation components. The computer system comprises: means for, during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; and a second visual indication indicative of the orientation of the body part of the user with respect to the computer system, where the second visual indication has a second simulated depth different from the first simulated depth; means for, while displaying the first visual indication and the second visual indication, receiving an indication of a change in pose of the body part of the user with respect to the one or more sensors; and means for, in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a computer program product is described. The computer program product includes one or more programs configured to be executed by one or more processors of a computer system that is in communication with one or more display generation components, the one or more programs include instructions for: during an enrollment process for generating a representation of a user, where the enrollment process includes capturing information about one or more physical characteristics of a user of the computer via one or more sensors, displaying, via a display generation component of the one or more display generation components: a first visual indication indicative of a target orientation of a body part of the user with respect to the computer system, where the first visual indication has a first simulated depth; a second visual indication indicative of the orientation of the body part of the user with respect to the computer system, where the second visual indication has a second simulated depth different from the first simulated depth; while displaying the first visual indication and the second visual indication, receiving an indication of a change in pose of the body part of the user with respect to the one or more sensors; and in response to receiving the indication of the change in pose of the body part of the user with respect to the one or more sensors, shifting a relative position of the first visual indication and the second visual indication with a simulated parallax that is based on the change in orientation of the body part of the user with respect to the one or more sensors and a difference between the first simulated depth of the first visual indication and the second simulated depth of the second visual indication, including: in accordance with a determination that the body part of the user has moved closer to a target range of poses relative to the one or more sensors, shifting the relative position of the first visual indication and the second visual indication includes shifting the relative position of the first visual indication and the second visual indication toward a respective spatial arrangement of the first visual indication and the second visual indication; and in accordance with a determination that the body part of the user has moved further away from the target range of poses relative to the one or more sensors, shifting the relative position of the first visual indication and the second visual indication includes shifting the relative position of the first visual indication and the second visual indication away from the respective spatial arrangement of the first visual indication and the second visual indication.

In accordance with some embodiments, a method is described. The method is performed at a computer system that is in communication with one or more display generation components. The method comprises: during an enrollment process for generating a representation of a user, where the enrollment process includes capturing information about one or more physical characteristics of a user of the computer system, prompting the user to make one or more facial expressions; and after prompting the user to make the one or more facial expressions: detecting, via one or more sensors, information about facial features of the user; and displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer system, prompting the user to make one or more facial expressions; and after prompting the user to make the one or more facial expressions: detecting, via one or more sensors, information about facial features of the user; and displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: during an enrollment process for generating a representation of a user, where the enrollment process includes capturing information about one or more physical characteristics of a user of the computer system, prompting the user to make one or more facial expressions; and after prompting the user to make the one or more facial expressions: detecting, via one or more sensors, information about facial features of the user; and displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a computer system is described. The computer system is in communication with one or more display generation components. The computer system comprises: one or more processors; and memory storing one or more programs configured to be executed by the one or more processors, the one or more programs including instructions for: during an enrollment process for generating a representation of a user, where the enrollment process includes capturing information about one or more physical characteristics of a user of the computer system, prompting the user to make one or more facial expressions; and after prompting the user to make the one or more facial expressions: detecting, via one or more sensors, information about facial features of the user; and displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a computer system is described. The computer system is in communication with one or more display generation components. The computer system comprises: means for, during an enrollment process for generating a representation of a user, where the enrollment process includes capturing information about one or more physical characteristics of a user of the computer system, prompting the user to make one or more facial expressions; and after prompting the user to make the one or more facial expressions: means for detecting, via one or more sensors, information about facial features of the user; and means for displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a computer program product is described. The computer program product includes one or more programs configured to be executed by one or more processors of a computer system that is in communication with one or more display generation components, the one or more programs include instructions for: during an enrollment process for generating a representation of a user, where the enrollment process includes capturing information about one or more physical characteristics of a user of the computer system, prompting the user to make one or more facial expressions; and after prompting the user to make the one or more facial expressions: detecting, via one or more sensors, information about facial features of the user; and displaying, via a display generation component of the one or more display generation components, a progress indication based on the information about the facial features of the user, where displaying the progress indicator includes: in accordance with a determination that the information about the facial features of the user indicates a first degree of progress toward making the one or more facial expressions, displaying the progress indicator with a first appearance that indicates the first degree of progress; and in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

In accordance with some embodiments, a method is described. The method is performed at a computer system that is in communication with one or more audio output devices. The method comprises: during an enrollment process for generating a representation of a user, where the enrollment process includes capturing information about one or more physical characteristics of the user of the computer system, outputting, via the one or more audio output devices, dynamic audio output of a first type; while outputting the dynamic audio output of the first type, receiving an indication of a change in pose of a biometric feature of the user of the computer system relative to one or more biometric sensors of the computer system; and in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a non-transitory computer-readable storage medium is described. The non-transitory computer-readable storage medium stores one or more programs configured to be executed by one or more processors of a computer system that is in communication with one or more audio output devices, the one or more programs including instructions for: during an enrollment process for generating a representation of a user, where the enrollment process includes capturing information about one or more physical characteristics of the user of the computer system, outputting, via the one or more audio output devices, dynamic audio output of a first type; while outputting the dynamic audio output of the first type, receiving an indication of a change in pose of a biometric feature of the user of the computer system relative to one or more biometric sensors of the computer system; and in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a transitory computer-readable storage medium is described. The transitory computer readable storage medium stores one or more programs configured to be executed by one or more processors of a computer system that is in communication with one or more audio output devices, the one or more programs including instructions for: during an enrollment process for generating a representation of a user, where the enrollment process includes capturing information about one or more physical characteristics of the user of the computer system, outputting, via the one or more audio output devices, dynamic audio output of a first type; while outputting the dynamic audio output of the first type, receiving an indication of a change in pose of a biometric feature of the user of the computer system relative to one or more biometric sensors of the computer system; and in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a computer system is described. The computer system is in communication with one or more audio output devices. The computer system comprises: one or more processors; and memory storing one or more programs configured to be executed by the one or more processors, the one or more programs including instructions for: during an enrollment process for generating a representation of a user, where the enrollment process includes capturing information about one or more physical characteristics of the user of the computer system, outputting, via the one or more audio output devices, dynamic audio output of a first type; while outputting the dynamic audio output of the first type, receiving an indication of a change in pose of a biometric feature of the user of the computer system relative to one or more biometric sensors of the computer system; and in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a computer system is described. The computer system is in communication with one or more audio output devices. The computer system comprises: means for, during an enrollment process for generating a representation of a user, where the enrollment process includes capturing information about one or more physical characteristics of the user of the computer system, outputting, via the one or more audio output devices, dynamic audio output of a first type; means for, while outputting the dynamic audio output of the first type, receiving an indication of a change in pose of a biometric feature of the user of the computer system relative to one or more biometric sensors of the computer system; and means for, in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a computer program product is described. The computer program product includes one or more programs configured to be executed by one or more processors of a computer system that is in communication with one or more audio output devices, the one or more programs include instructions for: during an enrollment process for generating a representation of a user, where the enrollment process includes capturing information about one or more physical characteristics of the user of the computer system, outputting, via the one or more audio output devices, dynamic audio output of a first type; while outputting the dynamic audio output of the first type, receiving an indication of a change in pose of a biometric feature of the user of the computer system relative to one or more biometric sensors of the computer system; and in response to receiving the indication of the change in pose of the biometric feature of the user of the computer system relative to the one or more biometric sensors, adjusting the dynamic audio output of the first type based on the change in pose of the biometric feature of the user of the computer system to indicate an amount of progress toward satisfying a set of one or more criteria.

In accordance with some embodiments, a method is described. The method is performed at a computer system that is in communication with one or more display generation components. The method comprises: while a representation of hands of a user of the computer system is visible in an extended reality environment, prompting the user of the computer system to move a position of the hands of the user into a first pose; after prompting the user of the computer system to move the position of the hands of the user into the first pose, detecting that the position of the hands of the user is in the first pose; and after detecting that the position of the hands of the user is in the first pose, prompting the user of the computer system to move the position of the hands of the user into a second pose; after prompting the user of the computer system to move the position of the hands of the user into the second pose, detecting that the position of the hands of the user is in the second pose; and in response to detecting that the position of the hands of the user is in the second pose, outputting confirmation that the position of the hands of the user has been detected in the second pose.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: while a representation of hands of a user of the computer system is visible in an extended reality environment, prompting the user of the computer system to move a position of the hands of the user into a first pose; after prompting the user of the computer system to move the position of the hands of the user into the first pose, detecting that the position of the hands of the user is in the first pose; and after detecting that the position of the hands of the user is in the first pose, prompting the user of the computer system to move the position of the hands of the user into a second pose; after prompting the user of the computer system to move the position of the hands of the user into the second pose, detecting that the position of the hands of the user is in the second pose; and in response to detecting that the position of the hands of the user is in the second pose, outputting confirmation that the position of the hands of the user has been detected in the second pose.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: while a representation of hands of a user of the computer system is visible in an extended reality environment, prompting the user of the computer system to move a position of the hands of the user into a first pose; after prompting the user of the computer system to move the position of the hands of the user into the first pose, detecting that the position of the hands of the user is in the first pose; and after detecting that the position of the hands of the user is in the first pose, prompting the user of the computer system to move the position of the hands of the user into a second pose; after prompting the user of the computer system to move the position of the hands of the user into the second pose, detecting that the position of the hands of the user is in the second pose; and in response to detecting that the position of the hands of the user is in the second pose, outputting confirmation that the position of the hands of the user has been detected in the second pose.

In accordance with some embodiments, a computer system is described. The computer system is in communication with one or more display generation components. The computer system comprises: one or more processors; and memory storing one or more programs configured to be executed by the one or more processors, the one or more programs including instructions for: while a representation of hands of a user of the computer system is visible in an extended reality environment, prompting the user of the computer system to move a position of the hands of the user into a first pose; after prompting the user of the computer system to move the position of the hands of the user into the first pose, detecting that the position of the hands of the user is in the first pose; and after detecting that the position of the hands of the user is in the first pose, prompting the user of the computer system to move the position of the hands of the user into a second pose; after prompting the user of the computer system to move the position of the hands of the user into the second pose, detecting that the position of the hands of the user is in the second pose; and in response to detecting that the position of the hands of the user is in the second pose, outputting confirmation that the position of the hands of the user has been detected in the second pose.

In accordance with some embodiments, a computer system is described. The computer system is in communication with one or more display generation components. The computer system comprises: means for, while a representation of hands of a user of the computer system is visible in an extended reality environment, prompting the user of the computer system to move a position of the hands of the user into a first pose; means for, after prompting the user of the computer system to move the position of the hands of the user into the first pose, detecting that the position of the hands of the user is in the first pose; means for, after detecting that the position of the hands of the user is in the first pose, prompting the user of the computer system to move the position of the hands of the user into a second pose; means for, after prompting the user of the computer system to move the position of the hands of the user into the second pose, detecting that the position of the hands of the user is in the second pose; and means for, in response to detecting that the position of the hands of the user is in the second pose, outputting confirmation that the position of the hands of the user has been detected in the second pose.

In accordance with some embodiments, a computer program product is described. The computer program product includes one or more programs configured to be executed by one or more processors of a computer system that is in communication with one or more display generation components, the one or more programs include instructions for: while a representation of hands of a user of the computer system is visible in an extended reality environment, prompting the user of the computer system to move a position of the hands of the user into a first pose; after prompting the user of the computer system to move the position of the hands of the user into the first pose, detecting that the position of the hands of the user is in the first pose; and after detecting that the position of the hands of the user is in the first pose, prompting the user of the computer system to move the position of the hands of the user into a second pose; after prompting the user of the computer system to move the position of the hands of the user into the second pose, detecting that the position of the hands of the user is in the second pose; and in response to detecting that the position of the hands of the user is in the second pose, outputting confirmation that the position of the hands of the user has been detected in the second pose.

In accordance with some embodiments, a method is described. The method is performed at a computer system that is in communication with one or more display generation components. The method comprises: after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; while concurrently displaying the representation of the user and the control user interface object, receiving input corresponding to the control user interface object; and in response to receiving the input corresponding to the control user interface object, adjusting the appearance of the representation of the user based on the lighting property associated with the representation of the user.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; while concurrently displaying the representation of the user and the control user interface object, receiving input corresponding to the control user interface object; and in response to receiving the input corresponding to the control user interface object, adjusting the appearance of the representation of the user based on the lighting property associated with the representation of the user.

In accordance with some embodiments, a transitory computer-readable storage medium is described. The transitory computer readable storage medium stores one or more programs configured to be executed by one or more processors of a computer system that is in communication with one or more display generation components, the one or more programs including instructions for: after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; while concurrently displaying the representation of the user and the control user interface object, receiving input corresponding to the control user interface object; and in response to receiving the input corresponding to the control user interface object, adjusting the appearance of the representation of the user based on the lighting property associated with the representation of the user.

In accordance with some embodiments, a computer system is described. The computer system is in communication with one or more display generation components. The computer system comprises: one or more processors; and memory storing one or more programs configured to be executed by the one or more processors, the one or more programs including instructions for: after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; while concurrently displaying the representation of the user and the control user interface object, receiving input corresponding to the control user interface object; and in response to receiving the input corresponding to the control user interface object, adjusting the appearance of the representation of the user based on the lighting property associated with the representation of the user.

In accordance with some embodiments, a computer system is described. The computer system is in communication with one or more display generation components. The computer system comprises: means for, after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; means for, while concurrently displaying the representation of the user and the control user interface object, receiving input corresponding to the control user interface object; and means for, in response to receiving the input corresponding to the control user interface object, adjusting the appearance of the representation of the user based on the lighting property associated with the representation of the user.

In accordance with some embodiments, a computer program product is described. The computer program product includes one or more programs configured to be executed by one or more processors of a computer system that is in communication with one or more display generation components, the one or more programs include instructions for: after capturing information about one or more physical characteristics of a user of the computer system, concurrently displaying, via a first display generation component of the one or more display generation components: a representation of the user, where one or more visual characteristics of the representation of the user are based on the captured information about the one or more physical characteristics of the user; and a control user interface object for adjusting an appearance of the representation of the user based on a lighting property associated with the representation of the user; while concurrently displaying the representation of the user and the control user interface object, receiving input corresponding to the control user interface object; and in response to receiving the input corresponding to the control user interface object, adjusting the appearance of the representation of the user based on the lighting property associated with the representation of the user.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7T illustrate example techniques for generating a representation of a user and/or displaying the representation of the user, in accordance with some embodiments.

FIG. 8 is a flow diagram of methods of providing guidance to a user during a process for generating a representation of the user, in accordance with various embodiments.

FIG. 9 is a flow diagram of methods of displaying a preview of a representation of a user, in accordance with various embodiments.

FIG. 10 is a flow diagram of methods of providing guidance to a user before a process for generating a representation of the user, in accordance with various embodiments.

FIGS. 11A and 11B are a flow diagram of methods of providing guidance to a user for aligning a body part of the user with a device, in accordance with various embodiments.

FIG. 12 is a flow diagram of methods of providing guidance to a user for making facial expressions, in accordance with various embodiments.

FIG. 13 is a flow diagram of methods of outputting audio guidance during a process for generating a representation of a user, in accordance with various embodiments.

FIGS. 14A-14D illustrate example techniques for prompting a user to position hands of the user in a plurality of poses, in accordance with some embodiments.

FIG. 15 is a flow diagram of methods of prompting a user to position hands of the user in a plurality of poses, in accordance with some embodiments.

FIGS. 16A-16G illustrate example techniques for adjusting an appearance of a representation of a user, in accordance with some embodiments.

FIG. 17 is a flow diagram of methods of adjusting an appearance of a representation of a user, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system provides non-visual feedback, such as audio feedback and/or haptic feedback, to a user during an enrollment process that includes capturing information about one or more physical characteristics of the user. During the enrollment process, the computer system prompts the user to move a position of a head of the user relative to an orientation of the computer system. The computer system includes a sensor that is positioned on a same side of the computer system as a first display generation component of the computer system, and the sensor is configured to capture the information about the one or more physical characteristics of the user. In some embodiments, the computer system generates a representation of the user based on the captured information about the one or more physical characteristics of the user. After prompting the user to move the position of the head of the user, the computer system determines whether a threshold amount of information about a first physical characteristic of the user has been captured. When the computer system determines that the threshold amount of information about the first physical characteristic of the user has been captured, the computer system outputs the non-visual feedback to confirm that the threshold amount of information has been captured and signaling to the user to prepare for a next step of the enrollment process. When the computer system determines that the threshold amount of information about the first physical characteristic of the user has not been captured, the computer system does not output the non-visual feedback. In some embodiments, the computer system provides audio and/or visual feedback indicating an amount of movement of the position of the head of the user relative to the computer system so that the user can determine whether to continue movement and/or stop movement of the position of the head of the user relative to the computer system.

In some embodiments, a computer system displays different portions of a representation of a user based on movement of the user and/or the computer system relative to one another. The computer system is configured to generate the representation of the user using captured information about one or more physical characteristics of the user. While displaying a first portion of the representation of the user, the computer system is configured to detect movement of the user and/or the computer system relative to one another, and in response to detecting the movement, the computer system displays a second portion, different from the first portion, of the representation of the user. In some embodiments, the computer system displays movement of the representation of the user that mirrors the detected movement of the user and/or the computer system relative to one another. In some embodiments, the computer system is configured to detect movement of the user and/or the computer system relative to one another along multiple different axes and/or in multiple different directions along a respective axis.

In some embodiments, a computer system displays three-dimensional content associated with different steps of an enrollment process that includes capturing one or more physical characteristics of the user. The computer system outputs first three-dimensional content that is associated with a first step of the enrollment process and, after outputting the first three-dimensional content, the computer system outputs second three-dimensional content that is associated with a second step of the enrollment process. The three-dimensional content is configured to provide guidance to a user about various steps of the enrollment process to facilitate a user's ability to perform and/or complete the enrollment process. In some embodiments, the computer system outputs audio feedback with the three-dimensional content, which provides further guidance to the user.

In some embodiments, a computer system displays first and second visual elements that guide a user to align a position of a body of the user with the computer system. The first and second visual elements are displayed at different simulated depths and are configured to move with respect to one another with simulated parallax that is based on movement of the body of the user relative to the computer system. The computer system shifts the displayed positions of the first and second visual elements based on the movement of the body of the user relative to the computer system. The first visual element is indicative of a target orientation and/or alignment of the body of the user and the computer system and the second visual element is indicative of a detected orientation and/or alignment of the body of the user and the computer system. When the first and second visual elements at least partially overlap with one another and/or are otherwise positioned to have a target spatial arrangement, the body of the user and the computer system are aligned with one another, such that one or more sensors of the computer system can capture one or more physical characteristics of the user.

In some embodiments, a computer system displays a progress bar indicating an amount of progress toward a user making one or more facial expressions. The computer system prompts the user to make one or more facial expressions during an enrollment process that includes capturing information about one or more physical characteristics of the user. The computer system detects information about facial features of the user and determines an amount of progress toward making the one or more facial expressions based on the information about the facial features of the user. The computer system then displays the progress bar having a respective appearance that is based on the amount of progress toward making the one or more facial expressions. For instance, when the information about the facial features of the user corresponds to a first facial expression of the one or more facial expressions, the computer system displays the progress bar having a first amount of fill. When the information about the facial features of the user does not correspond to the first facial expression of the one or more facial expressions, the computer system displays the progress bar having a second amount of fill that is less than the first amount of fill. In some embodiments, the progress bar is three-dimensional and extends in a z-direction relative to a viewpoint of the user. In some embodiments, a rate at which the progress bar fills slows down at portions of the progress bar that extend in the z-direction relative to the viewpoint of the user.

In some embodiments, a computer system outputs dynamic audio during an enrollment process that includes capturing one or more physical characteristics of a user. The computer system adjusts output of the dynamic audio based on a change in pose of the user relative to the computer system to provide an audible indication of an amount of progress toward completing a step of the enrollment process. In some embodiments, the computer system outputs and/or displays visual feedback in addition to the dynamic audio. In some embodiments, the dynamic audio includes different components and/or portions that are based on a physical location of the user and/or a physical location of the computer system.

In some embodiments, a computer system prompts a user to position hands of the user in a first pose. After the computer system detects that the position of the hands of the user is in the first pose, the computer system prompts the user to position the hands of the user in a second pose. In response to detecting that the position of the hands of the user is in the second pose, the computer system outputs confirmation so that the user understands that the position of the hands of the user is in the second pose. In some embodiments, the computer system outputs confirmation in response to detecting that the position of the hands of the user is in the first pose. In some embodiments, the computer system captures information about the hands of the user when the position of the hands of the user is in the first pose and/or in the second pose. In some embodiments, the computer system generates a representation of hands of the user based on the captured information about the hands of the user. In some embodiments, the computer system provides feedback to guide the user to position the hands of the user in the first pose and/or in the second pose.

In some embodiments, a computer system concurrently displays a representation of a user and a control user interface object that, when selected, causes the computer system to adjust an appearance of the representation of the user based on a lighting property associated with the representation of the user. In response to detecting user input corresponding to the control user interface object, the computer system adjusts the appearance of the representation of the user based on the lighting property associated with the representation of the user. In some embodiments, the computer system adjusts a skin tone of the representation of the user in response to detecting user input corresponding to the control user interface object. In some embodiments, the lighting property is based on actual lighting conditions that were present in a physical environment in which physical properties of the user of the computer system were captured. In some embodiments, the lighting property is based on simulated lighting in an extended reality environment in which the representation of the user is displayed. In some embodiments, the lighting property includes a color temperature, exposure, and/or brightness of the appearance of the representation of the user. In some embodiments, the computer system adjusts the appearance of the representation of the user based on a magnitude and/or direction associated with the user input corresponding to the control user interface object. In some embodiments, the computer system displays additional control user interface objects that, when selected, cause the computer system to adjust whether the representation of the user is wearing an accessory and/or adjust visual characteristics of the accessory.

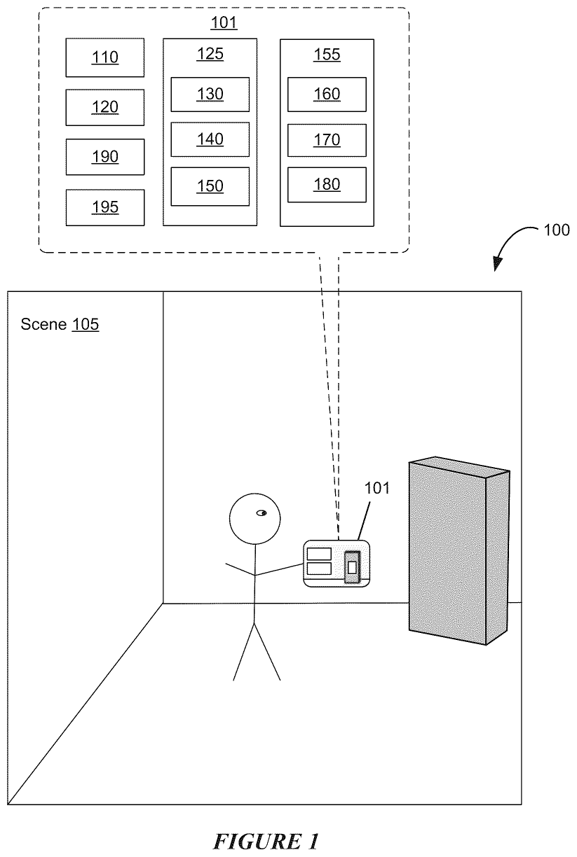

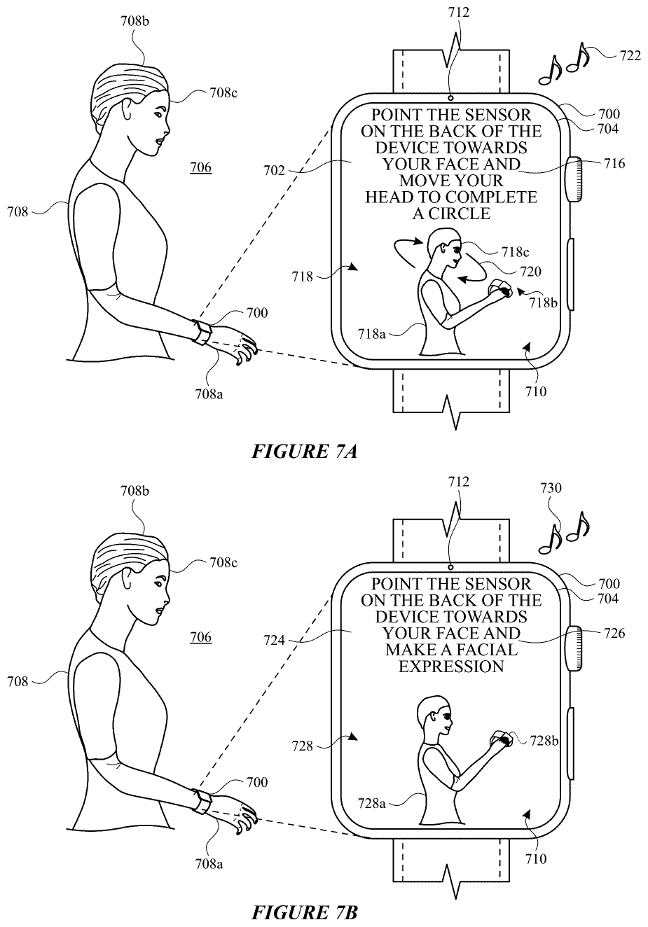

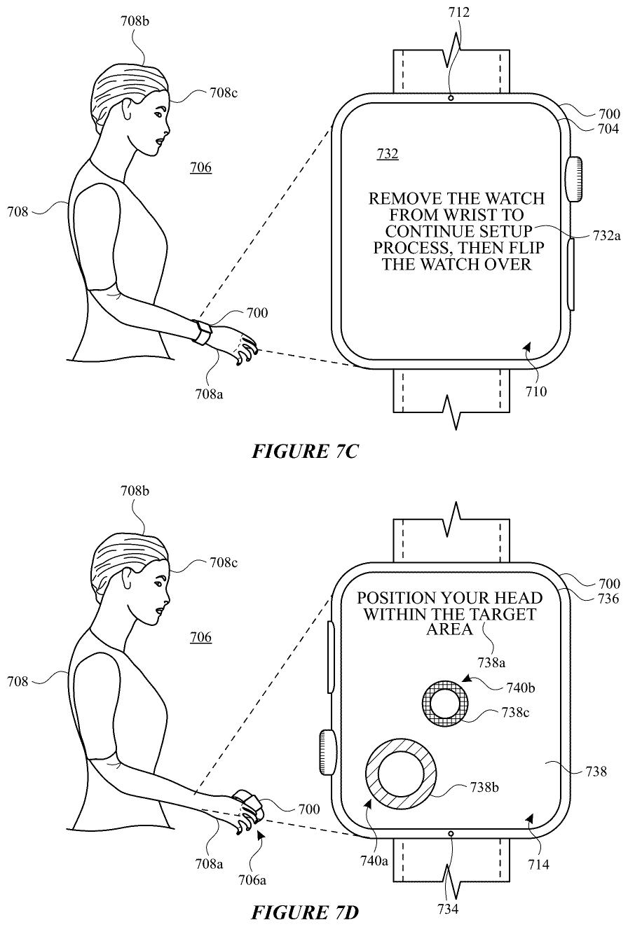

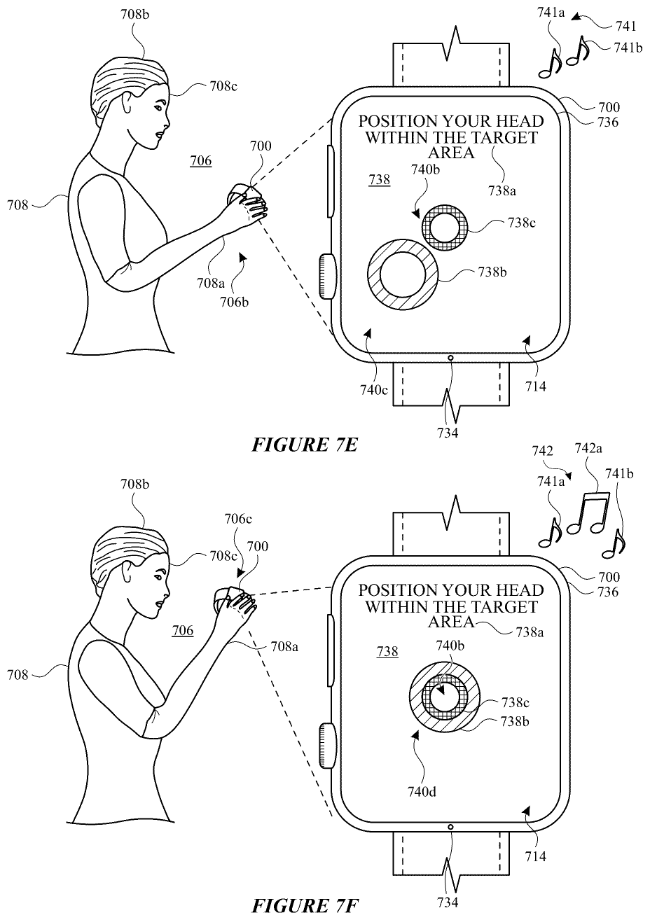

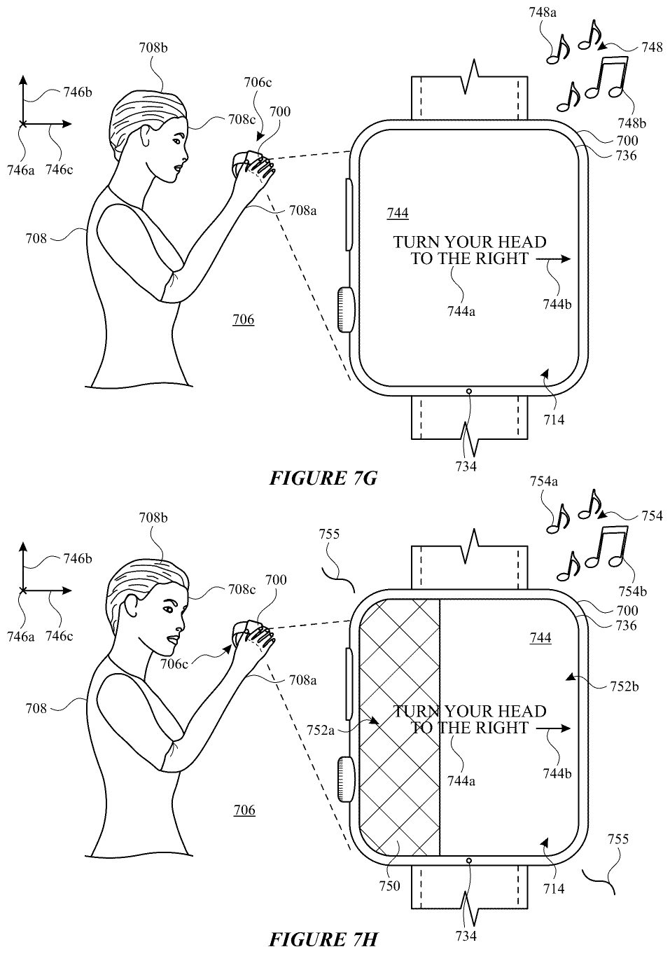

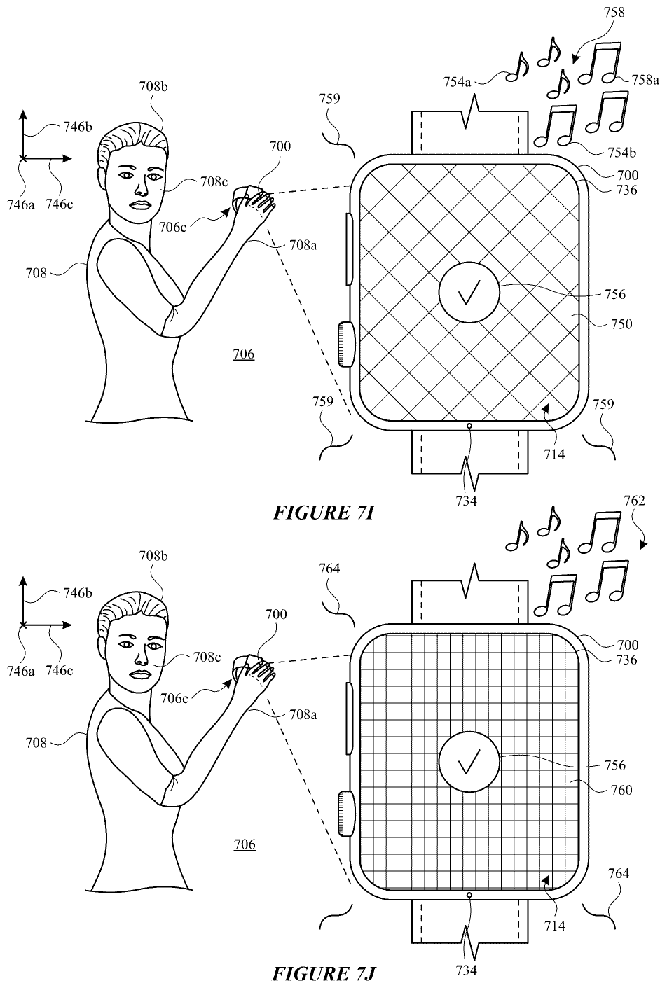

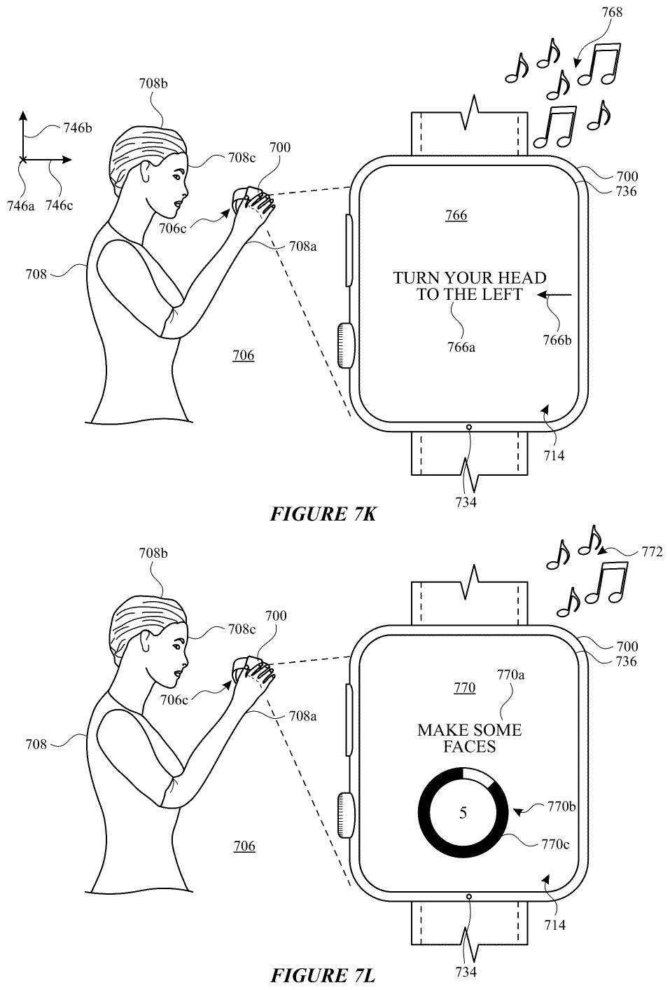

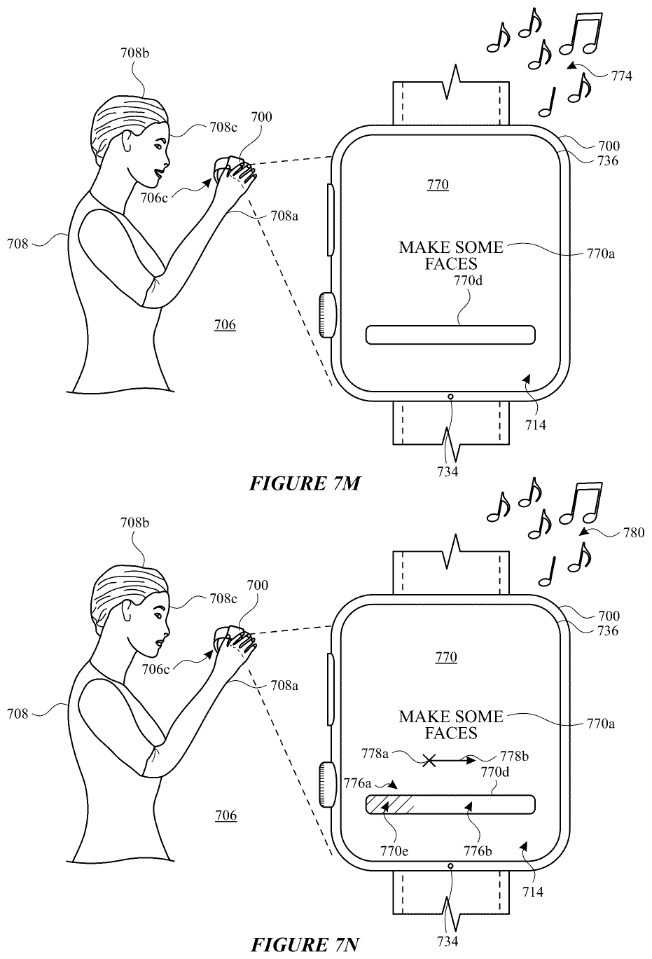

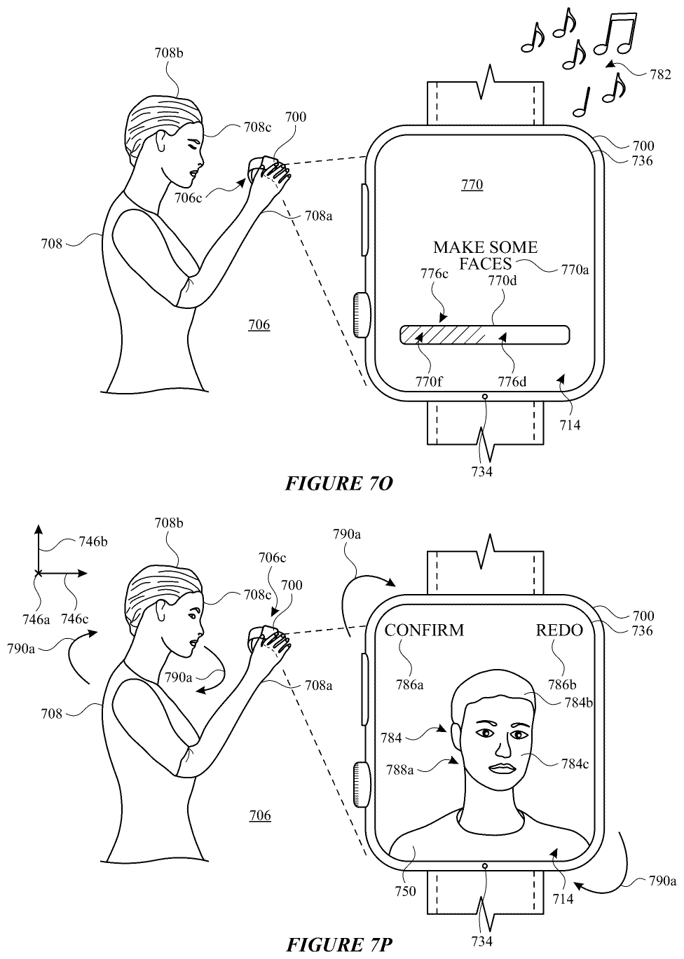

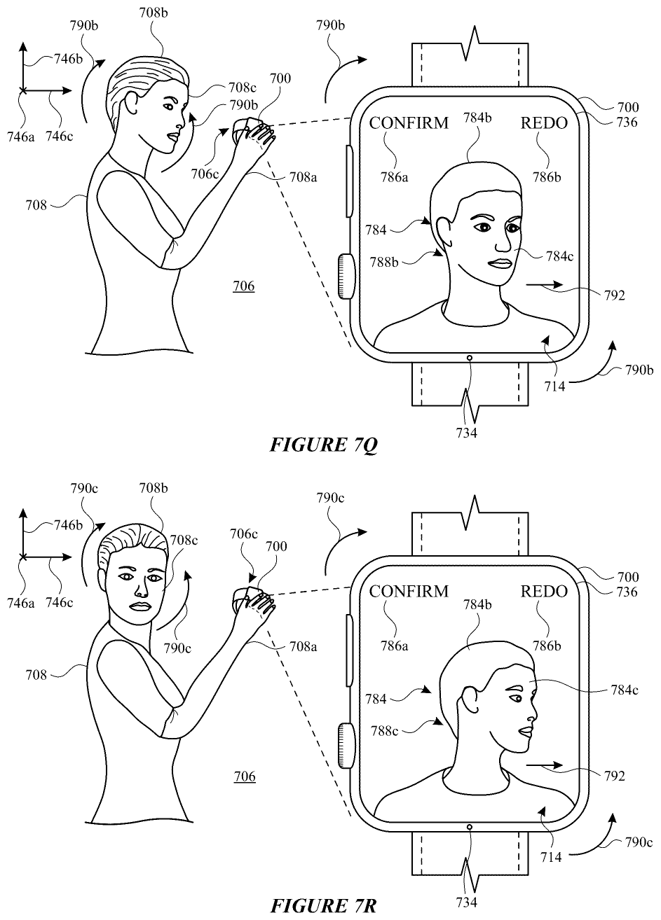

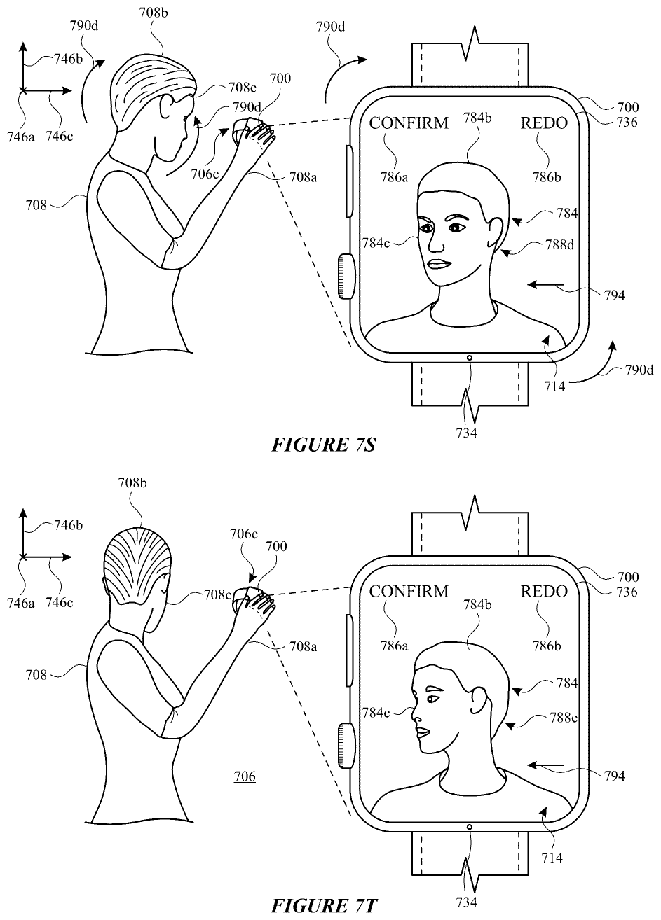

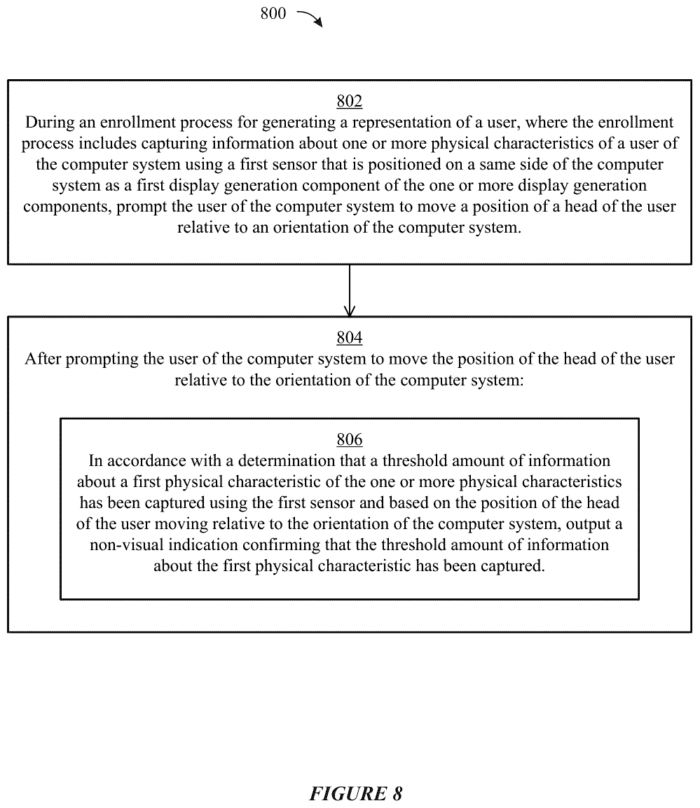

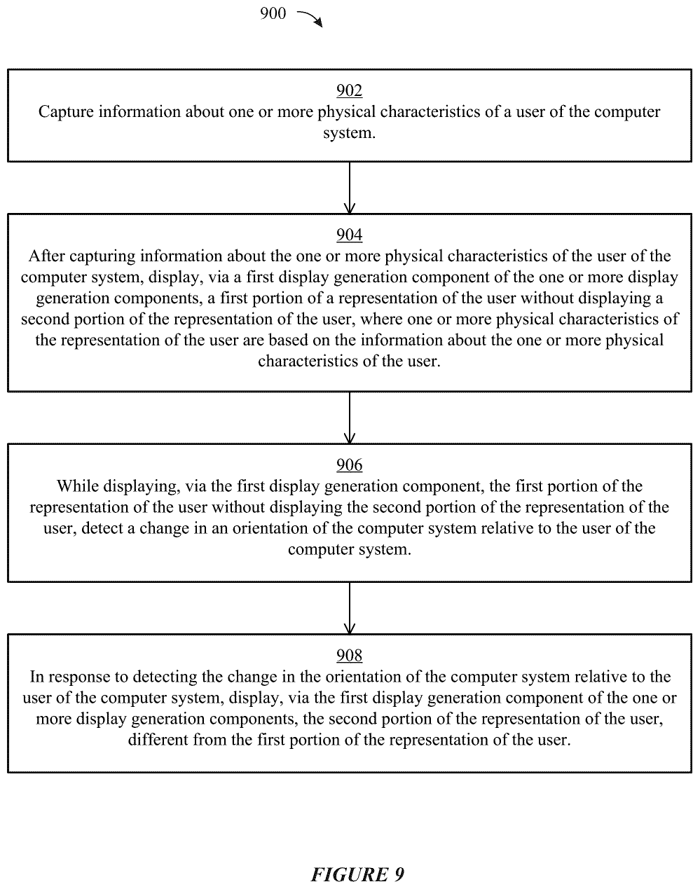

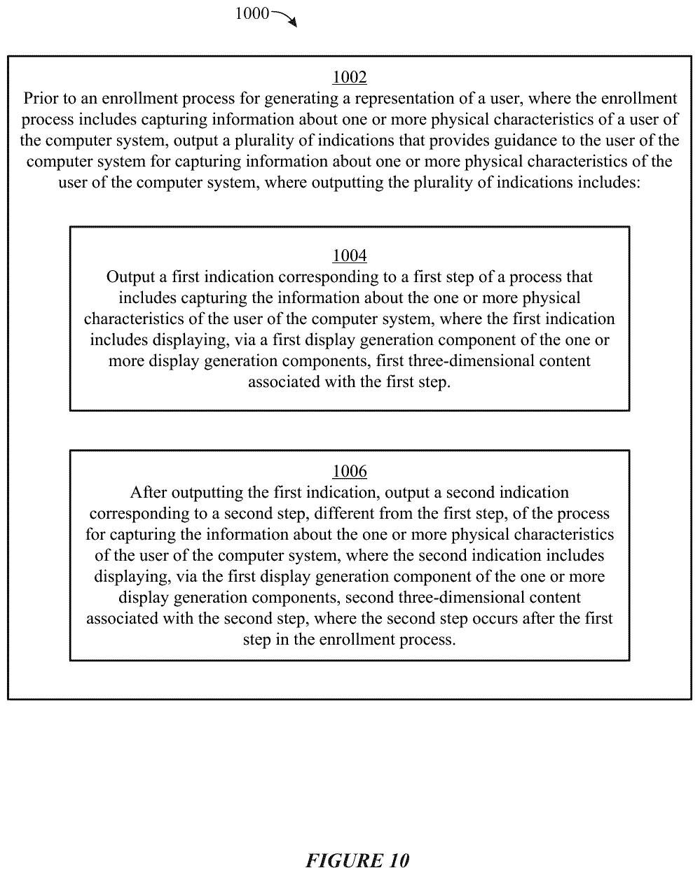

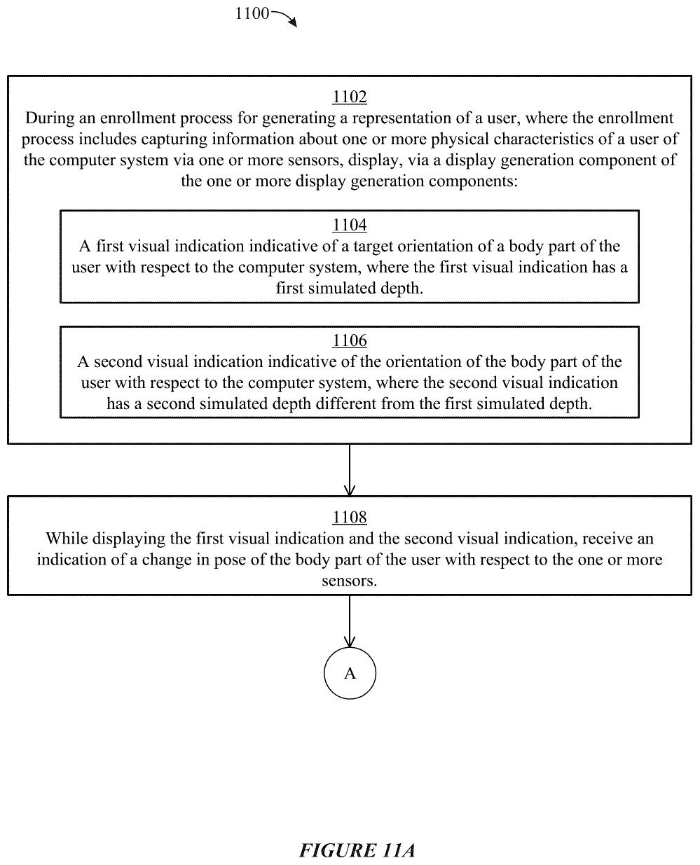

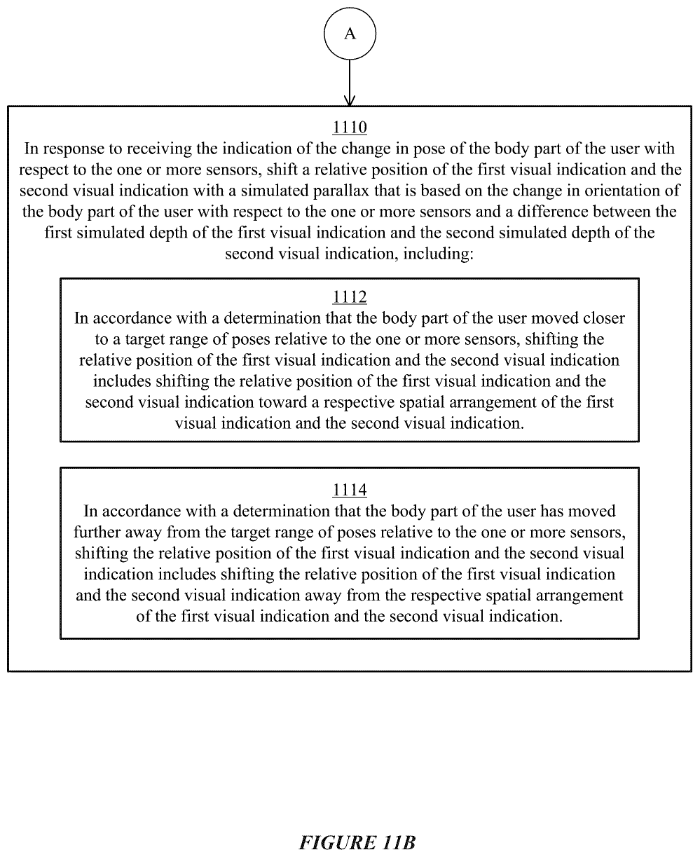

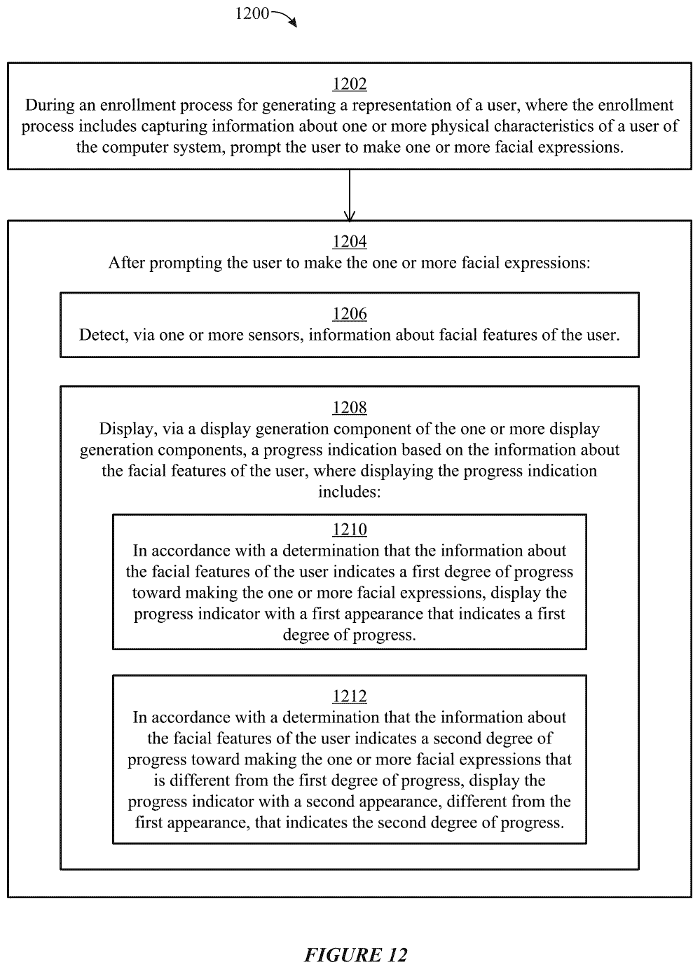

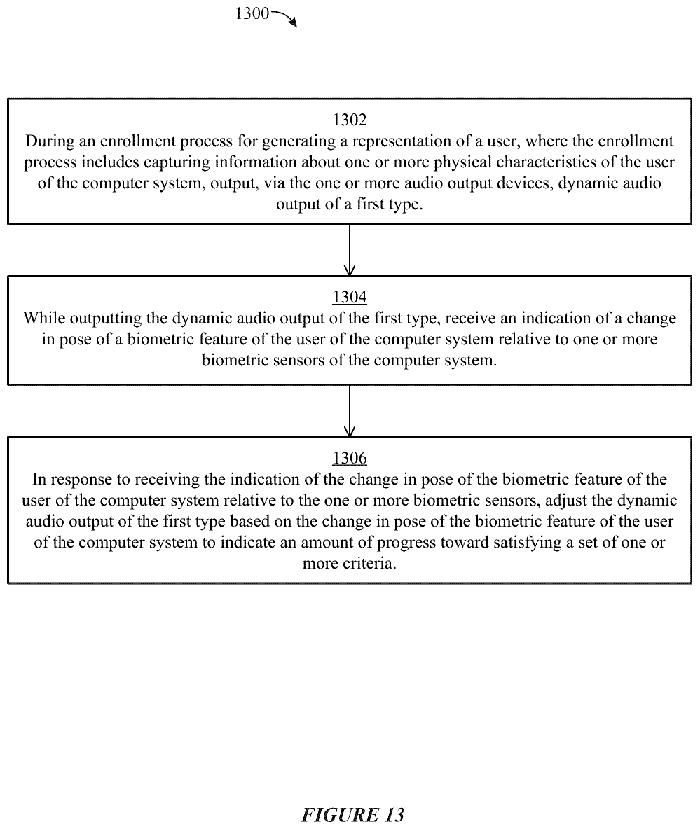

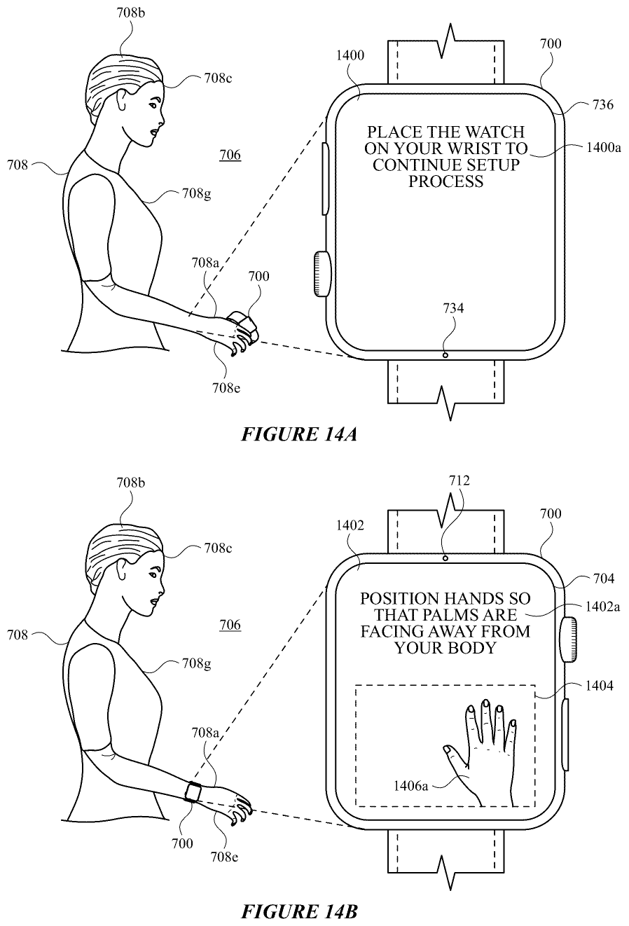

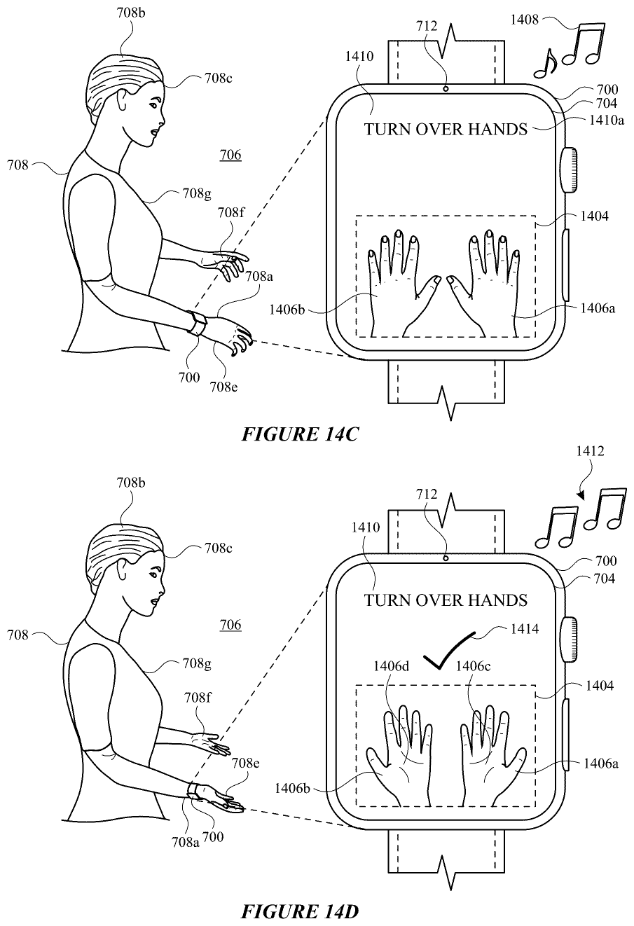

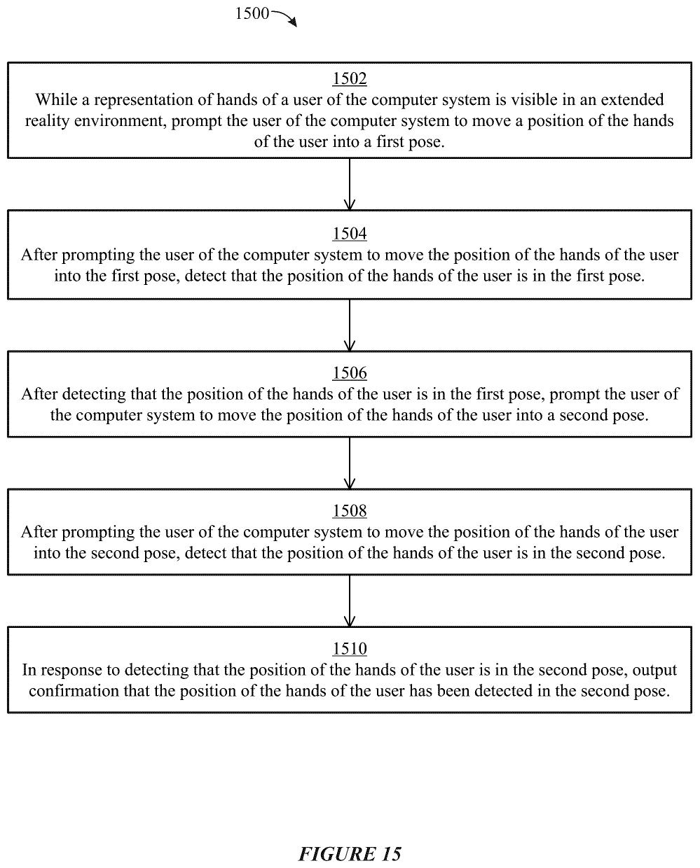

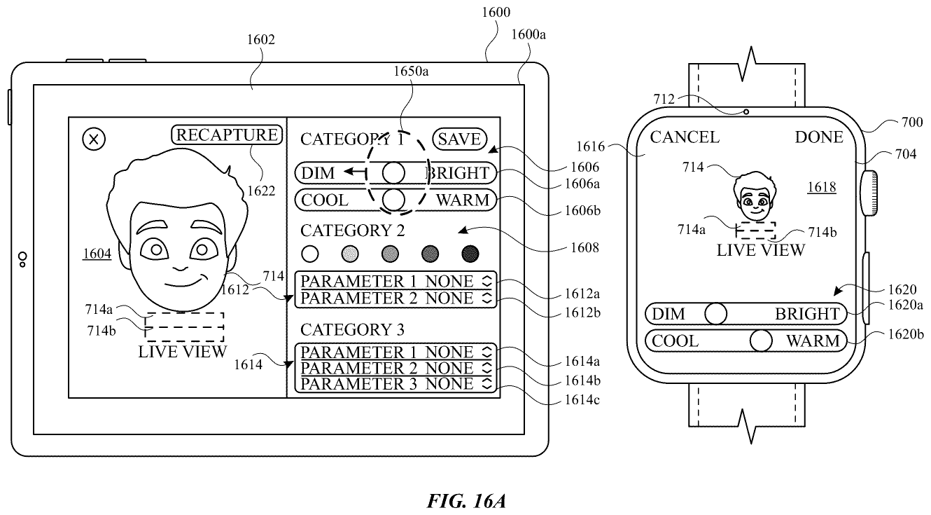

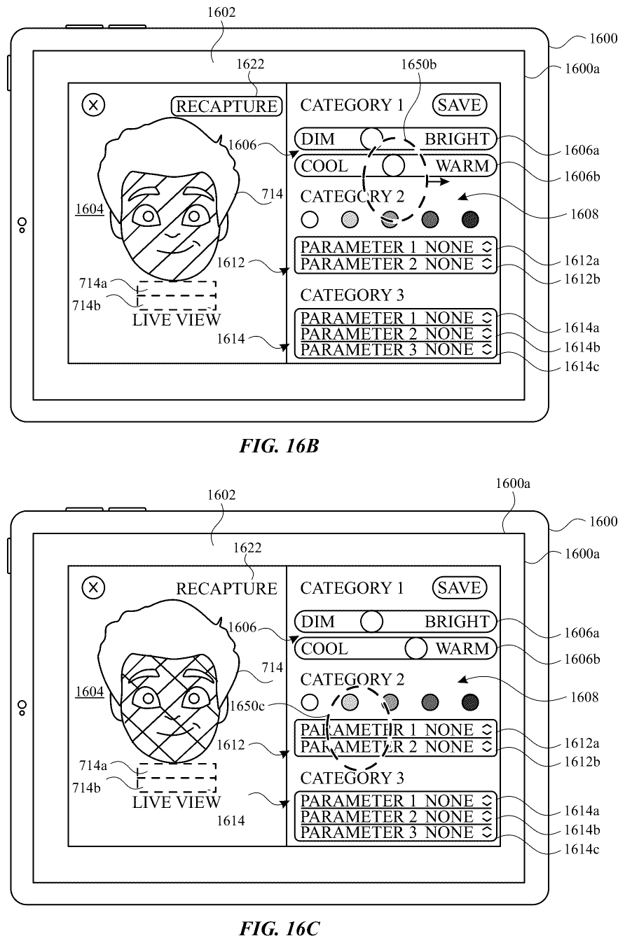

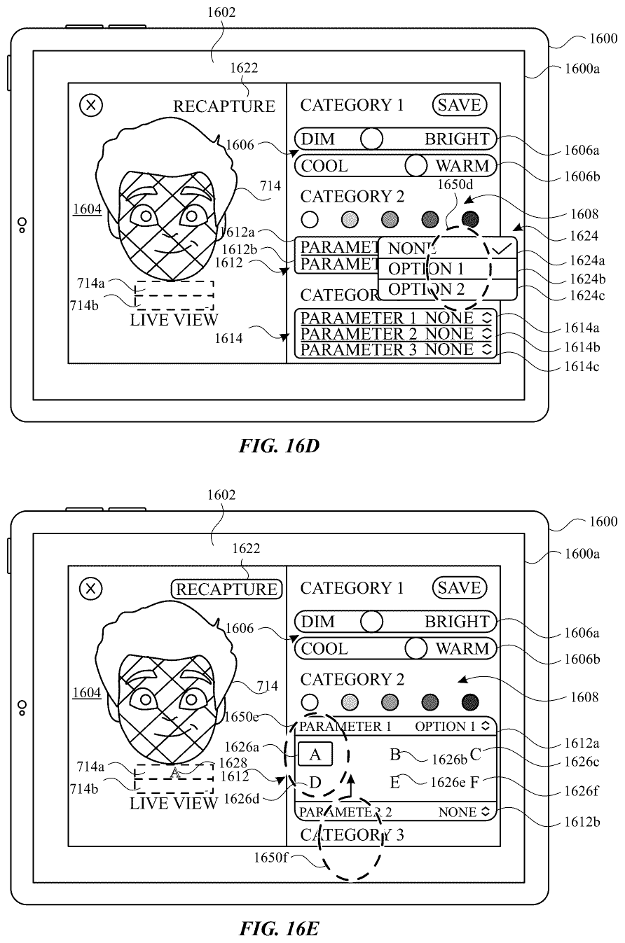

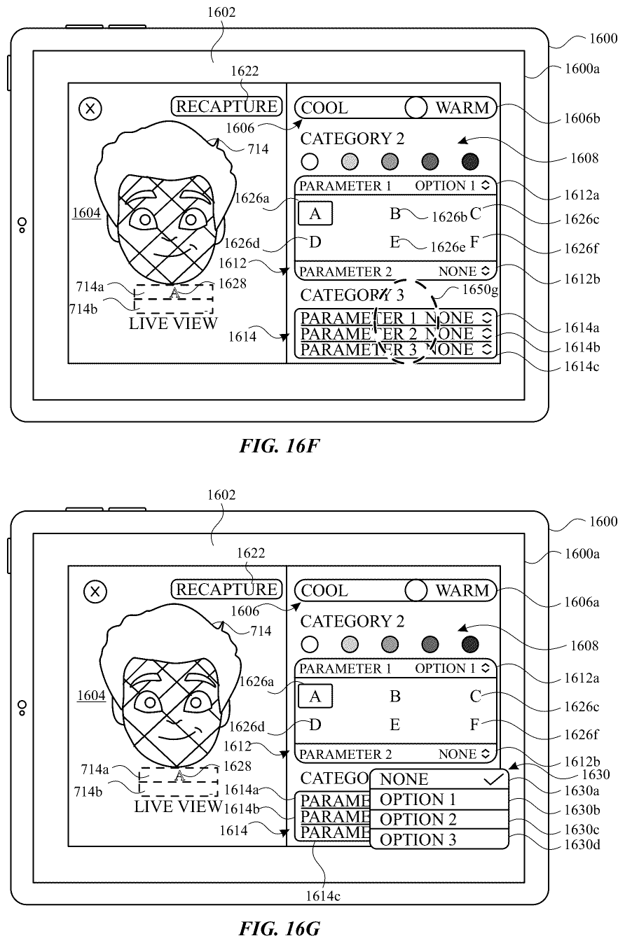

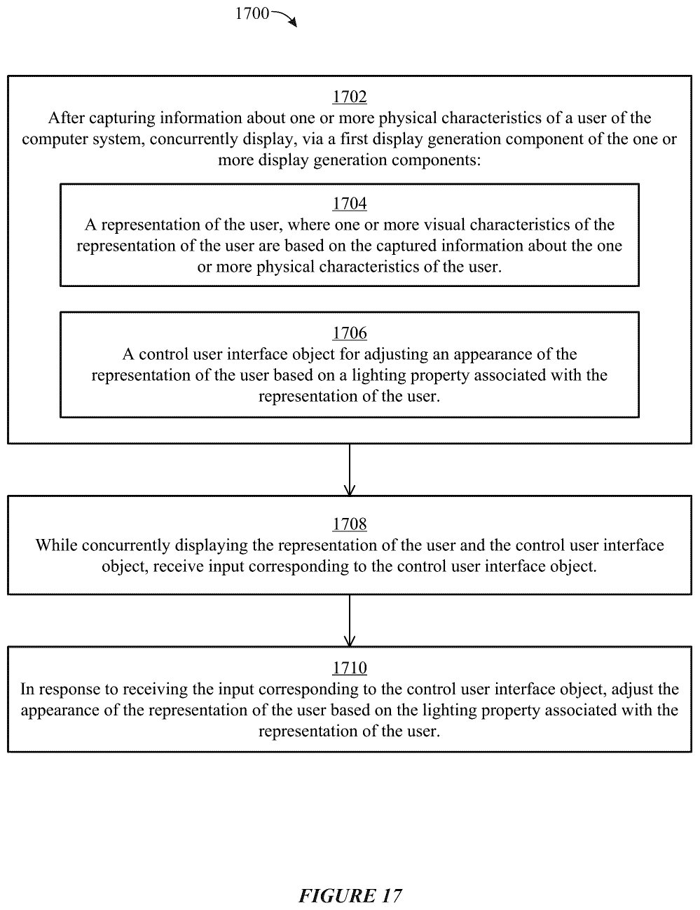

FIGS. 1-6 provide a description of example computer systems for providing XR experiences to users. FIGS. 7A-7T illustrate example techniques for generating and/or displaying a representation of a user, in accordance with some embodiments. FIG. 8 is a flow diagram of methods of providing guidance to a user during a process for generating a representation of the user, in accordance with various embodiments. FIG. 9 is a flow diagram of methods of displaying a preview of a representation of a user, in accordance with various embodiments. FIG. 10 is a flow diagram of methods of providing guidance to a user before a process for generating a representation of the user, in accordance with various embodiments. FIGS. 11A and 11B are a flow diagram of methods of providing guidance to a user for aligning a body part of the user with a device, in accordance with various embodiments. FIG. 12 is a flow diagram of methods of providing guidance to a user for making facial expressions, in accordance with various embodiments. FIG. 13 is a flow diagram of methods of outputting audio guidance during a process for generating a representation of a user, in accordance with various embodiments. The user interfaces in FIGS. 7A-7T are used to illustrate the processes in FIGS. 8-13. FIGS. 14A-14D illustrate example techniques for prompting a user to position hands of the user in a plurality of poses, in accordance with some embodiments. FIG. 15 is a flow diagram of methods of prompting a user to position hands of the user in a plurality of poses, in accordance with various embodiments. The user interfaces in FIGS. 14A-14D are used to illustrate the process in FIG. 15. FIGS. 16A-16G illustrate example techniques for adjusting an appearance of a representation of a user, in accordance with some embodiments. FIG. 17 is a flow diagram of methods of adjusting an appearance of a representation of a user, in accordance with various embodiments. The user interfaces in FIGS. 16A-16G are used to illustrate the process in FIG. 17.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, and/or a touch-screen), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, and/or velocity sensors), and optionally one or more peripheral devices 195 (e.g., home appliances, and/or wearable devices). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

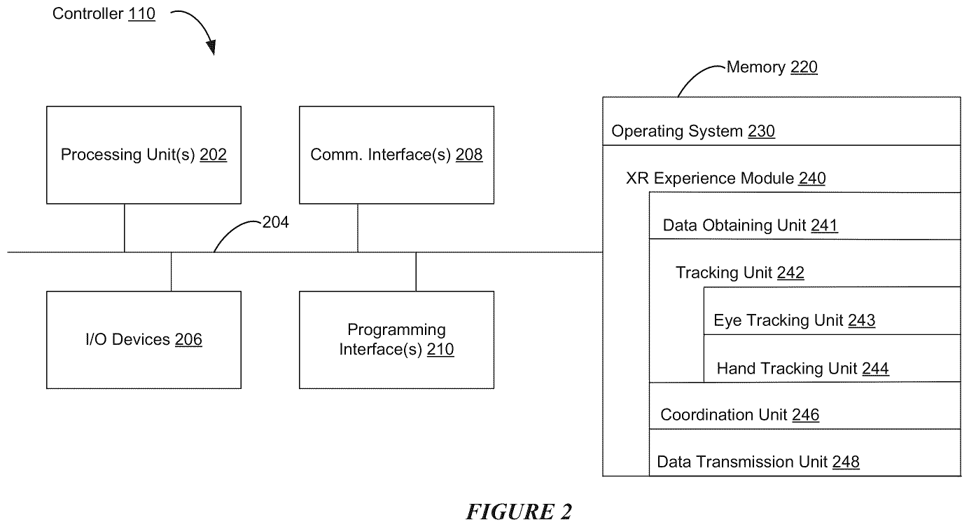

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server and/or central server). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, and/or IEEE 802.3x). In another example, the controller 110 is included within the enclosure (e.g., a physical housing) of the display generation component 120 (e.g., an HMD, or a portable electronic device that includes a display and one or more processors), one or more of the input devices 125, one or more of the output devices 155, one or more of the sensors 190, and/or one or more of the peripheral devices 195, or share the same physical enclosure or support structure with one or more of the above.

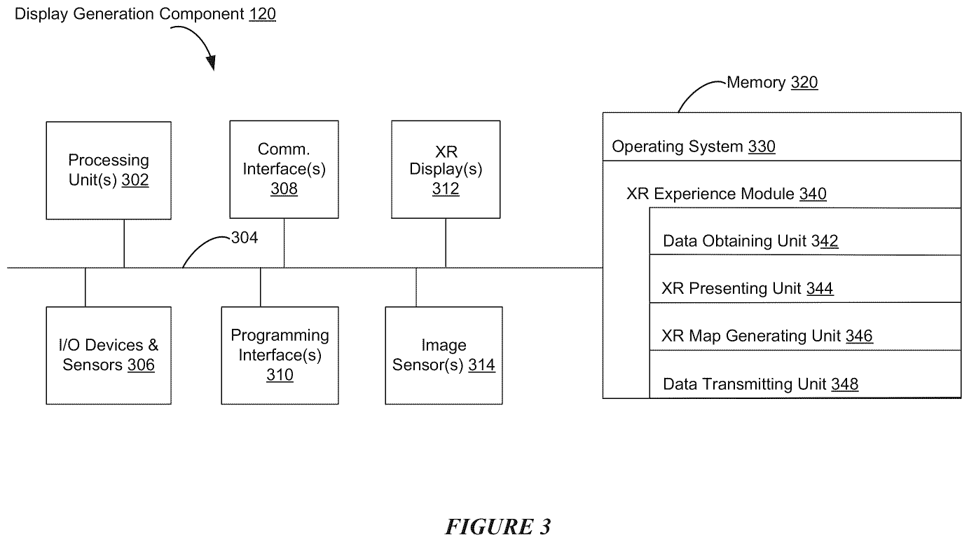

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head and/or on his/her hand.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, and/or location data) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

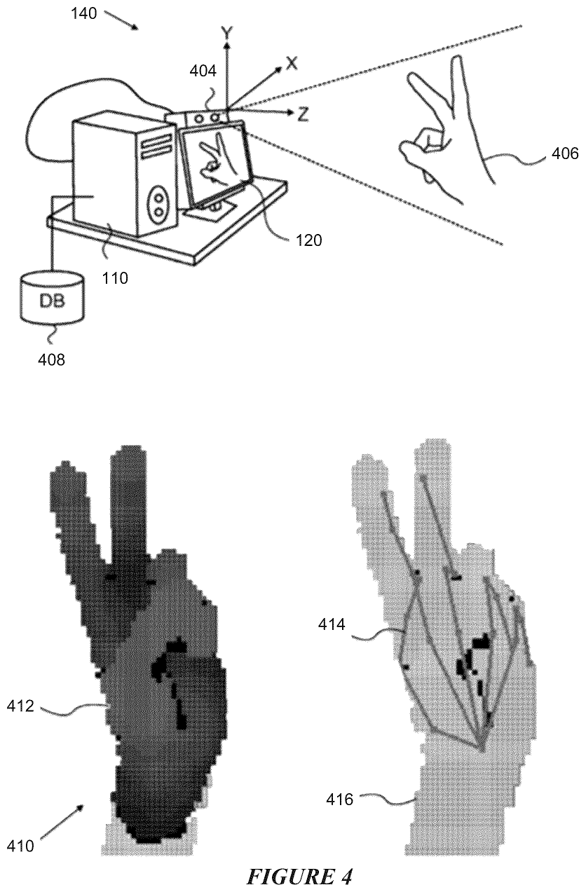

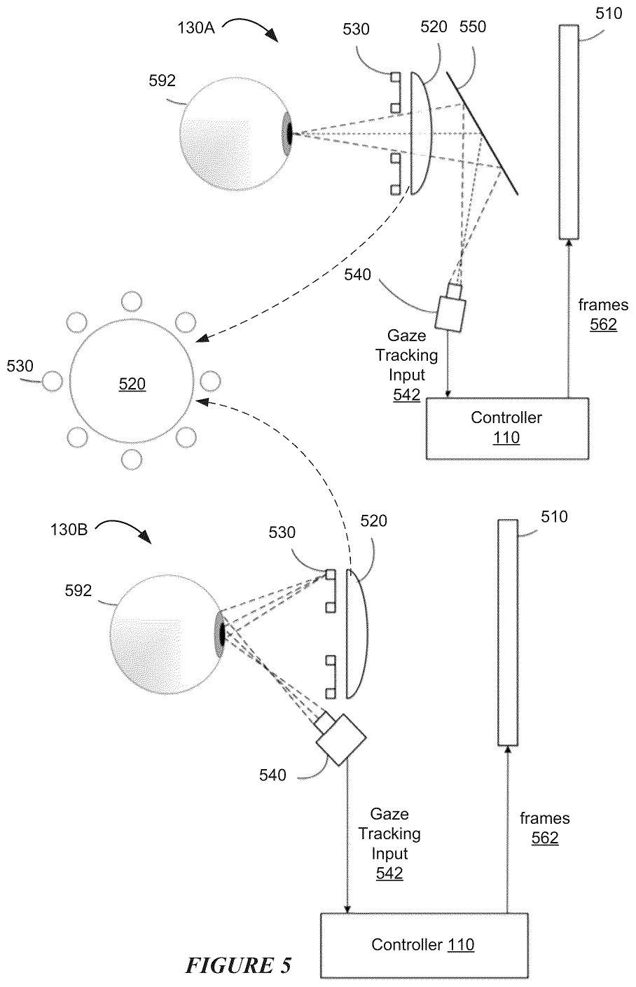

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data and/or location data) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, and/or blood glucose sensor), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, and/or location data) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data and/or location data) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, and/or end of the hand connecting to wrist) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, and/or a projector) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

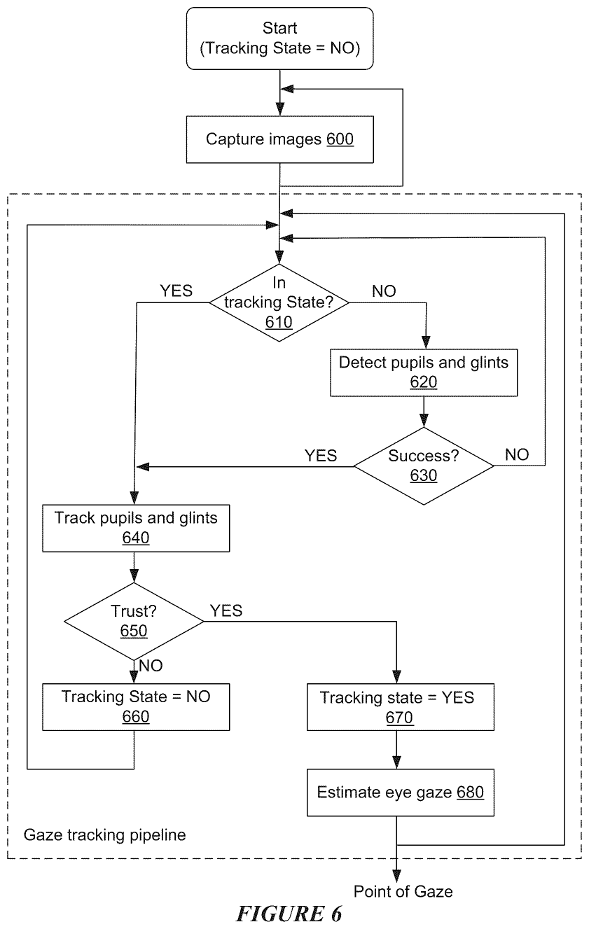

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### USER INTERFACES AND ASSOCIATED PROCESSES

Attention is now directed towards embodiments of user interfaces (“UP”) and associated processes that may be implemented on a computer system, such as a portable multifunction device or a head-mounted device, in communication with one or more display generation components and (optionally) one or more audio output devices.

FIGS. 7A-7T illustrate examples of generating and/or displaying a representation of a user. FIG. 8 is a flow diagram of an exemplary method 800 for providing guidance to a user during a process for generating a representation of the user. FIG. 9 is a flow diagram of an exemplary method 900 for displaying a preview of a representation of a user. FIG. 10 is a flow diagram of an exemplary method 1000 for providing guidance to a user before a process for generating a representation of the user. FIGS. 11A and 11B are a flow diagram of an exemplary method 1100 for providing guidance to a user for aligning a body part of the user with a device. FIG. 12 is a flow diagram of an exemplary method 1200 for providing guidance to a user for making facial expressions. FIG. 13 is a flow diagram of an exemplary method 1300 for outputting audio guidance during a process for generating a representation of a user. The user interfaces in FIGS. 7A-7T are used to illustrate the processes described below, including the processes in FIGS. 8-13.

FIGS. 7A-7T illustrate examples for capturing information that is used to generate a representation of a user and/or examples of displaying a representation of a user. In some embodiments, the representation of the user is displayed and/or otherwise used to communicate during a real-time communication session. In some embodiments, a real-time communication session includes real-time communication between the user of the computer system and a second user associated with a second computer system, different from the computer system, and the real-time communication session includes displaying and/or otherwise communicating, via the computer system and/or the second computer system, the user's facial and/or body expressions to the second user via the representation of the user. In some embodiments, the real-time communication session includes displaying the representation of the user and/or outputting audio corresponding to utterances of the user in real time. In some embodiments, the computer system and the second computer system are in communication with one another (e.g., wireless communication and/or wired communication) to enable information indicative of the representation of the user and/or audio corresponding to utterances of the user to be transmitted between one another. In some embodiments, the real-time communication session includes displaying the representation of the user (and, optionally, a representation of the second user) in an extended reality environment via display devices of the computer system and the second computer system.

While FIGS. 7A-7T illustrate computer system 700 as a watch, in some embodiments, computer system 700 is a head-mounted device (HMD). The HMD is configured to be worn on head 708b of user 708 and includes a first display on and/or in an interior portion of the HMD. The first display is visible to user 708 when user 708 is wearing the HMD on head 708b of user 708. For instance, the HMD at least partially covers the eyes of user 708 when placed on head 708b of user 708, such that the first display is positioned over and/or in front of the eyes of user 708. In some embodiments, the first display is configured to display an extended reality environment during a real-time communication session in which a user of the HMD is participating. In some embodiments, the HMD also includes a second display that is positioned on and/or in an exterior portion of the HMD. In some embodiments, the second display is not visible to user 708 when the HMD is placed on head 708b of user 708. In some embodiments, the first display of HMD is configured to display one or more tutorial indications (e.g., tutorial indications 702 and/or 724) about a process for capturing information about user 708 and/or display one or more prompts (e.g., prompt 732 and/or other prompts) instructing user 708 to remove the HMD from head 708b of user 708. The second display of the HMD displays one or more visual indications (e.g., prompts 744 and/or 766) providing user 708 with guidance for using the HMD to capture information about user 708 that is used to generate a representation of user (e.g., representation 784), as set forth below.

FIG. 7A illustrates computer system 700 (e.g., a watch and/or a smart watch) displaying tutorial indication 702 on display 704 of computer system 700. In addition, FIG. 7A shows physical environment 706 of user 708 who is using and/or associated with computer system 700. At FIG. 7A, computer system 700 is being worn on wrist 708a of user 708 within physical environment 706. Computer system 700 is a wearable device that is configured to be worn on the body of user 708 (e.g., on wrist 708a of user 708 and/or on head 708b of user 708). In some embodiments, computer system 700 is a headset, helmet, goggles, glasses, or a handheld device placed in a wearable frame. In some embodiments, computer system 700 is configured to be primarily used when worn on the body of user 708, but computer system 700 can also be used (e.g., interacted with via user 708 and/or used to capture information) when computer system 700 is removed from the body of user 708.

FIG. 7A illustrates first portion 710 (e.g., a first face and/or first side; a front side; and/or an interior portion of a head-mounted device (HMD)) of computer system 700, which includes display 704 and sensor 712 (e.g., an image sensor, such as a camera). When computer system 700 is worn on wrist 708a (or another portion of the body of user 708, such as head 708b and/or face 708c) of user 708, first portion 710 of computer system 700 is visible and/or unobstructed by a portion of the body of user 708. In other words, first portion 710 of computer system 700 is configured to be positioned so that display 704 is visible to user 708 (e.g., display 704 faces a direction that is opposite of wrist 708a and/or display 704 is positioned over and/or in front of eyes of user 708) when computer system 700 is positioned on wrist 708a of user 708 (or another portion of the body of user 708, such as head 708b and/or face 708c of user 708). As set forth below, computer system 700 also includes second portion 714 (e.g., a second face and/or second side; a back side; and/or an exterior portion of the HMD), which is illustrated at FIG. 7D. When computer system 700 is worn on wrist 708a of user 708 (or another portion of the body of user 708, such as head 708b and/or face 708c of user 708), second portion 714 of computer system 700 is obstructed by (e.g., resting on, contacting, and/or otherwise, positioned near) wrist 708a of user 708 (e.g., second portion 714 of the HMD is not visible to user when the HMD is placed on head 708b of user 708 because first portion 710 is covering and/or in front of the eyes of user 708). In other words, second portion 714 of computer system 700 is positioned so that a surface of second portion 714 faces a direction toward wrist 708a of user 708 (e.g., away from face 708c of user 708) while computer system 700 is worn on wrist 708a of user 708.

At FIG. 7A, computer system 700 is worn on the body (e.g., wrist 708a and/or another portion of the body, such as head 708b and/or face 708c) of user 708 and computer system 700 is displaying tutorial indication 702 on display 704. In some embodiments, computer system 700 displays tutorial indication 702 before a process for capturing information about user 708 (e.g., one or more physical characteristics of user 708) that is used to generate a representation of user 708, such as a virtual representation (e.g., representation 784) of user 708 and/or an avatar of user 708 that includes visual characteristics that are based on the captured information about user 708. In some embodiments, computer system 700 displays tutorial indication 702 after detecting a request to initiate the process for capturing information about user 708. In some embodiments, computer system 700 displays tutorial indication 702 as part of an initial setup process for computer system 700, where the initial setup process for computer system 700 is initiated when computer system 700 is first powered on and/or when user 708 first signs into an account associated with computer system 700. In some embodiments, computer system 700 displays tutorial indication 702 after receiving and/or detecting a request to launch a real-time communication application of computer system 700 for the first time (e.g., computer system 700 is configured to use and/or display a representation of user 708 during a real-time communication session associated with the real-time communication application, and when a representation of user 708 has not been generated, computer system 700 displays tutorial indication 702).

Tutorial indication 702 includes text 716 and visual indication 718 that provide user 708 with guidance for performing a first step of the process for capturing information about user 708. At FIG. 7A, text 716 includes written guidance and/or instructions for completing a step (e.g., a first step) of the process for capturing information about user 708. For instance, text 716 includes guidance for pointing a sensor (e.g., sensor 734) of computer system 700 on portion 714 of computer system 700 toward head 708b of user 708 and for moving head 708b to complete the step of the process for capturing information about user 708. At FIG. 7A, text 716 provides an explanation of and/or is otherwise associated with visual indication 718. For instance, visual indication 718 includes user representation 718a and device representation 718b demonstrating the first step of the process for capturing information about user 708. User representation 718a is demonstrating movement of head representation 718c with respect to device representation 718b, as indicated by arrows 720 at FIG. 7A.

In some embodiments, visual indication 718 is animated, such that user representation 718a and/or device representation 718b move over time to demonstrate the movement associated with the step for capturing information about user 708. In some embodiments, visual indication 718 is a recording (e.g., a video) of a person (e.g., represented by user representation 718a) performing the first step for capturing information about user 708. In some embodiments, visual indication 718 is three-dimensional, such that user representation 718a and/or device representation 718b appear to extend along three different and/or separate axes with respect to display 704. In some embodiments, visual indication 718 is displayed within a three-dimensional environment that includes one or more representations of physical objects within physical environment 706. In some embodiments, the one or more representations of physical objects within physical environment 706 are generated based on information captured by one or more sensors of computer system 700 (e.g., sensor 712, sensor 734, and/or additional sensors of computer system 700). In some embodiments, the one or more representations of physical objects within physical environment 706 are generated via spatial capture techniques and/or stereoscopically (e.g., based on information captured by one or more sensors of computer system 700).

At FIG. 7A, computer system 700 outputs audio 722 while displaying tutorial indication 702. In some embodiments, audio 722 is based on audio (e.g., audio 748, audio 754, audio 758, audio 762, and/or audio 768) that computer system 700 is configured to output during a step of the process for capturing information about user 708 that is associated with tutorial indication 702. As such, user 708 can listen to audio 722 while computer system 700 displays tutorial indication 702 and become familiar with audio prompts and/or other audio feedback that computer system 700 outputs during the step of the process for capturing information about user 708. User 708 can thus complete the step of the process for capturing information about user 708 more quickly and efficiently by familiarizing themselves with audio 722. In some embodiments, audio 722 is not based on audio that computer system 700 is configured to output during the step of the process for capturing information about user 708.

As set forth above, in some embodiments, computer system 700 is the HMD, and display 704 is an interior display of the HMD. In other words, display 704 is configured to be viewed by user 708 while the HMD is be worn on head 708b of user 708 and/or while first portion 710 covers the eyes of user 708. In some embodiments, tutorial indication 702 is displayed on display 704 while computer system 700 detects that user 708 is wearing the HMD on head 708b of user 708. In some embodiments, computer system 700 detects that user 708 is wearing computer system 700 based on detecting (e.g., detecting a presence of) a biometric feature, such as eyes or other facial features, of user 708.

At FIG. 7B, computer system 700 continues to be worn on the body (e.g., wrist 708a and/or another portion of the body, such as head 708b and/or face 708c) of user 708 and computer system 700 is displaying second tutorial indication 724 on display 704. In some embodiments, computer system 700 displays second tutorial indication 724 after displaying (e.g., after ceasing to display) tutorial indication 702. In some embodiments, computer system 700 displays a transition (e.g., a transition animation) between displaying tutorial indication 702 and second tutorial indication 724 to indicate that tutorial indication 702 and second tutorial indication 724 are associated with separate, distinct steps of the process for capturing information about user 708.

In some embodiments, computer system 700 displays second tutorial indication 724 before the process for capturing information about user 708 (e.g., one or more physical characteristics of user 708) that is used to generate a representation of user 708, such as a virtual representation of user 708 and/or an avatar of user 708 that includes visual characteristics that are based on the captured information about user 708. In some embodiments, computer system 700 displays second tutorial indication 724 after detecting a request to initiate the process for capturing information about user 708. In some embodiments, computer system 700 displays second tutorial indication 724 as part of an initial setup process for computer system 700, where the initial setup process for computer system 700 is initiated when computer system 700 is first powered on and/or when user 708 first signs into an account associated with computer system 700. In some embodiments, computer system 700 displays second tutorial indication 724 after receiving and/or detecting a request to launch a real-time communication application of computer system 700 for the first time (e.g., computer system 700 is configured to use and/or display a representation of user 708 during a real-time communication session associated with the real-time communication application, and when a representation of user 708 has not been generated, computer system 700 displays second tutorial indication 724).

At FIG. 7B, second tutorial indication 724 includes text 726 and visual indication 728 that provide user 708 with guidance for performing a step (e.g., a second step) of the process for capturing information about user 708, which is different from (e.g., separate and distinct from) the step of the process for capturing information about user 708 associated with first tutorial indication 702. Text 726 includes written guidance and/or instructions for completing the step of the process for capturing information about user 708. For instance, text 726 includes guidance for pointing a sensor (e.g., sensor 734 and/or one or more additional sensors of computer system 700) of computer system 700 on portion 714 of computer system 700 toward head 708b of user 708 and for making facial expressions to complete the step of the process for capturing information about user 708. At FIG. 7B, text 726 provides an explanation of and/or is otherwise associated with visual indication 728. For instance, visual indication 728 includes user representation 728a and device representation 728b demonstrating the second step of the process for capturing information about user 708. User representation 728a is demonstrating a representation of a person making one or more facial expressions (e.g., an open mouth smile, a closed mouth smile, and/or a raised eyebrows expression).

In some embodiments, visual indication 728 is animated, such that user representation 728a and/or device representation 728b move over time to demonstrate the one or more actions associated with the step for capturing information about user 708. In some embodiments, visual indication 728 is a recording (e.g., a video) of a person (e.g., represented by user representation 728a) performing the step for capturing information about user 708. In some embodiments, visual indication 728 is three-dimensional, such that user representation 728a and/or device representation 728b appear to extend along three different and/or separate axes with respect to display 704. In some embodiments, visual indication 728 is displayed within a three-dimensional environment that includes one or more representations of physical objects within physical environment 706. In some embodiments, the one or more representations of physical objects within physical environment 706 are generated based on information captured by one or more sensors (e.g., sensor 712, sensor 734, and/or one or more additional sensors of computer system 700) of computer system 700. In some embodiments, the one or more representations of physical objects within physical environment 706 are generated via spatial capture techniques and/or stereoscopically (e.g., based on information captured by one or more sensors of computer system 700).

At FIG. 7B, computer system 700 outputs audio 730 while displaying second tutorial indication 724. In some embodiments, audio 730 is based on audio (e.g., audio 772, audio 774, audio 780, and/or audio 782) that computer system 700 is configured to output during a step of the process for capturing information about user 708 that is associated with second tutorial indication 724. As such, user 708 can listen to audio 730 while computer system 700 displays second tutorial indication 724 and become familiar with audio prompts and/or other audio feedback that computer system 700 outputs during the step of the process for capturing information about user 708. User 708 can thus complete the step of the process for capturing information about user 708 more quickly and efficiently by familiarizing themselves with audio 730. In some embodiments, audio 730 is not based on audio that computer system 700 is configured to output during the step of the process for capturing information about user 708.

As set forth above, in some embodiments, computer system 700 is the HMD, and display 704 is an interior display of the HMD. In other words, display 704 is configured to be viewed by user 708 while the HMD is be worn on head 708b of user 708 and portion 710 covers the eyes of user 708. In some embodiments, second tutorial indication 724 is displayed on display 704 while computer system 700 detects that user 708 is wearing the HMD on head 708b of user 708. In some embodiments, computer system 700 detects that user 708 is wearing computer system 700 based on detecting (e.g., detecting a presence of) a biometric feature, such as eyes or other facial features, of user 708.

At FIG. 7C, computer system 700 displays prompt 732 after displaying tutorial indication 702 and/or second tutorial indication 724 (and, optionally, additional tutorial indications associated with additional steps of the process for capturing information about user 708). Prompt 732 includes visual indication 732a (e.g., text and/or graphics) instructing user 708 to remove computer system 700 from the body of user 708 (e.g., remove computer system 700 from wrist 708a of user 708 and/or remove computer system 700 from another portion of the body of user 708, such as head 708b and/or face 708c of user 708) as an action to perform to initiate and/or start an enrollment process (e.g., a setup process) of computer system 700.

At FIG. 7C, computer system 700 has not yet initiated the process that includes capturing information about user 708 for generating a representation of user 708 (e.g., a virtual representation, such as an avatar, that includes an appearance that is based on the captured information about user 708). As set forth below, computer system 700 captures information about user 708 with sensor 734 (and, optionally, additional sensors) that are inaccessible, obstructed, and/or otherwise in a position with respect to user 708 that is not suitable for capturing the information about user 708 when computer system 700 is being worn on the body of user 708 (e.g., sensor 734 (and, optionally, additional sensors) of the HMD are not directed toward a respective body part of user 708 when the HMD is worn on head 708b of user 708). Accordingly, computer system 700 outputs prompt 732 instructing user 708 to remove computer system 700 from the body of user 708 so that sensor 734 (and, optionally, additional sensors) can be effectively used to capture at least a portion of the information about user 708. While FIG. 7C illustrates prompt 732 as a being displayed on display 704 of computer system 700, in some embodiments, prompt 732 includes audio output (e.g., via a speaker of computer system 700 and/or via a wireless headset/headphones) and/or haptic output (e.g., via one or more haptic output devices of computer system 700) that instructs user 708 to remove computer system 700 from the body (e.g., wrist 708a and/or another portion of the body, such as head 708b and/or face 708c) of user 708.

As set forth above, in some embodiments, computer system 700 is the HMD, and display 704 is an interior display of the HMD. In other words, display 704 is configured to be viewed by user 708 while the HMD is be worn on head 708b of user 708 and/or while first portion 710 covers the eyes of user 708. In some embodiments, prompt 732 includes instructions to remove the HMD from head 708b of user 708 and to point a sensor of computer system 700 (e.g., sensor 734) toward head 708b and/or face 708c of user 708. In some embodiments, prompt 732 is displayed on display 704 while computer system 700 detects that user 708 is wearing the HMD on head 708b of user 708. In some embodiments, computer system 700 detects that user 708 is wearing computer system 700 based on detecting (e.g., detecting a presence of) a biometric feature, such as eyes or other facial features, of user 708.

In some embodiments, computer system 700 initiates the enrollment process when computer system 700 detects that user 708 is no longer wearing computer system 700 on the body of user 708, such as on wrist 708a and/or on head 708b of user 708. In some embodiments, computer system 700 detects that user 708 is not wearing computer system 700 based on detecting an absence of a biometric feature, such as eyes or other facial features, of user 708.

In some embodiments, before or after displaying prompt 732, computer system 700 displays and/or outputs information indicating that information about user 708 captured during at least the portion of the enrollment process are used to generate a representation of user 708. In some embodiments, computer system 700 displays and/or outputs information about using the representation of user 708 in a real-time communication session with another user associated with an external computer system, which provides context to user 708 about the purpose for capturing the information about user 708.

In some embodiments, before or after displaying prompt 732, computer system 700 displays and/or outputs prompts including an indication (e.g., text and/or graphics) related to a condition of physical environment 706 in which user 708 is located. For instance, sensor 712 (and/or other sensors) of computer system 700 captures information about physical environment 706 and computer system 700 determines whether the captured information is indicative of one or more conditions that could affect capturing the information about user 708. In some embodiments, the conditions that could affect capturing the information about user 708 include low lighting (e.g., light emitted from one or more light sources, such as a light bulb, a lamp, and/or the sun, is not reaching the user in sufficient quantities to enable computer system 700 to effectively capture the information about user 708), harsh lighting, an object positioned between computer system 700 and user 708 (e.g., an object obstructing an area in which one or more sensors of computer system 700 are configured to capture information), and/or an object and/or accessory positioned on a respective portion of the body of user 708 (e.g., glasses, a face covering, a head covering, and/or a hat). In some embodiments, the prompt including the indication related to the condition of physical environment 706 includes a suggestion and/or guidance to user 708 about correcting the condition that could affect capturing the information about user 708 (e.g., moving to an environment with different lighting conditions, adjusting the lighting conditions, and/or removing an object obstructing a portion of the body of user 708). In some embodiments, the prompt specifies the condition negatively affecting the capture (e.g., low lighting, harsh lighting, an object positioned between computer system 700 and user 708).

At FIG. 7D, user 708 has removed computer system 700 from the body (e.g., wrist 708a and/or another portion of the body, such as head 708b and/or face 708c) of user 708 in physical environment 706. In addition, FIG. 7D illustrates second portion 714 (e.g., a backside and/or an exterior portion of the HMD) of computer system 700 that is accessible and/or visible after user 708 removed computer system 700 from the body (e.g., wrist 708a and/or another portion of the body, such as head 708b and/or face 708c) of user 708. Second portion 714 of computer system 700 includes sensor 734 that is configured to capture various information about user 708. In some embodiments, computer system 700 includes one or more sensors in addition to sensor 734. In some embodiments, sensor 734 and/or additional sensors on second portion 714 of computer system 700 include one or more image sensors (e.g., IR cameras, 3D cameras, depth cameras, color cameras, RGB cameras (e.g., with a complimentary metal-oxide-semiconductor (CMOS) image sensor or a charge-coupled device (CCD) image sensor), one or more infrared (IR) cameras, and/or one or more event-based cameras), an inertial measurement unit (IMU), an accelerometer, a gyroscope, a thermometer, one or more physiological sensors (e.g., blood pressure monitor, heart rate monitor, blood oxygen sensor, and/or blood glucose sensor), one or more microphones, one or more speakers, a haptics engine, one or more depth sensors (e.g., a structured light, a time-of-flight, and/or two or more cameras that determine depth based on differences in perspectives of the two or more cameras), one or more light sensors, one or more tactile sensors, one or more orientation sensors, one or more proximity sensors, one or more location sensors, one or more motion sensors, and/or one or more velocity sensors.

At FIG. 7D, second portion 714 includes display 736 that is configured to display visual indications that provide instructions and/or otherwise guide user 708 to use computer system 700 to capture one or more physical characteristics of user 708 (e.g., via sensor 734 and/or one or more additional sensors of computer system 700). In some embodiments, display 736 is an external display on an exterior portion of the HMD, such that display 736 can be viewed by user 708 when computer system 700 is not being worn by user 708 (e.g., worn on wrist 708a, head 708b, and/or face 708c of user 708). In some embodiments, display 736 includes a non-zero amount of curvature. In some embodiments, display 736 is a lenticular display that is configured to display one or more visual elements with a three-dimensional effect. In some embodiments, display 736 is not a lenticular display.

In some embodiments, computer system 700 detects that computer system 700 has been removed from the body (e.g., wrist 708a and/or another portion of the body, such as head 708b and/or face 708c) of user 708. In response to detecting that computer system 700 has been removed from the body (e.g., wrist 708a and/or another portion of the body, such as head 708b and/or face 708c) of user 708, computer system 700 displays, via display, visual guidance 738, as shown at FIG. 7D.

In some embodiments, computer system 700 displays visual guidance 738 before computer system 700 begins capturing information about user 708. As set forth below, visual guidance 738 prompts a user to position the body of user 708 and/or to position computer system 700 in a predefined orientation relative to one another. In some embodiments, the predefined orientation of the body of user 708 and computer system 700 enables computer system 700 to capture the information about user 708 (e.g., via sensor 734 and/or additional sensors). At FIG. 7D, user 708 is holding computer system 700 at location 706a in physical environment 706 (e.g., with respect to head 708b and/or face 708c of user 708). While computer system 700 is positioned at location 706a, computer system 700 (and sensor 734) is not directed, oriented, and/or positioned near face 708c of user 708. Therefore, visual guidance 738 prompts user 708 to move their body and/or move computer system 700 so that face 708c and computer system 700 are aligned with one another in such a way that sensor 734 (and, optionally, one or more additional sensors of computer system 700) can capture information about head 708b and/or face 708c of user 708.

At FIG. 7D, visual guidance 738 includes text 738a, first position indicator 738b, and second position indicator 738c. Text 738a includes written guidance and/or instructions for aligning head 708b and/or face 708c of user 708 with computer system 700 (e.g., sensor 734 of computer system 700). For instance, text 738a includes guidance for positioning head 708b of user 708 so that head 708b of user 708 is within a target area and/or orientation with respect to computer system 700, as indicated by first position indicator 738b and/or second position indicator 738c. First position indicator 738b represents a position of head 708b of user 708 in physical environment 706 relative to sensor 734 of computer system 700. In some embodiments, second position indicator 738c represents a target position of head 708b of user 708 in physical environment 706 relative to sensor 734 of computer system 700 that enables sensor 734 to capture information about head 708b and/or face 708c of user 708. In some embodiments, second position indicator 738c represents a position of sensor 734 in physical environment 706, such that when first position indicator 738b and second position indicator 738c are aligned with one another (e.g., at least partially overlapping with one another on display 736), head 708b of user 708 is at the target position and/or orientation relative to sensor 734 and/or computer system 700.

In some embodiments, first position indicator 738b and second position indicator 738c are displayed with different simulated depths. For instance, first position indicator 738b is displayed to appear as being at a first depth from a perspective of user 708 and second position indicator 738c is displayed to appear as being at a second depth, different from the first depth, from the perspective of user 708. In some embodiments, the respective simulated depths of first position indicator 738b and second position indicator 738c are based on an orientation of head 708b and/or face 708c of user 708 relative to computer system 700 (e.g., sensor 734 of computer system 700). In some embodiments, computer system 700 displays first position indicator 738b and second position indicator 738c at different simulated depths by displaying first position indicator 738b and second position indicator 738c with respective sizes, positions, and/or visual effects that create, generate, and/or otherwise cause first position indicator 738b and second position indicator 738c to appear as being displayed at the respective simulated depths.

In some embodiments, computer system 700 is configured to move first position indicator 738b and/or second position indicator 738c on display 736 with simulated parallax. In other words, computer system 700 is configured to display movement of first position indicator 738b and second position indicator 738c with respect to one another on display 736 so that user 708 perceives displacement of first position indicator 738b with respect to second position indicator 738c (or vice versa) based on a change in a viewpoint of user 708. In some embodiments, computer system 700 displays movement of first position indicator 738b at a first speed on display 736 and movement of second position indicator 738c at a second speed, different from the first speed on display 736 to generate the simulated parallax.

At FIG. 7D, computer system 700 detects a position of head 708b of user 708 relative to a position of computer system 700 within physical environment 706 (via information captured via sensor 734 and/or one or more additional sensors of computer system 700). Computer system 700 uses information about the position of head 708b of user 708 to display first position indicator 738b at position 740a on display 736. At FIG. 7D, computer system 700 displays second position indicator 738c at position 740b on display 736. In some embodiments, computer system 700 displays second position indicator 738c at position 740b on display 736 based on information about the position of head 708b of user 708 relative to the position of computer system 700 within physical environment 706. In some embodiments, computer system 700 displays second position indicator 738c at position 740b as a default position and does not change the position of second position indicator 738c from position 740b based on the information about the position of head 708b of user 708 relative to the position of computer system 700 within physical environment 706. As the position of head 708b of user 708 moves relative to the position of computer system 700 within physical environment 706, computer system 700 updates display of the first position indicator 738b and/or second position indicator 738c.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, visual guidance 738 is displayed on display 736 while computer system 700 detects that user 708 is not wearing the HMD on head 708b of user 708. In some embodiments, computer system 700 detects that user 708 is not wearing computer system 700 based on detecting an absence of a biometric feature, such as eyes or other facial features, of user 708.

At FIG. 7E, user 708 is holding computer system 700 at location 706b in physical environment 706. While computer system 700 is positioned at location 706b (e.g., relative to head 708b and/or face 708c of user 708), computer system 700 (and sensor 734) is positioned closer to head 708b and/or face 708c of user 708, but is still not directed, oriented, aligned, and/or positioned near face 708c of user 708. Computer system 700 detects (e.g., via sensor 734) position of head 708b and/or face 708c of user 708 relative to computer system 700 within physical environment 706. For instance, computer system 700 receives information about a position of head 708b and/or face 708c of user relative to location 706b of computer system 700 in physical environment 706 from sensor 734 (and, optionally, one or more additional sensors of computer system 700). Based on the information received from sensor 734, computer system 700 displays first position indicator 738b (e.g., representative of position of head 708b and/or face 708c of user 708) at position 740c, which is closer to position 740b when compared to position 740a. Accordingly, computer system 700 provides a visual indication about where head 708b, face 708c, and/or computer system 700 are oriented with respect to one another relative to a target orientation (e.g., an orientation that enables sensor 734 to capture information about head 708b and/or face 708c of user 708).

In some embodiments, computer system 700 moves the position of first position indicator 738b (e.g., from position 740a to position 740c) based on a tilt of computer system 700 relative to head 708b and/or face 708c of user 708. In some embodiments, computer system 700 adjusts a color of first position indicator 738b as computer system 700 displays first position indicator 738b moving closer to position 740b of second position indicator 738c. In some embodiments, computer system 700 adjusts visual effects of first position indicator 738b based on the information received from sensor 734 (and, optionally, one or more additional sensors of computer system 700). For instance, in some embodiments, computer system 700 reduces an amount of blur, increases an amount of saturation, and/or increases a brightness of first position indicator 738b as computer system 700 moves the position of first position indicator 738b closer to position 740b of second position indicator 738c. In some embodiments, computer system 700 increases an amount of blur, reduces an amount of saturation, and/or reduces a brightness of first position indicator 738b as computer system 700 moves the position of first position indicator 738b further away from position 740b of second position indicator 738c. In some embodiments, computer system 700 moves the position of first position indicator 738b based on a direction of movement of computer system 700 (e.g., sensor 734 of computer system 700) relative to head 708b and/or face 708c of user 708, or vice versa. In some embodiments, computer system 700 moves the position of first position indicator 738b by an amount that is based on an amount of movement of computer system 700 (e.g., sensor 734 of computer system 700) relative to head 708b and/or face 708c of user 708, or vice versa. In some embodiments, computer system 700 adjusts the color of first position indicator 738b based on movement of computer system 700 relative to head 708b and/or face 708c of user 708, or vice versa, regardless of the direction of movement.

At FIG. 7E, computer system 700 maintains display of second position indicator 738c at position 740b to provide a target for user 708 when positioning head 708b, face 708c, and/or computer system 700 with respect to one another. In some embodiments, computer system 700 moves the position of second position indicator 738c from position 740b based on the information received from sensor 734 and/or one or more additional sensors of computer system 700 (e.g., moves the position of second position indicator 738c with respect to first position indicator 738b and/or with respect to display 736).

At FIG. 7E, computer system 700 outputs audio 741 while displaying visual guidance 738 and before detecting that head 708b, face 708c, and/or computer system 700 are oriented at the target orientation with respect to one another. In some embodiments, computer system 700 adjusts the output of audio (e.g., adjusts one or more properties of the audio (e.g., a volume level and/or an amount of reverberation)) based on respective positions of head 708b, face 708c, and/or computer system 700 relative to one another. For instance, in some embodiments, computer system 700 increases a volume of the output of audio 741 as head 708b, face 708c, and/or computer system 700 become closer to the target orientation with respect to one another.

In some embodiments, audio 741 includes different components and/or portions that facilitate guiding user 708 to align the respective positions of head 708b, face 708c, and/or computer system 700 relative to one another. For instance, in some embodiments, audio 741 includes first portion 741a corresponding to a position of head 708b and/or face 708c of user 708 relative to computer system 700 in physical environment 706 and second portion 741b corresponding to a location and/or position of computer system 700 (e.g., sensor 734 and/or another sensor of computer system 700) in physical environment 706. In some embodiments, first portion 741a and second portion 741b of audio 741 both include a repeating audio effect, such that first portion 741a and second portion 741b continuously loop for at least a predetermined amount of time (e.g., until the respective positions of head 708b, face 708c, and/or computer system 700 are aligned with one another and/or in a target orientation with respect to one another). In some embodiments, first portion 741a includes one or more first musical notes and second portion 741b includes one or more second musical notes, where the one or more first musical notes and the one or more second musical notes are spaced apart from one another by a harmonically significant amount, such as an integer number of octaves. In some embodiments, computer system 700 adjusts a volume of first portion 741a and/or second portion 741b relative to one another based on movement of head 708b, face 708c, and/or computer system 700 relative to one another in physical environment 706.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, visual guidance 738 is displayed on display 736 and computer system 700 displays movement of first position indicator 738b and/or second position indicator 738c based on detecting movement of user 708 and/or the HMD relative to one another.

At FIG. 7F, user 708 is holding computer system 700 at location 706c in physical environment 706 (e.g., with respect to head 708b and/or face 708c of user 708). While computer system 700 is positioned at location 706c, computer system 700 (and sensor 734) is directed, oriented, aligned, and/or positioned near face 708c of user 708. Computer system 700 detects (e.g., via sensor 734) position of head 708b and/or face 708c of user 708 relative to computer system 700 within physical environment 706. For instance, computer system 700 receives information about a position of head 708b and/or face 708c of user relative to location 706c of computer system 700 in physical environment 706 from sensor 734 (and, optionally, one or more additional sensors of computer system 700). Based on the information received from sensor 734, computer system 700 displays first position indicator 738b (e.g., representative of position of head 708b and/or face 708c of user 708) at position 740d, which overlaps with at least a portion of second position indicator 738c at position 740b. Accordingly, computer system 700 provides a visual indication about where head 708b, face 708c, and/or computer system 700 are oriented with respect to one another at the target orientation (e.g., an orientation that enables sensor 734 to capture information about head 708b and/or face 708c of user 708).

In some embodiments, when computer system 700 displays first position indicator 738b at position 740d on display 736 so that first position indicator 738b at least partially overlaps with second position indicator 738c, computer system 700 detects that head 708b, face 708c, and/or computer system 700 are oriented at the target orientation with respect to one another. In some embodiments, in response to detecting that head 708b, face 708c, and/or computer system 700 are oriented at the target orientation with respect to one another, computer system 700 outputs confirmation feedback to prompt user 708 to stop moving their body and/or computer system 700 and/or maintain the respective positions of head 708b, face 708c, and/or computer system 700. At FIG. 7F, the confirmation feedback includes audio 742. In some embodiments, audio 742 includes audio output that includes speech confirming that head 708b, face 708c, and/or computer system 700 are at the target orientation with respect to one another. In some embodiments, audio 742 includes audio having a first tone, pitch, frequency, wavelength, melody, and/or harmony.

In some embodiments, in response to detecting that head 708b, face 708c, and/or computer system 700 are oriented at the target orientation with respect to one another, computer system 700 outputs audio 742 having first portion 741a, second portion 741b, and third portion 742a. In some embodiments, third portion 742a audibly confirms that head 708b, face 708c, and/or computer system 700 are oriented at the target orientation with respect to one another. In some embodiments, third portion 742a includes one or more third musical notes that are spaced apart from the one or more first musical notes of first portion 741a and the one or more second musical notes of second portion 741b by a harmonically significant amount, such as an integer number of octaves.

In some embodiments, the confirmation feedback includes (e.g., in addition to, or in lieu of, audio 742) displaying visual feedback on display 736, such as a checkmark, text, and/or adjusting an appearance of visual guidance 738 (e.g., animating visual guidance 738 and/or displaying a flashing animation on display 736).

At FIGS. 7D-7F, visual guidance 738 includes text 738a, first position indicator 738b, and/or second position indicator 738c. In some embodiments, visual guidance 738 includes an image of user 708 (e.g., an image based on information captured via sensor 734) and/or a user interface object of a target and/or frame for which the image of user 708 is configured to be positioned within when head 708b, face 708c, and/or computer system 700 are in the target orientation with respect to one another.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, visual guidance 738 is displayed on display 736 and computer system 700 displays movement of first position indicator 738b and/or second position indicator 738c based on detecting movement of user 708 and/or the HMD relative to one another.

After computer system 700 determines that head 708b, face 708c, and/or computer system 700 are oriented at the target orientation with respect to one another, computer system 700 initiates a step (e.g., a first step) for capturing information about head 708b and/or face 708c of user 708, as shown at FIG. 7G.

At FIG. 7G, computer system 700 displays, via display 736, prompt 744 guiding user 708 to move head 708b in a predetermined direction within physical environment 706. Illustrated axes 746a-746c are provided for clarity, but are not part of the user interface of computer system 700. Prompt 744 includes text 744a that includes written guidance and/or instructions prompting user 708 to move head 708b in a direction along axis 746a that is to the right of user 708. At FIG. 7G, prompt 744 includes arrow 744b which points in the direction along axis 746a that is to the right of user 708 (e.g., from the perspective of user 708 viewing display 736). In some embodiments, prompt 744 includes other visual elements in addition to, or in lieu of, text 744a and/or arrow 744b. For instance, in some embodiments, prompt 744 includes a representation of a person (e.g., an avatar) moving their head to their right to demonstrate the step for capturing information about head 708b and/or face 708c of user 708 associated with prompt 744. In some embodiments, the representation of the person moving their head is an animation, a series of images, and/or a video that shows the representation of the person moving their head to their right over time.

At FIG. 7G, computer system 700 outputs audio 748 to further prompt user 708 to move head 708b in the direction along axis 746a that is to the right of user 708 in physical environment 706. In some embodiments, computer system 700 outputs audio 748 so that user 708 perceives audio 748 as being produced from a particular location within physical environment 706 (e.g., a location that is different from a location of computer system 700), such as by using head-related transfer function (HRTF) filters and/or cross talk cancellation techniques. For instance, in some embodiments, computer system 700 outputs audio 748 so that user 708 perceives audio 748 as being produced from a direction that is to the right of user 708 and/or computer system 700 in physical environment 706. Accordingly, an attention of user 708 is drawn to a location in physical environment 706 that is associated with the direction in which prompt 744 guides user 708 to move head 708b. In some embodiments, audio 748 includes continuous output of sound that prompts user 708 to move head 708b in the direction that is to the right of user 708 and/or computer system 700. In some embodiments, audio 748 includes audio bursts and/or intermittent output of sound that is produced at predetermined intervals of time. As set forth below, in some embodiments, computer system 700 is configured to adjust audio 748 based on movement of head 708b and/or face 708c of user 708 relative to computer system 700 (e.g., sensor 734 of computer system 700).

In some embodiments, computer system 700 adjusts one or more audio properties (e.g., a volume level and/or an amount of reverberation) of audio 748 based on detecting that respective positions of head 708b, face 708c, and/or computer system 700 are not aligned with one another and/or at the target orientation described above with reference to FIGS. 7D-7F (e.g., computer system 700 is not and/or no longer at location 706c relative to head 708b and/or face 708c of user 708 in physical environment 706). In some embodiments, in response to detecting that the respective positions of head 708b, face 708c, and/or computer system 700 are no longer aligned with one another and/or at the target orientation described above with reference to FIGS. 7D-7F, computer system 700 reduces a volume of audio 748 and/or ceases to output audio 748 to signal to user 708 that the respective positions of head 708b, face 708c, and/or computer system 700 are not in a proper orientation.

In some embodiments, audio 748 includes different components and/or portions that facilitate guiding user 708 to move head 708b and/or face 708c relative to computer system 700. For instance, in some embodiments, audio 748 includes first portion 748a corresponding to a position of head 708b and/or face 708c of user 708 relative to computer system 700 in physical environment 706 and second portion 748b corresponding to a location and/or position of computer system 700 (e.g., sensor 734 and/or another sensor of computer system 700) in physical environment 706. In some embodiments, first portion 748a and second portion 748b of audio 748 both include a repeating audio effect, such that first portion 748a and second portion 748b continuously loop for at least a predetermined amount of time (e.g., until the respective positions of head 708b, face 708c, and/or computer system 700 are at a target orientation with respect to one another). In some embodiments, first portion 748a includes one or more first musical notes and second portion 748b includes one or more second musical notes, where the one or more first musical notes and the one or more second musical notes are spaced apart from one another by a harmonically significant amount, such as an integer number of octaves. In some embodiments, computer system 700 adjusts a volume of first portion 748a and/or second portion 748b relative to one another based on movement of head 708b, face 708c, and/or computer system 700 relative to one another in physical environment 706.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 744 is displayed on display 736 of the HMD.

At FIG. 7H, computer system 700 detects movement of head 708b and/or face 708c of user 708 in a direction along axis 746a that is to the right of user 708. Based on the movement of head 708b and/or face 708c of user 708 relative to computer system 700, computer system 700 displays prompt 744 and progress indicator 750. At FIG. 7H, computer system 700 maintains display of prompt 744 to continue to guide user 708 to move head 708b further in the direction along axis 746a that is to the right of user 708. Progress indicator 750 provides a visual indication of an amount of progress toward head 708b of user 708 moving to a predefined orientation relative to computer system 700 (e.g., a predefined orientation that includes head 708b moving to a position that is in the direction along axis 746a toward the right of user 708).

At FIG. 7H, progress indicator 750 is displayed on first portion 752a of display 736 and not on second portion 752b. A size of first portion 752a (e.g., compared to second portion 752b and/or compared to a size of display 736) indicates the amount of progress toward user 708 completing movement of head 708b in the direction associated with prompt 744 (e.g., the direction along axis 746a that is to the right of user 708). At FIG. 7H, progress indicator 750 includes a color that is different from a background color, a color of prompt 744, and/or a color of second portion 752b of display 736. For instance, progress indicator 750 is shown as having first hatching at FIG. 7H to illustrate that progress indicator 750 includes a color that is different from the background color, the color of prompt 744, and/or a color of second portion 752b of display 736 (e.g., second portion 752b of display 736 does not include hatching). In some embodiments, the color of progress indicator 750 (e.g., the color of first portion 752a of display 736) is based on one or more colors of physical environment 706. For instance, in some embodiments, computer system 700 displays the color of progress indicator 750 (e.g., the color of first portion 752a of display 736) based on information captured by sensor 734 (and/or other sensors of computer system 700) that is indicative of one or more colors of one or more physical objects (e.g., walls, floors, ceilings, artwork, and/or physical objects) that are present in physical environment 706.

Computer system 700 is configured to display movement of progress indicator 750 over time based on detected movement of head 708b and/or face 708c of user 708 relative to computer system 700. In some embodiments, computer system 700 animates progress indicator 750 so that a size of progress indicator 750 changes (e.g., first portion 752a of display 736 increases or decreases relative to second portion 752b of display 736) over time to indicate whether user 708 should continue to move head 708b in a current direction of movement, move head 708b in a different direction, and/or maintain a position of head 708b.

In some embodiments, prompt 744 and/or progress indicator 750 includes an image of user 708 that is based on information captured by sensor 734 (and/or other sensors of computer system 700). For instance, in some embodiments, prompt 744 and/or progress indicator 750 includes an image of user 708 that enables user 708 to adjust a position of their body and/or computer system 700 to align head 708b and/or face 708c of user 708 in a target orientation relative to computer system 700 (e.g., sensor 734 of computer system 700). In some embodiments, computer system 700 displays the image of user 708 with an offset, skew, and/or shift that is based on an orientation of sensor 734 relative to display 736 of computer system 700. In some embodiments, computer system 700 applies an adjustment to image data received from sensor 734 (and/or other sensors of computer system 700) to display the image of user 708 with the offset, skew, and/or shift that causes user 708 to adjust the position of head 708b and/or face 708c relative to computer system 700. Displaying the image of user 708 with the offset, skew, and/or shift causes user 708 to move head 708b, face 708c, and/or computer system 700 so that sensor 734 (e.g., a sensing region of sensor 734) is directed at head 708b and/or face 708c of user 708. In other words, in some embodiments, sensor 734 is positioned offset and/or at an angle when compared to display 736, so computer system 700 adjusts how the image of user 708 is displayed on display 736 to prompt user 708 to tilt computer system 700 and/or adjust the position of head 708b and/or face 708c of user 708 so that sensor 734 is directed at head 708b and/or face 708c of user 708.

In some embodiments, progress indicator 750 includes (in addition to, or in lieu of, the color occupying first portion 752a of display 736) a user interface object that indicates a position of head 708b and/or face 708c of user 708 relative to computer system 700 (e.g., sensor 734 of computer system 700). For instance, in some embodiments, progress indicator 750 includes a ball and/or an orb that is displayed at a position on display 736 to visually indicate a physical position of head 708b and/or face 708c of user 708 relative to computer system 700 in physical environment 706. In some embodiments, progress indicator 750 includes a countdown that starts at a predetermined number and counts down to zero in response to detected movement of head 708b, face 708c, and/or computer system 700 relative to one another along axis 746a in a direction that is to the right of user 708.

At FIG. 7H, computer system 700 outputs audio 754 to indicate an amount of progress toward moving head 708b of user 708 to a target orientation relative to computer system 700 and/or to further prompt user 708 to move head 708b in the direction along axis 746a that is to the right of user 708 in physical environment 706. In some embodiments, computer system 700 outputs audio 754 so that user 708 perceives audio 754 as being produced from a particular location within physical environment 706 (e.g., a location that is different from a location of computer system 700), such as by using HRTF filters and/or cross talk cancellation techniques. For instance, in some embodiments, computer system 700 outputs audio 754 so that user 708 perceives audio 754 as being produced from a direction that is to the right of user 708 and/or computer system 700 in physical environment 706. Accordingly, an attention of user 708 is drawn to a location in physical environment 706 that is associated with the direction in which prompt 744 guides user 708 to move head 708b. In some embodiments, audio 754 includes continuous output of sound that prompts user 708 to move head 708b in the direction that is to the right of user 708 and/or computer system 700. In some embodiments, audio 754 includes audio bursts and/or intermittent output of sound that is produced at predetermined intervals of time. In some embodiments, audio 754 includes different audio properties when compared to audio 748 to indicate that head 708b of user 708 has moved relative to computer system 700 and/or that head 708b of user 708 and/or computer system 700 are oriented to a target orientation relative to one another. For instance, in some embodiments, audio 754 includes an increased volume and/or a different amount of reverberation as compared to audio 748 to provide audible feedback that enables user 708 to confirm that the movement of head 708b (and/or computer system 700) is consistent with movement associated with prompt 744. In some embodiments, computer system 700 is configured to adjust audio 748 and/or audio 754 based on movement of head 708b and/or face 708c of user 708 relative to computer system 700 along axis 746a, 746b, and/or axis 746c. In some embodiments, computer system 700 reduces a volume of audio 748 based on detection of movement of head 708b and/or face 708c along axis 746b and/or axis 746c because such movement is not in a direction of movement associated with prompt 744.

In some embodiments, audio 754 includes different components and/or portions that facilitate guiding user 708 to move head 708b and/or face 708c relative to computer system 700. For instance, in some embodiments, audio 754 includes first portion 754a corresponding to a position of head 708b and/or face 708c of user 708 relative to computer system 700 in physical environment 706 and second portion 754b corresponding to a location and/or position of computer system 700 (e.g., sensor 734 and/or another sensor of computer system 700) in physical environment 706. In some embodiments, first portion 754a and second portion 754b of audio 754 both include a repeating audio effect, such that first portion 754a and second portion 754b continuously loop for at least a predetermined amount of time (e.g., until the respective positions of head 708b, face 708c, and/or computer system 700 are at a target orientation with respect to one another). In some embodiments, first portion 754a includes one or more first musical notes and second portion 754b includes one or more second musical notes, where the one or more first musical notes and the one or more second musical notes are spaced apart from one another by a harmonically significant amount, such as an integer number of octaves. In some embodiments, computer system 700 adjusts a volume of first portion 754a and/or second portion 754b relative to one another based on movement of head 708b, face 708c, and/or computer system 700 relative to one another in physical environment 706.

At FIG. 7H, computer system 700 outputs haptic feedback 755 to indicate an amount of progress toward moving head 708b of user 708 to a target orientation relative to computer system 700 and/or to further prompt user 708 to move head 708b in the direction along axis 746a that is to the right of user 708 in physical environment 706.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 744 and/or progress indicator 750 are displayed on display 736 of the HMD.

At FIG. 7I, computer system 700 detects that head 708b and/or face 708c of user 708 has moved further in the direction along axis 746a. For instance, head 708b and/or face 708c of user 708 has moved (e.g., rotated) relative to computer system 700 (e.g., position of computer system 700 has been maintained at location 706c) within physical environment 706. Based on detecting the additional movement of head 708b and/or face 708c of user 708 in the direction along axis 746a, computer system 700 increases a size of progress indicator 750 so that progress indicator 750 is displayed on an entire display area of display 736 (e.g., progress indicator 750 is displayed on first portion 752a and second portion 752b of display 736). In some embodiments, when computer system 700 detects that head 708b and/or face 708c of user 708 have moved in the wrong direction along axis 746a, have moved along a different axis (e.g., axis 746b and/or axis 746c), and/or have not moved, computer system 700 updates display of progress indicator 750 accordingly. For instance, in some embodiments, computer system 700 reduces a size of progress indicator 750 (e.g., reduces a size of first portion 752a of display 736 relative to second portion 752b of display 736) when computer system 700 detects that head 708b and/or face 708c of user 708 move in the wrong direction along axis 746a. In some embodiments, computer system 700 maintains the size of progress indicator 750 (e.g., maintains display of progress indicator 750 as shown at FIG. 7H) when computer system 700 detects that head 708b and/or face 708c of user 708 move along a different axis (e.g., axis 746b and/or axis 746c) and/or do not move along axis 746a.

At FIG. 7I, computer system 700 displays confirmation indicator 756 and does not display prompt 744 (e.g., computer system 700 replaces display of prompt 744 with display of confirmation indicator 756). Confirmation indicator 756 includes a checkmark, which provides visual confirmation to user 708 that user 708 has moved head 708b, face 708c, and/or computer system 700 to a target orientation relative to one another (e.g., user 708 has satisfied performance of the action (e.g., movement of head 708b) associated with prompt 744).

At FIG. 7I, computer system 700 outputs audio 758 based on detecting that user 708 has moved head 708b, face 708c, and/or computer system 700 to a target orientation relative to one another. In some embodiments, audio 758 includes audio output that includes speech confirming that head 708b, face 708c, and/or computer system 700 are at the target orientation with respect to one another. In some embodiments, audio 758 includes audio having a first tone, pitch, frequency, wavelength, melody, and/or harmony. Audio 758 is configured to be output by computer system 700 to provide a non-visual confirmation to user 708 that user 708 has completed a step of the process for capturing information about user 708 (e.g., a step associated with prompt 744). As such, audio 758 enables user 708 to confirm that user 708 no longer needs to move head 708b of user 708 when user 708 may not be able to easily view and/or see display 736 of computer system 700.

In some embodiments, in response to detecting that head 708b, face 708c, and/or computer system 700 are oriented at the target orientation with respect to one another, computer system 700 outputs audio 758 having first portion 754a, second portion 754b, and third portion 758a. In some embodiments, third portion 758a audibly confirms that head 708b, face 708c, and/or computer system 700 are oriented at the target orientation with respect to one another. In some embodiments, third portion 758a includes one or more third musical notes that are spaced apart from the one or more first musical notes of first portion 754a and the one or more second musical notes of second portion 754b by a harmonically significant amount, such as an integer number of octaves.

In some embodiments, audio 758 is the same as audio 742, such that computer system 700 provides the same audio feedback after the completion of different steps of the process for capturing information about user 708. In some embodiments, computer system 700 is configured to output a melodic and/or harmonic sequence of confirmation audio that progresses and/or changes upon completion of subsequent steps of the process for capturing information about user 708. For instance, in some embodiments, audio 742 includes a first set of musical notes and audio 758 includes a second set of musical notes, where the second set of musical notes include the first set of musical notes and additional notes that harmonically and/or melodically follow the first set of musical notes.

At FIG. 7I, computer system 700 outputs haptic feedback 759 based on detecting that user 708 has moved head 708b, face 708c, and/or computer system 700 to a target orientation relative to one another. Haptic feedback 759 is configured to be output by computer system 700 to provide a non-visual confirmation to user 708 that user 708 has completed a step of the process for capturing information about user 708 (e.g., a step associated with prompt 744). As such, haptic feedback 759 enables user 708 to confirm that user 708 no longer needs to move head 708b of user 708 when user 708 may not be able to easily view and/or see display 736 of computer system 700.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 744, progress indicator 750, and/or confirmation indicator 756 are displayed on display 736 of the HMD.

At FIG. 7J, computer system 700 displays confirmation indicator 760 after displaying progress indicator 750 covering the entire display area of display 736. At FIG. 7J, confirmation indicator 760 includes a color that is different from the color of progress indicator 750, as indicated by second hatching at FIG. 7J. In some embodiments, confirmation indicator 760 includes a flash animation output by computer system 700. For instance, in some embodiments, confirmation indicator 760 includes an increased brightness as compared to progress indicator 750 and/or a white color that is displayed for a predetermined amount of time to appear as if display 736 is flashing. Confirmation indicator 760 further provides confirmation to user 708 that user 708 has completed the step of the process for capturing information about user 708 and allows user 708 to prepare for a next step of the process for capturing information about user 708.

At FIG. 7J, computer system 700 outputs audio 762. In some embodiments, audio 762 is the same as audio 758 and computer system 700 maintains the output of audio 758 while displaying confirmation indicator 760. In some embodiments, audio 762 is different from audio 758 and includes one or more different audio properties when compared to audio 758 (e.g., a different volume level and/or a different amount of reverberation). At FIG. 7J, computer system 700 outputs haptic feedback 764 to further provide non-visual confirmation to user 708 that the current step of the process for capturing information about user 708 has been completed.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, confirmation indicator 756 and/or confirmation indicator 760 are displayed on display 736 of the HMD.

After displaying confirmation indicator 760, outputting audio 762, and/or outputting haptic feedback 764, computer system 700 initiates a next step of the process for capturing information about user 708. At FIG. 7K, computer system 700 displays prompt 766 guiding user 708 to move head 708b in a predetermined direction within physical environment 706. Prompt 766 includes text 766a that includes written guidance and/or instructions prompting user 708 to move head 708b in a direction along axis 746a that is to the left of user 708. At FIG. 7K, prompt 766 includes arrow 766b which points in the direction along axis 746a that is to the left of user 708 (e.g., from the perspective of user 708 viewing display 736). In some embodiments, prompt 766 includes other visual elements in addition to, or in lieu of, text 766a and/or arrow 766b. For instance, in some embodiments, prompt 766 includes a representation of a person (e.g., an avatar) moving their head to their left to demonstrate the step for capturing information about head 708b and/or face 708c of user 708 associated with prompt 766. In some embodiments, the representation of the person moving their head is an animation, a series of images, and/or a video that shows the representation of the person moving their head to their left over time.

At FIG. 7K, computer system 700 outputs audio 768 to further prompt user 708 to move head 708b in the direction along axis 746a that is to the left of user 708 in physical environment 706. In some embodiments, computer system 700 outputs audio 768 so that user 708 perceives audio 768 as being produced from a particular location within physical environment 706 (e.g., a location that is different from a location of computer system 700), such as by using HRTF filters and/or cross talk cancellation techniques. For instance, in some embodiments, computer system 700 outputs audio 768 so that user 708 perceives audio 768 as being produced from a direction that is to the left of user 708 and/or computer system 700 in physical environment 706. Accordingly, an attention of user 708 is drawn to a location in physical environment 706 that is associated with the direction in which prompt 766 guides user 708 to move head 708b. In some embodiments, audio 768 includes continuous output of sound that prompts user 708 to move head 708b in the direction that is to the left of user 708 and/or computer system 700. In some embodiments, audio 768 includes audio bursts and/or intermittent output of sound that is produced at predetermined intervals of time. As set forth above, in some embodiments, computer system 700 is configured to adjust audio 768 based on movement of head 708b and/or face 708c of user 708 relative to computer system 700 (e.g., sensor 734 of computer system 700).

In some embodiments, after computer system 700 detects movement of head 708b, face 708c, and/or computer system 700 in the direction along axis 746a that is to the left of user 708 so that head 708b, face 708c, and/or computer system 700 are at a target orientation relative to one another, computer system 700 displays additional prompts guiding user 708 to complete additional steps of the process for capturing information about user 708. In some embodiments, computer system 700 displays and/or outputs prompts guiding user 708 to move head 708b and/or face 708c of user 708 along second axis 746b and/or third axis 746c so that computer system 700 can capture additional information about head 708b and/or face 708c of user 708. For instance, in some embodiments, computer system 700 displays and/or outputs one or more prompts to guide user 708 to move head 708b and/or face 708c in an upward direction (e.g., along axis 746b), a downward direction (e.g., along axis 746b), a frontward direction (e.g., along axis 746c), and/or a rearward direction (e.g., along axis 746c). In some embodiments, computer system 700 displays and/or outputs one or more prompts guiding user 708 to move head 708b and/or face 708c in three or more directions relative to computer system 700. In some embodiments, computer system 700 outputs audio feedback based on movement of head 708b and/or face 708c of user along different axes and/or in different directions relative to computer system 700. In some embodiments, computer system 700 adjusts one or more audio properties of the audio feedback as head 708b and/or face 708c move along different axes and/or in different directions relative to computer system 700 toward one or more target orientations with respect to computer system 700.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 766 is displayed on display 736 of the HMD.

After computer system 700 displays prompt 766 (and, optionally, one or more additional prompts) and determines that respective positions of head 708b, face 708c, and/or computer system 700 are in a target orientation with respect to one another, computer system 700 initiates a next step of the process for capturing information about user 708. For instance, at FIG. 7L, computer system 700 displays prompt 770 guiding user 708 to perform one or more actions associated with another step of the process for capturing information about user 708. For instance, at FIG. 7L, the step of the process for capturing information about user 708 includes capturing facial expressions of user 708.

At FIG. 7L, prompt 770 includes text 770a and countdown 770b. Text 770a provides visual, written guidance to user 708 to make one or more faces and/or facial expressions so that computer system 700 can capture additional information about face 708c of user 708. In some embodiments, text 770a of prompt 770 includes general guidance to make one or more facial expressions, where the general guidance does not prompt user 708 to make a particular facial expression. In some embodiments, text 770a of prompt 770 includes guidance for user 708 to make one or more specific and/or particular facial expressions, such as a closed mouth smile, an open mouth smile, and/or a raised eyebrow expression.

At FIG. 7L, prompt 770 includes countdown 770b, which provides an indication as to a time at which computer system 700 (e.g., sensor 734) is configured to begin capturing information about facial features (e.g., one or more physical characteristics of face 708c) of user 708. In some embodiments, computer system 700 is configured to animate countdown 770b so that an appearance of countdown 770b changes over time. For instance, computer system 700 changes the appearance of countdown 770b to count down from a predetermined time (e.g., six seconds) to zero time remaining. In some embodiments, computer system 700 adjusts and/or updates an appearance of visual indicator 770c of countdown 770b to increase and/or decrease in an amount of fill as countdown 770b counts down to zero time remaining. Countdown 770b enables user 708 to prepare to make facial expressions before computer system 700 begins capturing information about face 708c of user 708. Accordingly, computer system 700 can capture the information about face 708c of user 708 more quickly and efficiently, thereby reducing battery usage.

At FIG. 7L, computer system 700 outputs audio 772 while displaying prompt 770. In some embodiments, audio 772 includes one or more audio properties that guide user 708 to make one or more facial expressions. In some embodiments, audio 772 includes sound having speech instructing user 708 to make one or more facial expressions and/or to make specific, predetermined facial expressions. In some embodiments, audio 772 includes audio bursts that occur as countdown 770b counts down from the predetermined amount of time to zero time remaining.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 770 is displayed on display 736 of the HMD.

At FIG. 7M, computer system 700 ceases displaying countdown 770b when countdown 770b reaches zero time remaining and displays progress bar 770d on prompt 770. Progress bar 770d provides a visual indication to user 708 about an amount of progress toward completing capturing information about facial features (e.g., one or more physical characteristics of face 708c) of user 708. Computer system 700 is configured adjust and/or update an appearance of progress bar 770d based on whether facial features of user 708 (e.g., facial expressions user 708 makes in physical environment 706) correspond to and/or match one or more predetermined facial expressions.

At FIG. 7M, computer system 700 outputs audio 774. In some embodiments, audio 774 is the same as audio 772. In some embodiments, audio 774 includes sound having speech that guides user 708 to make one or more predetermined and/or specific facial expressions. In some embodiments, audio 774 includes sound indicating a type of facial expression for user 708 to make. For instance, in some embodiments, computer system 700 outputs audio 774 including laughter, thereby prompting user 708 to smile and/or laugh.

At FIG. 7M, computer system 700 has not detected that facial features of user 708 (e.g., one or more physical characteristics of face 708c) correspond to and/or match one or more facial expressions. As such, computer system 700 displays progress bar 770d as having no fill and/or as indicating no progress made toward completing making the one or more facial expressions (e.g., as indicated by no hatching in progress bar 770d at FIG. 7M). At FIG. 7M, user 708 adjusts and/or moves face 708c so that user 708 is making a first facial expression in physical environment 706 (e.g., user 708 has opened mouth 708d and/or is making an open mouth facial expression (e.g., an open mouth smile)).

In response to detecting user 708 making first facial expression in physical environment 706 (e.g., based on information received from sensor 734 and/or another sensor of computer system 700), computer system 700 displays (e.g., updates display of) progress bar 770d having first amount of fill 770e, as shown at FIG. 7N. At FIG. 7N, first amount of fill 770e includes a first color as indicated by first hatching. In addition, at FIG. 7N, first amount of fill 770e is included in first portion 776a of progress bar 770d, but not in second portion 776b of progress bar 770d. In some embodiments, first amount of fill 770e of progress bar 770d is an amount that corresponds to completion of a first facial expression of the one or more facial expressions. In some embodiments, computer system 700 animates and/or otherwise displays progress bar 770d filling as computer system 700 detects user 708 making first facial expression in physical environment 706.

In some embodiments, computer system 700 is configured to fill progress bar 770d at different rates (e.g., increase an amount of fill in progress bar 770d over different amounts of time) based on whether the first facial expression user 708 is making in physical environment 706 corresponds to and/or matches a predetermined facial expression. For instance, in some embodiments, computer system 700 displays progress bar 770d as filling at a first rate when the first facial expression user 708 is making in physical environment 706 corresponds to and/or matches a first predetermined facial expression (e.g., a first facial expression of the one or more facial expressions). In some embodiments, computer system 700 displays progress bar 770d as filling at a second rate (e.g., a non-zero fill rate), slower than the first rate, when the first facial expression user 708 is making in physical environment 706 does not correspond to and/or match a predetermined facial expression (e.g., at least one facial expression of the one or more facial expressions). Illustrated axes 778a-778b are provided for clarity, but are not part of the user interface of computer system 700. In some embodiments, progress bar 770d extends along axis 778a that is based on a viewpoint and/or perspective of user 708 viewing display 736. Accordingly, in some embodiments, progress bar 770d includes one or more portions that are not visible to user because the one or more portions extend along axis 778a. In some embodiments, computer system 700 displays progress bar 770d filling at the one or more portions that extend along axis 778a at a slower rate when compared to filling one or more additional portions of progress bar 770d that do not extend along axis 778a (e.g., extend along axis 778b). In other words, portions of progress bar 770d that extend along axis 778b are displayed as filling at a faster rate than the one or more portions extending along axis 778a.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 770 and/or progress bar 770d are displayed on display 736 of the HMD.

At FIG. 7N, computer system 700 outputs audio 780. In some embodiments, audio 780 is the same as audio 772 and/or audio 774. In some embodiments, audio 780 includes sound having speech that guides user 708 to make one or more predetermined and/or specific facial expressions. In some embodiments, audio 780 includes sound indicating a type of facial expression for user 708 to make. For instance, in some embodiments, computer system 700 outputs audio 780 including laughter, thereby prompting user 708 to smile and/or laugh.

At FIG. 7N, computer system 700 detects (e.g., via sensor 734 and/or one or more additional sensors of computer system 700) that user 708 is making a second facial expression in physical environment 706. In response to detecting that user 708 is making the second facial expression in physical environment 706, computer system 700 displays (e.g., updates display of) progress bar 770d with second amount of fill 770f to indicate the amount of progress that user 708 has made toward completing making the one or more facial expressions, as shown at FIG. 7O. At FIG. 7O, second amount of fill 770f includes the first color as indicated by first hatching. In some embodiments, computer system 700 is configured to change the color of fill within progress bar 770d as progress bar 770d fills over time. For instance, in some embodiments, computer system 700 displays progress bar 770d having a fill of a first color when progress bar includes first amount of fill 770e and displays progress bar 770d having a fill of a second color when progress bar includes second amount of fill 770f and/or an amount of fill that is greater than second amount of fill 770f.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 770 and/or progress bar 770d are displayed on display 736 of the HMD.

At FIG. 7O, second amount of fill 770f is included in third portion 776c of progress bar 770d, but not in fourth portion 776d of progress bar 770d. Third portion 776c of progress bar 770d is greater than first portion 776a and fourth portion 776d of progress bar 770d is less than second portion 776b, thereby indicating that the second facial expression made by user 708 in physical environment 706 is generating progress toward completing making the one or more facial expressions. In some embodiments, second amount of fill 770f of progress bar 770d is an amount that corresponds to completion of a first facial expression of the one or more facial expressions and a second facial expression of the one or more facial expressions. In some embodiments, computer system 700 animates and/or otherwise displays progress bar 770d filling (e.g., filling from first amount of fill 770e to second amount of fill 770f) as computer system 700 detects user 708 making second facial expression in physical environment 706.

As set forth above, in some embodiments computer system 700 is configured to fill progress bar 770d at varying rates based on detecting facial features of user 708. For instance, at FIG. 7O, a difference between second amount of fill 770f and first amount of fill 770e is less than a difference between first amount of fill 770e and no fill in progress bar 770d (e.g., as shown at FIG. 7M). Accordingly, in some embodiments, computer system 700 detects that the second facial expression made by user 708 in physical environment 706 does not completely and/or entirely correspond to a predetermined facial expression of the one or more facial expressions. Thus, in some embodiments, computer system 700 displays progress bar 770d as having less fill and/or filling at a slower rate when a facial expression made by user 708 does not completely and/or entirely correspond to a predetermined facial expression of the one or more facial expressions.

At FIG. 7O, computer system outputs audio 782. In some embodiments, audio 782 is the same as audio 772, audio 774, and/or audio 780. In some embodiments, audio 782 includes sound having speech that guides user 708 to make one or more predetermined and/or specific facial expressions. In some embodiments, audio 782 includes sound indicating a type of facial expression for user 708 to make. For instance, in some embodiments, computer system 700 outputs audio 782 including laughter, thereby prompting user 708 to smile and/or laugh. In some embodiments, audio 780 includes different audio properties when compared to audio 772, audio 774, and/or audio 780. For instance, in some embodiments, audio 782 includes an increased volume as compared to audio 772, audio 774, and/or audio 780 to indicate that user 708 is progressing toward completing making the one or more facial expressions. In some embodiments, computer system 700 increases the volume of audio output while displaying progress bar 770d at a rate that is proportional to a rate of fill of progress bar 770d.

In some embodiments, computer system 700 is configured to display progress bar 770d as being completely full (e.g., all of progress bar 770d includes fill) based on detecting that user 708 has made a predetermined number of facial expressions. In some embodiments, computer system 700 displays progress bar 770d as being completely full when a threshold amount of information about one or more physical characteristics of user have been captured while user 708 is making facial expressions in physical environment 706. In some embodiments, when computer system 700 displays progress bar 770d as completely full, computer system 700 outputs confirmation audio to provide a non-visual indication to user 708 that the one or more facial expressions have been detected and/or that one or more physical characteristics of face 708c of user 708 have been captured. In some embodiments, computer system 700 is configured to end and/or cease the process for capturing information about user 708 and/or to initiate another step of the process for capturing information about user 708 after displaying progress bar 770d as being completely full.

In some embodiments, computer system 700 is configured to end and/or cease the process for capturing information about user 708 and/or to initiate the next step of the process for capturing information about user 708 even when progress bar 770d is not being displayed as completely full (e.g., when computer system 700 has not detected a predetermined number of facial expressions and/or captured a threshold amount of information about one or more physical characteristics of user). For instance, in some embodiments, computer system 700 ends and/or ceases the process for capturing information about user 708 and/or initiates the next step of the process for capturing information about user 708 after a predetermined amount of time has passed since first displaying progress bar 770d. In other words, computer system 700 ends and/or moves on to a next step of the process for capturing information about user 708 when computer system 700 determines that user 708 is unlikely to complete making the one or more facial expressions within a predetermined amount of time. As set forth below, in some embodiments, computer system 700 provides an option for user 708 to cause computer system 700 to reinitiate the step for capturing information about facial features of user 708 after completing the process for capturing information about user 708.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, prompt 770 and/or progress bar 770d are displayed on display 736 of the HMD.

At FIG. 7P, computer system 700 displays representation 784 of user 708 as part of and/or after completing the process for capturing information about user 708. In some embodiments, representation 784 includes visual characteristics that are based on one or more physical characteristics of user 708 captured by computer system 700 (e.g., via sensor 734 and/or additional sensors of computer system 700). For instance, at FIG. 7P, representation 784 includes head representation 784b that includes visual characteristics based on one or more physical characteristics of head 708b of user 708 captured by computer system 700 (e.g., captured by computer system 700 while displaying prompt 744, prompt 766, and/or prompt 770). Representation 784 includes face representation 784c that incudes visual characteristics based on one or more physical characteristics of face 708c of user 708 captured by computer system 700 (e.g., captured while displaying prompt 744, prompt 766, and/or prompt 770). In other words, computer system 700 is configured to generate representation 784 of user 708 based on one or more physical characteristics of user 708 that are captured during the process for capturing information about user 708 described above with reference to FIGS. 7D-7O.

At FIG. 7P, computer system 700 displays confirm selectable option 786a and redo selectable option 786b while displaying representation 784 of user 708. In some embodiments, computer system 700 is configured to confirm, set, and/or otherwise enable representation 784 for use in a real-time communication session in response to detecting user input (e.g., an air gesture, a tap gesture, and/or a press gesture on a hardware input device of computer system 700) selecting confirm selectable option 786a. In some embodiments, computer system 700 is configured to initiate (e.g., re-initiate) the process for capturing information about user 708 in response to detecting user input (e.g., an air gesture, a tap gesture, and/or a press gesture on a hardware input device of computer system 700) selecting redo selectable option 786b. Accordingly, computer system 700 enables user 708 to view a preview of representation 784 and determine whether the visual characteristics of representation 784 are acceptable to user 708 (e.g., whether the visual characteristics of representation 784 accurately reflect and/or resemble physical characteristics of user 708). When user 708 determines that the visual characteristics of representation 784 are not acceptable to user 708, user 708 can cause computer system 700 to capture (e.g., re-capture) information about user 708 to generate (e.g., re-generate) representation 784 of user 708 so that representation 784 of user more accurately reflects and/or resembles an appearance of user 708.

In some embodiments, computer system 700 displays confirm selectable option 786a and/or redo selectable option 786b with a visual emphasis as compared to representation 784. For instance, in some embodiments, computer system 700 displays confirm selectable option 786a and/or redo selectable option 786b so that confirm selectable option 786a and/or redo selectable option 786b appear to be visually spaced in front of representation 784 (e.g., displayed as having a perceived depth that is less than a perceived depth of representation 784). As set forth above, in some embodiments, display 736 is a curved display and/or a lenticular display. Accordingly, in some embodiments, computer system 700 displays representation 784, confirm selectable option 786a, and/or redo selectable option 786b as appearing three-dimensional with respect to a perspective of user 708 viewing display 736. Thus, in some embodiments, computer system 700 is configured to visually emphasize confirm selectable option 786a and/or redo selectable option 786b so that user 708 can easily determine whether to confirm an appearance of representation 784 and/or capture additional information about user 708 to adjust visual characteristics of representation 784.

Computer system 700 is configured to animate and/or move representation 784 of user 708 over time so that user 708 can view different portions of representation 784 and better determine whether representation 784 is acceptable to user 708. In some embodiments, computer system 700 automatically (e.g., without user input and/or without detecting movement of computer system 700 and/or user 708 in physical environment 706) displays movement of representation 784 over time. Therefore, in some embodiments, user 708 can view different portions of representation 784 without moving and/or providing user inputs to computer system 700.

At FIG. 7P, computer system 700 displays first portion 788a of representation 784 of user 708 based on a detected orientation of head 708b, face 708c, and/or another portion of the body of user 708 relative to computer system 700. For instance, at FIG. 7P, user 708 holds computer system 700 in front of face 708c of user 708 while head 708b of user 708 is positioned straight forward and/or aligned with computer system 700 in physical environment 706. Based on detecting the orientation of head 708b, face 708c, and/or another portion of the body of user 708 relative to computer system 700, computer system 700 displays first portion 788a of representation 784, which includes head representation 784b and face representation 784c aligned and/or facing display 736 (e.g., a front facing perspective of representation 784).

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, representation 784 is displayed on display 736 of the HMD.

At FIG. 7P, computer system 700 detects movement 790a of user 708 and/or computer system 700 relative to one another along axis 746a. In response to detecting movement 790a of user 708 and/or computer system 700, computer system 700 displays second portion 788b of representation 784, as shown at FIG. 7Q.

At FIG. 7Q, second portion 788b of representation 784 is different from first portion 788a of representation 784 and second portion 788b of representation 784 is based on movement 790a of user 708 and/or computer system 700 relative to one another. As shown at FIG. 7Q, head 708b of user 708 has turned to the right of user 708 along axis 746a within physical environment 706 (e.g., when compared to a position of head 708b of user 708 shown at FIG. 7P). Based on movement 790a of user 708 and/or computer system 700 relative to one another, computer system 700 displays (e.g., updates display of) representation 784 to include second portion 788b. At FIG. 7Q, second portion 788b is a ¾ view of representation 784 as compared to the front facing view of first portion 788a of representation 784. In some embodiments, computer system 700 animates and/or displays movement of representation 784 to transition between displaying first portion 788a and second portion 788b of representation. At FIG. 7Q, computer system 700 displays second portion 788b as being a mirrored representation of user 708. In other words, computer system 700 displays movement of representation 784 (e.g., movement of head representation 784b) in direction 792 (e.g., to the left of representation 784) that mirrors movement 790a of user 708 and/or computer system 700 relative one another.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, representation 784 is displayed on display 736 of the HMD.

At FIG. 7Q, computer system 700 detects movement 790b of user 708 and/or computer system 700 relative to one another along axis 746a. In response to detecting movement 790b of user 708 and/or computer system 700, computer system 700 displays third portion 788c of representation 784, as shown at FIG. 7R.

At FIG. 7R, third portion 788c of representation 784 is different from first portion 788a of representation 784 and second portion 788b of representation 784. Third portion 788c of representation 784 is based on movement 790b of user 708 and/or computer system 700 relative to one another. As shown at FIG. 7R, head 708b of user 708 has turned further to the right of user 708 along axis 746a within physical environment 706 (e.g., when compared to a position of head 708b of user 708 shown at FIG. 7P and/or position of head 708b of user 708 shown at FIG. 7Q). Based on movement 790b of user 708 and/or computer system 700 relative to one another, computer system 700 displays (e.g., updates display of) representation 784 to include third portion 788c. At FIG. 7R, third portion 788c is a profile view of representation 784 as compared to the front facing view of first portion 788a of representation 784 and/or the ¾ view of second portion 788b of representation 784. In some embodiments, computer system 700 animates and/or displays movement of representation 784 to transition between displaying second portion 788b and third portion 788c of representation 784. At FIG. 7R, computer system 700 displays third portion 788c as being a mirrored representation of user 708. In other words, computer system 700 displays movement of representation 784 (e.g., movement of head representation 784b) further in direction 792 (e.g., to the left of representation 784) that mirrors movement 790b of user 708 and/or computer system 700 relative one another.

At FIGS. 7P-7R, computer system 700 displays representation 784 based on an amount of movement of user 708 and/or computer system 700 relative to one another. For instance, computer system 700 transitions from displaying first portion 788a (e.g., at FIG. 7P) of representation 784 to displaying second portion 788b (e.g., at FIG. 7Q) of representation based on movement 790a, which is a first amount of movement of user 708 and/or computer system 700 relative to one another in physical environment 706. Computer system 700 transitions from displaying second portion 788b (e.g., at FIG. 7Q) of representation 784 to displaying third portion 788c (e.g., at FIG. 7R) of representation 784 based on movement 790b, which is a second amount of movement of user 708 and/or computer system 700 relative to one another in physical environment 706. Accordingly, computer system 700 displays a respective portion of representation 784 based on a detected amount of movement of user 708 and/or computer system 700 relative to one another (e.g., detected via sensor 734 and/or another sensor of computer system 700) in physical environment 706.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, representation 784 is displayed on display 736 of the HMD.

At FIG. 7R, computer system 700 detects movement 790c of user 708 and/or computer system 700 relative to one another along axis 746a in a direction that is opposite to movement 790a and/or movement 790b. In response to detecting movement 790c of user 708 and/or computer system 700, computer system 700 displays fourth portion 788d of representation 784, as shown at FIG. 7S.

At FIG. 7S, fourth portion 788d of representation 784 is different from first portion 788a of representation 784, second portion 788b of representation 784, and third portion 788c of representation 784. Fourth portion 788d of representation 784 is based on movement 790c of user 708 and/or computer system 700 relative to one another. As shown at FIG. 7S, head 708b of user 708 has turned to the left of user 708 along axis 746a within physical environment 706 (e.g., when compared to a position of head 708b of user 708 shown at FIG. 7P, a position of head 708b of user 708 shown at FIG. 7Q, and/or a position of head 708b of user 708 shown at FIG. 7R). Based on movement 790c of user 708 and/or computer system 700 relative to one another, computer system 700 displays (e.g., updates display of) representation 784 to include fourth portion 788d. At FIG. 7S, fourth portion 788d is a ¾ view of a left side of representation 784. In some embodiments, computer system 700 animates and/or displays movement of representation 784 to transition between displaying third portion 788c and fourth portion 788d of representation 784. At FIG. 7S, computer system 700 displays fourth portion 788d as being a mirrored representation of user 708. In other words, computer system 700 displays movement of representation 784 (e.g., movement of head representation 784b) in direction 794 (e.g., to the right of representation 784) that mirrors movement 790c of user 708 and/or computer system 700 relative one another.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, representation 784 is displayed on display 736 of the HMD.

At FIG. 7S, computer system 700 detects movement 790d of user 708 and/or computer system 700 relative to one another along axis 746a in the same direction as movement 790c (and opposite a direction of movement 790a and/or movement 790b). In response to detecting movement 790d of user 708 and/or computer system 700, computer system 700 displays fifth portion 788e of representation 784, as shown at FIG. 7T.

At FIG. 7T, fifth portion 788e of representation 784 is different from first portion 788a of representation 784, second portion 788b of representation 784, third portion 788c of representation 784, and fourth portion 788d of representation 784. Fifth portion 788e of representation 784 is based on movement 790d of user 708 and/or computer system 700 relative to one another. As shown at FIG. 7T, head 708b of user 708 has turned further to the left of user 708 along axis 746a within physical environment 706 (e.g., when compared to a position of head 708b of user 708 shown at FIG. 7S). Based on movement 790d of user 708 and/or computer system 700 relative to one another, computer system 700 displays (e.g., updates display of) representation 784 to include fifth portion 788e. At FIG. 7T, fifth portion 788e is a profile view of a left side of representation 784. In some embodiments, computer system 700 animates and/or displays movement of representation 784 to transition between displaying fourth portion 788d and fifth portion 788e of representation 784. At FIG. 7T, computer system 700 displays fifth portion 788e as being a mirrored representation of user 708. In other words, computer system 700 displays movement of representation 784 (e.g., movement of head representation 784b) in direction 794 (e.g., to the right of representation 784) that mirrors movement 790d of user 708 and/or computer system 700 relative one another.

In some embodiments, computer system 700 is configured to display movement of representation 784 that mirrors movement of user 708 and/or computer system 700 relative to one another along axis 746a, axis 746b, and/or axis 746c. For instance, in some embodiments, computer system 700 displays representation 784 moving head representation 784b upward and/or downward based on movement of head 708b of user 708 along axis 746b relative to computer system 700. In some embodiments, computer system 700 displays representation 784 moving closer to and/or away from display 736 based on movement of user 708 along axis 746c relative to computer system 700. In some embodiments, computer system 700 is configured to display movement of representation 784 along multiple axes based on movement of user 708 along multiple axes (e.g., axes 746a, 746b, and/or 746c) relative to computer system 700.

As set forth above, in some embodiments, computer system 700 is the HMD, and display 736 is an exterior display of the HMD, which is different and/or separate from display 704. In other words, display 736 is configured to be viewed by user 708 while the HMD is not worn on head 708b of user 708. In some embodiments, representation 784 is displayed on display 736 of the HMD.

Additional descriptions regarding FIGS. 7A-7T are provided below in reference to methods 800, 900, 1000, 1100, 1200, and 1300 described with respect to FIGS. 7A-7T.

FIG. 8 is a flow diagram of an exemplary method 800 for providing guidance to a user during a process for generating a representation of the user, in accordance with some embodiments. In some embodiments, method 800 is performed at a computer system (e.g., 101 and/or 700) (e.g., a smartphone, a tablet, a watch, and/or a head-mounted device) that is in communication with one or more display generation components (e.g., 120, 704, and/or 736) (e.g., a heads-up display, a display, a touchscreen, and/or a projector) (e.g., a visual output device, a 3D display, and/or a display having at least a portion that is transparent or translucent on which images can be projected (e.g., a see-through display), a projector, a heads-up display, and/or a display controller) (and, optionally, that is in communication with and one or more cameras (e.g., an infrared camera, a depth camera, and/or a visible light camera)). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 800 are, optionally, combined and/or the order of some operations is, optionally, changed.

During an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation (e.g., 784) of a user (e.g., 708) (e.g., an avatar and/or a virtual representation of at least a portion of the user), where the enrollment process includes capturing (e.g., via the one or more cameras) information about one or more physical characteristics of a user (e.g., 708) of the computer system (e.g., 101 and/or 700) (e.g., data (e.g., image data, sensor data, and/or depth data) that represents a size, shape, position, pose, color, depth, and/or other characteristics of one or more body parts and/or features of body parts of the user) using a first sensor (e.g., 712 and/or 734) that is positioned on a same side (e.g., 710 and/or 714) of the computer system (e.g., 101 and/or 700) as a first display generation component (e.g., 120, 704, and/or 736) of the one or more display generation components (e.g., the same exterior face of the computer system, the first display generation component is at a position on and/or within the computer system that is proximate to the first sensor, and/or the first display generation component is at a position on and/or within the computer system, such that the first display generation component displays images appearing on an exterior face of the computer system that includes the first sensor), the computer system (e.g., 101 and/or 700) prompts (802) (e.g., a visual prompt displayed by the first display generation component, an audio prompt output via a speaker of the computer system, and/or a haptic prompt) the user (e.g., 708) of the computer system (e.g., 101 and/or 700) to move a position of a head (e.g., 708b) of the user (e.g., 708) relative to the computer system (e.g., 101 and/or 700) (e.g., a prompt instructing and/or guiding the user to move the head of the user in a particular direction and/or along a particular axis with respect to a position and/or orientation of the computer system in a physical environment in which the user is located). In some embodiments, the computer system (e.g., 101 and/or 700) is a head-mounted device and the first display generation component (e.g., 120, 704, and/or 736) is a display generation component that is configured to be viewed by the user (e.g., 708) when the head-mounted device is not placed on the head (e.g., 708b) of the user (e.g., 708) and/or over the eyes of the user (e.g., 708) and/or the first display generation component (e.g., 120, 704, and/or 736) is not configured to be viewed by the user (e.g., 708) when the head-mounted device is placed on the head (e.g., 708b) of the user (e.g., 708) and/or over the eyes of the user (e.g., 708).

After prompting the user (e.g., 708) of the computer system (e.g., 101 and/or 700) to move the position of the head (e.g., 708b) of the user (e.g., 708) relative to the orientation of the computer system (e.g., 101 and/or 700) (804) and in accordance with a determination that a threshold amount of information about a first physical characteristic (e.g., a first portion (e.g., left portion, right portion, upper portion, and/or lower portion) of a face of the user) of the one or more physical characteristics has been captured using the first sensor (e.g., 712 and/or 734) and based on the position of the head (e.g., 708b) of the user (e.g., 708) moving relative to the orientation of the computer system (e.g., 101 and/or 700) (e.g., the first sensor that is positioned on the same side of the computer system as the first display generation component has captured the first physical characteristic of the user as the user moves the position of the head of the user), the computer system (e.g., 101 and/or 700) outputs (806) a non-visual indication (e.g., 742, 758, 759, 762, and/or 764) (e.g., one or more audio indications and/or one or more haptic indications) confirming that the threshold amount of information about the first physical characteristic has been captured. In some embodiments, the computer system (e.g., 101 and/or 700) is configured to use the information about the first physical characteristic to generate the representation (e.g., 784) (e.g., a (2D or 3D) virtual representation, a (2D or 3D) avatar) of the user (e.g., 708) (e.g., the computer system generates a representation (e.g., an avatar) of the user that is based on the first physical characteristic and, optionally, other characteristics of the user, such that the representation of the user includes visual indications based on (e.g., with similar) sizes, shapes, positions, poses, colors, depths, and/or other characteristics of a body, hair, clothing, and/or other features of the user).

In some embodiments, in accordance with a determination that the threshold amount of information about the first physical characteristic of the one or more physical characteristics has not been captured (e.g., the sensor has not captured sufficient data associated with the first physical characteristic (e.g., due to a position of the user, due to movement of the user and/or a lack of movement of the user, due to movement of the computer system, due to an obstruction blocking the sensor, and/or due to an insufficient amount of time having passed for capturing the first physical characteristic)), the computer system (e.g., 101 and/or 700) forgoes outputting the non-visual confirmation (e.g., 742, 758, 759, 762, and/or 764) (and, optionally, continuing prompting the user of the computer system to move a position of a head of the user relative to an orientation of the computer system).

Outputting a non-visual indication confirming that the threshold amount of information about the first physical characteristic has been captured allows a user to quickly understand that the information about the first physical characteristic has been captured and prepare to move on to capturing a second physical characteristic, thereby reducing power usage and improving battery life of the computer system by enabling the user to use the computer system more quickly and efficiently.

In some embodiments, the computer system (e.g., 101 and/or 700) prompts the user (e.g., 708) of the computer system (e.g., 101 and/or 700) to move the position of the head (e.g., 708b) of the user (e.g., 708) relative to the computer system (e.g., 101 and/or 700) by displaying, via the first display generation component, a textual indication (e.g., 744a and/or 766a) (e.g., text and/or written words that provide guidance to the user of the computer system to move their head in a particular direction and/or toward a particular position with respect to the computer system). Displaying a textual indication prompting the user of the computer system to move the position of the head of the user relative to the computer system allows a user to quickly and easily understand how to move their head, thereby reducing power usage and improving battery life of the computer system by enabling the user to use the computer system more quickly and efficiently.

In some embodiments, the computer system (e.g., 101 and/or 700) prompts the user (e.g., 708) of the computer system (e.g., 101 and/or 700) to move the position of the head (e.g., 708b) of the user (e.g., 708) relative to the computer system (e.g., 101 and/or 700) by displaying, via the first display generation component, an arrow (e.g., 744b and/or 766b) pointing in a direction in which the position of the head (e.g., 708b) of the user (e.g., 708) is being prompted to move (e.g., a user interface object that points in a direction (e.g., left, right, up, and/or down) relative to a perspective of the user viewing the first display generation component toward the position in which the head of the user is being prompted to move). Displaying an arrow pointing in the direction in which the head of the user is being prompted to move allows a user to quickly and easily understand how to move their head, thereby reducing power usage and improving battery life of the computer system by enabling the user to use the computer system more quickly and efficiently.

In some embodiments, the computer system (e.g., 101 and/or 700) prompts the user (e.g., 708) of the computer system (e.g., 101 and/or 700) to move the position of the head (e.g., 708b) of the user (e.g., 708) relative to the computer system (e.g., 101 and/or 700) by displaying, via the first display generation component, an animated avatar (e.g., 718a and/or 728a) (e.g., a representation of another user or an avatar not associated with another user) that includes a head (e.g., 718c) of the animated avatar (e.g., 718a and/or 728a) moving (e.g., an animated series of images and/or a video that shows an avatar, such as an avatar of a user (e.g., a user different from the user of the computer system) or an avatar not of a user, moving a position of a representation of their head). In some embodiments, the head of the animated avatar moves in a direction (e.g., to the right of the animated avatar), which prompts the user to move the position of the head of the user relative to the computer system in a predetermined and/or desired direction (e.g., to the left of the user) that enables the computer system to capture the threshold amount of information about the first physical characteristic. Displaying an animated representation of an avatar moving their head to prompt the user of the computer system to move the position of the head of the user relative to the computer system allows a user to quickly and easily understand how to move their head relative to the computer system, thereby reducing power usage and improving battery life of the computer system by enabling the user to use the computer system more quickly and efficiently.

In some embodiments, the computer system (e.g., 101 and/or 700) provides feedback (e.g., 750, 754, 755, 756, 758, 759, 760, 762, and/or 764) (e.g., visual feedback, audio feedback, and/or haptic feedback) indicative of detected movement of the position of the head (e.g., 708b) of the user (e.g., 708) relative to the orientation of the computer system (e.g., 101 and/or 700) toward a target position (e.g., as the computer system detects and/or receives information about movement of the position of the head of the user toward the target position, the computer system outputs feedback that indicates where the position of the head of the user is located relative to the target position). In some embodiments, the target position includes a position that enables the computer system (e.g., 101 and/or 700) to capture the threshold amount of information about the first physical characteristic of the one or more physical characteristics of the user (e.g., 708). Providing feedback indicative of the movement of the position of the head of the user relative to the computer system toward a target position allows a user to quickly and easily understand whether to continue moving their head, stop moving their head, and/or move their head in a different direction, thereby reducing power usage and improving battery life of the computer system by enabling the user to use the computer system more quickly and efficiently.

In some embodiments, the computer system (e.g., 101 and/or 700) provides the feedback (e.g., 750, 754, 755, 756, 758, 759, 760, 762, and/or 764) indicative of the detected movement of the position of the head (e.g., 708b) of the user (e.g., 708) relative to the orientation of the computer system (e.g., 101 and/or 700) toward the target position by displaying, via the first display generation component (e.g., 120, 704, and/or 736), a portion (e.g., 752a) of the first display generation component (e.g., 120, 704, and/or 736) having a first color (e.g., a color of progress indicator 750) (e.g., the portion of the first display generation component includes the first color and a second portion (e.g., a remaining portion that does not include the portion), different from the portion, includes a second color (e.g., black) that is different from the first color), and the portion (e.g., 752a) of the first display generation component (e.g., 120, 704, and/or 736) increases in size (e.g., the portion of the first display generation component that includes the first color increases in size relative to the second portion of the display generation component) as the position of the head (e.g., 708b) of the user (e.g., 708) relative to the orientation of the computer system (e.g., 101 and/or 700) moves closer to the target position (e.g., the portion of the first display generation component indicates an amount of progress toward the position of the head of the user being at the target position, such that the portion increases in size as the position of the head of the user moves closer to the target position). Displaying the portion of the first display generation component having the first color that increases in size as the position of the head of the user relative to the orientation of the computer system moves closer to the target position allows a user to quickly and easily understand whether to continue moving their head, stop moving their head, and/or move their head in a different direction, thereby reducing power usage and improving battery life of the computer system by enabling the user to use the computer system more quickly and efficiently.

In some embodiments, the feedback (e.g., 750, 754, 755, 756, 758, 759, 760, 762, and/or 764) indicative of the detected movement of the position of the head (e.g., 708b) of the user (e.g., 708) relative to the orientation of the computer system (e.g., 101 and/or 700) toward the target position changes (e.g., adjusts in appearance, in volume level, in tone, in frequency, in intensity, and/or in brightness) based on detecting movement of the position of the head (e.g., 708b) of the user (e.g., 708) relative to the orientation of the computer system (e.g., 101 and/or 700) (e.g., change in direction and/or change in magnitude) (e.g., the feedback changes and/or adjusts to indicate an amount of progress toward the position of the head of the user reaching the target position). Changing the feedback based on detecting movement of the position of the head of the user relative to the orientation of the computer system allows a user to quickly and easily understand whether to continue moving their head, stop moving their head, and/or move their head in a different direction, thereby reducing power usage and improving battery life of the computer system by enabling the user to use the computer system more quickly and efficiently.

In some embodiments, after the computer system (e.g., 101 and/or 700) prompts the user (e.g., 708) of the computer system (e.g., 101 and/or 700) to move the position of the head (e.g., 708b) of the user (e.g., 708) relative to the orientation of the computer system (e.g., 101 and/or 700), the computer system (e.g., 101 and/or 700) displays, via the first display generation component (e.g., 120, 704, and/or 736), an image of the user (e.g., 708) (e.g., captured via the first sensor and/or a different sensor) (e.g., the first sensor includes a camera that is configured to capture an image of the user and provide information to the computer system about the image of the user so that the computer system displays the image of the user and the user can determine whether the position of the head of the user is in a predetermined position relative to the orientation of the computer system). In some embodiments, the image of the user (e.g., 708) is a live feed of a camera of the computer system (e.g., 101 and/or 700). In some embodiments, the image of the user (e.g., 708) is a live feed of a camera of the computer system (e.g., 101 and/or 700) that updates over time as a field of view of the camera changes and/or as the position of the head (e.g., 708b) of the user (e.g., 708) moves relative to the orientation of the computer system (e.g., 101 and/or 700). Displaying the image of the user captured allows a user to quickly and easily understand whether to continue moving their head, stop moving their head, and/or move their head in a different direction, thereby reducing power usage and improving battery life of the computer system by enabling the user to use the computer system more quickly and efficiently.

In some embodiments, displaying the image of the user (e.g., 708) (e.g., captured via the first sensor and/or captured via a second sensor) includes the computer system (e.g., 101 and/or 700) shifting (e.g., displaying the image of the user at a particular orientation and/or position by applying an amount of skew, distortion, and/or another visual effect to the image of the user), via the first display generation component (e.g., 120, 704, and/or 736), a position of the image of the user (e.g., 708) to prompt the user (e.g., 708) to point the first sensor (e.g., 712 and/or 734) in a predetermined orientation with respect to the user (e.g., 708) (e.g., the image of the user is shifted to a position that is off center and/or otherwise not aligned with edges of the first display generation component, which causes the user of the computer system to adjust an orientation of the computer system and/or adjust a position of a portion of a body of the user so that a sensing area of the first sensor is pointing at and/or includes the user of the computer system (e.g., at the head and/or face of the user of the computer system)). Shifting the image of the user on the first display generation component to prompt the user to point the first sensor in a predetermined orientation with respect to the user allows a user to quickly and easily align the computer system with the user to capture the first physical characteristic of the one or more physical characteristics, thereby reducing power usage and improving battery life of the computer system by enabling the user to use the computer system more quickly and efficiently.

In some embodiments, after the computer system (e.g., 101 and/or 700) prompts the user (e.g., 708) of the computer system (e.g., 101 and/or 700) to move the position of the head (e.g., 708b) of the user (e.g., 708) relative to the orientation of the computer system (e.g., 101 and/or 700), the computer system (e.g., 101 and/or 700) displays, via the first display generation component (e.g., 120, 704, and/or 736), a visual indicator (e.g., 750) (e.g., a ball, an orb, and/or another shape that represents the position of the head of the user relative to the orientation of the computer system and/or that represents the position of the head of the user relative to a target position of the head of the user) of the position of the head (e.g., 708b) of the user (e.g., 708) relative to the orientation of the computer system (e.g., 101 and/or 700), where the visual indicator (e.g., 750) does not include an image of the user (e.g., 708) (e.g., the visual indicator does not include an image, video, and/or features representative of the user of the computer system captured by the first sensor and/or another sensor of the computer system). Displaying the visual indicator of the position of the head of the user relative to the orientation of the computer system allows a user to quickly and easily understand whether to continue moving their head, stop moving their head, and/or move their head in a different direction without using additional power to display an image of the user, thereby reducing power usage and improving battery life of the computer system by enabling the user to use the computer system more quickly and efficiently.

In some embodiments, the non-visual indication (e.g., 742, 758, 759, 762, and/or 764) confirming that the threshold amount of information about the first physical characteristic has been captured includes audio feedback (e.g., 742, 758, and/or 762) (e.g., audio output via an audio output device (e.g., a speaker) in communication with the computer system). In some embodiments, the audio feedback (e.g., 742, 758, and/or 762) includes continuous audio output. In some embodiments, the audio feedback (e.g., 742, 758, and/or 762) includes bursts of audio output that occur at predetermined intervals of time. Outputting audio confirming that the threshold amount of information about the first physical characteristic has been captured allows a user to quickly understand that the information about the first physical characteristic has been captured and prepare to move on to capturing a second physical characteristic, thereby reducing power usage and improving battery life of the computer system by enabling the user to use the computer system more quickly and efficiently.

In some embodiments, the audio feedback (e.g., 742, 758, and/or 762) includes first audio feedback (e.g., 742, 758, and/or 762) (e.g., first audio output via an audio output device (e.g., a speaker) in communication with the computer system that includes first audio properties (e.g., first volume, first frequency, first tone, first wavelength, first melody, and/or first pitch)). After the computer system (e.g., 101 and/or 700) prompts the user (e.g., 708) of the computer system (e.g., 101 and/or 700) to move the position of the head (e.g., 708b) of the user (e.g., 708) relative to the orientation of the computer system (e.g., 101 and/or 700), the computer system (e.g., 101 and/or 700) outputs second audio feedback (e.g., 741, 748, and/or 754) (e.g., second audio output via an audio output device (e.g., a speaker) in communication with the computer system that includes second audio properties (e.g., second volume, second frequency, second tone, second wavelength, second melody, and/or second pitch)) based on the position of the head (e.g., 708b) of the user (e.g., 708) relative to the orientation of the computer system (e.g., 101 and/or 700) approaching a target position (e.g., a position of the head of the user relative to the orientation of the computer system that enables the computer system to capture the first physical characteristic of the one or more physical characteristics). Outputting second audio feedback based on the position of the head of the user relative to the orientation of the computer system approaching a target position allows the user to understand when to stop moving the position of their head and the computer system to capture the first physical characteristic more quickly, thereby reducing power usage and improving battery life of the computer system by enabling the user to use the computer system more quickly and efficiently.

In some embodiments, after prompting the user (e.g., 708) of the computer system (e.g., 101 and/or 700) to move the position of the head (e.g., 708b) of the user (e.g., 708) relative to the orientation of the computer system (e.g., 101 and/or 700), in accordance with a determination that the threshold amount of information about the first physical characteristic (e.g., a first portion (e.g., left portion, right portion, upper portion, and/or lower portion) of a face of the user) of the one or more physical characteristics has been captured using the first sensor (e.g., 712 and/or 734), and based on the position of the head (e.g., 708b) of the user (e.g., 708) moving relative to the orientation of the computer system (e.g., 101 and/or 700) (e.g., the first sensor that is positioned on the same side of the computer system as the first display generation component has captured the first physical characteristic of the user as the user moves the position of the head of the user), the computer system (e.g., 101 and/or 700) displays, via the first display generation component (e.g., 120, 704, and/or 736), visual feedback (e.g., 750, 756, and/or 760) (e.g., a user interface object, such as a filled progress bar, a check mark, and/or text) confirming that the threshold amount of information about the first physical characteristic has been captured (e.g., the computer system has captured enough information about the first physical characteristic to generate at least a portion of the representation of the user). Displaying visual feedback confirming that the threshold amount of information about the first physical characteristic has been captured allows a user to quickly understand that the information about the first physical characteristic has been captured and prepare to move on to capturing a second physical characteristic, thereby reducing power usage and improving battery life of the computer system by enabling the user to use the computer system more quickly and efficiently.

In some embodiments, displaying the visual feedback (e.g., 750, 756, and/or 760) confirming that the threshold amount of information about the first physical characteristic has been captured includes the computer system (e.g., 101 and/or 700) changing a color (e.g., a color of progress indicator 750 as shown at FIG. 7I and a color of confirmation indicator 760 as shown at FIG. 7J) (e.g., transitioning from displaying a progress indicator with a first color to displaying the progress indicator with a second color, different from the first color) of at least a portion of a progress indicator (e.g., 750) (e.g., a progress bar and/or a portion of the first display generation component that indicates an amount of information captured about the first physical characteristic as compared to the threshold amount of information). In some embodiments, the progress indicator (e.g., 750) is the portion (e.g., 752a) of the first display generation component (e.g., 120, 704, and/or 736) having the first color that increases in size as the position of the head (e.g., 708b) of the user (e.g., 708) moves relative to the orientation of the computer system (e.g., 101 and/or 700). In some embodiments, the computer system (e.g., 101 and/or 700) updates an appearance of the progress indicator (e.g., 750) over time based on movement of the position of the head (e.g., 708b) of the user (e.g., 708) relative to the orientation of the computer system (e.g., 101 and/or 700) and/or as the enrollment process progresses over time. Adjusting a color of a progress indicator allows a user to quickly understand that the information about the first physical characteristic has been captured and prepare to move on to capturing a second physical characteristic, thereby reducing power usage and improving battery life of the computer system by enabling the user to use the computer system more quickly and efficiently.

In some embodiments, displaying the visual feedback (e.g., 750, 756, and/or 760) confirming that the threshold amount of information about the first physical characteristic has been captured includes the computer system (e.g., 101 and/or 700) displaying, via the first display generation component (e.g., 120, 704, and/or 736), a flashing animation (e.g., 760) (e.g., temporary increase in brightness of the first display generation component followed by a decrease in brightness of the first display generation component and/or displaying a first predefined color (e.g., white or off-white) on the first display generation component for a predetermined amount of time (e.g., half a second or one second) followed by displaying a second predefined color after the predetermined amount of time has elapsed). Displaying a flashing animation allows the computer system to quickly convey to a user that the information about the first physical characteristic has been captured and that the user should prepare to move on to capturing a second physical characteristic, thereby reducing power usage and improving battery life of the computer system by enabling the user to use the computer system more quickly and efficiently. In addition, displaying a flashing animation allows a user of the computer system to determine that the information about the first physical characteristic has been captured even when the user is not looking directly at the computer system, thereby providing improved visual feedback.

In some embodiments, after prompting the user (e.g., 708) of the computer system (e.g., 101 and/or 700) to move the position of the head (e.g., 708b) of the user (e.g., 708) relative to the orientation of the computer system (e.g., 101 and/or 700), the computer system (e.g., 101 and/or 700) displays, via the first display generation component (e.g., 120, 704, and/or 736), a progress indicator (e.g., 750) indicative of detected movement of the position of the head (e.g., 708b) of the user (e.g., 708) relative to the orientation of the computer system (e.g., 101 and/or 700) toward a target position (e.g., a progress bar and/or a portion of the first display generation component that indicates an amount of information captured about the first physical characteristic as compared to the threshold amount of information), where a color of the progress indicator (e.g., 750) (e.g., a color of fill within a progress bar and/or a color of a portion of the first display generation component) is based on a color of a physical environment (e.g., 706) in which the computer system (e.g., 101 and/or 700) is located (e.g., the color of the progress indicator is based on information (e.g., received from one or more sensors in communication with the computer system) about a particular color and/or a combination of colors present in a physical environment in which the computer system is located (e.g., a portion of the physical environment that is within a sensing area of the one or more sensors)). Displaying a progress indicator with a first color that is based on a second color of a physical environment in which the computer system is located provides a more varied, detailed, and/or realistic user experience.

In some embodiments, while capturing the first physical characteristic (or alternatively, a second physical characteristic) (e.g., a portion of a face, mouth, lips, eyes, and/or hands) of the one or more physical characteristics of the user (e.g., 708) of the computer system (e.g., 101 and/or 700) using the first sensor (e.g., 712 and/or 734), the computer system (e.g., 101 and/or 700) displays, via the first display generation component (e.g., 120, 704, and/or 736), an indication (e.g., 750) of an amount of progress toward completing capturing information about the first physical characteristic of the one or more physical characteristics (e.g., a countdown, a progress bar, and/or a portion of the first display generation component that indicates an amount of information captured about the second physical characteristic as compared a the threshold amount of information that is needed to complete capturing the information about the second physical characteristic). Displaying an indication of an amount of progress toward completing capturing information about the second physical characteristic of the one or more physical characteristics allows a user to quickly understand that the information about the second physical characteristic has been captured and prepare to move on to capturing a third physical characteristic, thereby reducing power usage and improving battery life of the computer system by enabling the user to use the computer system more quickly and efficiently.

In some embodiments, prompting the user (e.g., 708) of the computer system (e.g., 101 and/or 700) to move the position of the head (e.g., 708b) of the user (e.g., 708) relative to the computer system (e.g., 101 and/or 700) includes the computer system (e.g., 101 and/or 700) prompting (e.g., via prompt 744 and/or 766) the user (e.g., 708) of the computer system (e.g., 101 and/or 700) to move the position of the head (e.g., 708b) of the user (e.g., 708) in a first direction (e.g., left, right, up, and/or down) relative to the computer system (e.g., 101 and/or 700). After outputting the non-visual indication (e.g., 742, 758, 759, 762, and/or 764) confirming that the threshold amount of information about the first physical characteristic has been captured, the computer system (e.g., 101 and/or 700) prompts (e.g., via prompt 744 and/or 766) (e.g., a visual prompt displayed by the first display generation component, an audio prompt output via a speaker of the computer system, and/or a haptic prompt) the user (e.g., 708) of the computer system (e.g., 101 and/or 700) to move the position of the head (e.g., 708b) of the user (e.g., 708) in a second direction (e.g., left, right, up, and/or down), different from the first direction, relative to the computer system (e.g., 101 and/or 700) (e.g., a prompt instructing and/or guiding the user to move the head of the user in the second direction and/or along a particular axis with respect to a position and/or orientation of the computer system in a physical environment in which the user is located). Prompting the user of the computer system to move the position of the head of the user in a second direction after outputting the non-visual indication confirming that the threshold amount of information about the first physical characteristic allows a user to quickly prepare to move on to capturing a second physical characteristic, thereby reducing power usage and improving battery life of the computer system by enabling the user to use the computer system more quickly and efficiently.

In some embodiments, the computer system (e.g., 101 and/or 700) prompts (e.g., via prompt 744 and/or 766) the user (e.g., 708) of the computer system (e.g., 101 and/or 700) to move the position of the head (e.g., 708b) of the user (e.g., 708) in three or more directions (e.g., left, right, up, and/or down). In some embodiments, the computer system (e.g., 101 and/or 700) captures details about physical characteristics of the user (e.g., 708) while the user (e.g., 708) moves the position of the head (e.g., 708b) of the user (e.g., 708) in the three or more directions. In some embodiments, the computer system (e.g., 101 and/or 700) outputs sequential prompts (e.g., prompts 744 and/or 766) that guide the user (e.g., 708) to move the position of the head (e.g., 708b) of the user (e.g., 708) in the three or more directions (e.g., a first prompt guiding the user to move the position of the head of the user in a first direction, followed by a second prompt guiding the user to move the position of the head of the user in a second direction, followed by a third prompt guiding the user to move the position of the head of the user in a third direction). Prompting the user of the computer system to move the position of the head of the user in three or more directions allows a user to quickly transition between capturing the one or more physical characteristics of the user and reduces an amount of time required to capture the one or more physical characteristics of the user, thereby reducing power usage and improving battery life of the computer system by enabling the user to use the computer system more quickly and efficiently.

In some embodiments, after outputting the non-visual indication (e.g., 742, 758, 759, 762, and/or 764) confirming that the threshold amount of information about the first physical characteristic has been captured, the computer system (e.g., 101 and/or 700) prompts (e.g., via prompt 770) the user (e.g., 708) of the computer system (e.g., 101 and/or 700) to make one or more facial expressions (e.g., one or more particular and/or predetermined facial expressions (e.g., smile with mouth closed, smile with mouth open, and/or raised eyebrow expression) and/or general facial expressions (e.g., a prompt guiding the user to move a position of eyes, eyebrows, lips, forehead, and/or cheeks of a face of the user over time without providing an indication of one or more particular and/or predetermined facial expression)). In some embodiments, the computer system (e.g., 101 and/or 700) outputs sequential prompts (e.g., prompt 770) that guide the user (e.g., 708) to make respective facial expressions of the one or more facial expressions (e.g., a first prompt guiding the user to make a first facial expression, followed by a second prompt guiding the user to make a second facial expression, followed by a third prompt guiding the user to make a third facial expression). Prompting the user of the computer system to make one or more facial expressions after outputting the non-visual indication confirming that the threshold amount of information about the first physical characteristic has been captured allows a user to quickly transition between capturing the one or more physical characteristics of the user and reduces an amount of time needed to capture the one or more physical characteristics of the user, thereby reducing power usage and improving battery life of the computer system by enabling the user to use the computer system more quickly and efficiently.

In some embodiments, prompting the user (e.g., 708) of the computer system (e.g., 101 and/or 700) to make the one or more facial expressions includes the computer system (e.g., 101 and/or 700) outputting a countdown (e.g., 770b and/or 770c) (e.g., displaying and/or outputting audio associated with a timer that counts down from a predetermined amount of time (e.g., three seconds or five seconds)) indicative of a time at which the computer system (e.g., 101 and/or 700) captures information (e.g., capture the one or more facial expressions) (e.g., a time at which the computer system uses and/or activates one or more sensors in communication with the computer system to capture information about the facial expression (e.g., information about mouth of the user, which is used to determine whether the position of the mouth of the user matches and/or corresponds to the one or more facial expressions)). Outputting a countdown indicative of a time at which the computer system captures information about the user allows a user to prepare to make one or more facial expressions and reduces an amount of time needed to capture the one or more physical characteristics of the user, thereby reducing power usage and improving battery life of the computer system by enabling the user to use the computer system more quickly and efficiently.

In some embodiments, prompting the user (e.g., 708) of the computer system (e.g., 101 and/or 700) to make the one or more facial expressions includes the computer system (e.g., 101 and/or 700) prompting (e.g., via prompt 770) a user (e.g., 708) to make one or more general facial expressions (e.g., displaying a visual indication and/or outputting audio instructing and/or prompting the user of the computer system to make some faces without guiding and/or instructing the user to make a specific facial expression). Prompting the user to make one or more general facial expressions allows a user to cycle through different facial expressions instead of spending time matching particular facial expressions and reduces an amount of time needed to capture the one or more physical characteristics of the user, thereby reducing power usage and improving battery life of the computer system by enabling the user to use the computer system more quickly and efficiently.

In some embodiments, after capturing the information about the one or more physical characteristics of the user (e.g., 708), the computer system (e.g., 101 and/or 700) displays, via the first display generation component (e.g., 120, 704, and/or 736), a preview of a representation (e.g., 784) of the user (e.g., 708) (e.g., an unedited, preliminary, and/or first version of the representation of the user that includes a first appearance (e.g., the computer system is configured to, in response to one or more user inputs, edit the representation of the user to include a second appearance before using the representation of the user during a real-time communication)), where the representation (e.g., 784) is based on at least some of the captured information. Displaying a preview of the representation of the user after capturing the one or more physical characteristics of the user allows a user to view the representation of the user and/or edit the representation of the user, if desired, which provides a more varied, detailed, and/or realistic user experience.

In some embodiments, prompting the user (e.g., 708) of the computer system (e.g., 101 and/or 700) to move the position of the head (e.g., 708b) of the user (e.g., 708) relative to the computer system (e.g., 101 and/or 700) includes the computer system (e.g., 101 and/or 700) displaying, via the first display generation component (e.g., 736), a visual indication (e.g., 744, 744a, 744b, 750, 766, 766a, and/or 766b) associated with movement of the position of the head (e.g., 708b) of the user (e.g., 708) relative to the computer system (e.g., 101 and/or 700) (e.g., text, an arrow, and/or an animated representation of another user that provide guidance to the user of the computer system to move their head in a particular direction and/or toward a particular position with respect to the computer system and/or a progress bar and/or a portion of the first display generation component that indicates an amount of information captured about the first physical characteristic as compared to the threshold amount of information). In some embodiments, the first display generation component (e.g., 736) is positioned on an outer portion (e.g., 714) of the computer system (e.g., 101 and/or 700) (e.g., the first display generation component is positioned on, included in, and/or located on an outer surface of the computer system, where the outer surface is different from an inner surface that is configured to be viewed and/or seen by the user of the computer system while the user wears and/or uses the computer system in a primary mode of operation). In some embodiments, a second display generation component (e.g., 704), different from the first display generation component (e.g., 736), of the one or more display generation components (e.g., 120, 704, and/or 736) is a primary display generation component (e.g., a display that is larger than the first display, a display that is higher resolution than the first display, and/or a display that is configured to display more colors than the first display) of the computer system (e.g., 101 and/or 700) while the computer system (e.g., 101 and/or 700) is in a normal mode of operation (e.g., the second display generation component is positioned on, included in, and/or located on an inner surface of the computer system, where the inner surface is configured to be viewed and/or seen by the user when the computer system is used in a normal and/or primary mode of operation (e.g., a mode of operation that does not include capturing the one or more physical characteristics of the user)).

Displaying a visual indication associated with movement of the position of the head of the user relative to the computer system on the first display generation component that is positioned on an outer portion of the computer system allows a user to easily receive feedback while the one or more physical characteristics of the user are captured without having to change an orientation of the computer system, thereby reducing power usage and improving battery life of the computer system by enabling the user to use the computer system more quickly and efficiently.

In some embodiments, the first display generation component (e.g., 736) and the first sensor (e.g., 734) are positioned on a first side (e.g., 714) of the computer system (e.g., 101 and/or 700) (e.g., the first display generation component is positioned on, included in, and/or located on an outer surface and/or side of the computer system, where the outer surface is different from an inner surface and/or side that is configured to be viewed and/or seen by the user of the computer system while the user wears and/or uses the computer system in a primary mode of operation) and the second display generation component (e.g., 704) is positioned on a second side (e.g., 710) (e.g., the second display generation component is positioned on, included in, and/or located on an inner surface and/or side of the computer system, where the inner surface and/or side is configured to be viewed and/or seen by the user when the computer system is used in a normal and/or primary mode of operation (e.g., a mode of operation that does not include capturing the one or more physical characteristics of the user)), different from the first side (e.g., 714), of the computer system (e.g., 101 and/or 700). In some embodiments, the second display generation component (e.g., 704) is configured to display an augmented reality user interface (e.g., a simulated environment in which one or more virtual objects are superimposed over a physical environment, or a representation thereof and/or a simulated environment in which a representation of a physical environment is transformed by computer-generated sensory information). Displaying a visual indication associated with movement of the position of the head of the user relative to the computer system on the first display generation component that is positioned on an outer portion of the computer system allows a user to easily receive feedback while the one or more physical characteristics of the user are captured without having to change an orientation of the computer system, thereby reducing power usage and improving battery life of the computer system by enabling the user to use the computer system more quickly and efficiently.

In some embodiments, during the enrollment process for generating a representation (e.g., 784) of the user (e.g., 708) (e.g., before capturing information about the one or more physical characteristics of the user and/or while capturing information about the one or more physical characteristics of the user) and in accordance with a determination that a set of one or more criteria is met (e.g., one or more sensors in communication with the computer system provide information to the computer system indicating that a physical environment in which the computer system is located does not include sufficient lighting for capturing the one or more physical characteristics of the user, an object and/or hair of the user is blocking and/or covering a portion of a body (e.g., a face) of the user, and/or a position of a portion of the body of the user is not in a target position and/or orientation relative to the orientation of the computer system), the computer system (e.g., 101 and/or 700) prompts (e.g., via prompt 732) the user (e.g., 708) of the computer system (e.g., 101 and/or 700) to perform one or more actions (e.g., displaying a visual indication, outputting audio, and/or outputting haptic feedback that guides a user to move a position of a portion of a body of the user relative to the orientation of the computer system, move a position and/or orientation of the computer system, move and/or adjust a position of one or more physical objects within a physical environment in which the computer system is located, and/or move and/or adjust a position of hair of the user of the computer system). Prompting the user of the computer system to perform one or more actions in accordance with a determination that a set of one or more criteria is met allows a user to improve conditions for capturing the one or more physical characteristics of the user so that the user does not have to spend additional time capturing the one or more physical characteristics of the user, thereby reducing power usage and improving battery life of the computer system by enabling the user to use the computer system more quickly and efficiently. In addition, prompting the user of the computer system to perform one or more actions in accordance with a determination that a set of one or more criteria is met allows the computer system to more accurately capture the one or more physical characteristics of the user, thereby providing a more varied, detailed, and/or realistic user experience.

In some embodiments, the one or more actions include moving to a physical environment (e.g., 706) with at least a threshold amount of lighting (e.g., displaying a visual indication, outputting audio, and/or outputting haptic feedback guiding a user to increase and/or reduce an amount of light in a physical environment in which the computer system is located and/or to move to a different physical environment that includes an increased and/or reduced amount of lighting as compared to a current physical environment in which the computer system is located). Prompting the user of the computer system to move to a physical environment with at least a threshold amount of lighting in accordance with a determination that a set of one or more criteria is met allows a user to improve conditions for capturing the one or more physical characteristics of the user so that the user does not have to spend additional time capturing the one or more physical characteristics of the user, thereby reducing power usage and improving battery life of the computer system by enabling the user to use the computer system more quickly and efficiently.

In some embodiments, the one or more actions include moving hair of the user (e.g., 708) away from a face (e.g., 708c) of the user (e.g., 708) (e.g., displaying a visual indication, outputting audio, and/or outputting haptic feedback guiding a user to move and/or remove hair that is blocking, covering, and/or obstructing the face of the user). Prompting the user of the computer system to move hair away from a face of the user in accordance with a determination that a set of one or more criteria is met allows a user to improve conditions for capturing the one or more physical characteristics of the user so that the user does not have to spend additional time capturing the one or more physical characteristics of the user, thereby reducing power usage and improving battery life of the computer system by enabling the user to use the computer system more quickly and efficiently.

In some embodiments, the one or more actions include positioning a face (e.g., 708c) of the user (e.g., 708) in a predefined orientation relative to the computer system (e.g., 101 and/or 700) (e.g., displaying a visual indication (e.g., a frame displayed on the first display generation component), outputting audio, and/or outputting haptic feedback guiding a user to move the face of the user in a particular direction and/or along a particular axis with respect to a position and/or orientation of the computer system in a physical environment in which the user is located). Prompting the user of the computer system to move a position of a face of the user in a predefined orientation relative to the computer system in accordance with a determination that a set of one or more criteria is met allows a user to improve conditions for capturing the one or more physical characteristics of the user so that the user does not have to spend additional time capturing the one or more physical characteristics of the user, thereby reducing power usage and improving battery life of the computer system by enabling the user to use the computer system more quickly and efficiently.

In some embodiments, aspects/operations of methods 900, 1000, 1100, 1200, 1300, 1500, and/or 1700 may be interchanged, substituted, and/or added among these methods. For example, the non-visual indication output in method 800 is optionally output by computer systems configured to perform methods 900, 1000, 1100, 1200, 1300, 1500, and/or 1700. For brevity, these details are not repeated here.

FIG. 9 is a flow diagram of an exemplary method 900 for displaying a preview of a representation of a user, in accordance with some embodiments. In some embodiments, method 900 is performed at a computer system (e.g., 101 and/or 700) (e.g., a smartphone, a tablet, and/or head-mounted device) that is in communication with one or more display generation components (e.g., 120, 704, and/or 736) (e.g., a visual output device, a 3D display, a display having at least a portion that is transparent or translucent on which images can be projected (e.g., a see-through display), a projector, a heads-up display, and/or a display controller) (and, optionally, that is in communication with and one or more cameras (e.g., an infrared camera; a depth camera; a visible light camera)). In some embodiments, the method 900 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 900 are, optionally, combined and/or the order of some operations is, optionally, changed.

The computer system (e.g., 101 and/or 700) captures (902) information about one or more physical characteristics (e.g., data (e.g., image data, sensor data, and/or depth data) that represents a size, shape, position, pose, color, depth, and/or other characteristics of one or more body parts and/or features of body parts of the user) of a user (e.g., 708) of the computer system (e.g., 101 and/or 700).

After capturing (e.g., during an enrollment process) information about the one or more physical characteristics (e.g., data (e.g., image data, sensor data, and/or depth data) that represents a size, shape, position, pose, color, depth, and/or other characteristics of one or more body parts and/or features of body parts of the user) of the user (e.g., 708) of the computer system (e.g., 101 and/or 700), the computer system (e.g., 101 and/or 700) displays (904), via a first display generation component (e.g., 120, 704, and/or 736) of the one or more display generation components, a first portion (e.g., 788a, 788b, 788c, 788d, and/or 788e) (e.g., a first portion of representations of one or more body parts of the user) of a representation (e.g., 784) of the user (e.g., 708) (e.g., the portion of the representation of the user is displayed at a first orientation on the first display generation component and/or at a first orientation within an environment displayed on the first display generation component) without displaying a second portion (e.g., 788a, 788b, 788c, 788d, and/or 788e) of the representation (e.g., 784) of the user (e.g., 708), where one or more physical characteristics of the representation (e.g., 784) of the user (e.g., 708) are based on the information about the one or more physical characteristics of the user (e.g., 708) (e.g., the information related to the user of the computer system to generate a representation (e.g., an avatar) of the user that includes visual indications similar to the captured and/or detected size, shape, position, pose, color, depth, and/or other characteristics of a body, clothing, hair, and/or features of the first user). In some embodiments, the computer system (e.g., 101 and/or 700) generates a representation (e.g., 784) of the user (e.g., 708) (e.g., an avatar and/or a virtual representation of at least a portion of the first user) based on the information about the one or more physical characteristics of the user (e.g., 708), including selecting one or more physical characteristics of the representation (e.g., 784) based on the one or more captured physical characteristics of the user (e.g., 708) (e.g., the computer system uses the information related to the user of the computer system to generate a representation (e.g., an avatar) of the user that includes visual indications similar to the captured and/or detected size, shape, position, pose, color, depth, and/or other characteristics of a body, clothing, hair, and/or features of the user).

While displaying, via the first display generation component (e.g., 120, 704, and/or 736), the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708), the computer system (e.g., 101 and/or 700) detects (906) a change in an orientation of the computer system (e.g., 101 and/or 700) relative to the user (e.g., 708) of the computer system (e.g., 101 and/or 700) (e.g., the user physically moves the computer system with respect to one or more body parts of the user, the user physically moves one or more body parts of the user with respect to the computer system, and/or the user physically moves one or more body parts of the user and the computer system with respect to one another).

In response to detecting the change in the orientation of the computer system (e.g., 101 and/or 700) relative to the user (e.g., 708) of the computer system (e.g., 101 and/or 700), the computer system (e.g., 101 and/or 700) displays (908), via the first display generation component (e.g., 120, 704, and/or 736) of the one or more display generation components, the second portion (e.g., 788a, 788b, 788c, 788d, and/or 788e) of the representation (e.g., 784) of the user (e.g., 708) (e.g., a second portion of representations of one or more body parts of the user), different from the first portion (e.g., 788a, 788b, 788c, 788d, and/or 788e) of the representation (e.g., 784) of the user (e.g., 708) (e.g., the second portion of the representation of the user is displayed at a second orientation on the first display generation component and/or at a second orientation within the environment displayed on the first display generation component). In some embodiments, the first portion (e.g., 788a, 788b, 788c, 788d, and/or 788e) of the representation (e.g., 784) of the user (e.g., 708) includes a representation of a first body part (e.g., 708b and/or 708c) of the user (e.g., 708) displayed at a first angle and/or orientation and the second portion (e.g., 788a, 788b, 788c, 788d, and/or 788e) of the representation (e.g., 784) of the user (e.g., 708) includes a representation of the first body part (e.g., 708b and/or 708c) of the user (e.g., 708) displayed at a second angle and/or orientation, where the second angle and/or orientation is different from the first angle and/or orientation and based on the change in orientation of the computer system (e.g., 101 and/or 700) relative to the user (e.g., 708) of the computer system (e.g., 101 and/or 700). In some embodiments, the second portion (e.g., 788a, 788b, 788c, 788d, and/or 788e) of the representation (e.g., 784) of the user (e.g., 708) includes a representation of one or more features, characteristics, and/or body parts that are not included in the first portion (e.g., 788a, 788b, 788c, 788d, and/or 788e) of the representation (e.g., 784) of the user (e.g., 708).

Displaying the second portion of the representation of the user, different from the first portion of the representation of the user, in response to detecting the change in the orientation of the computer system relative to the user of the computer system allows a user to quickly view multiple portions of the representation of the user and determine whether the representation of the user is acceptable to the user, thereby reducing power usage and improving battery life of the computer system by enabling the user to use the computer system more quickly and efficiently.

In some embodiments, in response to detecting the change in the orientation of the computer system (e.g., 101 and/or 700) relative to the user (e.g., 708) of the computer system (e.g., 101 and/or 700), the computer system (e.g., 101 and/or 700) displays, via the first display generation component (e.g., 120, 704, and/or 736), an animation of a transition (e.g., an animation of a transition between portions 788a, 788b, 788c, 788d, and/or 788e) between displaying the first portion (e.g., 788a, 788b, 788c, 788d, and/or 788e) of the representation (e.g., 784) of the user (e.g., 708) to displaying the second portion (e.g., 788a, 788b, 788c, 788d, and/or 788e) of the representation (e.g., 784) of the user (e.g., 708) (e.g., displaying movement (e.g., along one or more axes) of the representation of the user from a first position and/or orientation corresponding to the first portion to a second position and/or orientation corresponding to the second portion over time). Displaying the animation of the transition between displaying the first portion of the representation of the user to displaying the second portion of the representation of the user provides a realistic transition between different portions of the representation of the user, which provides a more varied, detailed, and/or realistic experience.

In some embodiments, in response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes rotation along a first axis (e.g., 746a, 746b, and/or 746c) (e.g., movement and/or rotation of the computer system relative to the user along the first axis and/or movement and/or rotation of the user relative to the computer system along the first axis), the computer system (e.g., 101 and/or 700) displays, via the first display generation component (e.g., 120, 704, and/or 736), the representation (e.g., 784) of the user (e.g., 708) moving in a first direction (e.g., 792 and/or 794) (e.g., the representation of the user moves, tilts, and/or shifts in the first direction on the first display generation component (e.g., with respect to one or more edges of the first display generation component)). In response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes rotation along a second axis (e.g., 746a, 746b, and/or 746c) (e.g., movement and/or rotation of the computer system relative to the user along the second axis and/or movement and/or rotation of the user relative to the computer system along the second axis), different from the first axis (e.g., 746a, 746b, and/or 746c) (e.g., the first axis extends in left and right directions with respect to viewpoint of the user and the second axis extends in upward and downward directions with respect to the viewpoint of the user), the computer system (e.g., 101 and/or 700) displays, via the first display generation component (e.g., 120, 704, and/or 736), the representation (e.g., 784) of the user (e.g., 708) moving in a second direction (e.g., 792 and/or 794) (e.g., the representation of the user moves, tilts, and/or shifts in the second direction on the first display generation component (e.g., with respect to one or more edges of the first display generation component)), different from the first direction (e.g., 792 and/or 794).

Displaying the representation of the user moving in the first direction or the second direction based on the change in the orientation of the computer system relative to the user of computer system including rotation along a first axis or a second axis provides a more realistic representation of the user, which provides a more varied, detailed, and/or realistic experience.

In some embodiments, in response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes rotation in a third direction along a third axis (e.g., 746a, 746b, and/or 746c) (e.g., movement and/or rotation of the computer system relative to the user along in a third direction (e.g., a left direction and/or a right direction) along the third axis and/or movement and/or rotation of the user relative to the computer system in the third direction (e.g., a left direction and/or a right direction) along the third axis), the computer system (e.g., 101 and/or 700) displays, via the first display generation component (e.g., 120, 704, and/or 736), the representation (e.g., 784) of the user (e.g., 708) moving in a fourth direction (e.g., 792 and/or 794) (e.g., the representation of the user moves, tilts, and/or shifts in the fourth direction that is based on the third direction on the first display generation component (e.g., with respect to one or more edges of the first display generation component)). In response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes rotation in a fifth direction along the third axis (e.g., 746a, 746b, and/or 746c) (e.g., movement and/or rotation of the computer system relative to the user along in a fifth direction (e.g., a left direction and/or a right direction) along the third axis and/or movement and/or rotation of the user relative to the computer system in the fifth direction (e.g., a left direction and/or a right direction) along the third axis), the computer system (e.g., 101 and/or 700) displays, via the first display generation component (e.g., 120, 704, and/or 736), the representation (e.g., 784) of the user (e.g., 708) moving in a sixth direction (e.g., 792 and/or 794) (e.g., the representation of the user moves, tilts, and/or shifts in the sixth direction that is based on the fifth direction on the first display generation component (e.g., with respect to one or more edges of the first display generation component)), different from the fourth direction (e.g., 792 and/or 794).

Displaying the representation of the user moving in the fourth direction or the sixth direction based on the change in the orientation of the computer system relative to the user of computer system including rotation in a third direction or a fifth direction along a third axis provides a more realistic representation of the user, which provides a more varied, detailed, and/or realistic experience.

In some embodiments, in response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes a first amount of movement (e.g., 790a) (e.g., a first amount of displacement between a current position and a prior position of the computer system and/or the user and/or a first amount of rotation of the computer system relative to the user of the computer system about an axis), the computer system (e.g., 101 and/or 700) displays, via the first display generation component (e.g., 120, 704, and/or 736), the representation (e.g., 784) of the user (e.g., 708) moving a first amount (e.g., an amount of movement between portion 788a and portion 788b of representation 784) (e.g., the representation of the user moves, tilts, and/or shifts from a first position to a second position by the first amount on the first display generation component). In response to detecting the change in the orientation of the computer system (e.g., 101 and/or 700) relative to the user (e.g., 708) of the computer system (e.g., 101 and/or 700) and in accordance with a determination that the change in the orientation of the computer system (e.g., 101 and/or 700) relative to the user (e.g., 708) of the computer system (e.g., 101 and/or 700) includes a second amount of movement (e.g., 790a and 790b) (e.g., a second amount of displacement between a current position and a prior position of the computer system and/or the user and/or a second amount of rotation of the computer system relative to the user of the computer system about an axis), different from the first amount of movement (e.g., 790a) (e.g., the second amount of movement is less than the first amount of movement or the second amount of movement is greater than the first amount of movement), the computer system (e.g., 101 and/or 700) displays, via the first display generation component (e.g., 120, 704, and/or 736), the representation (e.g., 784) of the user (e.g., 708) moving a second amount (e.g., an amount of movement between portion 788a and portion 788c of representation 784) (e.g., the representation of the user moves, tilts, and/or shifts from a first position to a second position by the second amount on the first display generation component), different from the first amount (e.g., an amount of movement between portion 788a and portion 788b of representation 784).

Displaying the representation of the user moving the first amount or the second amount based on the change in the orientation of the computer system relative to the user of computer system including a first amount of movement or a second amount of movement provides a more realistic representation of the user, which provides a more varied, detailed, and/or realistic experience.

In some embodiments, while displaying the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708), the computer system (e.g., 101 and/or 700) detects first user input (e.g., a press gesture, a tap gesture, a touch gesture, an air gesture, and/or a rotational input gesture) corresponding to selection of a first selectable option (e.g., 786a) (e.g., a confirmation selectable option) for confirming an appearance of the representation (e.g., 784) of the user (e.g., 708) (e.g., the first selectable option is configured to, when selected, confirm an appearance of the representation of the user, such that the computer system is configured to display the representation of the user having the appearance in a real-time communication). In response to detecting the first user input corresponding to selection of the first selectable option (e.g., 786a), the computer system (e.g., 101 and/or 700) confirms the appearance of the representation (e.g., 784) of the user (e.g., 708) (e.g., accepting the appearance of the representation of the user and/or exiting an editing mode for modifying the appearance of the representation of the user so that the representation of the user can be used and/or displayed during a real-time communication). In some embodiments, when the computer system (e.g., 101 and/or 700) does not detect user input selecting the first selectable option (e.g., 786a) (e.g., the computer system detects user input selecting a different selectable option), the computer system (e.g., 101 and/or 700) discards (e.g., deletes, removes, and/or otherwise does not confirm) the representation (e.g., 784) of the user (e.g., 708) and/or initiates (e.g., re-initiates) a process for capturing (e.g., re-captures) information about the one or more physical characteristics of the user (e.g., 708) of the computer system (e.g., 101 and/or 700).

Displaying the first selectable option for confirming the appearance of the representation of the user allows a user to quickly determine whether the representation of the user is acceptable to the user and/or whether the user would like to edit the appearance of the representation of the user, thereby reducing power usage and improving battery life of the computer system by enabling the user to use the computer system more quickly and efficiently.

In some embodiments, the first user input (e.g., a press gesture, a tap gesture, a touch gesture, and/or a rotational input gesture) corresponds to a hardware input device (e.g., a physical depressible button, a rotatable input device, and/or a solid state button) in communication with the computer system (e.g., 101 and/or 700). Enabling the first selectable option to be selected via user input corresponding to a hardware input device in communication with the computer system allows for the use of fewer and/or less precise sensors resulting in a more compact, lighter, and cheaper computer system.

In some embodiments, while displaying the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708), the computer system (e.g., 101 and/or 700) detects second user input (e.g., a press gesture, a tap gesture, a touch gesture, an air gesture, and/or a rotational input gesture) corresponding to selection of a second selectable option (e.g., 786b) (e.g., a redo selectable option) for capturing second information about the one or more physical characteristics of the user (e.g., 708) of the computer system (e.g., 101 and/or 700) (e.g., the second selectable option is configured to, when selected, cause the computer system to initiate and/or reinitiate capturing of information (e.g., second information) about the one or more physical characteristics of the user of the computer system to provide a more realistic and/or accurate representation of the user). In response to detecting the second user input corresponding to selection of the second selectable option (e.g., 786b), the computer system (e.g., 101 and/or 700) initiates a process for capturing second information about the one or more physical characteristics of the user (e.g., 708) of the computer system (e.g., 101 and/or 700) (e.g., activating one or more sensors of the computer system to capture and/or collect data (e.g., image data, sensor data, and/or depth data) that represents a size, shape, position, pose, color, depth, and/or other characteristics of one or more body parts and/or features of body parts of the user).

Displaying the second selectable option for capturing second information about the physical characteristics of the user of the computer system allows a user to capture additional information that is used to generate the representation of the user so that the representation of the user is more accurate and/or more closely resembles an appearance of the user, which provides a more varied, detailed, and/or realistic experience.

In some embodiments, the second user input (e.g., a press gesture, a tap gesture, a touch gesture, and/or a rotational input gesture) corresponds to a hardware input device (e.g., a physical depressible button, a rotatable input device, and/or a solid state button) in communication with the computer system (e.g., 101 and/or 700). Enabling the second selectable option to be selected via user input corresponding to a hardware input device in communication with the computer system allows for the use of fewer and/or less precise sensors resulting in a more compact, lighter, and cheaper computer system.

In some embodiments, displaying the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708) includes the computer system (e.g., 101 and/or 700) displaying one or more selectable options (e.g., 786a and/or 786b) (e.g., first selectable option for confirming an appearance of the representation of the user, a second selectable option for capturing second information about the one or more physical characteristics of the user, and/or a third selectable option for editing an appearance of the representation of the user) associated with configuring the representation (e.g., 784) of the user (e.g., 708) (e.g., confirming, changing, updating, and/or regenerating an appearance of the representation of the user), where the one or more selectable options (e.g., 786a and/or 786b) are displayed as appearing to be positioned in front of the representation (e.g., 784) of the user (e.g., 708) (e.g., the one or more selectable options include a visual effect (e.g., simulated shadow, parallax, blur, occlusion, and/or a depth effect) so that the one or more selectable options appear to be spatially in front of the representation of the user (e.g., so that the one or more selectable options are more prominent and/or more clearly displayed to the user)). In some embodiments, the one or more selectable options at least partially obstruct the user's view of the first portion of the representation of the user. Displaying the one or more selectable options as appearing to be positioned in front of the representation of the user allows the user of the computer system to easily view and/or interact with the one or more selectable options, thereby providing improved visual feedback.

In some embodiments, displaying the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708) includes the computer system (e.g., 101 and/or 700) displaying text (e.g., 786a and/or 786b) associated with the representation (e.g., 784) of the user (e.g., 708) (e.g., text providing information about the representation of the user, text indicating that capturing of the one or more physical characteristics of the user is completed, text indicating that an appearance of the representation of the user can be edited, text indicating that that the one or more physical characteristics of the user can be re-captured, and/or text indicating that the appearance of the representation of the user can be confirmed and/or approved), where the text (e.g., 786a and/or 786b) is displayed as appearing to be positioned in front of the representation (e.g., 784) of the user (e.g., 708) (e.g., the text includes a visual effect so that the text appears to be spatially in front of the representation of the user (e.g., so that the text is more prominent and/or more clearly displayed to the user)). In some embodiments, the text (e.g., 786a and/or 786b) at least partially obstructs the user's view of the first portion (e.g., 788a, 788b, 788c, 788d, and/or 788e) of the representation (e.g., 784) of the user (e.g., 708). Displaying the text as appearing to be positioned in front of the representation of the user allows the user of the computer system to easily view and/or understand the text, thereby providing improved visual feedback.

In some embodiments, the first display generation component (e.g., 120, 704, and/or 736) is a lenticular display (e.g., a display including one or more lenses (e.g., a lenticular lens film formed over an array of pixels) that enable different images and/or different visual elements to be viewed on the display when viewing the display from different angles (e.g., different viewing perspectives having different angles with respect to the display)) that is configured to display the representation (e.g., 784) of the user (e.g., 708) with a three-dimensional effect (e.g., the representation of the user appears to extend along three different axes (e.g., an x-axis, a y-axis, and a z-axis) with respect to the lenticular display). In some embodiments, the lenticular display is configured to enable stereoscopic viewing of the display, such that a user perceives the representation (e.g., 784) of the user (e.g., 708) as being three-dimensional. Displaying the representation of the user with a three-dimensional effect on a lenticular display generation component allows the representation of the user to appear more lifelike, which provides a more varied, detailed, and/or realistic user experience.

In some embodiments, the first display generation component (e.g., 120, 704, and/or 736) is a curved display (e.g., the first display generation component is a lenticular display that includes curvature (e.g., convex curvature) to facilitate a lenticular effect that enables different images and/or different visual elements to be viewed on the display when viewing the display from different angles (e.g., different viewing perspectives having different angles with respect to the display)). The first display generation component including a curved display enables the computer system to more closely fit and/or align with a face of the user of the computer system, thereby improving the ergonomics of the computer system.

In some embodiments, capturing the information about the one or more physical characteristics of the user (e.g., 708) of the computer system (e.g., 101 and/or 700) includes the computer system (e.g., 101 and/or 700) capturing the information about the one or more physical characteristics of the user (e.g., 708) of the computer system (e.g., 101 and/or 700) via one or more sensors (e.g., 712 and/or 734) in communication with the computer system (e.g., 101 and/or 700) (e.g., one or more cameras (e.g., an infrared camera, a depth camera, and/or a visible light camera), image sensors, light sensors, depth sensors, tactile sensors, orientation sensors, proximity sensors, temperature sensors, location sensors, motion sensors, and/or velocity sensors), where the one or more sensors (e.g., 712 and/or 734) are configured to capture the information about the one or more physical characteristics of the user (e.g., 708) of the computer system (e.g., 101 and/or 700) while the first display generation component (e.g., 120, 704, and/or 736) is visible to the user (e.g., 708) of the computer system (e.g., 101 and/or 700) (e.g., the one or more sensors are positioned on a same exterior face of the computer system as the first display generation component, at a position on and/or within the computer system that is proximate to the first display generation component, and/or at a position on and/or within the computer system, such that the first display generation component displays images appearing on an exterior face of the computer system that includes the one or more sensors). In some embodiments, the computer system (e.g., 101 and/or 700) is a head-mounted device and the first display generation component (e.g., 120, 704, and/or 736) is a display generation component that is configured to be viewed by the user (e.g., 708) when the head-mounted device is not placed on the head (e.g., 708b) of the user (e.g., 708) and/or over the eyes of the user (e.g., 708) and/or the first display generation component (e.g., 120, 704, and/or 736) is not configured to be viewed by the user (e.g., 708) when the head-mounted device is placed on the head (e.g., 708b) of the user (e.g., 708) and/or over the eyes of the user (e.g., 708).

Enabling the one or more sensors to capture the information about the one or more physical characteristics of the user of the computer system while the first display generation component is visible to the user of the computer system allows a user to view guidance and/or prompts on the first display generation component while the one or more sensors capture the information about the one or more physical characteristics of the user, thereby reducing power usage and improving battery life of the computer system by enabling the user to use the computer system more quickly and efficiently.

In some embodiments, after displaying the first portion (e.g., 788a, 788b, 788c, 788d, and/or 788e) of the representation (e.g., 784) of the user (e.g., 708) without displaying the second portion (e.g., 788a, 788b, 788c, 788d, and/or 788e) of the representation (e.g., 784) of the user (e.g., 708), the computer system (e.g., 101 and/or 700) displays, via the first display generation component (e.g., 120, 704, and/or 736), a third portion (e.g., 788a, 788b, 788c, 788d, and/or 788e) of the representation (e.g., 784) of the user (e.g., 708) (e.g., a third portion of representations of one or more body parts of the user), different from the first portion (e.g., 788a, 788b, 788c, 788d, and/or 788e) of the representation (e.g., 784) of the user (e.g., 708), without detecting the change in the orientation of the computer system (e.g., 101 and/or 700) relative to the user (e.g., 708) of the computer system (e.g., 101 and/or 700) (e.g., the computer system is configured to display movement of the representation of the user automatically, so that the computer system displays the first portion of the representation of the user and then displays the third portion of the representation of the user without detecting movement of the user and/or the computer system and/or without receiving user input). Displaying the third portion of the representation of the user without detecting the change in the orientation of the computer system relative to the user of the computer system allows a user to quickly view multiple portions of the representation of the user and determine whether the representation of the user is acceptable to the user without requiring movement of the user and/or the computer system, thereby reducing power usage and improving battery life of the computer system by enabling the user to use the computer system more quickly and efficiently.

In some embodiments, while displaying, via the first display generation component (e.g., 120, 704, and/or 736), the second portion (e.g., 788a, 788b, 788c, 788d, and/or 788e) of the representation (e.g., 784) of the user (e.g., 708) without displaying a fourth portion (e.g., 788a, 788b, 788c, 788d, and/or 788e) of the representation (e.g., 784) of the user (e.g., 708), the computer system (e.g., 101 and/or 700) detects a change in an orientation of a head (e.g., 708b) and/or face (e.g., 708c) of the user (e.g., 708) of the computer system (e.g., 101 and/or 700) relative to the computer system (e.g., 101 and/or 700) (e.g., the user physically moves the computer system with respect to the head and/or face of the user, the user physically moves the head and/or face of the user with respect to the computer system, and/or the user physically moves the head and/or face of the user and the computer system with respect to one another). In response to detecting the change in the orientation of the head (e.g., 708b) and/or face (e.g., 708c) of the user (e.g., 708) of the computer system (e.g., 101 and/or 700) relative to the computer system (e.g., 101 and/or 700), the computer system (e.g., 101 and/or 700) displays, via the display generation component (e.g., 120, 704, and/or 736), the fourth portion (e.g., 788a, 788b, 788c, 788d, and/or 788e) of the representation (e.g., 784) of the user (e.g., 708) (e.g., a fourth portion of representations of one or more body parts of the user), different from the second portion (e.g., 788a, 788b, 788c, 788d, and/or 788e) of the representation (e.g., 784) of the user (e.g., 708) (e.g., the fourth portion of the representation of the user is displayed at a third orientation on the first display generation component and/or at a third orientation within the environment displayed on the first display generation component). In some embodiments, the second portion (e.g., 788a, 788b, 788c, 788d, and/or 788e) of the representation (e.g., 784) of the user (e.g., 708) includes a representation of a first body part of the user (e.g., 708) displayed at a first angle and/or orientation and the fourth portion (e.g., 788a, 788b, 788c, 788d, and/or 788e) of the representation (e.g., 784) of the user (e.g., 708) includes a representation of the first body part of the user (e.g., 708) displayed at a third angle and/or orientation, where the third angle and/or orientation is different from the first angle and/or orientation and based on the change in orientation of the head (e.g., 708b) and/or face (e.g., 708c) of the user (e.g., 708) relative to the computer system (e.g., 101 and/or 700). In some embodiments, the fourth portion (e.g., 788a, 788b, 788c, 788d, and/or 788e) of the representation (e.g., 784) of the user (e.g., 708) includes a representation of one or more features, characteristics, and/or body parts that are not included in the second portion (e.g., 788a, 788b, 788c, 788d, and/or 788e) of the representation (e.g., 784) of the user (e.g., 708).

In some embodiments, in response to detecting the change in the orientation of the head (e.g., 708b) and/or face (e.g., 708c) of the user (e.g., 708) of the computer system (e.g., 101 and/or 700) relative to the computer system (e.g., 101 and/or 700) in a first direction, the computer system (e.g., 101 and/or 700) displays movement of the second portion (e.g., 788a, 788b, 788c, 788d, and/or 788e) of the representation (e.g., 784) of the user (e.g., 708) in a second direction, based on the first direction, to display the fourth portion (e.g., 788a, 788b, 788c, 788d, and/or 788e) of the representation (e.g., 784) of the user (e.g., 708). In some embodiments, in response to detecting the change in the orientation of the head (e.g., 708b) and/or face (e.g., 708c) of the user (e.g., 708) of the computer system (e.g., 101 and/or 700) relative to the computer system (e.g., 101 and/or 700) in a third direction, different from the first direction, the computer system (e.g., 101 and/or 700) displays movement of the second portion (e.g., 788a, 788b, 788c, 788d, and/or 788e) of the representation (e.g., 784) of the user (e.g., 708) in a fourth direction, different from the second direction, and based on the third direction, to display the fourth portion (e.g., 788a, 788b, 788c, 788d, and/or 788e) of the representation (e.g., 784) of the user (e.g., 708).

In some embodiments, a change between the second portion (e.g., 788a, 788b, 788c, 788d, and/or 788e) of the representation (e.g., 784) of the user (e.g., 708) and the fourth portion (e.g., 788a, 788b, 788c, 788d, and/or 788e) of the representation (e.g., 784) of the user (e.g., 708) is based on a detected direction of movement and/or a detected amount of movement associated with the change in the orientation of the head (e.g., 708b) and/or face (e.g., 708c) of the user (e.g., 708) of the computer system (e.g., 101 and/or 700) relative to the computer system (e.g., 101 and/or 700). In some embodiments, the computer system (e.g., 101 and/or 700) displays movement of the representation (e.g., 784) of the user (e.g., 708) by an amount that is based on (e.g., the same as and/or proportionate to) the detected amount of movement associated with the change in the orientation of the head (e.g., 708b) and/or face (e.g., 708c) of the user (e.g., 708) of the computer system (e.g., 101 and/or 700) relative to the computer system (e.g., 101 and/or 700). In some embodiments, the computer system (e.g., 101 and/or 700) displays movement of the representation (e.g., 784) of the user (e.g., 708) in a direction that is based on the detected direction of movement associated with the change in the orientation of the head (e.g., 708b) and/or face (e.g., 708c) of the user (e.g., 708) of the computer system (e.g., 101 and/or 700) relative to the computer system (e.g., 101 and/or 700).

Displaying the fourth portion of the representation of the user, different from the second portion of the representation of the user, in response to detecting the change in the orientation of the head and/or face of the user of the computer system relative to the computer system allows a user to quickly view multiple portions of the representation of the user and determine whether the representation of the user is acceptable to the user, thereby reducing power usage and improving battery life of the computer system by enabling the user to use the computer system more quickly and efficiently.

In some embodiments, while displaying, via the first display generation component (e.g., 120, 704, and/or 736), the second portion (e.g., 788a, 788b, 788c, 788d, and/or 788e) of the representation (e.g., 784) of the user (e.g., 708) (e.g., a second portion of a representation of a face (e.g., making a first facial expression) of the user) without displaying a fifth portion (e.g., 788a, 788b, 788c, 788d, and/or 788e) of the representation (e.g., 784) of the user (e.g., 708), the computer system (e.g., 101 and/or 700) detects a change in a pose of one or more facial features (e.g., a change in a facial expression) of the user (e.g., 708) of the computer system (e.g., 101 and/or 700) (e.g., the user physically moves one or more portions (e.g., eyes, lips, nose, mouth, cheeks, and/or eyebrows) of the face of the user). In response to detecting the change in the pose of the one or more facial features of the user (e.g., 708) of the computer system (e.g., 101 and/or 700), the computer system (e.g., 101 and/or 700) displays, via the display generation component (e.g., 120, 704, and/or 736), the fifth portion (e.g., 788a, 788b, 788c, 788d, and/or 788e) of the representation (e.g., 784) of the user (e.g., 708) (e.g., a fifth portion of a representation of a face (e.g., making a second facial expression) of the user), different from the second portion (e.g., 788a, 788b, 788c, 788d, and/or 788e) of the representation (e.g., 784) of the user (e.g., 708) (e.g., the fifth portion of the representation of the user is displayed as having a different facial expression when compared to the second portion of the representation of the user).

In some embodiments, in response to detecting the change in the pose of the one or more facial features of the user (e.g., 708) of the computer system (e.g., 101 and/or 700) to a first pose (e.g., a first facial expression), the computer system (e.g., 101 and/or 700) displays the fifth portion (e.g., 788a, 788b, 788c, 788d, and/or 788e) of the representation (e.g., 784) of the user (e.g., 708) including a face representation (e.g., 784c) in a second pose that is based on the first pose. In some embodiments, in response to detecting the change in the pose of the one or more facial features of the user (e.g., 708) of the computer system (e.g., 101 and/or 700) to a third pose (e.g., a second facial expression), different from the first pose, the computer system (e.g., 101 and/or 700) displays the fifth portion (e.g., 788a, 788b, 788c, 788d, and/or 788e) of the representation (e.g., 784) of the user (e.g., 708) including the face representation (e.g., 784c) in a fourth pose based on the third pose, wherein the fourth pose is different from the second pose.

In some embodiments, the second portion (e.g., 788a, 788b, 788c, 788d, and/or 788e) of the representation (e.g., 784) of the user (e.g., 708) includes a face representation (e.g., 784c) having a first pose and the fifth portion (e.g., 788a, 788b, 788c, 788d, and/or 788e) of the representation (e.g., 784) of the user (e.g., 708) includes the face representation (e.g., 784c) having a second pose, different from the first pose. In some embodiments, the computer system (e.g., 101 and/or 700) displays and/or animates the face representation (e.g., 784c) in the first pose moving by a first amount and/or in a first direction to display the face representation (e.g., 784c) in the second pose, where the first amount and/or the first direction is based on a second amount and/or a second direction of movement associated with the change in pose of the one or more facial features of the user (e.g., 708) of the computer system (e.g., 101 and/or 700).

Displaying the fifth portion of the representation of the user, different from the second portion of the representation of the user, in response to detecting the change in the pose of the face of the user of the computer system relative to the computer system allows a user to quickly view multiple portions of the representation of the user and determine whether the representation of the user is acceptable to the user, thereby reducing power usage and improving battery life of the computer system by enabling the user to use the computer system more quickly and efficiently.

In some embodiments, aspects/operations of methods 800, 1000, 1100, 1200, 1300, 1500, and/or 1700 may be interchanged, substituted, and/or added among these methods. For example, computer systems configured to perform methods 800, 1000, 1100, 1200, 1300, 1500, and/or 1700 can optionally display the first and/or second portions of the representation of the user after capturing information about one or more physical characteristics of the user. For brevity, these details are not repeated here.

FIG. 10 is a flow diagram of an exemplary method 1000 for providing guidance to a user before a process for generating a representation of the user, in accordance with some embodiments. In some embodiments, method 1000 is performed at a computer system (e.g., 101 and/or 700) (e.g., a smartphone, a tablet, and/or head-mounted device) that is in communication with one or more display generation components (e.g., 120, 704, and/or 736) (e.g., a visual output device, a 3D display, a display having at least a portion that is transparent or translucent on which images can be projected (e.g., a see-through display), a projector, a heads-up display, and/or a display controller) (and, optionally, that is in communication with and one or more cameras (e.g., an infrared camera; a depth camera; a visible light camera)). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1000 are, optionally, combined and/or the order of some operations is, optionally, changed.

Prior to an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation (e.g., 784) of a user (e.g., 708) (e.g., an avatar and/or a virtual representation of at least a portion of the first user), wherein the enrollment process includes capturing (e.g., via the one or more cameras) information about one or more physical characteristics of a user (e.g., 708) of the computer system (e.g., 101 and/or 700) (e.g., data (e.g., image data, sensor data, and/or depth data) that represents a size, shape, position, pose, color, depth, and/or other characteristics of one or more body parts and/or features of body parts of the user), the computer system (e.g., 101 and/or 700) outputs (1002) a plurality of indications (e.g., 718, 728, and/or 732) (e.g., a series and/or sequential series of images, a video, and/or audio) that provides guidance (e.g., visual, audio, textual, and/or haptic instructions, tutorials, and/or other information that facilitates a user's ability to capture the information about the one or more physical characteristics) to the user (e.g., 708) of the computer system (e.g., 101 and/or 700) for capturing information about one or more physical characteristics of the user (e.g., 708) of the computer system (e.g., 101 and/or 700)

Outputting the plurality of indications (e.g., 718, 728, and/or 732) includes the computer system (e.g., 101 and/or 700) outputting (1004) a first indication (e.g., 718) (e.g., a first animation, a first video, a first visual, audio, textual, and/or haptic output that provides first instructions, tutorials, and/or other information facilitating a user's ability to complete a first step in a process (e.g., an enrollment process) that includes capturing the information about (e.g., a first physical characteristic of) the one or more physical characteristics of the user) corresponding to a first step (e.g., a portion of a process that includes capturing the information about the one or more physical characteristics of the user, such as a step including capturing first facial features of the user, where the first facial features include a right side portion of a face of the user, a left side portion of the face of the user, an upper portion of the face of the user, a lower portion of the face of the user, eyebrows of the face of the user, eyes of the face of the user, and/or a mouth of the face of the user) of a process that includes capturing the information about the one or more physical characteristics of the user (e.g., 708) of the computer system (e.g., 101 and/or 700), where the first indication (e.g., 718) includes displaying, via a first display generation component (e.g., 120, 704, and/or 736) of the one or more display generation components, first three-dimensional content (e.g., 718a, 718b, and/or 718c) (e.g., a three-dimensional video and/or one or more images that is a spatial capture, a stereoscopic capture, and/or a recording including examples, tutorials, and/or other instructions for completing the first step of the process that includes capturing the information about the one or more physical characteristics of the user) associated with the first step.

Outputting the plurality of indications (e.g., 718, 728, and/or 732) includes, after outputting the first indication (e.g., 718), the computer system (e.g., 101 and/or 700) outputting (1006) a second indication (e.g., 728) (e.g., a second animation, a second video, a second visual, audio, textual, and/or haptic output that provides second instructions, tutorials, and/or other information facilitating a user's ability to complete a second step in the process (e.g., an enrollment process) that includes capturing the information about (e.g., a second physical characteristic of) the one or more physical characteristics of the user) (in some embodiments, the second indication is displayed after completion of the first indication and/or after the first indication ceases to be output) corresponding to a second step (e.g., a portion of a process that includes capturing the information about the one or more physical characteristics of the user, such as a step including capturing second facial features of the user, where the second facial features include a right side portion of a face of the user, a left side portion of the face of the user, an upper portion of the face of the user, a lower portion of the face of the user, eyebrows of the face of the user, eyes of the face of the user, and/or a mouth of the face of the user), different from the first step, of the process for capturing the information about the one or more physical characteristics of the user (e.g., 708) of the computer system (e.g., 101 and/or 700), where the second indication (e.g., 728) includes displaying, via the first display generation component (e.g., 120, 704, and/or 736) of the one or more display generation components, second three-dimensional content (e.g., 728a and/or 728b) (e.g., a three-dimensional video and/or one or more images that is a spatial capture, a stereoscopic capture, and/or a recording including examples, tutorials, and/or other instructions for completing the second step of the process that includes capturing the information about the one or more physical characteristics of the user) associated with the second step, wherein the second step occurs after the first step in the enrollment process. In some embodiments, the computer system (e.g., 101 and/or 700) is a head mounted device (“HMD”) that is configured to be worn on a head (e.g., 708b) and/or face (e.g., 708c) of the user (e.g., 708) and the computer system (e.g., 101 and/or 700) outputs the first indication (e.g., 718) and the second indication (e.g., 728) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user).

Outputting the first indication corresponding to a first step of a process that includes capturing the information about the one or more physical characteristics of the user of the computer system and outputting the second indication corresponding to a second step of the process for capturing the information about the one or more physical characteristics of the user provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, the first three-dimensional content (e.g., 718a, 718b, and/or 718c) and/or the second three-dimensional content (e.g., 728a and/or 728b) include spatially captured content (e.g., using spatial capture and/or spatial mapping to display one or more three-dimensional objects associated with a physical environment (e.g., a physical environment in which the computer system is located)). In some embodiments, the computer system (e.g., 101 and/or 700) is in communication with one or more sensors (e.g., 712 and/or 734) (e.g., one or more cameras (e.g., an infrared camera, a depth camera, and/or a visible light camera), image sensors, light sensors, depth sensors, tactile sensors, orientation sensors, proximity sensors, temperature sensors, location sensors, motion sensors, and/or velocity sensors) that capture information about a physical environment (e.g., 706) in which the computer system (e.g., 101 and/or 700) is located and the computer system (e.g., 101 and/or 700) displays the first indication (e.g., 718) and/or the second indication (e.g., 728) in an extended reality environment that includes one or more three-dimensional objects that are generated using spatial capture and/or spatial mapping techniques based on the information received from the one or more sensors (e.g., 712 and/or 734). In some embodiments, the spatially captured content is a 3D model. In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the first three-dimensional content (e.g., 718a, 718b, and/or 718c) and the second three-dimensional content (e.g., 728a and/or 728b) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user). The first three-dimensional content and/or the second three-dimensional content including spatially captured content allows a user to view the first indication and/or the second indication in a familiar environment, thereby providing a more varied, detailed, and/or realistic user experience.

In some embodiments, the first three-dimensional content (e.g., 718a, 718b, and/or 718c) and/or the second three-dimensional content (e.g., 728a and/or 728b) include stereoscopically captured content (e.g., using stereoscopy (e.g., displaying and/or combining two or more images captured via one or more sensors in communication with the computer system to display one or more objects appearing to have depth and/or appearing to be three-dimensional and/or displaying and/or combining separate first and second video streams (e.g., feeds) captured and/or generated based on information received from one or more sensors in communication with the computer system, where the first video stream corresponds to a right eye of the user (e.g., is viewed by the right eye of the user) and the second video stream corresponds to a left eye of the user (e.g., is viewed by the left eye of the user) so that user perceives the one or more objects as having depth and/or as three-dimensional) to display one or more three-dimensional objects). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the first three-dimensional content (e.g., 718a, 718b, and/or 718c) and the second three-dimensional content (e.g., 728a and/or 728b) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user). The first three-dimensional content and/or the second three-dimensional content including stereoscopically captured content allows a user to view the first indication and/or the second indication in a familiar environment, thereby providing a more varied, detailed, and/or realistic user experience.

In some embodiments, the first three-dimensional content (e.g., 718a, 718b, and/or 718c) and/or the second three-dimensional content (e.g., 728a and/or 728b) include a recording of a person (e.g., 718a and/or 728a) demonstrating the enrollment process (e.g., a sequence of images, a video (e.g., a pre-recorded video), and/or an animation including an individual that is different from the user of the computer system demonstrating the first step of the process for capturing the information about the one or more physical characteristics of the user of the computer system and/or the second step of the process for capturing the information about the one or more physical characteristics of the user of the computer system). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the recording of a person (e.g., 718a and/or 728a) demonstrating the enrollment process while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user). The first three-dimensional content and/or the second three-dimensional content including a recording of a person demonstrating the enrollment process provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, outputting the plurality of indications (e.g., 718, 728, and/or 732) that provides guidance to the user (e.g., 708) of the computer system (e.g., 101 and/or 700) for capturing information about one or more physical characteristics of the user (e.g., 708) of the computer system (e.g., 101 and/or 700) includes outputting first audio (e.g., 722 and/or 730) that is substantially the same as (or the same as) second audio (e.g., 741, 742, 748, 754, 758, 762, 768, 772, 774, 780, and/or 782) configured to be output during the enrollment process (e.g., the computer system outputs (e.g., concurrently with the plurality of indications) the first audio that is the same as second audio associated with feedback that guides the user during enrollment process so that the user can associate one or more actions that are demonstrated via the plurality of indications with the second audio that is output during the enrollment process (e.g., the user can quickly perform the one or more actions based on already hearing the first audio and associating the first audio with one or more actions that the user is prompted to perform during the enrollment process)). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the first audio (e.g., 722 and/or 730) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user) and outputs the second audio (e.g., 741, 742, 748, 754, 758, 762, 768, 772, 774, 780, and/or 782) while the HMD is not worn on the head (e.g., 708b) and/or face (e.g., 708c) of the user (e.g., 708) (e.g., while the computer system detects that the HMD is not being worn on the head and/or face of the user, such as by detecting an absence of a biometric feature (e.g., eyes) of the user).

Outputting the first audio that is substantially the same as the second audio configured to be output during the enrollment process provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, the first audio (e.g., 722 and/or 730) includes a first portion (e.g., 722) (e.g., a first audio recording, a first portion and/or a first amount of time of the first audio that includes a first tone, a first pitch, a first frequency, a first melody, a first harmony, and/or a first wavelength) associated with the first step (e.g., the first portion of the first audio is output with the first indication) and a second portion (e.g., 730) (e.g., a second audio recording, a second portion and/or a second amount of time of the first audio that includes a second tone, a second pitch, a second frequency, a second melody, a second harmony, and/or a second wavelength) associated with the second step (e.g., the second portion of the first audio is output with the second indication), the first portion (e.g., 722) and the second portion (e.g., 730) of the first audio (e.g., 722 and/or 730) are different from one another (e.g., the first portion and the second portion include one or more respective audio properties (e.g., tone, pitch, frequency, melody, harmony, and/or wavelength) that are different from one another), and the second audio (e.g., 741, 742, 748, 754, 758, 762, 768, 772, 774, 780, and/or 782) includes a third portion (e.g., 748, 754, 758, 762, and/or 768) (e.g., a third audio recording, a third portion and/or a third amount of time of the second audio that includes a third tone, a third pitch, a third frequency, a third melody, a third harmony, and/or a third wavelength) that is substantially the same as (or the same as) the first portion (e.g., 722) (e.g., the first portion of the first audio and the third portion of the second audio include the same audio properties as one another) and a fourth portion (e.g., 772, 774, 780, and/or 782) (e.g., a fourth audio recording, a fourth portion and/or a fourth amount of time of the second audio that includes a fourth tone, a fourth pitch, a fourth frequency, a fourth melody, a fourth harmony, and/or a fourth wavelength) that is substantially the same as (or the same as) the second portion (e.g., 730) (e.g., the second portion of the first audio and the fourth portion of the second audio include the same audio properties as one another). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the first portion (e.g., 722) and the second portion (e.g., 730) of the first audio (e.g., 722 and/or 730) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user) and the computer system (e.g., 101 and/or 700) outputs the third portion (e.g., 748, 754, 758, 762, and/or 768) and the fourth portion (e.g., 772, 774, 780, and/or 782) of the second audio (e.g., 741, 742, 748, 754, 758, 762, 768, 772, 774, 780, and/or 782) while the HMD is not worn on the head (e.g., 708b) and/or face (e.g., 708c) of the user (e.g., 708) (e.g., while the computer system detects that the HMD is not being worn on the head and/or face of the user, such as by detecting an absence of a biometric feature (e.g., eyes) of the user).

Outputting different portions of the first audio that are the same as portions of the second audio during different steps of the process that includes capturing the information about the one or more physical characteristics of the user provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, the computer system (e.g., 101 and/or 700) is a wearable device (e.g., a head mounted device (e.g., “HMD”)). After outputting the plurality of indications (e.g., 718, 728, and/or 732) that provides guidance to the user (e.g., 708) of the computer system (e.g., 101 and/or 700) for capturing information about one or more physical characteristics of the user (e.g., 708) of the computer system (e.g., 101 and/or 700), the computer system (e.g., 101 and/or 700) prompts (e.g., via prompt 732) (e.g., displaying, via the first display generation component, text, images, and/or user interface objects, outputting audio feedback, and/or outputting haptic feedback that include guidance to the user) the user (e.g., 708) of the computer system (e.g., 101 and/or 700) to remove the computer system (e.g., 101 and/or 700) from a body (e.g., 708a, 708b, and/or 708c) (e.g., a head, a face, and/or a wrist) of the user (e.g., 708) (e.g., take off the wearable computer system so that it is no longer worn on the body part of the user). In some embodiments, the computer system (e.g., 101 and/or 700) is a head mounted device (e.g., “HMD”) and the computer system (e.g., 101 and/or 700) prompts the user to remove the HMD from the head (e.g., 708b) and/or face (e.g., 708c) of the user (e.g., 708) after outputting the plurality of indications (e.g., 718, 728, and/or 732). Prompting the user to remove the computer system from a body of the user provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, the first display generation component (e.g., 704) is an internal display generation component of the computer system (e.g., 101 and/or 700) (e.g., the first display generation component is positioned on, included in, and/or located on an internal and/or inner surface of the computer system, where the internal and/or inner surface is configured to be viewed and/or seen by the user when the computer system is used in a normal and/or primary mode of operation (e.g., a mode of operation that does not include capturing the one or more physical characteristics of the user)), a second display generation component (e.g., 736) of the one or more display generation components (e.g., 120, 704, and/or 736) is an external display generation component of the computer system (e.g., 101 and/or 700) (e.g., the second display generation component is positioned on, included in, and/or located on an exterior and/or outer surface of the computer system, where the exterior and/or outer surface is different from an internal and/or inner surface that is configured to be viewed and/or seen by the user of the computer system while the user wears and/or uses the computer system in a primary mode of operation), and the second display generation component (e.g., 736) is configured to display one or more prompts (e.g., 738, 744, 766, and/or 770) during the enrollment process (e.g., text, an arrow, and/or an animated representation of another user that provide guidance to the user of the computer system to move their body in a particular direction and/or toward a particular position with respect to the computer system and/or a progress bar and/or a portion of the second display generation component that indicates an amount of information captured about the first physical characteristic as compared to the threshold amount of information).

In some embodiments, the computer system (e.g., 101 and/or 700) is a head mounted device (e.g., “HMD”) and the first display generation component (e.g., 704) is configured to be viewed by the user (e.g., 708) while the HMD is being worn on a head (e.g., 708b) and/or face (e.g., 708c) of the user (e.g., 708). In some embodiments, the first display generation component (e.g., 704) is positioned in front of and/or covers the eyes of the user (e.g., 708) while the HMD is worn on the head (e.g., 708b) and/or face (e.g., 708c) of the user (e.g., 708). In some embodiments, the second display generation component (e.g., 736) is not configured to be viewed by the user (e.g., 708) while the HMD is being worn on the head (e.g., 708b) and/or face (e.g., 708c) of the user (e.g., 708). In some embodiments, the second display generation component (e.g., 736) is configured to be viewed by the user (e.g., 708) while the HMD is not being worn on the head (e.g., 708b) and/or face (e.g., 708c) of the user (e.g., 708).

Displaying one or more prompts during the enrollment process on a second display generation component that is an external display generation component allows a user to easily receive feedback while the one or more physical characteristics of the user are captured without having to change an orientation of the computer system, thereby reducing power usage and improving battery life of the computer system by enabling the user to use the computer system more quickly and efficiently.

In some embodiments, the first three-dimensional content (e.g., 718a, 718b, and/or 718c) associated with the first step is representative of a first stage of the enrollment process (e.g., a first portion and/or first one or more steps of the enrollment process that include capturing information about one or more first characteristics of the one or more physical characteristics of the user of the computer system, such as capturing information about a face and/or head of the user of the computer system), and the second three-dimensional content (e.g., 728a and/or 728b) associated with the second step is representative of a second stage of the enrollment process (e.g., a second portion and/or second one or more steps of the enrollment process that include capturing information about one or more second characteristics of the one or more physical characteristics of the user of the computer system, such as capturing information about facial expressions and/or hands of the user of the computer system), different from the first stage of the enrollment process (e.g., the first stage of the enrollment process is distinct from the second stage of the enrollment process). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the first three-dimensional content (e.g., 718a, 718b, and/or 718c) and the second three-dimensional content (e.g., 728a and/or 728b) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user).

The first three-dimensional content being representative of a first stage of the enrollment process and the second three-dimensional content being representative of a second stage of the enrollment process, different from the first stage of the enrollment process, provides guidance to a user of the computer system to enable the user to reduce an amount of time the user spends capturing the one or more physical characteristics of the user, thereby reducing power usage and improving battery life of the computer system by enabling the user to use the computer system more quickly and efficiently.

In some embodiments, the plurality of indications (e.g., 718, 728, and/or 732) that provides guidance to the user (e.g., 708) of the computer system (e.g., 101 and/or 700) for capturing information about one or more physical characteristics of the user (e.g., 708) of the computer system (e.g., 101 and/or 700) is output during a setup process of the computer system (e.g., 101 and/or 700) (e.g., when the computer system is first turned on or connected to a companion computer system) (e.g., the setup process is part of an initial setup process for the computer system that enables a user to select and/or configure settings, functions, and/or operations of the computer system (e.g., prior to the user being able to use the computer system in a normal mode of operation)). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the plurality of indications (e.g., 718, 728, and/or 732) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user). Displaying the plurality of indications during a setup process of the computer system allows the user to generate a representation of a user without having to navigate to additional user interfaces, thereby reducing the number of user inputs needed to perform an operation.

In some embodiments, the plurality of indications (e.g., 718, 728, and/or 732) that provides guidance to the user (e.g., 708) of the computer system (e.g., 101 and/or 700) for capturing information about one or more physical characteristics of the user (e.g., 708) of the computer system (e.g., 101 and/or 700) is output after launching a communication session application (e.g., an application of the computer system that enables voice and/or video conferencing between a user associated with the computer system and one or more users associated with respective external computer systems) for a first time after setup of the computer system (e.g., 101 and/or 700) (e.g., the user launches the communication session application without having launched the communication session application previously). In some embodiments, the computer system (e.g., 101 and/or 700) is an HMD that is configured to be worn on a head (e.g., 708b) and/or face (e.g., 708c) of the user (e.g., 708) and the computer system (e.g., 101 and/or 700) outputs the plurality of indications (e.g., 718, 728, and/or 732) while the HMD is worn on the head (e.g., 708b) and/or face (e.g., 708c) of the user (e.g., 708) (e.g., while the computer system detects that the HMD is being worn on the head and/or face of the user, such as by detecting a presence of a biometric feature (e.g., eyes) of the user). Displaying the plurality of indications after launching a communication session application for a first time after setup of the computer system allows the user to generate a representation of a user without having to navigate to additional settings user interfaces, thereby reducing the number of user inputs needed to perform an operation.

In some embodiments, after outputting the second indication (e.g., 728) corresponding to the second step, different from the first step, of the process for capturing the information about the one or more physical characteristics of the user (e.g., 708) of the computer system (e.g., 101 and/or 700), the computer system (e.g., 101 and/or 700) detects an occurrence of an event (e.g., the computer system is in communication with one or more sensors, such as biometric sensors, that are configured to provide information to the computer system about whether the computer system is in a particular orientation (e.g., the computer system is an HMD that is being worn on a head and/or face of the user and/or that is not being worn on the head and/or face of the user), and the computer system determines that the computer system is in a first orientation (e.g., the computer system is an HMD and the HMD is not being worn on the head and/or face of the user) based on the information received from the one or more sensors (e.g., one or more biometric sensors of the computer system do not detect eyes of the user indicating that the computer system is not being worn on the head and/or face of the user)). In response to detecting the occurrence of the event (e.g., that the computer system is not being worn on a head and/or face of the user (e.g., one or more biometric sensors in communication with the computer system do not detect eyes of the user)), the computer system (e.g., 101 and/or 700) initiates the enrollment process (e.g., the process that includes capturing the information about the one or more physical characteristics of the user of the computer system).

Initiating the enrollment process in response to detecting the occurrence of the event allows for the enrollment process to begin without additional user input, thereby reducing the number of inputs needed to perform an operation. In addition, initiating the enrollment process in response to detecting the occurrence of the event allows for information that is used to generate the representation of the user to be captured more quickly, thereby reducing power usage and improving battery life of the computer system by enabling the user to use the computer system more quickly and efficiently.

In some embodiments, aspects/operations of methods 800, 900, 1100, 1200, 1300, 1500, and/or 1700 may be interchanged, substituted, and/or added among these methods. For example, computer systems configured to perform methods 800, 900, 1100, 1200, 1300, 1500, and/or 1700 can optionally display the plurality of indications that provides guidance to the user of the computer system for capturing information about one or more physical characteristics of the user. For brevity, these details are not repeated here.

FIGS. 11A and 11B are a flow diagram of an exemplary method 1100 for providing guidance to a user for aligning a body part of the user with a device, in accordance with some embodiments. In some embodiments, method 1100 is performed at a computer system (e.g., 101 and/or 700) (e.g., a smartphone, a tablet, a watch, and/or a head-mounted device) that is in communication with one or more display generation components (e.g., 120, 704, and/or 736) (e.g., a visual output device, a 3D display, and/or a display having at least a portion that is transparent or translucent on which images can be projected (e.g., a see-through display), a projector, a heads-up display, and/or a display controller) (and, optionally, that is in communication with and one or more cameras (e.g., an infrared camera; a depth camera; and/or a visible light camera)). In some embodiments, the method 1100 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1100 are, optionally, combined and/or the order of some operations is, optionally, changed.

During an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation (e.g., 784) of a user (e.g., 708) (e.g., an avatar and/or a virtual representation of at least a portion of the first user), where the enrollment process includes capturing (e.g., via the one or more cameras) information about one or more physical characteristics of a user (e.g., 708) of the computer system (e.g., 101 and/or 700) (e.g., data (e.g., image data, sensor data, and/or depth data) that represents a size, shape, position, pose, color, depth, and/or other characteristics of one or more body parts and/or features of body parts of the user) via one or more sensors (e.g., 712 and/or 734) (e.g., one or more sensors in communication with the computer system such, such as motion sensors, proximity sensors, cameras (e.g., an infrared camera, a depth camera, and/or a visible light camera), and/or biometric sensors (e.g., facial detection sensors, fingerprint sensors, and/or iris sensors)), the computer system (e.g., 101 and/or 700) displays (1102), via a display generation component (e.g., 120, 704, and/or 736) of the one or more display generation components a first visual indication (e.g., 738c) (1104) (e.g., a first visual object, such as an annular object, an orb, a three-dimensional object, another shape, text, and/or an image) indicative of a target orientation of a body part (e.g., 708a, 708b, and/or 708c) of the user (e.g., 708) with respect to the computer system (e.g., 101 and/or 700) (e.g., an orientation of the body part of the user with respect to a position of the computer system within the physical environment in which the computer system and/or the user are located, where the orientation of the body part with respect to the computer system is an orientation in which one or more sensors of the computer system can accurately, effectively, and/or suitably capture the information about one or more physical characteristics of the user of the computer system), where the first visual indication has a first simulated depth (e.g., the first visual indication is displayed so that the user perceives the first visual indication as being displayed at a first depth on the display generation component) (e.g., the first visual indication is displayed at a size, position, and/or with one or more visual effects (e.g., blur, refraction, sharpness, and/or vibrancy) to cause the first visual indication to appear as being displayed at a first depth on the display generation component), and a second visual indication (e.g., 738b) (1106) (e.g., a second visual object, such as an annular object, an orb, a three-dimensional object, another shape, text, and/or an image) indicative of the orientation of the body part (e.g., 708a, 708b, and/or 708c) of the user (e.g., 708) with respect to the computer system (e.g., 101 and/or 700) (e.g., a detected, sensed, estimated, and/or approximate orientation of the body part of the user with respect to a position of the computer system within the physical environment in which the computer system and/or the user are located, where the detected, sensed, estimated, and/or approximate orientation is based on information and/or data captured via one or more sensors of the computer system), where the second visual indication has a second simulated depth different from the first simulated depth (e.g., the second visual indication is displayed so that the user perceives the second visual indication as being displayed at a second depth on the display generation component) (e.g., the second visual indication is displayed at a size, position, and/or with one or more visual effects (e.g., blur, refraction, sharpness, and/or vibrancy) to cause the first visual indication to appear as being displayed at a second depth on the display generation component).

While displaying the first visual indication (e.g., 738c) and the second visual indication (e.g., 738b), the computer system (e.g., 101 and/or 700) receives (1108) an indication of a change in pose (e.g., position and/or orientation) of the body part (e.g., 708a, 708b, and/or 708c) of the user (e.g., 708) with respect to the one or more sensors (e.g., 712 and/or 734) (e.g., an indication associated with a detected, estimated, approximated, and/or sensed orientation of a particular body part (e.g., a head and/or a face) of the user with respect to a position of the computer system within a physical environment in which the computer system and/or the user is located).

In response to receiving the indication of the change in pose of the body part (e.g., 708a, 708b, and/or 708c) of the user (e.g., 708) with respect to the one or more sensors (e.g., 712 and/or 734), the computer system (e.g., 101 and/or 700) shifts (1110) a relative position of the first visual indication (e.g., 738c) and the second visual indication (e.g., 738b) (e.g., moving the first visual indication with respect to the second visual indication, moving the second visual indication with respect to the first visual indication, and/or moving both the first visual indication and the second visual indication with respect to one another) with a simulated parallax (e.g., a perceived displacement of the first visual indication with respect to the second visual indication, or vice versa, based on a change in the user's viewpoint of the first display generation component and/or movement of the first visual indication at a first speed on the first display generation component and movement of the second visual indication at a second speed, different from the first speed, on the first display generation component) that is based on the change in orientation of the body part (e.g., 708a, 708b, and/or 708c) of the user (e.g., 708) with respect to the one or more sensors (e.g., 712 and/or 734) (e.g., based on a detected, sensed, estimated, and/or approximate orientation of the body part of the user with respect to a position of the computer system within a physical environment in which the computer system and/or the user are located, where the detected, sensed, estimated, and/or approximate orientation of the body part is based on information and/or data captured via the one or sensors of the computer system) and a difference between the first simulated depth of the first visual indication (e.g., 738c) and the second simulated depth of the second visual indication (e.g., 738b) (e.g., the simulated parallax is generated and/or otherwise caused at least partially based on the difference between perceived depths of the first visual indication and the second visual indication).

In accordance with a determination that the body part (e.g., 708a, 708b, and/or 708c) of the user (e.g., 708) has moved closer to a target range of poses relative to the one or more sensors (e.g., 712 and/or 734) (e.g., the detected, sensed, estimated, and/or approximate orientation of the body part of the user has moved closer to a target orientation with respect to the one or more sensors of the computer system, where the target orientation enables the one or more sensors (e.g., cameras) of the computer system to accurately, effectively, and/or suitably capture the one or more physical characteristics of the user), shifting (1112) the relative position of the first visual indication (e.g., 738c) and the second visual indication (e.g., 738b) includes the computer system (e.g., 101 and/or 700) shifting (1112) the relative position of the first visual indication (e.g., 738c) and the second visual indication (e.g., 738b) toward a respective (e.g., target) spatial arrangement (e.g., toward an arrangement shown at FIG. 7F) of the first visual indication (e.g., 738c) and the second visual indication (e.g., 738b) (e.g., the first visual indication and/or the second visual indication move toward respective positions that cause the first visual indication and the second visual indication to overlap and/or partially overlap one another).

In accordance with a determination that the body part (e.g., 708a, 708b, and/or 708c) of the user (e.g., 708) has moved further away from the target range of poses relative to the one or more sensors (e.g., 712 and/or 734) (e.g., the detected, sensed, estimated, and/or approximate orientation of the body part of the user has moved away from the target orientation with respect to the one or more sensors of the computer system, such that the one or more sensors (e.g., cameras) of the computer are not able to accurately, effectively, and/or suitably capture the one or more physical characteristics of the user), shifting the relative position of the first visual indication (e.g., 738c) and the second visual indication (e.g., 738b) includes the computer system (e.g., 101 and/or 700) shifting (1114) the relative position of the first visual indication (e.g., 738c) and the second visual indication (e.g., 738b) away from the respective (e.g., target) spatial arrangement (e.g., away from an arrangement shown at FIG. 7F) of the first visual indication (e.g., 738c) and the second visual indication (e.g., 738b) (e.g., the first visual indication and/or the second visual indication move away from the respective positions that cause the first visual indication and the second visual indication to overlap and/or partially overlap one another and/or the first visual indication and/or the second visual indication move further away from one another).

Shifting the relative position of the first visual indication and the second visual indication with a simulated parallax that is based on the change in orientation of the body part of the user with respect to the one or more sensors and a difference between the first simulated depth of the first visual indication and the second simulated depth of the second visual indication allows a user to quickly and easily align the body part of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the body part (e.g., 708a, 708b, and/or 708c) of the user (e.g., 708) includes a face (e.g., 708c) of the user (e.g., 708) (e.g., a physical face of the user) and the relative position of the first visual indication (e.g., 738c) and the second visual indication (e.g., 738b) is based on an orientation of the face (e.g., 708c) of the user (e.g., 708) with respect to the one or more sensors (e.g., 712 and/or 734) of the computer system (e.g., 101 and/or 700) (e.g., respective positions of the first visual indication and the second visual indication indicate where the orientation of the face of the user is located relative to a target position with respect to the one or more sensors of the computer system). The relative position of the first visual indication and the second visual indication being based on an orientation of a face of the user with respect to one or more sensors of the computer system allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the first visual indication (e.g., 738c) or the second visual indication (e.g., 738b) moves based on a tilt of the computer system (e.g., 101 and/or 700) relative to a face (e.g., 708c) of the user (e.g., 708) (e.g., the first visual indication and/or the second visual indication is displayed on the display generation component of the one or more display generation components as moving based on a user tilting and/or otherwise changing a position of the computer system and/or a position of the face of the user relative to one another).

In some embodiments, in response to detecting the tilt of the computer system (e.g., 101 and/or 700) relative to the face (e.g., 708c) of the user (e.g., 708) changing in a first direction, the computer system (e.g., 101 and/or 700) moves the first visual indication (e.g., 738c) or the second visual indication (e.g., 738b) in a second direction that is based on the first direction. In some embodiments, in response to detecting the tilt of the computer system (e.g., 101 and/or 700) relative to the face (e.g., 708c) of the user (e.g., 708) changing in a third direction, different from the first direction, the computer system (e.g., 101 and/or 700) moves the first visual indication (e.g., 738c) or the second visual indication (e.g., 738b) in a fourth direction that is based on the third direction, wherein the third direction is different from the second direction.

In some embodiments, in response to detecting the tilt of the computer system (e.g., 101 and/or 700) relative to the face (e.g., 708c) of the user (e.g., 708) changing by a first amount, the computer system (e.g., 101 and/or 700) moves the first visual indication (e.g., 738c) or the second visual indication (e.g., 738b) a second amount that is based on the first amount. In some embodiments, in response to detecting the tilt of the computer system (e.g., 101 and/or 700) relative to the face (e.g., 708c) of the user (e.g., 708) changing by a third amount, different from the first amount, the computer system (e.g., 101 and/or 700) moves the first visual indication (e.g., 738c) or the second visual indication (e.g., 738b) a fourth amount that is based on the third amount, wherein the fourth amount is different from the second amount.

In some embodiments, the computer system (e.g., 101 and/or 700) moves the first visual indication (e.g., 738c) or the second visual indication (e.g., 738b) a first amount and/or in a first direction that is based on a second amount of movement and/or a second direction associated with a change (e.g., a detected change) in the tilt of the computer system (e.g., 101 and/or 700) relative to the face (e.g., 708c) of the user (e.g., 708).

Moving the first visual indication or the second visual indication based on a tilt of the computer system relative to a face of the user allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the first visual indication (e.g., 738c) or the second visual indication (e.g., 738b) changes color (e.g., transition from a first color to a second color and/or fade from a first color to a second color) based on a tilt of the computer system (e.g., 101 and/or 700) relative to a face (e.g., 708c) of the user (e.g., 708) (e.g., the first visual indication and/or the second visual indication changes color based on a user tilting and/or otherwise changing a position of the computer system and/or a position of the face of the user relative to one another).

In some embodiments, in response to detecting the tilt of the computer system (e.g., 101 and/or 700) relative to the face (e.g., 708c) of the user (e.g., 708) changing in a first direction, the computer system (e.g., 101 and/or 700) changes the color of the first visual indication (e.g., 738c) or the second visual indication (e.g., 738b) in a second direction (e.g., along the color spectrum, such as in a warmer direction or a cooler direction) that is based on the first direction. In some embodiments, in response to detecting the tilt of the computer system (e.g., 101 and/or 700) relative to the face (e.g., 708c) of the user (e.g., 708) changing in a third direction, different from the first direction, the computer system (e.g., 101 and/or 700) changes the color of the first visual indication (e.g., 738c) or the second visual indication (e.g., 738b) in a fourth direction (e.g., along the color spectrum, such as in a warmer direction or a cooler direction) that is based on the third direction, wherein the fourth direction is different from the second direction.

In some embodiments, in response to detecting the tilt of the computer system (e.g., 101 and/or 700) relative to the face (e.g., 708c) of the user (e.g., 708) changing by a first amount, the computer system (e.g., 101 and/or 700) changes the color of the first visual indication (e.g., 738c) or the second visual indication (e.g., 738b) by a second amount (e.g., an amount of change and/or movement along the color spectrum) that is based on the first amount. In some embodiments, in response to detecting the tilt of the computer system (e.g., 101 and/or 700) relative to the face (e.g., 708c) of the user (e.g., 708) changing by a third amount, different from the first amount, the computer system (e.g., 101 and/or 700) changes the color of the first visual indication (e.g., 738c) or the second visual indication (e.g., 738b) by a fourth amount (e.g., an amount of change and/or movement along the color spectrum) that is based on the third amount, wherein the fourth amount is different from the second amount.

In some embodiments, the computer system (e.g., 101 and/or 700) changes the color of the first visual indication (e.g., 738c) or the second visual indication (e.g., 738b) by a first amount and/or in a first direction that is based on a second amount of movement and/or a second direction associated with a change (e.g., a detected change) in the tilt of the computer system (e.g., 101 and/or 700) relative to the face (e.g., 708c) of the user (e.g., 708).

Changing a color of the first visual indication or the second visual indication based on a tilt of the computer system relative to a face of the user allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the first visual indication (e.g., 738c) or the second visual indication (e.g., 738b) changes appearance (e.g., transition and/or fade between a first amount of blur to a second amount of blur, transition and/or fade between a first amount of saturation to a second amount of saturation and/or transition and/or fade between a first amount of brightness to a second amount of brightness) based on a distance between a face (e.g., 708c) of the user (e.g., 708) and the computer system (e.g., 101 and/or 700) (e.g., the first visual indication and/or the second visual indication includes a reduced amount of blur, an increased amount of saturation, and/or an increased amount of brightness based on a position of the computer system and a position of the face of the user becoming closer one another and/or the first visual indication and/or the second visual indication includes an increased amount of blur, a reduced amount of saturation, and/or a reduced amount of brightness based on a position of the computer system and a position of the face of the user becoming further from one another).

In some embodiments, in response to detecting the distance between the face (e.g., 708c) of the user (e.g., 708) and the computer system (e.g., 101 and/or 700) changing in a first direction (e.g., the face of the user moves closer to or further away from the computer system), the computer system (e.g., 101 and/or 700) changes an appearance of the first visual indication (e.g., 738c) or the second visual indication (e.g., 738b) in second direction (e.g., moves in a second direction on the first display generation component and/or changes color along the color spectrum, such as in a warmer direction or a cooler direction) that is based on the first direction. In some embodiments, in response to detecting the distance between the face (e.g., 708c) of the user (e.g., 708) and the computer system (e.g., 101 and/or 700) changing in a third direction (e.g., the face of the user moves closer to or further away from the computer system), different from the first direction, the computer system (e.g., 101 and/or 700) changes an appearance of the first visual indication (e.g., 738c) or the second visual indication (e.g., 738b) in fourth direction (e.g., moves in a second direction on the first display generation component and/or changes color along the color spectrum, such as in a warmer direction or a cooler direction) that is based on the third direction, wherein the fourth direction is different from the second direction.

In some embodiments, in response to detecting the distance between the face (e.g., 708c) of the user (e.g., 708) and the computer system (e.g., 101 and/or 700) changing by a first amount, the computer system (e.g., 101 and/or 700) changes an appearance of the first visual indication (e.g., 738c) or the second visual indication (e.g., 738b) by a second amount (e.g., an amount of change in blur, saturation, and/or brightness) that is based on the first amount. In some embodiments, in response to detecting the distance between the face (e.g., 708c) of the user (e.g., 708) and the computer system (e.g., 101 and/or 700) changing by a third amount, different from the first amount, the computer system (e.g., 101 and/or 700) changes an appearance of the first visual indication (e.g., 738c) or the second visual indication (e.g., 738b) by a fourth amount (e.g., an amount of change in blur, saturation, and/or brightness) that is based on the third amount, wherein the fourth amount is different from the second amount.

In some embodiments, the computer system (e.g., 101 and/or 700) changes an appearance of the first visual indication (e.g., 738c) or the second visual indication (e.g., 738b) by a first amount and/or in a first direction that is based on a second amount of movement and/or a second direction associated with a change (e.g., a detected change) in the tilt of the computer system (e.g., 101 and/or 700) relative to the face (e.g., 708c) of the user (e.g., 708).

Changing an appearance of the first visual indication or the second visual indication based on a distance between a face of the user and the computer system allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the first visual indication (e.g., 738c) is a first ring and the second visual indication (e.g., 738b) is a second ring (e.g., annular user interface objects). In some embodiments, the first visual indication includes a first ring having a first size and the second visual indication includes a second ring having a second size, different from the first size. The first visual indication and the second visual indication including rings allows the computer system to display simple visual elements that guide the user in aligning the body part of the user with the computer system, which reduces energy usage of the computer system.

In some embodiments, the display generation component (e.g., 120, 704, and/or 736) of the one or more display generation components is a lenticular display (e.g., a display including one or more lenses (e.g., a lenticular lens film formed over an array of pixels) that enable different images and/or different visual elements to be viewed on the display when viewing the display from different angles (e.g., different viewing perspectives having different angles with respect to the display)). In some embodiments, the lenticular display is configured to enable stereoscopic viewing of the display, such that a user perceives one or more visual elements displayed on the display as being three-dimensional. In some embodiments, the display generation component (e.g., 120, 704, and/or 736) is a lenticular display that includes curvature (e.g., convex curvature) to facilitate a lenticular effect that enables different images and/or different visual elements to be viewed on the display when viewing the display from different angles (e.g., different viewing perspectives having different angles with respect to the display). Displaying the first visual indication and the second visual indication on a lenticular display allows first visual indication and the second visual indication to appear as three-dimensional objects and further assists the user in aligning the body part of the user with the one or more sensors of the computer system, which reduces power usage and improves battery life of the computer system by enabling the user to use the computer system more quickly and efficiently.

In some embodiments, the change in pose of the body part (e.g., 708a, 708b, and/or 708c) of the user (e.g., 708) includes movement of the body part (e.g., 708a, 708b, and/or 708c) of the user (e.g., 708) in a first direction relative to the computer system (e.g., 101 and/or 700) (e.g., a position of the computer system and/or a position of the body part of the user moving relative to one another in the first direction), and shifting the relative position of the first visual indication (e.g., 738c) and the second visual indication (e.g., 738b) is based on the movement of the body part (e.g., 708a, 708b, and/or 708c) of the user (e.g., 708) in the first direction relative to the computer system (e.g., 101 and/or 700) (e.g., the relative position of the first visual indication and the second visual indication is shifted in a direction that is based on a position of the computer system and/or a position of the body part of the user moving relative to one another in the first direction). Shifting the relative position of the first visual indication and the second visual indication based on movement of the body part of the user in a first direction relative to the computer system allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the change in pose of the body part (e.g., 708a, 708b, and/or 708c) of the user (e.g., 708) includes movement of the body part (e.g., 708a, 708b, and/or 708c) of the user (e.g., 708) relative to the computer system (e.g., 101 and/or 700) (e.g., a position of the computer system and/or a position of the body part of the user moving relative to one another), and shifting the relative position of the first visual indication (e.g., 738c) and the second visual indication (e.g., 738b) is based on an amount of the movement of the body part (e.g., 708a, 708b, and/or 708c) of the user (e.g., 708) relative to the computer system (e.g., 101 and/or 700) (e.g., shifting the relative position of the first visual indication and the second visual indication includes an amount of movement of the first visual indication and the second visual indication that is based on (e.g., proportionate to) the amount of movement of the position of the computer system and the position of the body part of the user relative to one another). Shifting the relative position of the first visual indication and the second visual indication based on an amount of movement of the body part of the user relative to the computer system allows a user to quickly and easily align the face of the user with the one or more sensors of the computer system so that information about the one or more physical characteristics of the user of the computer system can be captured, thereby reducing power usage and improving battery life of the computer system by enabling the user to use the computer system more quickly and efficiently.

In some embodiments, the first visual indication (e.g., 738c) and/or the second visual indication (e.g., 738b) transition from a first color to a second color based on the change in pose of the body part (e.g., 708a, 708b, and/or 708c) of the user (e.g., 708) with respect to the one or more sensors (e.g., 712 and/or 734) of the computer system (e.g., 101 and/or 700) without regard to a direction of movement associated with the change in pose of the body part (e.g., 708a, 708b, and/or 708c) of the user (e.g., 708) with respect to the one or more sensors (e.g., 712 and/or 734) (e.g., the first visual indication and/or the second visual indication change colors based on the change in pose of the body part of the user with respect to the one or more sensors of the computer system, but the first color and/or the second color of the first visual indication and/or the second visual indication is not based on a direction of movement that is associated with the change in the pose of the body part of the user with respect to the one or more sensors). In some embodiments, shifting the relative position of the first visual indication (e.g., 738c) and the second visual indication (e.g., 738b) includes shifting the relative position of the first visual indication (e.g., 738c) and the second visual indication (e.g., 738b) in different directions based on the direction of movement associated with the change in pose of the body part (e.g., 708a, 708b, and/or 708c) of the user (e.g., 708) with respect to the one or more sensors (e.g., 712 and/or 734) (e.g., the relative position of the first visual indication and the second visual indication changes (e.g., left, right, up, and/or down) based on (e.g., proportionate to) the direction of movement (e.g., left, right, up, and/or down) associated with the change in pose of the body part of the user with respect to the one or more sensors of the computer system).

In some embodiments, prior to detecting the change in pose of the body part (e.g., 708a, 708b, and/or 708c) of the user (e.g., 708) with respect to the one or more sensors (e.g., 712 and/or 734) of the computer system (e.g., 101 and/or 700), the computer system (e.g., 101 and/or 700) displays the first visual indication (e.g., 738c) and/or the second visual indication (e.g., 738b) including a first color. In some embodiments, in response to detecting the change in pose of the body part (e.g., 708a, 708b, and/or 708c) of the user (e.g., 708) with respect to the one or more sensors (e.g., 712 and/or 734) of the computer system (e.g., 101 and/or 700) to a first pose, the computer system (e.g., 101 and/or 700) adjusts display of the first visual indication (e.g., 738c) and/or the second visual indication (e.g., 738b) to include a second color, different from the first color, without regard to a direction of movement associated with the change in pose of the body part (e.g., 708a, 708b, and/or 708c) of the user (e.g., 708) with respect to the one or more sensors (e.g., 712 and/or 734). In some embodiments, in response to detecting the change in pose of the body part (e.g., 708a, 708b, and/or 708c) of the user (e.g., 708) with respect to the one or more sensors (e.g., 712 and/or 734) of the computer system (e.g., 101 and/or 700) to a second pose, different from the first pose, the computer system (e.g., 101 and/or 700) adjusts display of the first visual indication (e.g., 738c) and/or the second visual indication (e.g., 738b) to include a third color, different from the first color and the second color, without regard to a direction of movement associated with the change in pose of the body part (e.g., 708a, 708b, and/or 708c) of the user (e.g., 708) with respect to the one or more sensors (e.g., 712 and/or 734).

In some embodiments, in response to detecting the change in pose of the body part (e.g., 708a, 708b, and/or 708c) of the user (e.g., 708) with respect to the one or more sensors (e.g., 712 and/or 734) in a first direction, the computer system (e.g., 101 and/or 700) shifts the relative position of the first visual indication (e.g., 738c) and the second visual indication (e.g., 738b) in a second direction that is based on the first direction. In some embodiments, in response to detecting the change in pose of the body part (e.g., 708a, 708b, and/or 708c) of the user (e.g., 708) with respect to the one or more sensors (e.g., 712 and/or 734) in a third direction, different from the first direction, the computer system (e.g., 101 and/or 700) shifts the relative position of the first visual indication (e.g., 738c) and the second visual indication (e.g., 738b) in a fourth direction that is based on the third direction, wherein the fourth direction is different from the second direction.

Shifting the relative position of the first visual indication and the second visual indication based on a direction of movement associated with the change in pose of the body part of the user with respect to the one or more sensors, but changing a color of the first visual indication and/or the second visual indication without regard to the direction of movement associated the change in pose of the body part of the user with respect to the one or more sensors, allows a user to quickly and easily align the body part of the user with the one or more sensors of the computer system without using additional battery power to change the color of the first visual indication and/or the second visual indication, thereby reducing power usage and improving battery life of the computer system.

In some embodiments, after shifting the relative position of the first visual indication (e.g., 738c) and the second visual indication (e.g., 738b) into the respective spatial arrangement of the first visual indication (e.g., 738c) and the second visual indication (e.g., 738b) (e.g., the change in pose of the body part of the user with respect to the one or more sensors is indicative of the pose of the body part of the user being in a target pose (e.g., orientation and/or position) with respect to the one or more sensors, where the target pose enables the one or more sensors of the computer system to capture the one or more physical characteristics of the user), the computer system (e.g., 101 and/or 700) initiates a process for capturing one or more facial characteristics (e.g., characteristics of face 708c) (e.g., one or more physical characteristics of a face of the user, such as one or more physical characteristics of eyes, eyebrows, nose, mouth, lips, cheeks, and/or a chin of the user) of the one or more physical characteristics of the user (e.g., 708) of the computer system (e.g., 101 and/or 700) (e.g., the computer system prompts the user to perform one or more actions (e.g., move a head of the user and/or make facial expressions) to facilitate and/or cause the computer system to begin capturing the one or more physical characteristics and/or the computer system activates the one or more sensors to begin capturing the one or more physical characteristics). Initiating the process for capturing one or more facial characteristics of the one or more physical characteristics of the user of the computer system after shifting the relative position of the first visual indication and the second visual indication into the respective spatial arrangement allows the computer system to begin capturing the one or more physical characteristics of the user without additional input, thereby reducing the number of inputs needed to perform an operation. In addition, initiating the process for capturing one or more facial characteristics of the one or more physical characteristics of the user of the computer system after shifting the relative position of the first visual indication and the second visual indication into the respective spatial arrangement allows for information that is used to generate the representation of the user to be captured more quickly, thereby reducing power usage and improving battery life of the computer system by enabling the user to use the computer system more quickly and efficiently.

In some embodiments, after initiating the process for capturing the one or more facial characteristics (e.g., one or more physical characteristics of a face of the user, such as one or more physical characteristics of eyes, eyebrows, nose, mouth, lips, cheeks, and/or a chin of the user) of the one or more physical characteristics of the user (e.g., 708) of the computer system (e.g., 101 and/or 700), the computer system (e.g., 101 and/or 700) prompts (e.g., via prompt 744 and/or 766) the user (e.g., 708) of the computer system (e.g., 101 and/or 700) to move a position of a head (e.g., 708b) of the user (e.g., 708) relative to the computer system (e.g., 101 and/or 700) (e.g., outputting a prompt instructing and/or guiding the user to move the head of the user in a particular direction and/or along a particular axis with respect to a position and/or orientation of the computer system in a physical environment in which the user is located). Prompting the user of the computer system to move a position of a head of the user relative to the computer system allows a user to quickly and easily orient their head into a position for capturing the one or more facial characteristics and reduces an amount of time needed to capture the one or more facial characteristics, thereby reducing power usage and improving battery life of the computer system by enabling the user to use the computer system more quickly and efficiently.

In some embodiments, after prompting the user (e.g., 708) of the computer system (e.g., 101 and/or 700) to move the position of the head (e.g., 708b) of the user (e.g., 708) relative to the computer system (e.g., 101 and/or 700), the computer system (e.g., 101 and/or 700) displays, via the display generation component (e.g., 120, 704, and/or 736) of the one or more display generation components, feedback (e.g., 750, 754, 755, 756, 758, 759, 760, 762, and/or 764) indicative (e.g., visual feedback, audio feedback, and/or haptic feedback) of movement of the position of the head (e.g., 708b) of the user (e.g., 708) relative to the computer system (e.g., 101 and/or 700) (e.g., as the computer system detects and/or receives information about movement of the position of the head of the user toward a target position, the computer system outputs feedback that indicates where the position of the head of the user is located relative to the target position). Providing feedback indicative of the movement of the position of the head of the user relative to the computer system toward a target position allows a user to quickly and easily understand whether to continue moving their head, stop moving their head, and/or move their head in a different direction, thereby reducing power usage and improving battery life of the computer system by enabling the user to use the computer system more quickly and efficiently.

In some embodiments, after shifting the relative position of the first visual indication (e.g., 738c) and the second visual indication (e.g., 738b) into the respective spatial arrangement of the first visual indication (e.g., 738c) and the second visual indication (e.g., 738b) (e.g., the change in pose of the body part of the user with respect to the one or more sensors is indicative of the pose of the body part of the user being in a target pose (e.g., orientation and/or position) with respect to the one or more sensors, where the target pose enables the one or more sensors of the computer system to capture the one or more physical characteristics of the user), the computer system (e.g., 101 and/or 700) initiates a process (e.g., a process that includes displaying prompt 770) for capturing one or more facial expression characteristics (e.g., one or more physical characteristics of a face of the user, such as one or more physical characteristics of eyes, eyebrows, nose, mouth, lips, cheeks, and/or a chin of the user while the user is making one or more facial expressions (e.g., smiling with closed mouth, smiling with open mouth, and/or eyebrows raised)) of the user (e.g., 708) of the computer system (e.g., 101 and/or 700). Initiating the process for capturing one or more facial expression characteristics of the user of the computer system after shifting the relative position of the first visual indication and the second visual indication into the respective spatial arrangement allows the computer system to begin capturing the one or more physical characteristics of the user without additional input, thereby reducing the number of inputs needed to perform an operation. In addition, initiating the process for capturing one or more facial expression characteristics of the one or more physical characteristics of the user of the computer system after shifting the relative position of the first visual indication and the second visual indication into the respective spatial arrangement allows for information that is used to generate the representation of the user to be captured more quickly, thereby reducing power usage and improving battery life of the computer system by enabling the user to use the computer system more quickly and efficiently.

In some embodiments, after shifting the relative position of the first visual indication (e.g., 738c) and the second visual indication (e.g., 738b) into the respective spatial arrangement of the first visual indication (e.g., 738c) and the second visual indication (e.g., 738b), the computer system (e.g., 101 and/or 700) displays, via the display generation component (e.g., 120, 704, and/or 736) of the one or more display generation components, a visual indication (e.g., 756 and/or 760) (e.g., a check mark, text, and/or a confirmation user interface object) confirming that the body part (e.g., 708a, 708b, and/or 708c) of the user (e.g., 708) is in the target orientation with respect to the computer system (e.g., 101 and/or 700) (e.g., the change in pose of the body part of the user with respect to the one or more sensors is indicative of the pose of the body part of the user being in a target pose (e.g., orientation and/or position) with respect to the one or more sensors, where the target pose enables the one or more sensors of the computer system to capture the one or more physical characteristics of the user). Displaying a visual indication confirming that the body part of the user is in the target orientation with respect to the computer system allows a user to quickly understand that the body part of the user is aligned with the computer system and prepare to move on to capturing the one or more physical characteristics of the user, thereby reducing power usage and improving battery life of the computer system by enabling the user to use the computer system more quickly and efficiently.

In some embodiments, the visual indication (e.g., 756 and/or 760) is displayed after completion of at least two steps of the enrollment process (e.g., the computer system displays the visual indication that confirms that a step of the enrollment process has been successfully completed after the computer system captures information about a physical characteristic of the one or more physical characteristics). Displaying the visual indication after completion of at least two steps of the enrollment process allows the user to associate the visual indication with completion of a respective step of the enrollment process and quickly prepare to move on to a subsequent step of the enrollment process, thereby reducing power usage and improving battery life of the computer system by enabling the user to use the computer system more quickly and efficiently.

In some embodiments, aspects/operations of methods 800, 900, 1000, 1200, 1300, 1500, and/or 1700 may be interchanged, substituted, and/or added among these methods. For example, computer systems configured to perform methods 800, 900, 1000, 1200, 1300, 1500, and/or 1700 can optionally display the first visual indication and/or the second visual indication. For brevity, these details are not repeated here.

FIG. 12 is a flow diagram of an exemplary method 1200 for providing guidance to a user for making facial expressions, in accordance with some embodiments. In some embodiments, method 1200 is performed at a computer system (e.g., 101 and/or 700) (e.g., a smartphone, a tablet, a watch, and/or a head-mounted device) that is in communication with one or more display generation components (e.g., 120, 704, and/or 736) (e.g., a visual output device, a 3D display, and/or a display having at least a portion that is transparent or translucent on which images can be projected (e.g., a see-through display), a projector, a heads-up display, and/or a display controller) (and, optionally, that is in communication with and one or more cameras (e.g., an infrared camera; a depth camera; and/or a visible light camera)). In some embodiments, the method 1200 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1200 are, optionally, combined and/or the order of some operations is, optionally, changed.

During an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation (e.g., 784) of a user (e.g., 708) (e.g., an avatar and/or a virtual representation of at least a portion of the first user), where the enrollment process includes capturing (e.g., via the one or more cameras) information about one or more physical characteristics of a user (e.g., 708) of the computer system (e.g., 101 and/or 700) (e.g., data (e.g., image data, sensor data, and/or depth data) that represents a size, shape, position, pose, color, depth, and/or other characteristics of one or more body parts and/or features of body parts of the user), the computer system (e.g., 101 and/or 700) prompts (e.g., via prompt 770) (1202) (e.g., via visual, audio, and/or haptic output) the user (e.g., 708) to make one or more facial expressions (e.g., one or more particular and/or predetermined facial expressions (e.g., smile with mouth closed, smile with mouth open, and/or raised eyebrow expression) and/or general facial expressions (e.g., a prompt guiding the user to move a position of eyes, eyebrows, lips, forehead, and/or cheeks of a face of the user over time without providing an indication of one or more particular and/or predetermined facial expression)); and

After prompting the user (e.g., 708) to make the one or more facial expressions (1204), the computer system (e.g., 101 and/or 700) detects (1206), via one or more sensors (e.g., 712 and/or 734), information about facial features of the user (e.g., 708) (e.g., an indication associated with a detected, estimated, approximated, and/or sensed orientation of one or more features (e.g., eyes, eyebrows, lips, mouth, and/or cheeks) of a face of the user with respect to a position of the computer system within a physical environment in which the computer system and/or the user is located).

After prompting the user (e.g., 708) to make the one or more facial expressions (1204), the computer system (e.g., 101 and/or 700) displays (1208), via a display generation component (e.g., 120, 704, and/or 736) of the one or more display generation components, a progress indication (e.g., 770d) based on the information about the facial features of the user (e.g., 708) (e.g., a visual element and/or user interface object that includes a hollow (e.g., unfilled and/or uncolored (e.g., a color of a background)) shape having a first end and a second end and the hollow shape is configured to be filled (e.g., with one or more colors) from the first end to the second end to indicate a progress of completing enrollment of capturing the facial expression and/or additional facial expressions).

Displaying the progress indicator (e.g., 770d) includes, in accordance with a determination that the information about the facial features of the user (e.g., 708) indicates a first degree of progress toward making the one or more facial expressions (e.g., the detected, sensed, estimated, and/or approximate orientation of the one or more features of the face of the user are positioned at target orientations (e.g., match target orientations) associated with the facial expression), the computer system (e.g., 101 and/or 700) displaying (1210) the progress indicator (e.g., 770d) with a first appearance (e.g., amount of fill 770e and/or amount of fill 770f) that indicates the first degree of progress (e.g., filling the progress indicator (e.g., with one or more colors) a first amount from the first end toward the second, where the first amount is greater than the second amount).

Displaying the progress indicator (e.g., 770d) includes, in accordance with a determination that the information about the facial features of the user (e.g., 708) indicates a second degree of progress toward making the one or more facial expressions that is different from the first degree of progress (e.g., the detected, sensed, estimated, and/or approximate orientation of the one or more features of the face of the user are not positioned at target orientations (e.g., do not match target orientations) associated with the facial expression), the computer system (e.g., 101 and/or 700) displaying (1212) the progress indicator (e.g., 770d) with a second appearance (e.g., amount of fill 770e and/or amount of fill 770f), different from the first appearance, that indicates the second degree of progress (e.g., filling the progress indicator (e.g., with one or more colors) a second amount from the first end toward the second, where the second amount is less than the first amount).

Displaying the progress indicator with the first appearance or the second appearance based on a determination that the information about the facial features of the user indicates a first degree of progress or a second degree of progress toward making the one or more facial expressions allows a user to quickly determine whether to continue making the same facial expression or a different facial expression, thereby reducing power usage and improving battery life of the computer system by enabling the user to use the computer system more quickly and efficiently.

In some embodiments, the progress indicator (e.g., 770d) is a progress bar (e.g., 770d) (e.g., a visual element and/or user interface object that includes a hollow (e.g., unfilled and/or uncolored (e.g., a color of a background)) shape having a first end and a second end and the hollow shape is configured to be filled (e.g., with one or more colors) from the first end to the second end to indicate a progress of completing enrollment of capturing the facial expression and/or additional facial expressions). In some embodiments, the progress bar (e.g., 770d) includes a shape that extends along at least three axes (e.g., 778a and/or 778b) with respect to the display generation component (e.g., 120, 704, and/or 736) of the one or more display generation components. The progress indicator including a progress bar allows a user to quickly determine whether to continue making the same facial expression or a different facial expression, thereby reducing power usage and improving battery life of the computer system by enabling the user to use the computer system more quickly and efficiently.

In some embodiments, the progress bar (e.g., 770d) is three dimensional (e.g., the progress bar includes portions that extend along three different axes (e.g., an x-axis, a y-axis, and a z-axis) with respect to the display generation component of the one or more display generation components). The progress bar being three-dimensional enables the computer system to display a more compact progress bar, thereby reducing power usage and improving battery life of the computer system.

In some embodiments, one or more first portions (e.g., portions of progress bar 770d that extend along axis 778a) of the progress bar (e.g., 770d) associated with making respective facial expressions (e.g., completing making a respective facial expression) of the one or more facial expressions extend along a first axis (e.g., 778a) that is based on a viewpoint of the user (e.g., 708) of the computer system (e.g., 101 and/or 700) (e.g., the first axis (e.g., a z-axis) extends in a direction that is parallel to the viewpoint of the user, such that the one or more portions of the progress bar are not visible to the user of the computer system (e.g., the one or more portions of the progress extend into and/or out of the display generation component and are not visible to the user of the computer system)). Including the one or more portions of the progress bar that extend along a first axis that is based on a viewpoint of the user of the computer system enables the computer system to display a more compact progress indicator, thereby reducing power usage and improving battery life of the computer system.

In some embodiments, displaying the progress indicator (e.g., 770d) includes the computer system (e.g., 101 and/or 700) changing an appearance of the progress bar (e.g., 770d) at a first rate at one or more second portions (e.g., portions of progress bar 770d that extend along axis 778b) of the progress bar (e.g., 770d) that are between the one or more first portions (e.g., portions of progress bar 770d that extend along axis 778a) of the progress bar (e.g., 770d) (e.g., the progress bar fills the one or more second portions that are positioned between the one or more first portions of the progress bar at a first rate of time), and changing an appearance of the progress bar (e.g., 770d) at a second rate, slower than the first rate, at the one or more first portions (e.g., portions of progress bar 770d that extend along axis 778a) (e.g., the progress bar fills the one or more first portions at a second rate of time that is slower than the first rate because the one or more first portions extend along the first axis that is based on the viewpoint of the user, and therefore, the one or more first portions are at least partially not visible to the user and appear to fill slower than the one or more second portions (e.g., the one or more second portions are entirely visible to the user and/or are more visible to the user when compared to the one or more first portions)). In some embodiments, the one or more second portions (e.g., portions of progress bar 770d that extend along axis 778b) extend along a second axis (e.g., 778b) (e.g., an x-axis) that extends along a length of the display generation component (e.g., 120, 704, and/or 736) of the one or more display generation components. Changing the appearance of the progress bar at a first rate at one or more second portions and changing the appearance of the progress bar at a second rate, slower than the first rate, at the one or more first portions enables the computer system to reduce an amount of power usage when displaying the progress bar, thereby reducing power usage and improving battery life of the computer system.

In some embodiments, the first appearance that indicates the first degree of progress includes a first color (e.g., a first color indicated by hatching in FIG. 7N) (e.g., a first color that is different from a background color (e.g., black)). While displaying the progress indicator (e.g., 770d) with the first appearance that indicates the first degree of progress, the computer system (e.g., 101 and/or 700) detects, via the one or more sensors (e.g., 712 and/or 734), second information about the facial features of the user (e.g., 708) (e.g., second information associated with a detected, estimated, approximated, and/or sensed orientation of one or more features (e.g., eyes, eyebrows, lips, mouth, and/or cheeks) of a face of the user with respect to a position of the computer system within a physical environment in which the computer system and/or the user is located). In response to detecting the second information about the facial features of the user (e.g., 708), the computer system (e.g., 101 and/or 700) displays, via the display generation component (e.g., 120, 704, and/or 736) of the one or more display generation components, the progress indication (e.g., 770d) with a third appearance that indicates a third degree of progress toward making the one or more facial expressions (e.g., filling the progress indicator a second amount from the first end toward the second, where the second amount is greater than the first amount), wherein the third appearance includes a second color (e.g., the second color is different from the first color to indicate that the user is making additional progress toward making the one or more facial expressions and the second color is different from a background color (e.g., black)), different from the first color.

Displaying the progress indicator with the third appearance in response to detecting the second information about the facial features of the user allows a user to quickly determine whether to continue making the same facial expression or a different facial expression, thereby reducing power usage and improving battery life of the computer system by enabling the user to use the computer system more quickly and efficiently.

In some embodiments, prompting the user (e.g., 708) to make one or more facial expressions includes the computer system (e.g., 101 and/or 700) outputting audio (e.g., 772, 774, 780, and/or 782) (e.g., sound output via an audio output device (e.g., a speaker and/or headphones) in communication with the computer system) that prompts the user (e.g., 708) to make a first facial expression (e.g., an open mouth smile, a closed mouth smile, and/or a raised eyebrow expression) of the one or more facial expressions. Outputting audio that prompts the user to make a first facial expression allows a user to quickly change a facial expression to the first facial expression so that the computer system can capture the one or more physical characteristics of the user, thereby reducing power usage and improving battery life of the computer system by enabling the user to use the computer system more quickly and efficiently.

In some embodiments, displaying the progress indicator (e.g., 770d) includes, in accordance with a determination that the information about the facial features of the user (e.g., 708) satisfies a set of one or more criteria (e.g., the detected, sensed, estimated, and/or approximate orientation of the one or more features of the face of the user are positioned at one or more target orientations (e.g., match target orientations) associated with the facial expression), the computer system (e.g., 101 and/or 700) displaying the progress indicator (e.g., 770d) changing appearance at a first rate (e.g., a non-zero rate) (e.g., the progress indicator fills at a first rate of time). In some embodiments, displaying the progress indicator (e.g., 770d) includes, in accordance with a determination that the information about the facial features of the user (e.g., 708) does not satisfy the set of one or more criteria (e.g., the detected, sensed, estimated, and/or approximate orientation of the one or more features of the face of the user are not positioned at one or more target orientations (e.g., match target orientations) associated with the facial expression), the computer system (e.g., 101 and/or 700) displaying the progress indicator (e.g., 770d) changing appearance at a second rate (e.g., a non-zero rate) (e.g., the progress indicator fills at a second rate of time that is slower than the first rate of time), slower than the first rate.

Displaying the progress indicator changing appearance at the first rate or the second rate based on whether or not the information about the facial features satisfies the set of one or more criteria allows a user to quickly determine whether to continue making the same facial expression or a different facial expression, thereby reducing power usage and improving battery life of the computer system by enabling the user to use the computer system more quickly and efficiently.

In some embodiments, the representation (e.g., 784) of the user (e.g., 708) is based on the information about the facial features (e.g., features of face 708c) of the user (e.g., 708) (e.g., the computer system uses the information about the facial features of the user to generate a representation (e.g., an avatar) of the user, where the representation includes a representation of a face that includes similar facial features to the facial features of the user). In some embodiments, the computer system (e.g., 101 and/or 700) is configured to capture first information about first facial features of the user (e.g., 708) when the user (e.g., 708) is making and/or the user (e.g., 708) is prompted to make a first facial expression of the one or more facial expressions. In some embodiments, the computer system (e.g., 101 and/or 700) is configured to capture second information second facial features, different from the first facial features, of the user (e.g., 708) when the user (e.g., 708) is making and/or the user is prompted to make a second facial expression, different from the first facial expression, of the one or more facial expressions. In some embodiments, the representation (e.g., 784) of the user (e.g., 708) is based on the first information about the first facial features of the user (e.g., 708) and the second information about the second facial features of the user (e.g., 708). The representation of the user being based on the information about the facial features of the user enables the representation of the user to appear more lifelike and/or to more closely resemble the user, thereby providing a more varied, detailed, and/or realistic user experience.

In some embodiments, after displaying the progress indication (e.g., 770d) based on the information about the facial features of the user (e.g., 708) for a predetermined amount of time (e.g., 1 second, 5 seconds, 10 seconds, 20 seconds, 30 seconds, one minute, two minutes, five minutes, or ten minutes), the computer system (e.g., 101 and/or 700) initiates a next step of the enrollment process without regard to whether or not the information about the facial features of the user (e.g., 708) corresponds to (e.g., matches) the one or more facial expressions (e.g., the computer system initiates a next step of the enrollment process after the predetermined amount of time even when the user does not fully make all of the facial expressions that are needed to fully progress the progress indicator, and, optionally, uses any information detected about the facial features of the user to generate the representation of the user). Initiating a next step of the enrollment process without regard to whether or not the information about the facial features of the user corresponds to the one or more facial expressions after displaying the progress indication for the predetermined amount of time allows the user to quickly complete the enrollment process, thereby reducing power usage and improving battery life of the computer system.

In some embodiments, after initiating the next step of the enrollment process (e.g., a step of the enrollment process that enables the representation of the user generated by the computer system to be edited (e.g., via one or more user inputs)), the computer system (e.g., 101 and/or 700) displays (e.g., concurrently displaying or non-concurrently displaying), via the display generation component (e.g., 120, 704, and/or 736) of the one or more display generation components, the representation (e.g., 784) of the user (e.g., 708) (e.g., an avatar and/or a virtual representation of at least a portion of the first user that is based on the information about the facial features of the user); and a selectable option (e.g., 786b) for capturing second information about the facial features of the user (e.g., 708) (e.g., a selectable option that, when selected, is configured to cause the computer system to initiate a process to capture and/or recapture second information about the facial features of the user). Displaying the selectable option for capturing second information about the facial features of the user allows a user to cause the computer system to capture additional information about the facial features of the user to generate a more lifelike representation of the user and/or a representation of the user that more closely resembles the user, thereby providing a more varied, detailed, and/or realistic user experience.

In some embodiments, the one or more facial expressions include two or more of a closed mouth smile (e.g., smiling without exposing teeth and/or an interior portion of a mouth of the user), an open mouth smile (e.g., smiling with teeth and/or an interior of a mouth of the user exposed), and raised eyebrows (e.g., moving eyebrows upward from a resting position and/or increasing a size at which eyes of the user are opened). The one or more facial expressions including two or more of a closed mouth smile, an open mouth smile, and raised eyebrows allows the computer system to capture sufficient information about the facial features of the user to generate a more lifelike representation of the user and/or a representation of the user that more closely resembles the user, thereby providing a more varied, detailed, and/or realistic user experience.

In some embodiments, aspects/operations of methods 800, 900, 1000, 1100, 1300, 1500, and/or 1700 may be interchanged, substituted, and/or added among these methods. For example, computer systems configured to perform methods 800, 900, 1000, 1100, 1300, 1500, and/or 1700 can optionally display the progress indication based on information about facial features of the user. For brevity, these details are not repeated here.

FIG. 13 is a flow diagram of an exemplary method 1300 for outputting audio guidance during a process for generating a representation of a user, in accordance with some embodiments. In some embodiments, method 1300 is performed at a computer system (e.g., 101 and/or 700) (e.g., a smartphone, a tablet, a watch, and/or a head-mounted device) that is in communication with one or more audio output devices (e.g., one or more speakers). In some embodiments, the method 1300 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1300 are, optionally, combined and/or the order of some operations is, optionally, changed.

During an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation (e.g., 784) of a user (e.g., 708) (e.g., an avatar and/or a virtual representation of at least a portion of the first user), where the enrollment process includes capturing (e.g., via the one or more cameras) information about one or more physical characteristics of the user (e.g., 708) of the computer system (e.g., 101 and/or 700) (e.g., data (e.g., image data, sensor data, and/or depth data) that represents a size, shape, position, pose, color, depth, and/or other characteristics of one or more body parts and/or features of body parts of the user), the computer system (e.g., 101 and/or 700) outputs (1302), via the one or more audio output devices, dynamic audio output of a first type (e.g., 741, 742, 748, 754, 758, 762, 768, 772, 774, 780, and/or 782) (e.g., audio having one or more first tones, pitches, frequencies, melodies, rhythms, tempos, chords, and/or tunes that changes over time).

While outputting the dynamic audio output of the first type (e.g., 741, 742, 748, 754, 758, 762, 768, 772, 774, 780, and/or 782), the computer system (e.g., 101 and/or 700) receives (1304) an indication (e.g., detected, sensed, estimated, and/or approximate change in orientation of a biometric feature of the user with respect to a position of the computer system (e.g., one or more biometric sensors of the computer system) within a physical environment in which the computer system and/or the user are located) of a change in pose (e.g., position and/or orientation) of a biometric feature (e.g., 708b and/or 708c) (e.g., face, head, eyes, and/or hand) of the user (e.g., 708) of the computer system (e.g., 101 and/or 700) relative to one or more biometric sensors (e.g., 712 and/or 734) (e.g., one or more of a facial recognition sensor, an iris recognition sensor, a hand geometry sensor, and/or a fingerprint sensor) of the computer system (e.g., 101 and/or 700) (e.g., a position and/or orientation of the biometric feature of the user changes with respect to a position and/or orientation of the one or more biometric sensors of the computer system within a physical environment in which the computer system and/or the user are located).

In response to receiving the indication of the change in pose of the biometric feature (e.g., 708b and/or 708c) of the user (e.g., 708) of the computer system (e.g., 101 and/or 700) relative to the one or more biometric sensors (e.g., 712 and/or 734), the computer system (e.g., 101 and/or 700) adjusts (1306) the dynamic audio output of the first type (e.g., 741, 742, 748, 754, 758, 762, 768, 772, 774, 780, and/or 782) (e.g., adjusting a volume, pitch, tone, frequency, reverberation, beat, and/or wavelength of the dynamic audio output) based on the change in pose of the biometric feature (e.g., 708b and/or 708c) of the user (e.g., 708) of the computer system (e.g., 101 and/or 700) (e.g., the adjustment of the dynamic audio output of the first type is associated with the change in pose of the biometric feature with respect to the one or more biometric sensors of the computer system within the physical environment in which the computer system and the user are located) to indicate an amount of progress toward satisfying a set of one or more criteria (e.g., the set of one or more criteria include capturing the information about the one or more physical characteristics of the user of the computer system (e.g., the biometric feature) and/or receiving an indication that the biometric feature is oriented at one or more target orientations with respect to the computer system and/or the one or more biometric sensors of the computer system).

Adjusting the dynamic audio output of the first type based on the change in pose of the biometric feature of the user of the computer system to indicate an amount of progress toward satisfying a set of one or more criteria allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, in accordance with a determination that the change in pose of the biometric feature (e.g., 708b and/or 708c) of the user (e.g., 708) of the computer system (e.g., 101 and/or 700) relative to the one or more biometric sensors (e.g., 712 and/or 734) includes rotation of the biometric feature (e.g., 708b and/or 708c) of the user (e.g., 708) of the computer system (e.g., 101 and/or 700) relative to the one or more biometric sensors (e.g., 712 and/or 734) about a first axis (e.g., 746a, 746b, and/or 746c) (e.g., a position of the biometric feature of the user and/or a position of the one or more biometric sensors rotate relative to one another about a first axis of rotation), the computer system (e.g., 101 and/or 700) adjusts a first audio property of the dynamic audio output (e.g., 741, 742, 748, 754, 758, 762, 768, 772, 774, 780, and/or 782) (e.g., adjusting one or more first audio properties (e.g., volume, pitch, tone, frequency, reverberation, beat, and/or wavelength) of the dynamic audio output of the first type). In accordance with a determination that the change in pose of the biometric feature (e.g., 708b and/or 708c) of the user (e.g., 708) of the computer system (e.g., 101 and/or 700) relative to the one or more biometric sensors (e.g., 712 and/or 734) includes rotation of the biometric feature (e.g., 708b and/or 708c) of the user (e.g., 708) of the computer system (e.g., 101 and/or 700) relative to the one or more biometric sensors (e.g., 712 and/or 734) about a second axis (e.g., 746a, 746b, and/or 746c) (e.g., a position of the biometric feature of the user and/or a position of the one or more biometric sensors rotate relative to one another about a second axis of rotation that is different from the first axis of rotation), different from the first axis (e.g., 746a, 746b, and/or 746c), the computer system (e.g., 101 and/or 700) adjusts a second audio property of the dynamic audio output (e.g., 741, 742, 748, 754, 758, 762, 768, 772, 774, 780, and/or 782), wherein the first audio property is different from the second audio property (e.g., adjusting one or more second audio properties (e.g., volume, pitch, tone, frequency, reverberation, beat, and/or wavelength) of the dynamic audio output of the first type).

In some embodiments, the first audio property of the dynamic audio output of the first type (e.g., 741, 742, 748, 754, 758, 762, 768, 772, 774, 780, and/or 782) and the second audio property of the dynamic audio output of the first type (e.g., 741, 742, 748, 754, 758, 762, 768, 772, 774, 780, and/or 782) are different from one another in that the dynamic audio output of the first type (e.g., 741, 742, 748, 754, 758, 762, 768, 772, 774, 780, and/or 782) is output so as to simulate the audio being output from different directions (e.g., relative to the computer system). In some embodiments, the computer system (e.g., 101 and/or 700) adjusts the first audio property of the dynamic audio output (e.g., 741, 742, 748, 754, 758, 762, 768, 772, 774, 780, and/or 782) by a first amount (e.g., a first amount of change in volume, pitch, tone, frequency, reverberation, beat, and/or wavelength) based on a second amount and/or direction of movement associated with the rotation of the biometric feature (e.g., 708b and/or 708c) of the user (e.g., 708) of the computer system (e.g., 101 and/or 700) relative to the one or more biometric sensors (e.g., 712 and/or 734) about the first axis (e.g., 746a, 746b, and/or 746c). In some embodiments, the computer system (e.g., 101 and/or 700) adjusts the second audio property of the dynamic audio output (e.g., 741, 742, 748, 754, 758, 762, 768, 772, 774, 780, and/or 782) by a third amount (e.g., a third amount of change in volume, pitch, tone, frequency, reverberation, beat, and/or wavelength) based on a fourth amount and/or direction of movement associated with the rotation of the biometric feature (e.g., 708b and/or 708c) of the user (e.g., 708) of the computer system (e.g., 101 and/or 700) relative to the one or more biometric sensors (e.g., 712 and/or 734) about the second axis (e.g., 746a, 746b, and/or 746c).

Adjusting the dynamic audio output of the first type based on rotation of the biometric feature of the user of the computer system relative to the one or more biometric sensors about the first axis and the second axis allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, while outputting the dynamic audio output of the first type (e.g., 741, 742, 748, 754, 758, 762, 768, 772, 774, 780, and/or 782), the computer system (e.g., 101 and/or 700) displays, via a display generation component (e.g., 120, 704, and/or 736) in communication with the computer system (e.g., 101 and/or 700), a visual indication (e.g., 738, 738a, 738b, 738c, 744 744a, 744b, 750, 766, 766a, 766b, 770, and/or 770d) associated with the enrollment process (e.g., a progress bar and/or a portion of the first display generation component that indicates an amount of progress toward satisfying the set of one or more criteria and/or a visual prompt guiding the user to move the pose of the biometric feature of the user relative to the one or more biometric sensors in a predetermined manner). Displaying the visual indication associated with the enrollment process while outputting the dynamic audio output of the first type further allows a user to determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, the dynamic audio output of the first type (e.g., 741, 742, 748, 754, 758, 762, 768, 772, 774, 780, and/or 782) includes a first component (e.g., 741a, 748a, and/or 754a) (e.g., a first component of the dynamic audio output of the first type that includes a first tone, a first pitch, a first frequency, a first melody, a first harmony, and/or a first wavelength and/or is output so as to simulate the first component being output from a first location) indicative of the pose of the biometric feature (e.g., 708b and/or 708c) of the user (e.g., 708) of the computer system (e.g., 101 and/or 700) (e.g., the first component of the dynamic audio output of the first type is associated with and/or otherwise indicates the position and/or orientation of the biometric feature of the user of the computer system (e.g., relative to the one or more biometric sensors of the computer system)) and a second component (e.g., 741b, 748b, and/or 754b) (e.g., a second component of the dynamic audio output of the first type that includes a second tone, a second pitch, a second frequency, a second melody, a second harmony, and/or a second wavelength and/or is output so as to simulate the second component being output from a second location) indicative of a location of the one or more biometric sensors (e.g., 712 and/or 734) (e.g., the second component of the dynamic audio output of the first type indicates a position and/or orientation of the one or more biometric features and/or a target pose of the biometric feature of the user relative to the one or more biometric sensors of the computer system). In some embodiments, outputting the dynamic audio output of the first type (e.g., 741, 742, 748, 754, 758, 762, 768, 772, 774, 780, and/or 782) includes concurrent output of the first component (e.g., 741a, 748a, and/or 754a) and the second component (e.g., 741b, 748b, and/or 754b).

The dynamic audio output of the first type including the first component indicative of the pose of the biometric feature of the user of the computer system and the second component indicative of a location of the one or more biometric sensors further allows a user to determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, while outputting the dynamic audio output of the first type (e.g., 741, 742, 748, 754, 758, 762, 768, 772, 774, 780, and/or 782), the computer system (e.g., 101 and/or 700) displays, via a display generation component (e.g., 120, 704, and/or 736) in communication with the computer system (e.g., 101 and/or 700), a first visual indication (e.g., 738c) indicative of the pose of the biometric feature (e.g., 708b and/or 708c) of the user (e.g., 708) of the computer system (e.g., 101 and/or 700) relative to the one or more biometric sensors (e.g., 712 and/or 734) (e.g., the first visual indication is displayed at a first position on the display generation component that indicates how the pose of the biometric feature of the user of the computer system relates and/or compares to a target pose) and a second visual indication (e.g., 738b) indicative of the location of the one or more biometric sensors (e.g., 712 and/or 734) (e.g., the second visual indication is displayed at a second position on the display generation component that indicates the location, pose, position, and/or orientation of the one or more biometric sensors and/or indicates a target pose for the biometric feature of the user of the computer system). Displaying the first visual indication and the second visual indication further allows a user to determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments the first component (e.g., 741a, 748a, and/or 754a) of the dynamic audio output of the first type (e.g., 741, 742, 748, 754, 758, 762, 768, 772, 774, 780, and/or 782) includes a first repeating audio component (e.g., a first clip, a first series of musical notes, a first melody, and/or a first tune of audio that repeats indefinitely and/or repeats a predetermined number of times) and the second component (e.g., 741b, 748b, and/or 754b) of the dynamic audio output of the first type (e.g., 741, 742, 748, 754, 758, 762, 768, 772, 774, 780, and/or 782) includes a second repeating audio component (e.g., a second clip, a second series of musical notes, a second melody, and/or a second tune of audio that repeats indefinitely and/or repeats a predetermined number of times). In some embodiments, outputting the dynamic audio output of the first type (e.g., 741, 742, 748, 754, 758, 762, 768, 772, 774, 780, and/or 782) includes concurrent output of the first repeating audio and the second repeating audio. The first component of the dynamic audio output of the first type including a first repeating audio component and the second component of the dynamic audio output of the first type including a second repeating audio component provides repetitive guidance to a user that allows the user to determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, the first repeating audio component and the second repeating audio component are harmonically spaced apart by a first harmonically significant spacing (e.g., the first repeating audio component includes one or more first musical notes at a first octave and the second repeating audio component includes one or more second musical notes at a second octave, where the first octave and the second octave are different from one another by a first integer number of octaves (e.g., one octave, two octaves, or three octaves)). Harmonically spacing apart the first repeating audio and the second repeating audio allows a user to better distinguish between the first repeating audio and the second repeating audio, and thus, determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, in accordance with a determination that the change in pose of the biometric feature (e.g., 708b and/or 708c) of the user (e.g., 708) of the computer system (e.g., 101 and/or 700) indicates that the pose of the biometric feature (e.g., 708b and/or 708c) of the user (e.g., 708) of the computer system (e.g., 101 and/or 700) is at a target pose (e.g., a position and/or orientation of the biometric feature relative to the one or more biometric sensors that enables the one or more biometric sensors to capture information about the one or more physical characteristics of the user), the computer system (e.g., 101 and/or 700) outputs a third audio component (e.g., 742a and/or 758a) (e.g., a third component of the dynamic audio output of the first type that includes a third tone, a third pitch, a third frequency, a third melody, a third harmony, and/or a third wavelength and/or is output so as to simulate the third component being output from a third location) of the dynamic audio output of the first type (e.g., 741, 742, 748, 754, 758, 762, 768, 772, 774, 780, and/or 782), where the third audio component (e.g., 742a and/or 758a) is harmonically spaced apart from the first component (e.g., 741a, 748a, and/or 754a) and the second component (e.g., 741b, 748b, and/or 754b) by a second harmonically significant spacing (e.g., the first component includes one or more first musical notes at a first octave, the second component includes one or more second musical notes at a second octave, and the third audio component includes one or more third musical notes at a third octave, where the third octave is different from both the first octave and the second octave by a second integer number of octaves (e.g., one octave, two octaves, or three octaves)). In some embodiments, outputting the dynamic audio output of the first type (e.g., 741, 742, 748, 754, 758, 762, 768, 772, 774, 780, and/or 782) includes concurrently outputting the first component (e.g., 741a, 748a, and/or 754a), the second component (e.g., 741b, 748b, and/or 754b), and the third audio component (e.g., 742a and/or 758a). In some embodiments, the first component (e.g., 741a, 748a, and/or 754a), the second component (e.g., 741b, 748b, and/or 754b), and the third audio component (e.g., 742a and/or 758a) (e.g., when output concurrently) form a musical chord, where musical notes of the first component (e.g., 741a, 748a, and/or 754a), the second component (e.g., 741b, 748b, and/or 754b), and/or the third audio component (e.g., 742a and/or 758a) are not evenly spaced (e.g., not evenly spaced by octave and/or on a musical scale). In some embodiments, the musical chord is a C major chord (e.g., the first component includes a C note, the second component includes a E note, and the third audio component includes a G note). In some embodiments, the musical chord is an F major chord (e.g., the first component includes an F note, the second component includes an A note, and the third audio component includes a C note). In some embodiments, musical chord is an A minor chord (e.g., the first component includes an A note, the second component includes a C note, and the third audio component includes an E note).

Harmonically spacing apart the third component from the first component and the second component allows a user to understand to stop adjusting the pose of the biometric feature because the pose of the biometric feature is at the target pose, thereby reducing power usage and improving battery life of the computer system by enabling the user to use the computer system more quickly and efficiently.

In some embodiments, adjusting the dynamic audio output of the first type (e.g., 741, 742, 748, 754, 758, 762, 768, 772, 774, 780, and/or 782) based on the change in pose of the biometric feature (e.g., 708b and/or 708c) of the computer system (e.g., 101 and/or 700) relative to the one or more biometric sensors (e.g., 712 and/or 734) of the computer system (e.g., 101 and/or 700) includes the computer system (e.g., 101 and/or 700) outputting the dynamic audio output of the first type (e.g., 741, 742, 748, 754, 758, 762, 768, 772, 774, 780, and/or 782) so as to simulate audio being produced from a first location (e.g., outputting the dynamic audio output of the first type so that it is perceived by a user as being produced from a first direction (e.g., to the right of the computer system, to the left of the computer system, above the computer system, and/or below the computer system)) that is based on the change in pose of the biometric feature (e.g., 708b and/or 708c) of the user (e.g., 708) of the computer system (e.g., 101 and/or 700) relative to the one or more biometric sensors (e.g., 712 and/or 734) of the computer system (e.g., 101 and/or 700) (e.g., the first location moves further away from a position of the computer system when the change in pose of the biometric feature moves further away from a target pose of the biometric feature and the first location moves closer to the position of the computer system when the change in pose of the biometric feature moves closer toward the target pose of the biometric feature). Outputting the dynamic audio output of the first type so as to simulate audio being produced from a first location that is based on the change in pose of the biometric feature of the user of the computer system relative to the one or more biometric sensors of the computer system allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, adjusting the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700) relative to the one or more biometric sensors (e.g., 712 and/or 734) of the computer system (e.g., 101 and/or 700) includes the computer system (e.g., 101 and/or 700) adjusting a volume (e.g., increasing or decreasing the volume) of the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700) relative to the one or more biometric sensors (e.g., 712 and/or 734) of the computer system (e.g., 101 and/or 700) (e.g., the volume decreases when the change in pose of the biometric feature moves further away from a target pose of the biometric feature and the volume increases when the change in pose of the biometric feature moves closer toward the target pose of the biometric feature). In some embodiments, the computer system (e.g., 101 and/or 700) adjusts the volume of the dynamic audio output of the first type (e.g., 741, 742, 748, 754, 758, 762, 768, 772, 774, 780, and/or 782) by a first amount and/or direction (e.g., a first amount of increase or a first amount of decrease) based on (e.g., proportionate to) a second amount and/or direction of movement associated with the change in pose of the biometric feature (e.g., 708b and/or 708c) of the user (e.g., 708) of the computer system (e.g., 101 and/or 700) relative to the one or more biometric sensors (e.g., 712 and/or 734). Adjusting the volume of the dynamic audio output of the first type based on the change in pose of the biometric feature of the user of the computer system relative to the one or more biometric sensors of the computer system allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, adjusting the volume of the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700) relative to the one or more biometric sensors (e.g., 712 and/or 734) of the computer system (e.g., 101 and/or 700) includes the computer system (e.g., 101 and/or 700) adjusting a first volume level of a first component (e.g., 741a, 748a, and/or 754a) (e.g., a first component of the dynamic audio output of the first type that includes a first tone, a first pitch, a first frequency, a first melody, a first harmony, and/or a first wavelength and/or is output so as to simulate the first component being output from a first location) of the dynamic audio output of the first type (e.g., 741, 742, 748, 754, 758, 762, 768, 772, 774, 780, and/or 782) indicative of the pose of the biometric feature (e.g., 708b and/or 708c) of the user (e.g., 708) of the computer system (e.g., 101 and/or 700) (e.g., the first component of the dynamic audio output of the first type is associated with and/or otherwise indicates the position and/or orientation of the biometric feature of the user of the computer system (e.g., relative to the one or more biometric sensors of the computer system)) relative to a second volume level of a second component (e.g., 741b, 748b, and/or 754b) (e.g., a second component of the dynamic audio output of the first type that includes a second tone, a second pitch, a second frequency, a second melody, a second harmony, and/or a second wavelength and/or is output so as to simulate the second component being output from a second location) of the dynamic audio output of the first type (e.g., 741, 742, 748, 754, 758, 762, 768, 772, 774, 780, and/or 782) indicative of a location of the one or more biometric sensors (e.g., 712 and/or 734) (e.g., the second component of the dynamic audio output of the first type indicates a position and/or orientation of the one or more biometric features and/or a target pose of the biometric feature of the user relative to the one or more biometric sensors of the computer system).

In some embodiments, the first volume level increases and the second volume level decreases when the change in pose of the biometric feature (e.g., 708b and/or 708c) moves further away from a target pose of the biometric feature (e.g., 708b and/or 708c) and the first volume level decreases and the second volume increases when the change in pose of the biometric feature (e.g., 708b and/or 708c) moves closer toward the target pose of the biometric feature (e.g., 708b and/or 708c). In some embodiments, the computer system (e.g., 101 and/or 700) adjusts the first volume level of the dynamic audio output of the first type (e.g., 741, 742, 748, 754, 758, 762, 768, 772, 774, 780, and/or 782) by a first amount and/or direction (e.g., a first amount of increase or a first amount of decrease) based on (e.g., proportionate to) a second amount and/or direction of movement associated with a change in pose of the biometric feature (e.g., 708b and/or 708c) of the user (e.g., 708) of the computer system (e.g., 101 and/or 700) relative to the one or more biometric sensors (e.g., 712 and/or 734). In some embodiments, the computer system (e.g., 101 and/or 700) adjusts the second volume level of the dynamic audio output of the first type (e.g., 741, 742, 748, 754, 758, 762, 768, 772, 774, 780, and/or 782) by a third amount and/or direction (e.g., a third amount of increase or a first amount of decrease) based on the second amount and/or direction of movement associated with the change in pose of the biometric feature (e.g., 708b and/or 708c) of the user (e.g., 708) of the computer system (e.g., 101 and/or 700) relative to the one or more biometric sensors (e.g., 712 and/or 734).

Adjusting the first volume level of the first component relative to the second volume level of the second component allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, after adjusting the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700), the computer system (e.g., 101 and/or 700) outputs, via the one or more audio output devices, second audio output (e.g., 742, 742a, 758, 758a, and/or 762)(e.g., dynamic audio output and/or uniform audio output) indicating that the amount of progress has satisfied the set of one or more criteria (e.g., the pose of the biometric feature of the user of the computer system is at a target pose (e.g., position and/or orientation) relative to the one or more biometric sensors of the computer system). Outputting the second audio output indicating that the amount of progress has satisfied the set of one or more criteria allows a user to confirm that the pose of the biometric feature at a predetermined pose and prepare themselves for capturing one or more additional physical characteristics of the one or more physical characteristics of the user, thereby reducing power usage and improving battery life of the computer system by enabling the user to use the computer system more quickly and efficiently.

In some embodiments, the dynamic audio output of the first type (e.g., 741, 742, 748, 754, 758, 762, 768, 772, 774, 780, and/or 782) is output during a first step of the enrollment process (e.g., a step of the enrollment process for capturing one or more first physical characteristics of the one or more physical characteristics of the user). After receiving a second indication that a second step of the enrollment process has been completed (e.g., the one or more biometric sensors and/or one or more additional sensors in communication with the computer system have captured one or more second physical characteristics of the one or more physical characteristics of the user associated with the second step of the enrollment process), the computer system (e.g., 101 and/or 700) outputs third audio output (e.g., 742, 742a, 758, 758a, and/or 762) (e.g., dynamic audio output and/or uniform audio output) indicating that the second step of the enrollment process is complete. Outputting the third audio output indicating that the second step of the enrollment process is complete allows a user to confirm that the pose of the biometric feature at a predetermined pose and prepare themselves for capturing one or more additional physical characteristics of the one or more physical characteristics of the user, thereby reducing power usage and improving battery life of the computer system by enabling the user to use the computer system more quickly and efficiently.

In some embodiments, the second audio output (e.g., 742, 742a, 758, 758a, and/or 762) and the third audio output (e.g., 742, 742a, 758, 758a, and/or 762) are the same audio output (e.g., the computer system outputs the same type of audio (e.g., audio having the same audio properties (e.g., volume, pitch, tone, frequency, reverberation, beat, and/or wavelength)) after the completion of the first step of the enrollment process and after the completion of the second step of the enrollment process (and, optionally, after the completion of each step in the enrollment process)). Outputting the same audio output after the completion of the first step of the enrollment process and after the completion of the second step of the enrollment process allows a user to become familiar with completing each step of the enrollment process, and thus, prepare themselves for the next step of the enrollment process, thereby reducing power usage and improving battery life of the computer system by enabling the user to use the computer system more quickly and efficiently.

In some embodiments, the second audio output (e.g., 742, 742a, 758, 758a, and/or 762) includes a first harmonic sequence (e.g., a first series of musical notes) and the third audio output (e.g., 742, 742a, 758, 758a, and/or 762) includes a second harmonic sequence (e.g., a second series of musical notes) that is sequentially associated with the first harmonic sequence (e.g., the second harmonic sequence includes the second series of musical notes which include the first series of musical notes and one or more additional musical notes that harmonically and/or melodically follow the first series of musical notes). Outputting the second audio output with the first harmonic sequence and the third audio output with the second harmonic sequence that is sequentially associated with the first harmonic sequence allows a user to become familiar with completing steps of the enrollment process, and thus, prepare themselves for the next step of the enrollment process, thereby reducing power usage and improving battery life of the computer system by enabling the user to use the computer system more quickly and efficiently.

In some embodiments, the dynamic audio output of the first type (e.g., 741, 742, 748, 754, 758, 762, 768, 772, 774, 780, and/or 782) is output during a first step of the enrollment process (e.g., a step of the enrollment process for capturing one or more first physical characteristics of the one or more physical characteristics of the user). After adjusting the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700), the computer system (e.g., 101 and/or 700) detects an occurrence of an event indicative of the amount of progress toward satisfying the set of one or more criteria (e.g., detecting that the pose of the biometric feature of the user of the computer system relative to the one or more biometric sensors of the computer system is at a target pose (e.g., a target position and/or a target orientation relative to the one or more biometric sensors)). In response to detecting the occurrence of the event, the computer system (e.g., 101 and/or 700) outputs, via the one or more audio output devices, dynamic audio output of a second type (e.g., 741, 742, 748, 754, 758, 762, 768, 772, 774, 780, and/or 782) (e.g., audio having one or more second tones, pitches, frequencies, melodies, rhythms, tempos, chords, and/or tunes that changes by a first amount and/or in a first direction over time based on a second amount of change and/or a second direction of user input, such as movement of a body part of the user relative to the computer system), different from the dynamic audio output of the first type (e.g., 741, 742, 748, 754, 758, 762, 768, 772, 774, 780, and/or 782) (e.g., the dynamic audio output of the first type includes one or more audio properties (e.g., volume, pitch, tone, frequency, reverberation, beat, and/or wavelength) that are different from one or more audio properties of the dynamic audio output of the second type), where the dynamic audio output of the second type (e.g., 741, 742, 748, 754, 758, 762, 768, 772, 774, 780, and/or 782) is associated with a second step of the enrollment process (e.g., a step of the enrollment process for capturing one or more second physical characteristics of the one or more physical characteristics of the user), different from the first step of the enrollment process.

Outputting the dynamic audio output of the second type during a second step of the enrollment process allows a user to distinguish between steps of the enrollment process and quickly prepare for performing one or more actions associated with the second step of the enrollment process, thereby reducing power usage and improving battery life of the computer system by enabling the user to use the computer system more quickly and efficiently.

In some embodiments, while outputting the dynamic audio output of the first type (e.g., 741, 742, 748, 754, 758, 762, 768, 772, 774, 780, and/or 782), the computer system (e.g., 101 and/or 700) displays, via a display generation component (e.g., 120, 704, and/or 736) in communication with the computer system (e.g., 101 and/or 700), a first visual indication (e.g., 738, 744, 766, and/or 770) associated with the first step of the enrollment process (e.g., a progress bar and/or a portion of the first display generation component that indicates an amount of progress toward satisfying the set of one or more criteria and/or a visual prompt guiding the user to move the pose of the biometric feature of the user relative to the one or more biometric sensors in a predetermined manner). While outputting the dynamic audio output of the second type (e.g., 741, 742, 748, 754, 758, 762, 768, 772, 774, 780, and/or 782), the computer system (e.g., 101 and/or 700) displays, via the display generation component (e.g., 120, 704, and/or 736) in communication with the computer system (e.g., 101 and/or 700), a second visual indication (e.g., 738, 744, 766, and/or 770), different from the first visual indication (e.g., 738, 744, 766, and/or 770), associated with the second step of the enrollment process (e.g., a progress bar and/or a portion of the first display generation component that indicates an amount of progress toward satisfying a second set of one or more criteria associated with the second step of the enrollment process and/or a visual prompt guiding the user to move the a body part of the user relative to the one or more biometric sensors in a predetermined manner).

Displaying the first visual indication associated with the first step of the enrollment process while outputting the dynamic audio output of the first type and displaying the second visual indication associated with the second step of the enrollment process while outputting the dynamic audio output of the second type provides additional guidance so that the user can quickly complete a respective step of the enrollment process, thereby reducing power usage and improving battery life of the computer system by enabling the user to use the computer system more quickly and efficiently.

In some embodiments, the dynamic audio output of the second type (e.g., 741, 742, 748, 754, 758, 762, 768, 772, 774, 780, and/or 782) includes a dynamic component (e.g., 741a, 741b, 742a, 748a, 748b, 754a, 754b, and/or 758a) (e.g., a component of the dynamic audio output of the second type having one or more third tones, pitches, frequencies, melodies, rhythms, tempos, chords, and/or tunes that changes by a first amount and/or a first direction over time based on a second amount of change and/or a second direction of user input, such as movement of a body part of the user relative to the computer system) that is adjusted (e.g., over time) based on a second amount of progress toward satisfying a second set of one or more criteria associated with the second step of the enrollment process (e.g., the second set of one or more criteria include capturing the information about the one or more physical characteristics of the user of the computer system (e.g., the biometric feature) and/or receiving an indication that a biometric feature is oriented at one or more target orientations with respect to the computer system and/or the one or more biometric sensors of the computer system). In some embodiments, the dynamic component of the dynamic audio output of the second type is adjusted in a different manner (e.g., one or more audio properties of the dynamic component are changed by different amounts and/or different audio properties of the dynamic component are changed as compared to adjusting the dynamic audio output of the first type) when compared to adjusting the dynamic audio output of the first type.

The dynamic audio output of the second type including a dynamic component that is adjusted based on a second amount of progress toward satisfying a second set of one or more criteria associated with the second step of the enrollment process provides additional guidance to the user so that the second step of the enrollment process can be completed more quickly, thereby reducing power usage and improving battery life of the computer system by enabling the user to use the computer system more quickly and efficiently.

In some embodiments, after outputting the dynamic audio output of the second type (e.g., 741, 742, 748, 754, 758, 762, 768, 772, 774, 780, and/or 782), the computer system (e.g., 101 and/or 700) outputs fourth audio output (e.g., 741, 742, 748, 754, 758, 762, 768, 772, 774, 780, and/or 782) (e.g., dynamic audio output and/or uniform audio output; verbal audio output; or non-verbal audio output) prompting the user (e.g., 708) of the computer system (e.g., 101 and/or 700) to move the biometric feature (e.g., 708b and/or 708c) to a predetermined pose relative to the one or more biometric sensors (e.g., 712 and/or 734) (e.g., the fourth audio output guides the user to change the pose of the biometric feature relative to the one or more biometric sensors so that the biometric feature is in a target pose (e.g., a target position and/or a target orientation with respect to the one or more biometric sensors)). In some embodiments, the computer system (e.g., 101 and/or 700) adjusts the fourth audio output (e.g., 741, 742, 748, 754, 758, 762, 768, 772, 774, 780, and/or 782) by a first amount and/or in a first direction based on (e.g., proportionate to) a second amount and/or direction of movement associated with a change in pose of the biometric feature (e.g., 708b and/or 708c) of the user (e.g., 708) of the computer system (e.g., 101 and/or 700) relative to the one or more biometric sensors (e.g., 712 and/or 734). Outputting the fourth audio output prompting the user of the computer system to move the biometric feature to a predetermined pose relative to the one or more biometric sensors provides guidance to the user of the computer system so that the user can complete a step of the enrollment process more quickly, thereby reducing power usage and improving battery life of the computer system by enabling the user to use the computer system more quickly and efficiently.

In some embodiments, after outputting the dynamic audio output of the second type (e.g., 741, 742, 748, 754, 758, 762, 768, 772, 774, 780, and/or 782), the computer system (e.g., 101 and/or 700) detects an occurrence of an event indicative of a third amount of progress toward satisfying a third set of one or more criteria associated with the second step of the enrollment process (e.g., detecting that a pose of a biometric feature of the user of the computer system relative to the one or more biometric sensors of the computer system is at a target pose (e.g., a target position and/or a target orientation relative to the one or more biometric sensors) and/or detecting that a threshold amount of information about a first physical characteristic of the one or more physical characteristics of the user has been captured via the one or more biometric sensors). In response to detecting the occurrence of the event, the computer system (e.g., 101 and/or 700) outputs, via the one or more audio output devices, dynamic audio output of a third type (e.g., 741, 742, 748, 754, 758, 762, 768, 772, 774, 780, and/or 782) (e.g., audio having one or more fourth tones, pitches, frequencies, melodies, rhythms, tempos, chords, and/or tunes that changes by a first amount and/or in a first direction over time based on a second amount of change and/or a second direction of user input, such as movement of a body part of the user relative to the computer system), where the dynamic audio output of the third type (e.g., 741, 742, 748, 754, 758, 762, 768, 772, 774, 780, and/or 782) is associated with a third step of the enrollment process (e.g., a step of the enrollment process for capturing one or more second physical characteristics of the one or more physical characteristics of the user), different from the first step of the enrollment process and the second step of the enrollment process.

Outputting the dynamic audio output of the third type during a third step of the enrollment process allows a user to distinguish between steps of the enrollment process and quickly prepare for performing one or more actions associated with the second step of the enrollment process, thereby reducing power usage and improving battery life of the computer system by enabling the user to use the computer system more quickly and efficiently.

In some embodiments, after outputting the dynamic audio output of the second type (e.g., 741, 742, 748, 754, 758, 762, 768, 772, 774, 780, and/or 782), the computer system (e.g., 101 and/or 700) detects an occurrence of an event indicative of the amount of progress not satisfying the set of one or more criteria (e.g., detecting that the pose of the biometric feature of the user of the computer system relative to the one or more biometric sensors of the computer system is not at a target pose (e.g., a target position and/or a target orientation relative to the one or more biometric sensors) and/or detecting a change in the pose of the biometric feature of the user of the computer system relative to the one or more biometric sensors of the computer system away from the target pose). In response to detecting the occurrence of the event, the computer system (e.g., 101 and/or 700) adjusts the dynamic audio output of the second type (e.g., 741, 742, 748, 754, 758, 762, 768, 772, 774, 780, and/or 782) (e.g., adjusting a volume, pitch, tone, frequency, reverberation, beat, and/or wavelength of the dynamic audio output of the second type and/or ceasing to output the dynamic audio output of the second type).

Adjusting the dynamic audio output of the second type in response to detecting the occurrence of the event allows a user to readjust a pose of the biometric feature and enable the computer system to more quickly capture the one or more physical characteristics of the user, thereby reducing power usage and improving battery life of the computer system by enabling the user to use the computer system more quickly and efficiently.

In some embodiments, adjusting the dynamic audio output of the first type (e.g., 741, 742, 748, 754, 758, 762, 768, 772, 774, 780, and/or 782) includes the computer system (e.g., 101 and/or 700) adjusting an amount of reverberation (e.g., a frequency of repetition, a resonance, and/or a pulsation of effect) of the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700) relative to the one or more biometric sensors (e.g., 712 and/or 734) (e.g., the computer system reduces an amount of reverberation of the dynamic audio output of the first type as the pose of the biometric feature of the user of the computer system relative to the one or more biometric features approaches a target pose and/or the computer system increases an amount of reverberation of the dynamic audio output of the first type as the pose of the biometric feature of the user of the computer system relative to the one or more biometric features moves further away from the target pose). In some embodiments, the computer system (e.g., 101 and/or 700) adjusts the reverberation of the dynamic audio output of the first type (e.g., 741, 742, 748, 754, 758, 762, 768, 772, 774, 780, and/or 782) by a first amount and/or direction (e.g., a first amount of increase or a first amount of decrease) based on (e.g., proportionate to) a second amount and/or direction of movement associated with the change in pose of the biometric feature (e.g., 708b and/or 708c) of the user (e.g., 708) of the computer system (e.g., 101 and/or 700) relative to the one or more biometric sensors (e.g., 712 and/or 734).

Adjusting an amount of reverberation of the dynamic audio output of the first type based on the change in pose of the biometric feature of the user of the computer system relative to the one or more biometric sensors allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, adjusting the dynamic audio output of the first type (e.g., 741, 742, 748, 754, 758, 762, 768, 772, 774, 780, and/or 782) includes the computer system (e.g., 101 and/or 700) adjusting a volume level (e.g., increasing a volume level or decreasing a volume level) of the dynamic audio output of the first type (e.g., 741, 742, 748, 754, 758, 762, 768, 772, 774, 780, and/or 782) based on the change in pose of the biometric feature (e.g., 708b and/or 708c) of the user (e.g., 708) of the computer system (e.g., 101 and/or 700) relative to the one or more biometric sensors (e.g., 712 and/or 734) (e.g., the computer system increases the volume level of the dynamic audio output of the first type as the pose of the biometric feature of the user of the computer system relative to the one or more biometric features approaches a target pose and/or the computer system decreases the volume level of the dynamic audio output of the first type as the pose of the biometric feature of the user of the computer system relative to the one or more biometric features moves further away from the target pose). In some embodiments, the computer system (e.g., 101 and/or 700) adjusts the volume of the dynamic audio output of the first type (e.g., 741, 742, 748, 754, 758, 762, 768, 772, 774, 780, and/or 782) by a first amount and/or direction (e.g., a first amount of increase or a first amount of decrease) based on (e.g., proportionate to) a second amount and/or direction of movement associated with the change in pose of the biometric feature (e.g., 708b and/or 708c) of the user (e.g., 708) of the computer system (e.g., 101 and/or 700) relative to the one or more biometric sensors (e.g., 712 and/or 734).

Adjusting a volume level of the dynamic audio output of the first type based on the change in pose of the biometric feature of the user of the computer system relative to the one or more biometric sensors allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, the set of one or more criteria includes aligning (e.g., while displaying prompt 738 including first visual indication 738b and second visual indication 738c) the biometric feature (e.g., 708b and/or 708c) (e.g., a head, a face, and/or hands of the user) of the user (e.g., 708) of the computer system (e.g., 101 and/or 700) in a predetermined pose (e.g., a target position and/or a target orientation that enables the one or more biometric sensors to capture information about the biometric feature, and, optionally, use the information to generate the representation of the user) relative to the one or more biometric sensors (e.g., 712 and/or 734) of the computer system (e.g., 101 and/or 700). Adjusting the dynamic audio output of the first step to indicate an amount of progress toward aligning the biometric feature in a predetermined pose relative to the one or more biometric sensors allows a user to quickly determine whether to maintain a pose of the biometric feature and/or further change the pose of the biometric feature so that the computer system can capture the one or more physical characteristics of the user, thereby reducing power usage and improving battery life of the computer system by enabling the user to use the computer system more quickly and efficiently.

In some embodiments, the set of one or more criteria includes detecting (e.g., while displaying prompt 744 and/or prompt 766) a predetermined amount of movement (e.g., movement in a particular direction (e.g., left, right, up, and/or down)) of a position of a head (e.g., 708b) (e.g., a physical head) of the user (e.g., 708) of the computer system (e.g., 101 and/or 700) relative to the one or more biometric sensors (e.g., 712 and/or 734) of the computer system (e.g., 101 and/or 700) (e.g., detecting that the position of the head of the user has moved relative to the one or more biometric sensors by a predetermined amount that enables the one or more biometric sensors to capture one or more first physical characteristics of at least a portion (e.g., a left portion, a right portion, an upper portion, and/or a lower portion) of the head of the user). Adjusting the dynamic audio output of the first step to indicate an amount of progress toward a predetermined amount of movement of a position of a head of the user of the computer system relative to the one or more biometric sensors of the computer system allows a user to quickly determine whether to maintain a position of the head of the user and/or continue moving the head of the user so that the computer system can capture the one or more physical characteristics of the user, thereby reducing power usage and improving battery life of the computer system by enabling the user to use the computer system more quickly and efficiently.

In some embodiments, the set of one or more criteria includes at least one criterion that is met based on detecting (e.g., while displaying prompt 770 including progress bar 770d) that the user (e.g., 708) of the computer system (e.g., 101 and/or 700) is making one or more facial expressions (e.g., detecting, sensing, estimating, and/or approximating that an orientation of the one or more facial features of the user are positioned at target orientations (e.g., match target orientations) associated with the one or more facial expressions). Adjusting the dynamic audio output of the first type to indicate an amount of progress toward detecting that the user of the computer system is making one or more facial expressions allows a user to quickly determine whether to continue making the same facial expression or a different facial expression, thereby reducing power usage and improving battery life of the computer system by enabling the user to use the computer system more quickly and efficiently.

In some embodiments, aspects/operations of methods 800, 900, 1000, 1100, 1200, 1500, and/or 1700 may be interchanged, substituted, and/or added among these methods. For example, computer systems configured to perform methods 800, 900, 1000, 1100, 1200, 1500, and/or 1700 can output the dynamic audio output of the first type. For brevity, these details are not repeated here.

FIGS. 14A-14D illustrate examples of prompting a user to position hands of the user in a plurality of poses. FIG. 15 is a flow diagram of an exemplary method 1500 for prompting a user to position hands of the user in a plurality of poses. The user interfaces in FIGS. 14A-14D are used to illustrate the processes described below, including the processes in FIG. 15.

FIGS. 14A-14D illustrate examples for prompting a user to position hands of the user in a plurality of poses. In some embodiments, a computer system, such as computer system 700, captures information about the hands of the user to generate at least a portion of a representation of the user, such as representation 714. In some embodiments, the representation of the user is displayed and/or otherwise used to communicate during a real-time communication session. In some embodiments, a real-time communication session includes real-time communication between the user of the computer system and a second user associated with a second computer system, different from the computer system, and the real-time communication session includes displaying and/or otherwise communicating, via the computer system and/or the second computer system, the user's facial and/or body expressions to the second user via the representation of the user. In some embodiments, the real-time communication session includes displaying the representation of the user and/or outputting audio corresponding to utterances of the user in real time. In some embodiments, the computer system and the second computer system are in communication with one another (e.g., wireless communication and/or wired communication) to enable information indicative of the representation of the user and/or audio corresponding to utterances of the user to be transmitted between one another. In some embodiments, the real-time communication session includes displaying the representation of the user (and, optionally, a representation of the second user) in an extended reality environment via display devices of the computer system and the second computer system.

As set forth above with reference to FIGS. 7C-7O, in some embodiments, computer system 700 captures first information about one or more first physical characteristics of user 708 while computer system 700 is removed from the body (e.g., wrist 708a and/or another portion of the body, such as head 708b and/or face 708c) of user 708. As set forth below with reference to FIGS. 14A-14D, in some embodiments, computer system 700 captures second information about one or more second physical characteristics of user 708 while computer system 700 is placed on the body (e.g., wrist 708a and/or another portion of the body, such as head 708b and/or face 708c) of user 708. In some embodiments, computer system 700 uses at least a portion of both the one or more first physical characteristics of user 708 and the one or more second physical characteristics of user 708 to generate a representation of user 708, such as representation 714. In some embodiments, the one or more first physical characteristics of user 708 correspond to physical characteristics of portions of the body of user 708 that are inaccessible and/or outside of a capturing area and/or field of sensor 712 while computer system 700 is on the body (e.g., wrist 708a and/or another portion of the body, such as head 708b and/or face 708c) of user 708, such as physical characteristics of head 708b and/or face 708c of user 708. In some embodiments, the one or more second physical characteristics of user 708 correspond to physical characteristics of portions of the body of user 708 that are accessible and/or suitable for capturing via sensor 712 while computer system 700 is on the body (e.g., wrist 708a and/or another portion of the body, such as head 708b and/or face 708c) of user 708, such as first hand 708e and/or second hand 708f of user 708.

While FIGS. 14A-14D illustrate computer system 700 as a watch, in some embodiments, computer system 700 is a head-mounted device (HMD). The HMD is configured to be worn on head 708b of user 708 and includes a first display on and/or in an interior portion of the HMD. The first display is visible to user 708 when user 708 is wearing the HMD on head 708b of user 708. For instance, the HMD at least partially covers the eyes of user 708 when placed on head 708b of user 708, such that the first display is positioned over and/or in front of the eyes of user 708. In some embodiments, the first display is configured to display an extended reality environment during a real-time communication session in which a user of the HMD is participating. In some embodiments, the HMD also includes a second display that is positioned on and/or in an exterior portion of the HMD. In some embodiments, the second display is not visible to user 708 when the HMD is placed on head 708b of user 708.

FIG. 14A illustrates computer system 700 (e.g., a watch and/or a smart watch) displaying prompt 1400 on display 736 of computer system 700 while computer system 700 is not positioned on the body of user 708. In some embodiments, computer system 700 displays prompt 1400 after computer system 700 detects user input corresponding to confirm selectable option 786a while displaying representation 714 of user 708, as shown at FIG. 7T. In some embodiments, computer system 700 displays prompt 1400 after capturing information about user 708, such as first hand 708e and second hand 708f of user 708, where the information is used to as part of a calibration process for detecting user inputs. In some embodiments, computer system 700 displays prompt 1400 as part of a separate process from the calibration process for detecting user inputs. In some embodiments, computer system 700 displays prompt 1400 after computer system 700 captures information about head 708b and/or face 708c of user 708, as described above with reference to FIGS. 7C-7O.

At FIG. 14A, prompt 1400 includes visual indication 1400a (e.g., text and/or graphics) guiding and/or instructing user 708 to place computer system 700 onto the body of user 708 (e.g., position computer system 700 on wrist 708a of user 708 and/or position computer system 700 onto another portion of the body of user 708, such as head 708b and/or face 708c of user 708) as an action to initiate and/or start a step of an enrollment process (e.g., a setup process) of computer system 700. For instance, at FIG. 14A, prompt includes the text “Place the watch on your wrist to continue setup process.” As such, user 708 views prompt 1400 and understands that computer system 700 should be placed onto the body of user 708 so that a step (e.g., the next step) of the enrollment process can be initiated. In some embodiments, an alternative prompt to prompt 1400 shown at FIG. 14A includes the text “Place the head mounted device on your head to continue setup process.” As such, user 708 views prompt 1400 and understands that computer system 700 should be placed onto the head of user 708 (e.g., with an internal display of the head mounted device being over the user's eyes, so that the user can see prompts for continuing the enrollment process).

At FIG. 14A, computer system 700 has not yet initiated the step of the enrollment process. In some embodiments, the step of the enrollment process includes capturing information about first hand 708e and/or second hand 708f of user 708 for generating at least a portion of a representation of user 708, such as representation 714. As set forth below, computer system 700 captures information about first hand 708e and/or second hand 708f of user 708 with sensor 712 (and, optionally, additional sensors) that are accessible when computer system 700 is being worn on the body of user 708. Accordingly, computer system 700 outputs prompt 1400 instructing user 708 to place computer system 700 onto the body of user 708 so that sensor 712 (and, optionally, additional sensors) can be effectively used to capture at least a portion of the information about user 708. While FIG. 14A illustrates prompt 1400 as a being displayed on display 736 of computer system 700, in some embodiments, prompt 1400 includes audio output (e.g., via a speaker of computer system 700 and/or via a wireless headset/headphones) and/or haptic output (e.g., via one or more haptic output devices of computer system 700) that instructs user 708 to place computer system 700 onto the body (e.g., wrist 708a and/or another portion of the body, such as head 708b and/or face 708c) of user 708 (e.g., rather than, or in addition to, display of the prompt).

As set forth above, in some embodiments, computer system 700 is an HMD, and display 736 is an exterior display of the HMD. In other words, display 736 is configured to be viewed by user 708 while the HMD is not worn on head 708b of user 708. In some embodiments, prompt 1400 includes instructions to place the HMD onto head 708b of user 708 and to direct a sensor of computer system 700 (e.g., sensor 712) toward first hand 708e and/or second hand 708f of user 708. In some embodiments, prompt 1400 is displayed on display 736 while computer system 700 detects that user 708 is not wearing the HMD on head 708b of user 708. In some embodiments, computer system 700 detects that user 708 is not wearing computer system 700 based on detecting an absence of a biometric feature, such as eyes or other facial features, of user 708.

In some embodiments, computer system 700 initiates the step of the enrollment process when computer system 700 detects that user 708 is wearing computer system 700 on the body of user 708, such as on wrist 708a and/or on head 708b of user 708. In some embodiments, computer system 700 detects that user 708 is wearing computer system 700 based on detecting (e.g., detecting a presence of) a biometric feature, such as eyes or other facial features, of user 708.

At FIG. 14B, user 708 has placed computer system 700 on the body (e.g., wrist 708 and/or another portion of the body, such as head 708b and/or face 708c) of user 708. In some embodiments, computer system 700 determines that computer system 700 is positioned on the body (e.g., wrist 708a and/or another portion of the body, such as head 708b and/or face 708c) of user 708 based on detecting (e.g., detecting a presence of) a biometric feature, such as eyes or other facial features of user 708. In response to determining that computer system 700 is positioned on the body (e.g., wrist 708a and/or another portion of the body, such as head 708b and/or face 708c) of user 708, computer system 700 displays prompt 1402 on display 704.

At FIG. 14B, prompt 1402 guides user 708 to move and/or orient first hand 708e and second hand 708f of user 708 into a first pose. In particular, prompt 1402 guides user 708 to position first hand 708e and second hand 708f so that first hand 708e and second hand 708f (e.g., palms of first hand 708e and second hand 708f) are positioned and/or oriented away from the body (e.g., torso 708g) of user 708. At FIG. 14B, prompt 1402 includes visual indicator 1402a (e.g., text and/or “Position hands so that palms are facing away from your body”) that directs and/or guides user 708 to position first hand 708e and second hand 708f in the first pose. Prompt 1402 includes target area indicator 1404 that provides a visual guide to user 708 so that user 708 can confirm that movement of first hand 708e and/or second hand 708f is toward the first pose.

At FIG. 14B, first hand 708e of user 708 is positioned away from torso 708g of the body of user 708 and computer system 700 detects, via sensor 712, first hand 708e of user 708. Based on detecting first hand 708e, computer system 700 displays first hand representation 1406a within target area indicator 1404 to confirm that first hand 708e has been detected by computer system 700. In some embodiments, first hand representation 1406a is a representation of first hand 708e that is based on information captured by sensor 712 (and/or additional sensors of computer system 700). In some embodiments, first hand representation 1406a includes one or more images and/or a video feed of first hand 708e that is captured by sensor 712 (and/or additional sensors of computer system 700). In some embodiments, sensor 712 includes a wide angle camera that can capture an image and/or information about first hand 708e while computer system 700 is worn on wrist 708a of user 708. In some embodiments, computer system 700 is the HMD and first hand representation 1406a is displayed on an internal display of the HMD while the HMD is worn on head 708b of user 708. In some embodiments, the HMD displays first hand representation 1406a as an optical or digital pass through representation of first hand 708e of user 708.

At FIG. 14B, first hand representation 1406a is displayed within target area indicator 1404. In some embodiments, first hand representation 1406a is displayed outside of target area indicator 1404 on display 704 (e.g., when first hand 708e is not within a predetermined distance of the first pose and/or not within a predetermined distance relative to computer system 700). In some embodiments, computer system 700 outputs additional feedback, such as audio and/or haptic feedback, that provides guidance and/or confirmation to user 708 about whether first hand 708e is moving toward or away from the first pose. In some embodiments, user 708 can adjust a position of first hand 708e and/or computer system 700 so that first hand representation 1406a is within target area indicator 1404 on display 704. In some embodiments, when first hand representation 1406a is within target area indicator 1404, first hand 708e of user 708 is positioned within a target area (e.g., relative to computer system 700) corresponding to the first pose. In some embodiments, the target area corresponding to the first pose enables sensor 712 to capture information about one or more physical characteristics of first hand 708e. In some embodiments, electronic device 700 causes sensor 712 to capture the information about the one or more physical characteristics of first hand 708e of user 708 in response to first hand representation 1406a being within target area indicator 1404 and/or in response to first hand representation 1406a being within target area indicator 1404 for a predetermined amount of time.

As set forth above, in some embodiments, computer system 700 is an HMD, and display 704 is an interior display of the HMD. In other words, display 704 is configured to be viewed by user 708 while the HMD is worn on head 708b of user 708. In some embodiments, prompt 1402 includes instructions to direct a sensor of computer system 700 (e.g., sensor 712) toward first hand 708e and/or second hand 708f of user 708.

At FIG. 14C, user 708 has moved second hand 708f so that both first hand 708e and second hand 708f are at positions away from torso 708g of user 708. In addition, palms of first hand 708e and second hand 708f are facing in a direction that is away from torso 708g, which is consistent with prompt 1402. At FIG. 14C, computer system 700 displays first hand representation 1406a and second hand representation 1406b in target area indicator 1404, thereby providing visual confirmation that first hand 708e and second hand 708f of user are at and/or near the first pose. In some embodiments, computer system 700 captures information about physical characteristics of first hand 708e and/or second hand 708f when first hand representation 1406a and second hand representation 1406b are positioned within target area indicator 1404 and/or when first hand representation 1406a and second hand representation 1406b are positioned within target area indicator 1404 for a predetermined amount of time.

In some embodiments, computer system 700 provides confirmation to user 708 that first hand 708e and second hand 708f are in the first pose in addition to displaying first hand representation 1406a and second hand representation 1406b in target area indicator 1404. For instance, in some embodiments, computer system 700 highlights, emphasizes, and/or otherwise displays an indicator to confirm that at a portion of first hand 708e and second hand 708f of user are detected and/or are determined to be in the first pose. In some embodiments, the portion of first hand 708e and second hand 708f includes fingertips of first hand 708e and second hand 708f. In some embodiments, computer system 700 highlights and/or contrasts fingertip representations of first hand representation 1406a and/or second hand representation 1406b to confirm that the fingertips of first hand 708e and second hand 708f are detected.

After computer system 700 determines that first hand 708e and second hand 708f of user 708 are in the first pose, computer system 700 outputs audio confirmation 1408, as shown at FIG. 14C. Audio confirmation 1408 allows user 708 to confirm that first hand 708e and second hand 708f are in the first pose and/or to stop moving first hand 708e and/or second hand 708f. In some embodiments, audio confirmation 1408 includes one or more chimes, tones, and/or melodies that signal to a user that first hand 708e and second hand 708f are in the first pose.

In some embodiments, after computer system 700 determines that first hand 708e and second hand 708f are in the first pose, computer system 700 displays prompt 1410, as shown at FIG. 14C. In some embodiments, computer system 700 displays prompt 1410 prior to determining and/or detecting that first hand 708e and second hand 708f are in the first pose (and, optionally, prior to outputting audio 1408). At FIG. 14C, prompt 1410 includes visual indication 1410a that provides guidance to user 708 to move first hand 708e and second hand 708f into a second pose, different from the first pose. For instance, prompt 1410 includes the text “Turn over hands,” thereby guiding user 708 to rotate and/or otherwise move the position of first hand 708e and second hand 708f into the second pose. In some embodiments, the second pose includes first hand 708e and second hand 708f positioned with palms of first hand 708e and second hand 708f facing toward torso 708g of the body of user 708 (e.g., first hand 708e and second hand 708f are rotated 180 degrees when in the second pose as compared to the first pose). In some embodiments, the second pose includes a different position of first hand 708e and/or second hand 708f relative to torso 708g and/or another portion of the body of user 708.

As set forth above, in some embodiments, computer system 700 is an HMD, and display 704 is an interior display of the HMD. In other words, display 704 is configured to be viewed by user 708 (and display prompt 1410) while the HMD is worn on head 708b of user 708.

At FIG. 14D, user 708 has moved (e.g., rotated) first hand 708e and second hand 708f so that the palms of first hand 708e and second hand 708f are facing toward torso 708g of user 708. At FIG. 14D, computer system 700 displays first hand representation 1406a and second hand representation 1406b in target area indicator 1404, thereby providing visual confirmation that first hand 708e and second hand 708f of user are detected. In some embodiments, sensor 712 includes a sensing area that is capable of detecting first hand 708e and second hand 708f of user 708 while computer system 700 is placed on the body of user 708. In some embodiments, prompt 1410 includes guidance to user 708 to reposition computer system 700 on the body of user 708 so that sensor 712 can detect and/or capture information about first hand 708e and second hand 708f.

First hand representation 1406a and second hand representation 1406b include palm representations 1406c and 1406d, respectively, which are displayed on display 704 based on detected movement of first hand 708e and second hand 708f In some embodiments, computer system 700 moves (e.g., animates and/or displays at different positions over time) first hand representation 1406a and second hand representation 1406b with respect to target area indicator 1404 and/or display 704 based on detected movement of first hand 708e and second hand 708f In some embodiments, computer system 700 captures information about physical characteristics of first hand 708e and/or second hand 708f when first hand representation 1406a and second hand representation 1406b are positioned within target area indicator 1404 and/or when first hand representation 1406a and second hand representation 1406b are positioned within target area indicator 1404 for a predetermined amount of time.

In some embodiments, computer system 700 provides confirmation to user 708 that first hand 708e and second hand 708f are in the second pose in addition to displaying first hand representation 1406a and second hand representation 1406b in target area indicator 1404. For instance, in some embodiments, computer system 700 highlights, emphasizes, and/or otherwise displays an indicator to confirm that at a portion of first hand 708e and second hand 708f of user are detected and/or in the second pose. In some embodiments, the portion of first hand 708e and second hand 708f includes fingertips of first hand 708e and second hand 708f In some embodiments, computer system 700 highlights and/or contrasts fingertip representations of first hand representation 1406a and/or second hand representation 1406b to confirm that the fingertips of first hand 708e and second hand 708f are detected.

After computer system 700 determines that first hand 708e and second hand 708f of user 708 are in the second pose, computer system 700 outputs audio confirmation 1412, as shown at FIG. 14D. Audio confirmation 1412 allows user 708 to confirm that first hand 708e and second hand 708f are in the second pose and/or to stop moving first hand 708e and/or second hand 708f In some embodiments, audio confirmation 1412 includes one or more chimes, tones, and/or melodies that signal to a user that first hand 708e and second hand 708f are in the second pose. In some embodiments, audio confirmation 1412 is the same as audio confirmation 1408. In some embodiments, audio confirmation 1408 and audio confirmation 1412 are different from one another.

In some embodiments, after computer system 700 determines that first hand 708e and second hand 708f are in the second pose, computer system 700 displays confirmation indicator 1414, as shown at FIG. 14D. At FIG. 14D, confirmation indicator 1414 includes a checkmark, which visually indicates that first hand 708e and second hand 708f are in the second pose. In some embodiments, confirmation indicator 1414 includes a symbol, icon, graphic, image, and/or visual element that is different from the checkmark. In some embodiments, confirmation indicator 1414 includes displaying a user interface and/or prompt associated with another step of the enrollment process. For instance, in some embodiments, after computer system 700 determines that first hand 708e and second hand 708f are in the second pose, computer system 700 displays a user interface and/or prompt guiding the user to perform another action that is different from positioning first hand 708e and second hand 708f in the second pose. In some embodiments, computer system 700 captures information about physical characteristics of first hand 708e and second hand 708f while first hand 708e and second hand 708f are in the second pose.

In some embodiments, after capturing information about physical characteristics of first hand 708e and second hand 708f of user 708, computer system 700 displays representation 714 of user 708, as set forth below with reference to FIGS. 16A-16G. In some embodiments, representation 714 includes hand representations that are generated by computer system 700 based on the information about physical characteristics of first hand 708e and second hand 708f of user 708 captured by computer system 700. In some embodiments, computer system 700 enables user 708 to modify and/or adjust an appearance of representation 714 including hand representations, as set forth below with reference to FIGS. 16A-16G.

FIG. 15 is a flow diagram of an exemplary method 1500 for prompting a user to position hands of the user in a plurality of poses, in accordance with some embodiments. In some embodiments, method 1500 is performed at a computer system (e.g., 101, 700, and/or 1600) (e.g., a smartphone, a tablet, a watch, and/or a head-mounted device) that is in communication with one or more display generation components (e.g., 120, 704, 736, and/or 1600a) (e.g., a visual output device, a 3D display, and/or a display having at least a portion that is transparent or translucent on which images can be projected (e.g., a see-through display), a projector, a heads-up display, and/or a display controller) (and, optionally, that is in communication with and one or more cameras (e.g., an infrared camera, a depth camera, and/or a visible light camera)). In some embodiments, the method 1500 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1500 are, optionally, combined and/or the order of some operations is, optionally, changed.

While a representation (e.g., 1406a and/or 1406b) of hands (e.g., 708e and/or 708f) of a user (e.g., 708) of the computer system (e.g., 101, 700, and/or 1600) is visible (e.g., as an optical passthrough or digital passthrough) (in some embodiments, the representation of hands is displayed via a display generation component of the one or more display generation components) in an extended reality environment (e.g., an environment associated with prompt 1402 and/or 1410) (e.g., an augmented reality environment, a virtual reality environment, and/or a mixed reality environment), the computer system (e.g., 101, 700, and/or 1600) prompts (1502) (e.g., 1402 and/or 1410) (e.g., a visual prompt displayed by the first display generation component, an audio prompt output via a speaker of the computer system, and/or a haptic prompt) the user (e.g., 708) of the computer system (e.g., 101, 700, and/or 1600) to move a position of the hands (e.g., 708e and/or 708f) (e.g., physical hands of the user) of the user (e.g., 708) into a first pose (e.g., a first pose of hands 708e and 708f shown at FIG. 14C) (e.g., a prompt instructing and/or guiding the user to move the hands of the user to a first position and/or orientation with respect to a position and/or orientation of the computer system in a physical environment in which the user is located). In some embodiments, the computer system (e.g., 101, 700, and/or 1600) prompts the user (e.g., 708) to move a position of the hands (e.g., 708e and/or 708f) of the user (e.g., 708) into the first pose during an enrollment process (e.g., a process that includes capturing data (e.g., image data, sensor data, and/or depth data) indicative of a size, shape, position, pose, color, depth and/or other characteristic of one or more body parts and/or features of body parts of a user) for generating a representation of a user (e.g., an avatar and/or a virtual representation of at least a portion of the user), where the enrollment process includes capturing (e.g., via the one or more cameras) information about one or more physical characteristics of a user (e.g., 708) of the computer system (e.g., 101, 700, and/or 1600) (e.g., data (e.g., image data, sensor data, and/or depth data) that represents a size, shape, position, pose, color, depth, and/or other characteristics of one or more body parts and/or features of body parts of the user).

After prompting (e.g., 1402 and/or 1410) the user (e.g., 708) of the computer system (e.g., 101, 700, and/or 1600) to move the position of the hands (e.g., 708e and/or 708f) of the user (e.g., 708) into the first pose, the computer system (e.g., 101, 700, and/or 1600) detects (1504) that the position of the hands (e.g., 708e and/or 708f) of the user (e.g., 708) is in the first pose (e.g., a first pose of hands 708e and 708f shown at FIG. 14C) (e.g., capturing data (e.g., image data, sensor data, and/or depth data) indicative of a size, shape, position, pose, color, depth and/or other characteristic of the hands of the user and the data indicates the hands of the user are in a position and/or orientation that is consistent with, matches, and/or corresponds to the first pose). In some embodiments, in response to detecting that the position of the hands (e.g., 708e and/or 708f) of the user (e.g., 708) is not in the first pose (e.g., the first information includes data that indicates the hands of the user are not in a position and/or orientation that is consistent with, matches, and/or corresponds to the first pose), the computer system (e.g., 101, 700, and/or 1600) continues to prompt (e.g., continues to display prompt 1402 and/or prompt 1410) the user (e.g., 708) of the computer system (e.g., 101, 700, and/or 1600) to move the position of the hands (e.g., 708e and/or 708f) of the user to the first pose (e.g., continuing to display and/or otherwise output guidance that instructs the user to move their hands into the first pose).

After detecting that the position of the hands (e.g., 708e and/or 708f) of the user (e.g., 708) is in the first pose (e.g., a first pose shown at FIG. 14C), the computer system (e.g., 101, 700, and/or 1600) prompts (1506) (e.g., 1402 and/or 1410) (e.g., after capturing the first information) the user (e.g., 708) of the computer system (e.g., 101, 700, and/or 1600) to move the position of the hands (e.g., 708e and/or 708f) of the user (e.g., 708) into a second pose (e.g., a second pose of hands 708e and 708f shown at FIG. 14D) (e.g., a prompt instructing and/or guiding the user to move the hands of the user to a second position and/or orientation with respect to a position and/or orientation of the computer system in a physical environment in which the user is located). In some embodiments, before, while, and/or after prompting the user (e.g., 708) of the computer system (e.g., 101, 700, and/or 1600) to move the position of the hands (e.g., 708e and/or 708f) of the user (e.g., 708) into the second pose, the computer system (e.g., 101, 700, and/or 1600) captures first information about one or more physical characteristics of the hands (e.g., 708e and/or 708f) of the user (e.g., 708) (e.g., capturing data (e.g., image data, sensor data, and/or depth data) indicative of a size, shape, position, pose, color, depth and/or other characteristic of the hands of the user that is used to generate a representation of the hands of the user).

After prompting (e.g., 1402 and/or 1410) the user (e.g., 708) of the computer system (e.g., 101, 700, and/or 1600) to move the position of the hands (e.g., 708e and/or 708f) of the user (e.g., 708) into the second pose (e.g., a second pose of hands 708e and 708f shown at FIG. 14D), the computer system (e.g., 101, 700, and/or 1600) detects (1508) that the position of the hands (e.g., 708e and/or 708f) of the user (e.g., 708) is in the second pose (e.g., a second pose of hands 708e and 708f shown at FIG. 14D) (e.g., capturing data (e.g., image data, sensor data, and/or depth data) indicative of a size, shape, position, pose, color, depth and/or other characteristic of the hands of the user and the data that indicates the hands of the user are in a position and/or orientation that is consistent with, matches, and/or corresponds to the second pose). In some embodiments, in response to detecting that the position of the hands (e.g., 708e and/or 708f) of the user (e.g., 708) is not in the second pose (e.g., the third information includes data that indicates the hands of the user are not in a position and/or orientation that is consistent with, matches, and/or corresponds to the second pose), the computer system (e.g., 101, 700, and/or 1600) continues to prompt (e.g., continues to display prompt 1402 and/or prompt 1410) the user (e.g., 708) of the computer system (e.g., 101, 700, and/or 1600) to move the position of the hands (e.g., 708e and/or 708f) of the user (e.g., 708) into the second pose (e.g., continuing to display and/or otherwise output guidance that instructs the user to move their hands into the second pose).

In response to detecting that the position of the hands (e.g., 708e and/or 708f) of the user (e.g., 708) is in the second pose (e.g., a second pose of hands 708e and 708f shown at FIG. 14D), the computer system (e.g., 101, 700, and/or 1600) outputs (1510) confirmation (e.g., 1408, 1412, and/or 1414) (e.g., displaying a visual indicator, such as a check mark and/or text (e.g., “success”), outputting audio output, outputting one or more haptic outputs, and/or outputting guidance and/or a prompt for performing a next step of an enrollment process) that the position of the hands (e.g., 708e and/or 708f) of the user (e.g., 708) has been detected in the second pose (e.g., a second pose of hands 708e and 708f shown at FIG. 14D). In some embodiments, prior to, while, and/or after outputting confirmation (e.g., 1408, 1412, and/or 1414) that the position of the hands (e.g., 708e and/or 708f) of the user (e.g., 708) has been detected in the second pose, the computer system (e.g., 101, 700, and/or 1600) captures second information, different from the first information, about one or more physical characteristics of the hands (e.g., 708e and/or 708f) of the user (e.g., 708) (e.g., capturing data (e.g., image data, sensor data, and/or depth data) indicative of a size, shape, position, pose, color, depth and/or other characteristic of the hands of the user that is used to generate a representation of the hands of the user). Prompting the user to move a position of the hands of the user in the first pose and prompting the user to move the position the hands of the user in the second pose allows a user of the computer system to quickly position the hands of the user in a predetermined pose, thereby reducing power usage and improving battery life of the device by enabling the user to use the device more quickly and efficiently. In addition, outputting confirmation that the position of the hands of the user has been detected in the second pose provides the user with confirmation that the position of the hands is in the proper pose, thereby providing improved feedback.

In some embodiments, in response to detecting that the position of the hands (e.g., 708e and/or 708f) of the user (e.g., 708) is in the first pose (e.g., a first pose of hands 708e and 708f shown at FIG. 14C), the computer system (e.g., 101, 700, and/or 1600) outputs confirmation (e.g., 1408, 1412, and/or 1414) (e.g., displaying a visual indicator, such as a check mark and/or text (e.g., “success”), outputting audio output, outputting one or more haptic outputs, and/or prompting the user to position the hands of the user in the second pose) that the position of the hands (e.g., 708e and/or 708f) of the user (e.g., 708) has been detected in the first pose (e.g., a first pose of hands 708e and 708f shown at FIG. 14C). Outputting confirmation that the position of the hands of the user has been detected in the first pose provides the user with confirmation that the position of the hands is in the proper pose, thereby providing improved feedback.

In some embodiments, first information (e.g., data (e.g., image data, sensor data, and/or depth data) that represents a size, shape, position, pose, color, depth, and/or other characteristics of one or more hands of the user) about the hands (e.g., 708e and/or 708f) of the user (e.g., 708) collected while in the first pose (e.g., a first pose of hands 708e and 708f shown at FIG. 14C) and the second pose (e.g., a second pose of hands 708e and 708f shown at FIG. 14D) is used to generate a virtual avatar (e.g., 714) of the user (e.g., 708) (e.g., an avatar and/or a virtual representation of at least a portion of the user). Separately from collecting the first information about the hands (e.g., 708e and/or 708f) of the user (e.g., 708) while in the first pose (e.g., a first pose of hands 708e and 708f shown at FIG. 14C) and the second pose (e.g., a second pose of hands 708e and 708f shown at FIG. 14D) (e.g., before or after capturing the first information), the computer system (e.g., 101, 700, and/or 1600) provides guidance (e.g., displaying, via a display generation component of the one or more display generation components, prompts, outputting audio, and/or outputting haptics), via one or more output devices (e.g., the one or more display generation components, one or more speakers and/or audio output devices, and/or one or more haptic output devices), that is used to position one or more hands (e.g., 708e and/or 708f) of the user (e.g., 708) to enable collection of second information (e.g., data (e.g., image data, sensor data, and/or depth data) that includes information about the hands of the user, movement of the hands of the user, and/or gestures made by the hands of the user (e.g., the user is attempting to provide a known and/or predetermined sequence of hand gesture inputs, the detected, observed, and/or captured information about the hands of the user is compared to the known and/or predetermined sequence of hand gesture inputs, and the comparison is used to adjust how the computer system interprets hand gesture inputs so that the detected, observed, and/or captured information about the hands of the user matches the known and/or predetermined sequence of hand gesture inputs) so that the computer system can detect and perform one or more functions based on the input and/or so that the computer system can more accurately detect the inputs). Generating a virtual avatar of the user based on first information collected by the computer system separately from capturing the second information, enables the computer system to quickly and efficiently capture information both for calibrating detection of one or more input techniques and to generate a virtual avatar of a user without the user having to navigate to another user interface, thereby reducing power usage and improving battery life of the device by enabling the user to use the device more quickly and efficiently and reducing the number of inputs needed to perform an operation.

In some embodiments, the computer system (e.g., 101, 700, and/or 1600) collects the second information before (e.g., prior to and/or during a separate step of an enrollment process that occurs before) collecting the first information. Capturing the second information before capturing the first information enables the computer system to quickly and efficiently capture information both for calibrating detection of one or more input techniques and to generate a virtual avatar of a user without the user having to navigate to another user interface, thereby reducing power usage and improving battery life of the device by enabling the user to use the device more quickly and efficiently and reducing the number of inputs needed to perform an operation. In addition, collecting the second information before proceeding with additional steps of an enrollment process allows the computer system to more effectively detect user inputs during the remaining steps of the enrollment process, thereby reducing power usage and improving battery life of the device by enabling the user to use the device more quickly and efficiently.

In some embodiments, prior to (e.g., before) prompting (e.g., 1402 and/or 1410) the user (e.g., 708) of the computer system (e.g., 101, 700, and/or 1600) to move the position of the hands (e.g., 708e and/or 708f) of the user (e.g., 708) into the first pose (e.g., a first pose of hands 708e and 708f shown at FIG. 14C), the computer system (e.g., 101, 700, and/or 1600) captures third information (e.g., capturing information about face 708c of user 708, as shown at FIGS. 7G-7O) (e.g., data (e.g., image data, sensor data, and/or depth data) that represents a size, shape, position, pose, color, depth, and/or other characteristics of a face of the user) about a face (e.g., 708c) of the user (e.g., 708), wherein the third information is used to generate a virtual representation (e.g., 714) of the user (e.g., 708) (e.g., an avatar and/or a virtual representation of at least a portion of the user). Capturing the third information prior to prompting the user of the computer system to move the position of the hands of the user into the first pose enables the computer system to quickly and efficiently capture information for different parts of a body of the user to generate a virtual representation of a user without the user having to navigate to another user interface, thereby reducing power usage and improving battery life of the device by enabling the user to use the device more quickly and efficiently and reducing the number of inputs needed to perform an operation.

In some embodiments, capturing the third information about the face (e.g., 708c) of the user (e.g., 708) includes capturing the third information about the face (e.g., 708c) of the user (e.g., 708) while the computer system (e.g., 101, 700, and/or 1600) is not placed on a body (e.g., not on wrist 708a and/or head 708b) of the user (e.g., 708) (e.g., the computer system is not being worn with a respective orientation and/or position relative to a respective portion of the user's body) (e.g., the computer system is a wearable computer system (e.g., a head-mounted display generation component, glasses, a headset, and/or a watch) that is configured to be worn on a body part of a user of the computer system) (in some embodiments, the computer system is a watch configured to be worn on a wrist of the user of the computer system) (in some embodiments, the computer system is in communication with one or more sensors that capture data indicative of whether the computer system is in the wearable position). In some embodiments, prompting (e.g., 1402 and/or 1410) the user (e.g., 708) of the computer system (e.g., 101, 700, and/or 1600) to move the position of the hands (e.g., 708e and/or 708f) of the user (e.g., 708) into the first pose (e.g., a first pose of hands 708e and 708f shown at FIG. 14C) includes prompting (e.g., 1402 and/or 1410) the user (e.g., 708) of the computer system (e.g., 101, 700, and/or 1600) to move the position of the hands (e.g., 708e and/or 708f) of the user (e.g., 708) into the first pose (e.g., a first pose of hands 708e and 708f shown at FIG. 14C) while the computer system (e.g., 101, 700, and/or 1600) is placed on the body (e.g., on wrist 708a and/or head 708b) of the user (e.g., 708) (e.g., the computer system is worn with a respective orientation and/or position relative to a respective portion of the user's body). Capturing the third information about the face of the user while the computer system is not placed on the body of the user and prompting the user of the computer system to move the position of the hands of the user into the first pose while the computer system is placed on the body of the user enables the computer system to capture information about portions of a body of the user that would otherwise not be accessible to the computer system while the computer system is placed on the body of the user. Accordingly, the computer system is able to capture the information related to the user without additional and/or external devices and/or sensors. In addition, the computer system is able to capture more information related to the user that is used to generate a more accurate representation of the user.

In some embodiments, after detecting that the position of the hands (e.g., 708e and/or 708f) of the user (e.g., 708) is in the first pose (e.g., a first pose of hands 708e and 708f shown at FIG. 14C) (e.g., in response to detecting that the position of the hands is in the first pose or in response to detecting the occurrence of another triggering condition), the computer system (e.g., 101, 700, and/or 1600) outputs first feedback (e.g., 1408 and/or 1412) (displaying a first visual indicator, outputting first audio output, and/or outputting one or more first haptic outputs) indicating that a first portion (e.g., one or more fingertips, one or more fingers, at least a portion of a palm, and/or at least a portion of a backside of a hand) of the hands (e.g., 708e and/or 708f) of the user (e.g., 708) has been detected. After detecting that the position of the hands (e.g., 708e and/or 708f) of the user (e.g., 708) is in the second pose (e.g., a second pose of hands 708e and 708f shown at FIG. 14D) (e.g., in response to detecting that the position of the hands is in the second pose or in response to detecting the occurrence of another triggering condition), the computer system (e.g., 101, 700, and/or 1600) outputs second feedback (e.g., 1408 and/or 1412) (displaying a second visual indicator, outputting second audio output, and/or outputting one or more second haptic outputs) indicating that the first portion of the hands (e.g., 708e and/or 708f) of the user (e.g., 708) has been detected, wherein the second pose (e.g., a second pose of hands 708e and 708f shown at FIG. 14D) is different from the first pose (e.g., a first pose of hands 708e and 708f shown at FIG. 14C) (e.g., the position of the hands of the user is different when in the second pose as compared to the first pose). In some embodiments, the first portion of the hands (e.g., 708e and/or 708f) of the user (e.g., 708) is in a different orientation relative to the computer system (e.g., 101, 700, and/or 1600) when the position of the hands (e.g., 708e and/or 708f) of the user (e.g., 708) is in the first pose (e.g., a first pose of hands 708e and 708f shown at FIG. 14C) as compared to the second pose (e.g., a second pose of hands 708e and 708f shown at FIG. 14D). Outputting feedback indicating that a first portion of the hands of the user has been detected facilitates a user's ability to position the hands of the user in a predetermined pose and/or orientation, thereby reducing power usage and improving battery life of the device by enabling the user to use the device more quickly and efficiently.

In some embodiments, the first portion of the hands (e.g., 708e and/or 708f) of the user (e.g., 708) includes one or more fingertips (e.g., ends of fingers and/or distal portions of fingers) of the hands (e.g., 708e and/or 708f) of the user (e.g., 708). Outputting feedback indicating that fingertips of the hands of the user has been detected facilitates a user's ability to position the hands of the user in a predetermined pose and/or orientation, thereby reducing power usage and improving battery life of the device by enabling the user to use the device more quickly and efficiently.

In some embodiments, the first pose (e.g., a first pose of hands 708e and 708f shown at FIG. 14C) includes the hands (e.g., 708e and/or 708f) of the user (e.g., 708) facing away from a body (e.g., torso 708g) of the user (e.g., 708) (e.g., palms of the hands of the user are facing away from a face and/or torso of the user so that the user cannot view and/or see the palms of the hands of the user), and the second pose (e.g., a second pose of hands 708e and 708f shown at FIG. 14D) includes the hands (e.g., 708e and/or 708f) of the user (e.g., 708) facing toward the body (e.g., torso 708g) of the user (e.g., 708) (e.g., palms of the hands of the user are facing toward the face and/or torso of the user so that the user can view and/or see the palms of the hands of the user).

In some embodiments, the first pose (e.g., a first pose of hands 708e and 708f shown at FIG. 14C) includes the hands (e.g., 708e and/or 708f) of the user being positioned within a predetermined distance range from the body (e.g., torso 708g) of the user (e.g., 708), such as between one inch and thirty inches away from the body (e.g., torso 708g) of the user (e.g., 708), between four inches and twenty-five inches away from the body (e.g., torso 708g) of the user (e.g., 708), and/or between six inches and twenty inches away from the body (e.g., torso 708g) of the user (e.g., 708). In some embodiments, the first pose (e.g., a first pose of hands 708e and 708f shown at FIG. 14C) includes the hands (e.g., 708e and/or 708f) of the user (e.g., 708) being positioned within a predetermined elevation range with respect to a surface (e.g., a physical surface in an environment in which the user is located (e.g., the ground, a chair, and/or a table) and/or a virtual surface), such as between zero feet and five feet, between six inches and three feet, or between 1 foot and 2 feet. In some embodiments, the first pose (e.g., a first pose of hands 708e and 708f shown at FIG. 14C) includes the hands (e.g., 708e and/or 708f) of the of the user (e.g., 708) being positioned such that an angle of arms of the user (e.g., 708) are within a predetermined angle range from a torso (e.g., 708g) and/or shoulder of the user (e.g., 708), such as between zero degrees and 150 degrees, between 10 degrees and 100 degrees, or between 30 degrees and 90 degrees. In some embodiments, the second pose (e.g., a second pose of hands 708e and 708f shown at FIG. 14D) includes the hands (e.g., 708e and/or 708f) of the user (e.g., 708) being positioned within predetermined distance range from the body (e.g., torso 708g) of the user (e.g., 708), such as between one inch and thirty inches away from the body (e.g., torso 708g) of the user (e.g., 708), between four inches and twenty-five inches away from the body (e.g., torso 708g) of the user (e.g., 708), and/or between six inches and twenty inches away from the body (e.g., torso 708g) of the user (e.g., 708). In some embodiments, the second pose (e.g., a second pose of hands 708e and 708f shown at FIG. 14D) includes the hands (e.g., 708e and/or 708f) of the user (e.g., 708) being positioned within a predetermined elevation range with respect to a surface (e.g., a physical surface in an environment in which the user is located (e.g., the ground, a chair, and/or a table) and/or a virtual surface), such as between zero feet and five feet, between six inches and three feet, or between 1 foot and 2 feet. In some embodiments, the second pose (e.g., a second pose of hands 708e and 708f shown at FIG. 14D) includes the hands (e.g., 708e and/or 708f) of the of the user (e.g., 708) being positioned such that an angle of arms of the user (e.g., 708) are within a predetermined angle range from a torso (e.g., 708g) and/or shoulder of the user (e.g., 708), such as between zero degrees and 150 degrees, between degrees and 100 degrees, or between 30 degrees and 90 degrees. The first pose including the hands of the user facing away from a body of the user and the second pose including the hands of the user facing toward the body of the user allows the computer system to detect and/or capture information about physical characteristics of both sides of the hands of the user, thereby providing a more varied, detailed, and/or realistic user experience.

In some embodiments, prompting (e.g., 1402 and/or 1410) the user (e.g., 708) of the computer system (e.g., 101, 700, and/or 1600) to move the position of the hands (e.g., 708e and/or 708f) of the user (e.g., 708) into the second pose (e.g., a second pose of hands 708e and 708f shown at FIG. 14D) includes displaying, via a display generation component (e.g., 120, 704, 736, and/or 1600a) of the one or more display generation components, a visual indication (e.g., 1410a) (e.g., an image, a symbol, an icon, text, and/or a visual element that guides a user to position the hands of the user into the second pose) to change the position of the hands (e.g., 708e and/or 708f) of the user (e.g., 708) from the first pose (e.g., a first pose of hands 708e and 708f shown at FIG. 14C) to the second pose (e.g., a second pose of hands 708e and 708f shown at FIG. 14D) (e.g., visual guidance to move the position of the hands of the user from the first pose into the second pose). Displaying the visual indication to change the position of the hands of the user from the first pose to the second pose facilitates a user's ability to position the hands of the user in a predetermined pose and/or orientation, thereby reducing power usage and improving battery life of the device by enabling the user to use the device more quickly and efficiently.

In some embodiments, prompting (e.g., 1402 and/or 1410) the user (e.g., 708) of the computer system (e.g., 101, 700, and/or 1600) to move the position of the hands (e.g., 708e and/or 708f) of the user (e.g., 708) into the second pose (e.g., a second pose of hands 708e and 708f shown at FIG. 14D) includes outputting, via an audio output device (e.g., a speaker) in communication with the computer system (e.g., 101, 700, and/or 1600), an audio prompt (e.g., 1408 and/or 1412) (e.g., audio output including a chime, speech, and/or audio cues that guide the user to position the hand of the user into the second pose) to change the position of the hands (e.g., 708e and/or 708f) of the user (e.g., 708) from the first pose (e.g., a first pose of hands 708e and 708f shown at FIG. 14C) to the second pose (e.g., a second pose of hands 708e and 708f shown at FIG. 14D) (e.g., audio guidance to move the position of the hands of the user from the first pose into the second pose). Outputting the audio prompt to change the position of the hands of the user from the first pose to the second pose facilitates a user's ability to position the hands of the user in a predetermined pose and/or orientation, thereby reducing power usage and improving battery life of the device by enabling the user to use the device more quickly and efficiently.

In some embodiments, after outputting confirmation (e.g., 1408, 1412, and/or 1414) that the position of the hands (e.g., 708e and/or 708f) of the user (e.g., 708) has been detected in the second pose (e.g., a second pose of hands 708e and 708f shown at FIG. 14D), the computer system (e.g., 101, 700, and/or 1600) provides (e.g., displaying, via a display generation component of the one or more display generation components) an option (e.g., 1606a, 1606b, 1608, 1612a, 1612b, 1614a, 1614b, and/or 1614c) (e.g., a selectable user interface object, such as a virtual button and/or text) to adjust an appearance of a virtual representation (e.g., 714) of the user (e.g., 708) (e.g., modifying, adjusting, and/or changing a visual appearance of the virtual representation of the user to add and/or remove accessories (e.g., headwear, head coverings, eyewear, and/or clothing), add and/or remove prosthetics, eyepatches, and/or hearing aids, adjust a skin tone of one or more portions of a body of the virtual representation of the user, adjust a hair color and/or hair style of the representation, adjust facial hair features of the representation, recapture information about one or more physical characteristics of the user, and/or restart the capturing of information about the one or more physical characteristics of the user), wherein the virtual representation (e.g., 714) of the user (e.g., 708) is generated via the computer system (e.g., 101, 700, and/or 1600) (e.g., the computer system captures one or more physical characteristics of the user and uses the captured one or more physical characteristics of the user to generate the virtual representation of the user, which includes one or more visual characteristics that are based on the one or more physical characteristics of the user). Displaying the option for adjusting an appearance of the virtual representation of the user enables the virtual representation of the user to be edited and/or modified without requiring additional inputs (e.g., user input) to navigate to a separate editing user interface, thereby reducing the number of inputs needed to edit the visual characteristic of the representation.

In some embodiments, the option (e.g., 1606a, 1606b, 1608, 1612a, 1612b, 1614a, 1614b, and/or 1614c) to adjust the appearance of the virtual representation (e.g., 714) of the user (e.g., 714) includes a first option (e.g., 1606a and/or 1606b) (e.g., a first selectable user interface object, such as a virtual button and/or text) to adjust an appearance of virtual hands (e.g., 714b) of the virtual representation (e.g., 714) of the user (e.g., 708) (e.g., adjust a skin tone, a color, a size, a shape, and/or visual characteristics of virtual hands of the virtual representation of the user). Displaying an option to adjust an appearance of virtual hands of the virtual representation of the user enables the virtual hands of the virtual representation of the user to be edited without requiring additional inputs (e.g., user input) to navigate to a separate editing user interface, thereby reducing the number of inputs needed to edit the eyewear of the representation.

In some embodiments, the option (e.g., 1606a, 1606b, 1608, 1612a, 1612b, 1614a, 1614b, and/or 1614c) to adjust the appearance of the virtual representation (e.g., 714) of the user (e.g., 708) includes a second option (e.g., 1606a, 1606b, and/or 1608) (e.g., a second selectable user interface object, such as a virtual button and/or text) to adjust a skin tone (e.g., a color, a color temperature, a brightness, an exposure, and/or a contrast) of virtual skin of the virtual representation (e.g., 714) of the user (e.g., 708) (e.g., adjust the skin tone of a face, hands, and/or other portions of virtual skin of the virtual representation of the user). Displaying an option to adjust a skin tone of virtual skin of the virtual representation of the user enables the skin tone of the virtual skin of the virtual representation of the user to be edited without requiring additional inputs (e.g., user input) to navigate to a separate editing user interface, thereby reducing the number of inputs needed to edit the eyewear of the representation.

In some embodiments, aspects/operations of methods 800, 900, 1000, 1100, 1200, 1300, and/or 1700 may be interchanged, substituted, and/or added among these methods. For brevity, these details are not repeated here.

FIGS. 16A-16G illustrate examples of adjusting an appearance of a representation of a user. FIG. 17 is a flow diagram of an exemplary method 1700 for adjusting an appearance of a representation of a user. The user interfaces in FIGS. 16A-16G are used to illustrate the processes described below, including the processes in FIG. 17.

FIGS. 16A-16G illustrate examples for adjusting an appearance of a representation of a user. In some embodiments, a computer system (e.g., computer system 700 and/or computer system 1600) captures information about the user to generate a representation of the user, such as representation 714. In some embodiments, the representation of the user is displayed and/or otherwise used to communicate during a real-time communication session. In some embodiments, a real-time communication session includes real-time communication between the user of the computer system and a second user associated with a second computer system, different from the computer system, and the real-time communication session includes displaying and/or otherwise communicating, via the computer system and/or the second computer system, the user's facial and/or body expressions to the second user via the representation of the user. In some embodiments, the real-time communication session includes displaying the representation of the user and/or outputting audio corresponding to utterances of the user in real time. In some embodiments, the computer system and the second computer system are in communication with one another (e.g., wireless communication and/or wired communication) to enable information indicative of the representation of the user and/or audio corresponding to utterances of the user to be transmitted between one another. In some embodiments, the real-time communication session includes displaying the representation of the user (and, optionally, a representation of the second user) in an extended reality environment via display devices of the computer system and the second computer system.

As set forth below with reference to FIGS. 16A-16G, in some embodiments, an appearance of the representation of the user can be modified, adjusted, and/or changed in response to receiving user inputs. While FIGS. 16A-16G illustrate computer system 1600 displaying avatar editing interface 1602, other computer systems, such as computer system 700, can also display an avatar editing interface and/or adjust an appearance of the representation of the user. In addition, while FIGS. 7A-7T and 14A-14D illustrate computer system 700 capturing information about physical characteristics of user 708 and generating representation 714 based on the captured information, computer system 1600 can also be used to capture the information about the physical characteristics of user 708 and generate representation 714 based on the captured information. Further, in some embodiments, computer system 700 and/or computer system 1600 is the HMD, which displays avatar editing user interface 1602 and/or avatar editing user interface 1616 on an internal display of the HMD while the HMD is being worn on head 708b of user 708.

At FIG. 16A, computer system 1600 displays, on display 1600a, avatar editing interface 1602, which includes live view 1604 of representation 714 of a user (e.g., user 708). At FIGS. 16A-16G, computer system 1600 (and/or computer system 700) displays representation 714 of the user as a head and/or face representation of the user. In some embodiments, computer system 1600 displays representation 714 of the user having torso representation 714a (e.g., a representation of a chest, shoulders, stomach, abdomen, and/or waist) of the user and/or hands representation 714b of the user.

While computer system 1600 displays live view 1604 of avatar editing interface 1602, live view 1604 is updated in real-time according to movement and/or mannerisms of the user. In some embodiments, computer system 1600 displays movement of representation 714 based on detected movement of the user. In some embodiments, computer system 1600 displays movement of representation 714, which is inverted and/or a mirror image of movement of the user. In some embodiments, computer system 1600 adjusts a size of representation 714 displayed on display 1600a based on movement of the user relative to computer system 1600. For instance, in some embodiments, computer system 1600 increases a size of representation 714 as a distance between the user and computer system 1600 decreases. Similarly, in some embodiments, computer system 1600 decreases a size of representation 714 as the distance between the user and computer system 1600 increases.

In some embodiments, computer system 1600 displays avatar editing user interface 1602 after capturing information about physical characteristics of the user, where the information about the physical characteristics of the user is used to generate representation 714. In some embodiments, computer system 1600 displays avatar editing user interface 1602 at an end of an enrollment process (e.g., an enrollment process that includes after capturing the information about physical characteristics of the user) and without detecting a request to display avatar editing user interface 1602. In some embodiments, computer system 1600 displays avatar editing user interface 1602 while displaying a communication user interface and in response to receiving a request to display avatar editing user interface 1602. In some embodiments, the communication user interface is associated with an ability of computer system 1600 to initiate and/or otherwise enable the user to participate in a real-time communication session. In some embodiments, computer system 1600 displays avatar editing user interface 1602 before initiating a real-time communication session (and, optionally, in response to receiving a request to display avatar editing user interface 1602). In some embodiments, computer system 1600 displays avatar editing user interface 1602 while a real-time communication session is active and/or ongoing (and, optionally, in response to receiving a request to display avatar editing user interface 1602). Therefore, in some embodiments, computer system 1600 is configured to adjust and/or modify an appearance of representation 714 after first generating representation 714, before initiating a real-time communication session, while a real-time communication session is active and/or ongoing, and/or in response to receiving a request to display avatar editing user interface 1602.

Avatar editing interface 1602 further includes various settings and/or parameters by which visual characteristics of representation 714 are adjusted. As an example, avatar editing interface 1602 includes settings 1606, which include brightness setting 1606a and warmth setting 1606b. Brightness setting 1606a and warmth setting 1606b are used to adjust a brightness and warmth of the skin (e.g., a skin tone) of representation 714, respectively. At FIG. 16A, brightness setting 1606a and warmth setting 1606b include slider user interface objects that are configured to adjust a brightness and warmth of the skin of representation 714, respectively. In some embodiments, brightness setting 1606a and warmth setting 1606b include user interface objects different from slider user interface objects. As another example, avatar editing interface 1602 includes color palette 1608 including a set of one or more colors and/or shades from which a color of the skin of representation 714 can be selected. As set forth below, computer system 1600 adjusts an appearance of the skin of representation 714 based on detecting user inputs corresponding to brightness setting 1606a, warmth setting 1606b, and/or color palette 1608.

In some embodiments, computer system 1600 displays representation 714 with a default appearance that is based on the information about physical characteristics of the user captured by computer system 700 and/or computer system 1600. In some embodiments, the default appearance of representation 714 includes a lighting property, such as a color temperature and/or an exposure. In some embodiments, the lighting property is based on actual light in an environment (e.g., physical environment 706) in which the user was located when computer system 700 and/or computer system 1600 captured information about physical characteristics of the user. In some embodiments, the actual light is based on light sources that generate light within the environment (e.g., physical environment 706), such as lamps, light bulbs, and/or sunlight. In some embodiments, the lighting property is based on simulated lighting in an extended reality environment associated with live view 1604. In some embodiments, the simulated lighting includes lighting from virtual light sources and the simulated lighting is not based on actual light within the physical environment in which the information about physical characteristics of the user was captured. In some embodiments, user input corresponding to brightness setting 1606a and/or warmth setting 1606b adjust the lighting property of the appearance of representation 714 from the default appearance to a modified and/or adjusted appearance.

As set forth below with reference to FIGS. 16C-16G, in some embodiments, avatar editing interface 1602 includes first set of parameters 1612 (e.g., first parameter 1612a and second parameter 1612b). In some embodiments, selecting a parameter allows for visual characteristics of one or more aspects of the avatar to be selected. By way of example, in some embodiments, parameters 1612 are used to select one or more aspects of eyewear of representation 714. In some embodiments, first parameter 1612a corresponds to eyeglasses and second parameter 1612b corresponds to eye patches. In some embodiments, avatar editing interface 1602 includes second set of parameters 1614. In some embodiments, second set of parameters 1614 are used to select one or more aspects of accessibility features. By way of example, in some embodiments, third parameter 1614a corresponds to hand and/or arm prosthetics, fourth parameter 1614b corresponds to hearing aids, and fifth parameter 1614c corresponds to wheelchairs.

At FIG. 16A, computer system 700 is also shown displaying, on display 704 (or display 736), avatar editing user interface 1616. In some embodiments, computer system 700 displays avatar editing user interface 1616 after capturing information about physical characteristics of first hand 708e and second hand 708f of user 708, as set forth above with reference to FIGS. 14A-14D. At FIG. 16A, avatar editing user interface 1616 includes live view 1618 of representation 714. While computer system 700 displays live view 1618 of avatar editing interface 1616, live view 1618 is updated in real-time according to movement and/or mannerisms of user 708. Avatar editing user interface 1616 includes settings 1620, which include brightness setting 1620a and warmth setting 1620b. In some embodiments, avatar editing user interface 1616 is scrollable so that computer system 700 displays additional settings and/or sets of parameters (e.g., corresponding to first set of parameters 1612 and/or second set of parameters 1614) in response to detecting one or more user inputs (e.g., a swipe gesture and/or an air gesture). Thus, computer system 700 is configured to display avatar editing user interface 1616, which enables computer system 700 to adjust an appearance of representation 714.

At FIG. 16A, avatar editing user interface 1602 includes recapture option 1622. In some embodiments, in response to detecting user input corresponding to recapture option 1622, computer system 1600 initiates a process for capturing and/or recapturing information about physical characteristics of the user (e.g., user 708). In some embodiments, after capturing and/or recapturing information about physical characteristics of the user, computer system 1600 generates and/or regenerates representation 714 based on the captured and/or recaptured information. As such, when the user determines that an appearance of representation 714 is not suitable and/or satisfactory (e.g., the appearance of representation 714 does not accurately reflect an appearance of the user), the user can cause computer system 1600 to capture and/or recapture information about physical characteristics of user 708 via recapture option 1622.

At FIG. 16A, computer system 1600 detects user input 1650a (e.g., a swipe gesture or an air gesture corresponding to a location of brightness setting 1606a) corresponding to brightness setting 1606a of avatar editing user interface 1602. In response to detecting user input 1650a, computer system 1600 adjusts an appearance of representation 714, as shown at FIG. 16B.

At FIG. 16B, computer system 1600 changes and/or modifies the appearance of representation 714, as indicated by first hatching at FIG. 16B. In response to detecting user input 1650a, computer system 1600 adjusts a position of brightness setting 1606a and modifies the appearance of representation 714. In some embodiments, brightness setting 1606a corresponds to an exposure of the appearance of representation 714. In some embodiments, brightness setting 1606a corresponds to an exposure of a skin tone of representation 714. At FIG. 16B, computer system 1600 has adjusted and/or modified the exposure of the skin tone of representation 714 based on detecting user input 1650a. In some embodiments, computer system 1600 adjusts the exposure of the skin tone of representation 714 based on a magnitude associated with user input 1650a. For instance, in some embodiments, computer system 1600 adjusts the exposure of the skin tone of representation 714 by an amount that is based on (e.g., proportional to) an amount of movement and/or displacement associated with user input 1650a. In some embodiments, computer system 1600 adjusts the exposure of the skin tone of representation 714 based on a direction associated with user input 1650a. For instance, user input 1650a includes movement in a leftward direction and/or in a direction toward a dimmer exposure setting. In some embodiments, computer system 1600 adjusts an appearance of representation 714 to include a dimmer exposure and/or a reduced brightness based on the direction of user input 1650a.

As set forth above, in some embodiments, computer system 1600 adjusts the exposure of the skin tone of representation 714 based on a lighting property of representation 714. For instance, in some embodiments, the lighting property is based on actual light in an environment in which information about physical characteristics of the user was captured and/or simulated light associated with live view 1604. In some embodiments, computer system 1600 adjusts the exposure of the skin tone of representation 714 from a default exposure to a first exposure based on detecting user input 1650a, where the default exposure is based on the lighting property.

At FIG. 16B, computer system 1600 maintains a position of warmth setting 1606b and changes the position of brightness setting 1606a in response to detecting user input 1650a. In some embodiments, computer system 1600 independently adjusts the exposure and/or brightness of the skin of representation 714 in response to user input 1650a. In other words, computer system 1600 adjusts the exposure and/or brightness of the skin of representation 714 in response to user input 1650a corresponding to brightness setting 1606a without adjusting a color temperature of the skin of representation 714. In some embodiments, computer system 700 adjusts the color temperature of the skin of representation 714 based on an adjustment to the exposure and/or brightness of the skin of representation 714 in response to user input 1650a.

At FIG. 16B, computer system 1600 detects user input 1650b (e.g., a swipe gesture or an air gesture corresponding to a location of warmth setting 1606b) corresponding to warmth setting 1606b. In response to detecting user input 1650b, computer system 1600 adjusts and/or modifies an appearance of representation 714, as shown at FIG. 16C.

At FIG. 16C, computer system 1600 changes and/or modifies the appearance of representation 714, as indicated by second hatching at FIG. 16C. In response to detecting user input 1650b, computer system 1600 adjusts a position of warmth setting 1606b and modifies the appearance of representation 714. In some embodiments, warmth setting 1606b corresponds to a color temperature of the appearance of representation 714. In some embodiments, warmth setting 1606b corresponds to a color temperature of a skin tone of representation 714. At FIG. 16C, computer system 1600 has adjusted and/or modified the color temperature of the skin tone of representation 714 based on detecting user input 1650b. In some embodiments, computer system 1600 adjusts the color temperature of the skin tone of representation 714 based on a magnitude associated with user input 1650b. For instance, in some embodiments, computer system 1600 adjusts the color temperature of the skin tone of representation 714 by an amount that is based on (e.g., proportional to) an amount of movement and/or displacement associated with user input 1650b. In some embodiments, computer system 1600 adjusts the color temperature of the skin tone of representation 714 based on a direction associated with user input 1650b. For instance, user input 1650b includes movement in a rightward direction and/or in a direction toward a warmer color temperature setting. In some embodiments, computer system 1600 adjusts an appearance of representation 714 to include a warmer color temperature based on the direction of user input 1650b.

As set forth above, in some embodiments, computer system 1600 adjusts the color temperature of the skin tone of representation 714 based on a lighting property of representation 714. For instance, in some embodiments, the lighting property is based on actual light in an environment in which information about physical characteristics of the user was captured and/or simulated light associated with live view 1604. In some embodiments, computer system 1600 adjusts the color temperature of the skin tone of representation 714 from a default color temperature to a first color temperature based on detecting user input 1650b, where the default color temperature is based on the lighting property.

At FIG. 16C, computer system 1600 maintains a position of brightness setting 1606a and changes the position of warmth setting 1606b in response to detecting user input 1650b. In some embodiments, computer system 1600 independently adjusts the color temperature of the skin of representation 714 in response to user input 1650b. In other words, computer system 1600 adjusts the color temperature of the skin of representation 714 in response to user input 1650b corresponding to warmth setting 1606b without adjusting an exposure and/or brightness of the skin of representation 714. In some embodiments, computer system 700 adjusts the exposure and/or brightness of the skin of representation 714 based on an adjustment to the color temperature of the skin of representation 714 in response to user input 1650b.

At FIG. 16C, computer system 1600 detects user input 1650c (e.g., a tap gesture or an air gesture corresponding to a location of first parameter 1612a of first set of parameters 1612) corresponding to selection of first parameter 1612a of first set of parameters 1612. In response to detecting user input 1650c, computer system 1600 displays menu 1624, as shown at FIG. 16D.

At FIG. 16D, menu 1624 includes selectable options (e.g., options 1624a-1624c) from which a user can select from any number of options corresponding first parameter 1612a. In some embodiments, first parameter 1612a corresponds to eyeglasses of representation 714. In some embodiments, in response to detecting user input 1650c, computer system 1600 displays selectable options (e.g., options 1624a-1624c) for various designs and/or categories of eyeglasses (e.g., frameless, thin frames, wire frames, thick frames, etc.). In some embodiments, in response to detecting user input corresponding to option 1624a (e.g., “NONE”), computer system 1600 displays representation 714 without eyeglasses. In some embodiments, in response to detecting user input corresponding to options 1624b and/or 1624c, computer system 1600 displays sub-options corresponding to the selected design and/or category of eyeglasses.

For instance, at FIG. 16D, computer system 1600 detects user input 1650d (e.g., a tap gesture or air gesture corresponding to a location of option 1624b) corresponding to selection of option 1624b of menu 1624. In response to detecting user input 1650d, computer system 1600 displays sub-options 1626a-1626f, as shown at FIG. 16E.

At FIG. 16E, sub-options 1626a-1626f correspond to different appearance sub-options that are associated with option 1624b of first parameter 1612a. In some embodiments, sub-options 1626a-1626f correspond to different types of eyeglasses that fall within a selected design and/or category of eyeglasses (e.g., frameless, thin frames, wire frames, thick frames, etc.). In some embodiments, sub-options 1626a-1626f include images, icons, and/or symbols representative of a particular pair of eyeglasses that can be included and/or worn by representation 714. As such, computer system 1600 organizes and/or displays sub-options on avatar editing user interface 1602 based on different parameters and/or categories, which reduces an amount of time user 708 spends searching for a particular appearance option for representation 714. In some embodiments, sub-options 1626a-1626f correspond to a different appearance option and/or accessory for representation 714, such as clothing, jewelry, headwear, and/or watches.

At FIG. 16E, computer system 1600 detects user input 1650e (e.g., a tap gesture or air gesture corresponding to a location of sub-option 1626a) corresponding to selection of sub-option 1626a. In response to detecting user input 1650e, computer system 1600 adjusts, modifies, and/or updates representation 714 so that representation 714 includes an appearance based on sub-option 1626a. For instance, at FIG. 16E, representation 714 includes appearance indicator 1628 (e.g., “A”), which is associated with sub-option 1626a. While FIG. 16E shows appearance indicator 1628 as including a letter on a shirt and/or torso of representation 714, in some embodiments, computer system 1600 displays representation 714 with a pair of eyeglasses that are based on sub-option 1626a. Therefore, in some embodiments, representation 714 is updated in real-time to reflect any changes to settings or parameters.

At FIG. 16E, computer system 1600 detects user input 1650f (e.g., a swipe gesture or air gesture corresponding to avatar editing user interface 1602) corresponding to a request to scroll avatar editing user interface 1602. In response to detecting user input 1650f, computer system 1600 scrolls avatar editing user interface 1602, as shown at FIG. 16F.

At FIG. 16F, computer system 1600 displays avatar editing user interface 1602, which includes second set of parameters 1614. As set forth above, in some embodiments, second set of parameters 1614 correspond to accessibility options for an appearance of representation 714. In some embodiments, third parameter 1614a corresponds to hand and/or arm prosthetics, fourth parameter 1614b corresponds to hearing aids, and fifth parameter 1614c corresponds to wheelchairs. In some embodiments, second set of parameters 1614 includes fewer than three parameters. In some embodiments, second set of parameters 1614 includes more than three parameters. In some embodiments, second set of parameters 1614 includes a sixth parameter corresponding to eye patches (e.g., instead of eye patches being included in first set of parameters 1612). In some embodiments, second set of parameters 1614 correspond appearance options of representation 714 that are different from accessibility options.

At FIG. 16F, computer system 1600 detects user input 1650g (e.g., a tap gesture or air gesture corresponding to a location of third parameter 1614a) corresponding to selection of third parameter 1614a. In response to detecting user input 1650g, computer system 1600 displays menu 1630, as shown at FIG. 16G.

At FIG. 16G, menu 1630 includes selectable options (e.g., options 1630a-1630d) from which a user can select from any number of options corresponding third parameter 1614a. In some embodiments, third parameter 1614a corresponds to hand and/or arm prosthetics that can be included with and/or worn by representation 714. In some embodiments, in response to detecting user input 1650g, computer system 1600 displays selectable options (e.g., options 1630a-1630d) for hand and/or arm prosthetics (e.g., right hand, left hand, both right hand and left hand, right arm, left arm, and/or both right arm and left arm). In some embodiments, in response to detecting user input corresponding to option 1630a (e.g., “NONE”), computer system 1600 displays representation 714 without a hand and/or arm prosthetic. In some embodiments, in response to detecting user input corresponding to options 1630b-1630d, computer system 1600 displays one or more sub-options corresponding to different types of hand and/or arm prosthetics that correspond to the selected selectable option.

As set forth above, in some embodiments, fourth parameter 1614b corresponds to hearing aids that can be included with and/or worn by representation 714. In some embodiments, in response to detecting user input corresponding to selection of fourth parameter 1614b, computer system 1600 displays a menu that includes selectable options for hearing aids (e.g., no hearing aids, right ear, left ear, and/or both right ear and left ear). In some embodiments, in response to detecting user input corresponding to a selectable option for hearing aids, computer system 1600 displays one or more sub-options of different types of hearing aids that correspond to the selected selectable option.

In some embodiments, fifth parameter 1614c corresponds to wheelchairs for representation 714. In some embodiments, in response to detecting user input corresponding to selection of fifth parameter 1614c, computer system 1600 displays a menu that includes selectable options for wheelchairs (e.g., no wheelchair and/or wheelchair). In some embodiments, in response to detecting user input corresponding to a selectable option for wheelchairs, computer system 1600 displays one or more sub-options of different types of wheelchairs that correspond to the selected selectable option.

FIG. 17 is a flow diagram of an exemplary method 1700 for adjusting an appearance of a representation of a user, in accordance with some embodiments. In some embodiments, method 1700 is performed at a computer system (e.g., 101, 700, and/or 1600) (e.g., a smartphone, a tablet, and/or head-mounted device) that is in communication with one or more display generation components (e.g., 120, 704, 736, and/or 1600a) (e.g., a visual output device, a 3D display, a display having at least a portion that is transparent or translucent on which images can be projected (e.g., a see-through display), a projector, a heads-up display, and/or a display controller) (and, optionally, that is in communication with and one or more cameras (e.g., an infrared camera; a depth camera; a visible light camera)). In some embodiments, the method 1700 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1700 are, optionally, combined and/or the order of some operations is, optionally, changed.

After capturing (e.g., during an enrollment process) information about one or more physical characteristics (e.g., data (e.g., image data, sensor data, and/or depth data) that represents a size, shape, position, pose, color, depth, and/or other characteristics of one or more body parts and/or features of body parts of the user) of a user (e.g., 708) of the computer system (e.g., 101, 700, and/or 1600), the computer system (e.g., 101, 700, and/or 1600) concurrently displays (1702), via a first display generation component (e.g., 120, 704, 736, and/or 1600a) of the one or more display generation components (e.g., 120, 704, 736, and/or 1600a) a representation (1704) (e.g., 714) of the user (e.g., 708) (e.g., the representation of the user is displayed at a first orientation on the first display generation component and/or at a first orientation within an environment displayed on the first display generation component), wherein one or more visual characteristics of the representation (e.g., 714) of the user (e.g., 708) are based on (e.g., have been automatically generated based on) the captured information about the one or more physical characteristics of the user (e.g., 708) (e.g., the information related to the user of the computer system to generate a representation (e.g., an avatar) of the user that includes visual indications similar to the captured and/or detected size, shape, position, pose, color, depth, and/or other characteristics of a body, clothing, hair, and/or features of the first user) and a control user interface object (1706) (e.g., 1606a, 1606b, and/or 1608) (e.g., an affordance and/or interactive visual element) for adjusting an appearance of the representation (e.g., 714) (e.g., a visual appearance of the representation displayed via the first display generation component, such as a skin tone) of the user (e.g., 708) based on a lighting property (e.g., a lighting condition in which the information about the physical characteristics was captured, a simulated lighting of an extended reality environment in which the representation is displayed, a color temperature of at least a portion of the representation (e.g., a skin of the representation), and/or an exposure of at least a portion of the representation (e.g., skin of the representation)) associated with the representation (e.g., 714) of the user (e.g., 708) (e.g., the control user interface object is configured to enable user adjustment of an appearance of the lighting property of the representation of the user).

In some embodiments, the computer system (e.g., 101, 700, and/or 1600) captures information about one or more physical characteristics (e.g., data (e.g., image data, sensor data, and/or depth data) that represents a size, shape, position, pose, color, depth, and/or other characteristics of one or more body parts and/or features of body parts of the user) of a user (e.g., 708) of the computer system (e.g., 101, 700, and/or 1600) using one or more sensors (e.g., cameras) in communication with the computer system (e.g., 101, 700, and/or 1600). In some embodiments, the computer system (e.g., 101, 700, and/or 1600) generates a representation (e.g., 714) of the user (e.g., 708) (e.g., an avatar and/or a virtual representation of at least a portion of the first user) based on the information about the one or more physical characteristics of the user (e.g., 708), including selecting one or more visual characteristics of the representation (e.g., 714) based on the one or more captured physical characteristics of the user (e.g., 708) (e.g., the computer system uses the information related to the user of the computer system to generate a representation (e.g., an avatar) of the user that includes visual indications similar to the captured and/or detected size, shape, position, pose, color, depth, and/or other characteristics of a body, clothing, hair, and/or features of the first user).

While concurrently displaying the representation (e.g., 714) of the user (e.g., 708) and the control user interface object (e.g., 1606a, 1606b, and/or 1608), the computer system (e.g., 101, 700, and/or 1600) receives (1708) input (e.g., 1650a and/or 1650b) (e.g., user input) (e.g., a press gesture, a tap gesture, a touch gesture, a swipe gesture, a slide gesture, an air gesture, and/or a rotational input gesture) corresponding to the control user interface object (e.g., 1606a, 1606b, and/or 1608).

In response to receiving the input (e.g., 1650a and/or 1650b) (e.g., user input) corresponding to the control user interface object (e.g., 1606a, 1606b, and/or 1608), the computer system (e.g., 101, 700, and/or 1600) adjusts (1710) (e.g., changing and/or modifying) the appearance of the representation (e.g., 714) of the user (e.g., 708) based on the lighting property associated with the representation (e.g., 714) of the user (e.g., 708) (e.g., changing a visual appearance of the representation of the user, such as skin tone, based on the lighting property). Adjusting the appearance of the representation of the user based on the lighting property allows the computer system to customize and/or generate a more realistic representation of the user, thereby providing a more varied, detailed, and/or realistic user experience. In addition, adjusting the appearance of the representation of the user based on the lighting property allows the computer system to account for different lighting conditions within a physical environment in which the user is located, thereby enabling the device to be used in a variety of lighting conditions.

In some embodiments, adjusting the appearance of the representation (e.g., 714) of the user (e.g., 708) based on the lighting property associated with the representation (e.g., 714) of the user (e.g., 708) includes: in accordance with a determination that the input (e.g., 1650a and/or 1650b) (e.g., user input) corresponding to the control user interface object (e.g., 1606a, 1606b, and/or 1608) has a first magnitude (e.g., a first amount of movement, a first amount of pressure, and/or a first duration of the input), the computer system (e.g., 101, 700, and/or 1600) adjusts the appearance of the representation (e.g., 714) of the user (e.g., 708) by a first amount (e.g., changing a color temperature of a skin tone of the representation of the user along the color spectrum, such as in a warmer direction or a cooler direction, changing a brightness of the skin tone of the representation of the user by a first amount, changing an exposure of the skin tone of the representation of the user by a first amount, and/or changing a contrast of the skin tone of the representation of the user by a first amount, or a color temperature correction based on a color temperature of light while a visual appearance of the user was being captured by one or more sensors). In some embodiments, adjusting the appearance of the representation (e.g., 714) of the user (e.g., 708) based on the lighting property associated with the representation (e.g., 714) of the user (e.g., 708) includes: in accordance with a determination that the input (e.g., 1650a and/or 1650b) (e.g., user input) corresponding to the control user interface object (e.g., 1606a, 1606b, and/or 1608) has a second magnitude (e.g., a second amount of movement, a second amount of pressure, and/or a second duration of the input) that is different from the first magnitude, the computer system (e.g., 101, 700, and/or 1600) adjusts the appearance of the representation (e.g., 714) of the user (e.g., 708) by a second amount (e.g., changing a color temperature of a skin tone of the representation of the user along the color spectrum, such as in a warmer direction or a cooler direction, changing a brightness of the skin tone of the representation of the user by a second amount, changing an exposure of the skin tone of the representation of the user by a second amount, and/or changing a contrast of the skin tone of the representation of the user by a second amount, or a color temperature correction based on a color temperature of light while a visual appearance of the user was being captured by one or more sensors) that is different from the first amount. Adjusting the appearance of the representation of the user based on a magnitude of the input (e.g., user input) allows the computer system to customize and/or generate a more realistic representation of the user, thereby providing a more varied, detailed, and/or realistic user experience. In addition, adjusting the appearance of the representation of the user based on the magnitude of the input (e.g., user input) allows the computer system to account for different lighting conditions within a physical environment in which the user is located, thereby enabling the device to be used in a variety of lighting conditions.

In some embodiments, adjusting the appearance of the representation (e.g., 714) of the user (e.g., 708) based on the lighting property associated with the representation (e.g., 714) of the user (e.g., 708) includes: in accordance with a determination that the input (e.g., 1650a and/or 1650b) (e.g., user input) corresponding to the control user interface object (e.g., 1606a, 1606b, and/or 1608) has a first input direction (e.g., a first direction of movement associated with the input), the computer system (e.g., 101, 700, and/or 1600) adjusts the appearance of the representation (e.g., 714) of the user (e.g., 708) in a corresponding first adjustment direction (e.g., changing a color temperature of a skin tone of the representation of the user along the color spectrum in a first adjustment direction, such as in a warmer direction or a cooler direction, changing a brightness of the skin tone of the representation of the user in a first adjustment direction, such as in a brighter direction or a dimmer direction, changing an exposure of the skin tone of the representation of the user in a first adjustment direction, such as a more exposure direction or a less exposure direction, and/or changing a contrast of the skin tone of the representation of the user in a first adjustment direction, such as a more contrast direction or a less contrast direction). In some embodiments, adjusting the appearance of the representation (e.g., 714) of the user (e.g., 708) based on the lighting property associated with the representation (e.g., 714) of the user (e.g., 708) includes: in accordance with a determination that the input (e.g., 1650a and/or 1650b) (e.g., user input) corresponding to the control user interface object (e.g., 1606a, 1606b, and/or 1608) has a second input direction (e.g., a second direction of movement associated with the input) that is different from the first input direction, the computer system (e.g., 101, 700, and/or 1600) adjusts the appearance of the representation (e.g., 714) of the user (e.g., 708) in a corresponding second adjustment direction (e.g., changing a color temperature parameter corresponding to a skin tone of the representation of the user along the color spectrum in a second adjustment direction, such as in a warmer direction or a cooler direction, changing a brightness parameter corresponding to the skin tone of the representation of the user in a second adjustment direction, such as in a brighter direction or a dimmer direction, changing an exposure parameter corresponding to the skin tone of the representation of the user in a second adjustment direction, such as a more exposure direction or a less exposure direction, and/or changing a contrast parameter corresponding to the skin tone of the representation of the user in a second adjustment direction, such as a more contrast direction or a less contrast direction) that is different from the first adjustment direction. In some embodiments, a parameter applies to the skin tone by adjusting the skin tone based on the parameter. In some embodiments, a parameter applies to the skin tone by adjusting visual data corresponding to the user (e.g., an image or video of the user) to change a detected or estimated skin tone. Adjusting the appearance of the representation of the user based on a direction of the input (e.g., user input) allows the computer system to customize and/or generate a more realistic representation of the user, thereby providing a more varied, detailed, and/or realistic user experience. In addition, adjusting the appearance of the representation of the user based on the direction of the input (e.g., user input) allows the computer system to account for different lighting conditions within a physical environment in which the user is located, thereby enabling the device to be used in a variety of lighting conditions.

In some embodiments, the lighting property associated with the representation (e.g., 714) of the user (e.g., 708) includes an adjustment to the appearance of the representation (e.g., 714) of the user (e.g., 708) (e.g., an adjustment to a skin tone of the representation of the user) that is based on lighting conditions (e.g., actual and/or non-simulated light generated by physical light sources) of a physical environment (e.g., 706) in which the information about the one or more physical characteristics of the user (e.g., 708) of the computer system (e.g., 101, 700, and/or 1600) was captured (e.g., an initial appearance of the representation of the user (e.g., an appearance of the representation of the user before receiving the user input) is based on lighting conditions of a physical environment in which the user of the computer system was located when the computer system captured the one or more physical characteristics of the user of the computer system). The lighting property including an adjustment to the appearance of the representation of the user that is based on lighting conditions of a physical environment allows the computer system to account for different lighting conditions within a physical environment in which the user is located, thereby enabling the device to be used in a variety of lighting conditions.

In some embodiments, the lighting property associated with the representation (e.g., 714) of the user (e.g., 708) includes an adjustment to the appearance of the representation (e.g., 714) of the user (e.g., 708) (e.g., an adjustment to a skin tone of the representation of the user) that is based on simulated lighting (e.g., simulated lighting in live view 1604) for displaying the representation (e.g., 714) of the user (e.g., 708) (e.g., light that is not based on actual light within a physical environment, light that is based on virtual light sources, and/or default and/or predetermined light). In some embodiments, an initial appearance of the representation of the user (e.g., an appearance of the representation of the user before receiving the user input) is based on the simulated lighting for displaying the representation of the user. The lighting property including an adjustment to the appearance of the representation of the user that is based on simulated lighting allows the computer system to customize and/or generate a more realistic representation of the user, thereby providing a more varied, detailed, and/or realistic user experience.

In some embodiments, the lighting property includes a color temperature (e.g., as controlled by warmth setting 1606b) (e.g., a color, a hue, a tone, a value, and/or a chroma of light emitted by the computer system (e.g., light emitted via a display generation component of the computer system and/or light emitted by the computer system that is visible to a user of the computer system) that can be adjusted within a predetermined range, such as between 1000 Kelvin and 10,000 Kelvin, between 1500 Kelvin and 8000 Kelvin, or between 2000 Kelvin and 6500 Kelvin). In some embodiments, the control user interface object (e.g., 1606a, 1606b, and/or 1608) includes two or more options for adjusting the color temperature of a skin tone of the representation (e.g., 714) of the user (e.g., 708), where the two or more options enable the color temperature of the skin tone of the representation (e.g., 714) of the user (e.g., 708) to be adjusted from a warmer color temperature to a cooler color temperature, or vice versa. The lighting property including a color temperature allows the computer system to customize and/or generate a more realistic representation of the user, thereby providing a more varied, detailed, and/or realistic user experience.

In some embodiments, the lighting property includes exposure (e.g., as controlled by brightness setting 1606a) (e.g., an exposure value that can be adjusted between −6 and 21, an amount of light per unit area, an amount of saturation of one or more colors, an amount of amplification of light, an amount of contrast, an ISO level that can be adjusted between ISO 100 and ISO 6400, and/or an amount of brightness). In some embodiments, the control user interface object (e.g., 1606a, 1606b, and/or 1608) includes two or more options for adjusting the exposure of a skin tone of the representation (e.g., 714) of the user (e.g., 708), where the two or more options enable the exposure of the skin tone of the representation (e.g., 714) of the user (e.g., 708) to be adjusted from a greater degree of exposure to a lesser degree of exposure, or vice versa. The lighting property including exposure allows the computer system to customize and/or generate a more realistic representation of the user, thereby providing a more varied, detailed, and/or realistic user experience.

In some embodiments, the control user interface object (e.g., 1606a, 1606b, and/or 1608) includes a slider user interface object (e.g., 1606a and/or 1606b) (e.g., an affordance and/or interactive visual element that is configured to slide, move, and/or be adjusted between a first end position and a second end position in response to user input). In some embodiments, the slider user interface object (e.g., 1606a and/or 1606b) enables the computer system (e.g., 101, 700, and/or 1600) to make a larger number and/or finer adjustments to the appearance of the representation (e.g., 714) of the user (e.g., 708) based on the light property associated with the representation (e.g., 714) of the user (e.g., 708) as compared to a finite list of selectable options. The control user interface object including a slider user interface object allows the computer system to include a greater degree of control for customizing and/or generating a more realistic representation of the user, thereby providing a more varied, detailed, and/or realistic user experience.

In some embodiments, the control user interface object (e.g., 1606a, 1606b, and/or 1608) is a first control user interface object and the lighting property is a first lighting property. The computer system (e.g., 101, 700, and/or 1600) displays, via the first display generation component (e.g., 120, 704, 736, and/or 1600a) of the one or more display generation components (e.g., 120, 704, 736, and/or 1600a) and concurrently with the representation (e.g., 714) of the user and the first control user interface object (e.g., 1606a, 1606b, and/or 1608), a second control user interface object (e.g., 1606a, 1606b, and/or 1608) (e.g., an affordance and/or interactive visual element) for adjusting the appearance of the representation (e.g., 714) of the user (e.g., 708) (e.g., a visual appearance of the representation of the user displayed via the first display generation component, such as a skin tone) based on a second lighting property (e.g., a simulated lighting property of an extended reality in which the representation of the user is displayed, such as a color temperature, exposure, contrast, and/or brightness) associated with the representation (e.g., 714) of the user (e.g., 708) (e.g., the second control user interface object is configured to enable user adjustment of an appearance of the second lighting property of the representation of the user), wherein the first control user interface object (e.g., 1606a, 1606b, and/or 1608) is configured to adjust the appearance of the representation (e.g., 714) of the user (e.g., 708) based on the first lighting property independent (e.g., separately) of the second lighting property, and wherein the second control user interface object (e.g., 1606a, 1606b, and/or 1608) is configured to adjust the appearance of the representation (e.g., 714) of the user (e.g., 708) based on the second lighting property independent (e.g., separately) of the first lighting property. In some embodiments, the first control user interface object (e.g., 1606a, 1606b, and/or 1608) and the second control user interface object (e.g., 1606a, 1606b, and/or 1608) are separate from one another, do not overlap with one another, and/or are distinct from one another. In some embodiments, the first lighting property and the second lighting property are different from one another. In some embodiments, the first lighting property and the second lighting property are both associated with a skin tone of the representation (e.g., 714) of the user (e.g., 708). Concurrently displaying a second control user interface object with the first control user interface object and the representation of the user allows the computer system to include multiple controls for customizing and/or generating a more realistic representation of the user, thereby providing a more varied, detailed, and/or realistic user experience.

In some embodiments, in response to receiving second input (e.g., 1650a and/or 1650b) (e.g., user input) (e.g., a press gesture, a tap gesture, a touch gesture, a swipe gesture, a slide gesture, an air gesture, and/or a rotational input gesture) requesting to adjust the appearance of the representation (e.g., 714) of the user (e.g., 708) and in accordance with a determination that the second input (e.g., 1650a and/or 1650b) (e.g., user input) corresponds to the first control user interface object (e.g., 1606a, 1606b, and/or 1608) (e.g., without detecting input (e.g., user input) corresponding to the second control user interface object), the computer system (e.g., 101, 700, and/or 1600) adjusts the appearance of the representation (e.g., 714) of the user (e.g., 708) based on the first lighting property associated with the representation (e.g., 714) of the user (e.g., 708) without adjusting the appearance of the representation (e.g., 714) of the user (e.g., 708) based on the second lighting property associated with the representation (e.g., 714) of the user (e.g., 708) (e.g., the computer system adjusts the appearance of the representation of the user based on the first lighting property associated with the representation of the user and does not adjust the appearance of the representation of the user based on the second lighting property associated with the representation of the user). In response to receiving second input (e.g., 1650a and/or 1650b) (e.g., user input) (e.g., a press gesture, a tap gesture, a touch gesture, a swipe gesture, a slide gesture, an air gesture, and/or a rotational input gesture) requesting to adjust the appearance of the representation (e.g., 714) of the user (e.g., 708) and in accordance with a determination that the second input (e.g., 1650a and/or 1650b) (e.g., user input) corresponds to the second control user interface object (e.g., 1606a, 1606b, and/or 1608) (e.g., without detecting input (e.g., user input) corresponding to the first control user interface object), the computer system (e.g., 101, 700, and/or 1600) adjusts the appearance of the representation (e.g., 714) of the user (e.g., 708) based on the second lighting property associated with the representation (e.g., 714) of the user (e.g., 708) without adjusting the appearance of the representation (e.g., 714) of the user (e.g., 708) based on the first lighting property associated with the representation (e.g., 714) of the user (e.g., 708) (e.g., the computer system adjusts the appearance of the representation of the user based on the second lighting property associated with the representation of the user and does not adjust the appearance of the representation of the user based on the first lighting property associated with the representation of the user). In some embodiments, in response to receiving second input (e.g., 1650a and/or 1650b) (e.g., user input) (e.g., a press gesture, a tap gesture, a touch gesture, a swipe gesture, a slide gesture, an air gesture, and/or a rotational input gesture) requesting to adjust the appearance of the representation (e.g., 714) of the user (e.g., 708) and in accordance with a determination that the second input (e.g., 1650a and/or 1650b) (e.g., user input) corresponds to the first control user interface object (e.g., 1606a, 1606b, and/or 1608) and the second control user interface object (e.g., 1606a, 1606b, and/or 1608) (e.g., the second input (e.g., user input) includes a first component corresponding to the first control user interface object and a second component corresponding to the second control user interface object), the computer system (e.g., 101, 700, and/or 1600) adjusts (e.g., simultaneously and/or concurrently) the appearance of the representation (e.g., 714) of the user (e.g., 708) based on the first lighting property associated with the representation (e.g., 714) of the user (e.g., 708) and adjusts the appearance of the representation (e.g., 714) of the user (e.g., 708) based on the second lighting property associated with the representation (e.g., 714) of the user (e.g., 708) (e.g., the computer system adjusts the appearance of the representation of the user based on both the first lighting property associated with the representation of the user and the second lighting property associated with the representation of the user). Enabling the appearance of the representation of the user to be adjusted based on the first lighting property, the second lighting property, or both the first lighting property and the second lighting property allows the computer system to include more refined and/or additional controls for customizing and/or generating a more realistic representation of the user, thereby providing a more varied, detailed, and/or realistic user experience.

In some embodiments, concurrently displaying the representation (e.g., 714) of the user (e.g., 708) and the control user interface object (e.g., 1606a, 1606b, and/or 1608) includes animating (e.g., displaying movement of the representation of the user that mirrors and/or imitates movement of the user) the representation (e.g., 714) of the user (e.g., 708) based on movement of the user (e.g., 708) relative to at least a portion of the computer system (e.g., 101, 700, and/or 1600) (e.g., in a physical environment in which the user is located) (e.g., the computer system receives information about a state of the body of the user, including movement of the user, and displays at least the portion of the representation of the user based on the received information). In some embodiments, the animation of the representation is displayed in conjunction with the detected movement of the user (e.g., matches the movement of the user). Animating the representation of the user based on movement of the user allows the user to comprehend that the representation is associated with the user, thereby providing improved feedback about a state of the device.

In some embodiments, animating the representation (e.g., 714) of the user (e.g., 708) includes displaying movement (e.g., movement in an orientation, position, location, and/or pose on the first display generation component of the one or more display generation components) of the representation (e.g., 714) of the user (e.g., 708) that is inverted (e.g., a mirror image) as compared to the movement of the user (e.g., 708) relative to at least the portion of the computer system (e.g., 101, 700, and/or 1600) (e.g., movement of the user relative to at least the portion of the computer system in a physical environment) (e.g., movement of the representation is displayed to the user as if the user is viewing their reflection in a mirror). In some embodiments, the animation of the representation is displayed in conjunction with the detected movement of the user (e.g., matches the movement of the user). Displaying movement of the representation of the user that is inverted as compared to movement of the user allows the user to comprehend that the representation is associated with the user, thereby providing improved feedback about a state of the device.

In some embodiments, while concurrently displaying the representation (e.g., 714) of the user (e.g., 708) and the control user interface object (e.g., 1606a, 1606b, and/or 1608), the computer system (e.g., 101, 700, and/or 1600) detects movement of the user (e.g., 708) relative to at least a portion of the computer system (e.g., 101, 700, and/or 1600) (e.g., physical movement of the user and/or at least the portion of the computer system relative to one another within a physical environment in which the user and at least the portion of the computer system are located). In response to detecting the movement of the user (e.g., 708) relative to at least the portion of the computer system (e.g., 101, 700, and/or 1600) and in accordance with a determination that the movement of the user (e.g., 708) relative to at least the portion of the computer system (e.g., 101, 700, and/or 1600) is toward at least the portion of the computer system (e.g., 101, 700, and/or 1600) (e.g., the movement causes a distance between the user and at least the portion of the computer system to decrease), the computer system (e.g., 101, 700, and/or 1600) displays, via the first display generation component (e.g., 120, 704, 736, and/or 1600a) of the one or more display generation components (e.g., 120, 704, 736, and/or 1600a), the representation (e.g., 714) of the user (e.g., 708) at a first size (e.g., a first size with respect to a display area of the first display generation component of the one or more display generation components). In response to detecting the movement of the user (e.g., 708) relative to at least the portion of the computer system (e.g., 101, 700, and/or 1600) and in accordance with a determination that the movement of the user (e.g., 708) relative to at least the portion of the computer system (e.g., 101, 700, and/or 1600) is away from at least the portion of the computer system (e.g., 101, 700, and/or 1600) (e.g., the movement causes a distance between the user and at least the portion of the computer system to increase), the computer system (e.g., 101, 700, and/or 1600) displays, via the first display generation component (e.g., 120, 704, 736, and/or 1600a) of the one or more display generation components (e.g., 120, 704, 736, and/or 1600a), the representation (e.g., 714) of the user (e.g., 708) at a second size (e.g., a second size with respect to a display area of the first display generation component of the one or more display generation components), different from (e.g., smaller than) the first size. Displaying the representation of the user at different sizes based on movement of the user allows the user to comprehend that the representation is associated with the user, thereby providing improved feedback about a state of the device.

In some embodiments, while concurrently displaying the representation (e.g., 714) of the user (e.g., 708) and the control user interface object (e.g., 1606a, 1606b, and/or 1608), the computer system (e.g., 101, 700, and/or 1600) displays, via the first display generation component (e.g., 120, 704, 736, and/or 1600a) of the one or more display generation components (e.g., 120, 704, 736, and/or 1600a), a first selectable option (e.g., 1612a and/or 1612b) (e.g., a selectable user interface object, such as a virtual button and/or text) for editing eyewear of the representation (e.g., 714) of the user (e.g., 708) (e.g., modifying, adjusting, and/or changing a visual appearance of the representation to add and/or remove eyewear accessories (e.g., glasses)). Displaying an option for editing eyewear of the representation of the user enables eyewear of the representation of the user to be edited without requiring additional inputs (e.g., user input) to navigate to a separate editing user interface, thereby reducing the number of inputs needed to edit the eyewear of the representation.

In some embodiments, the computer system (e.g., 101, 700, and/or 1600) detects a third input (e.g., 1650c) (e.g., user input) directed to the first selectable option (e.g., 1612a and/or 1612b). In response to detecting the third input (e.g., 1650c) (e.g., user input) (e.g., a press gesture, a tap gesture, a touch gesture, a swipe gesture, a slide gesture, an air gesture, and/or a rotational input gesture) directed to (e.g., corresponding to selection of) the first selectable option (e.g., 1612a and/or 1612b), the computer system (e.g., 101, 700, and/or 1600) displays, via the first display generation component (e.g., 120, 704, 736, and/or 1600a) of the one or more display generation components (e.g., 1120, 704, 736, and/or 1600a), a first eyewear category option (e.g., 1624a-1624c) (e.g., a first selectable user interface object, such as a virtual button and/or text corresponding to a first eyewear category (e.g., wireframe glasses or thick frame glasses)) and a second eyewear category option (e.g., 1624a-1624c) (e.g., a second selectable user interface object, such as a virtual button and/or text corresponding to a first eyewear category (e.g., wireframe glasses or thick frame glasses)). Displaying multiple eyewear category options allows a user of the computer system to quickly select an eyewear category and narrow eyewear options without having to scroll through and/or search for a particular type of eyewear, thereby reducing the number of inputs needed to edit the eyewear of the representation.

In some embodiments, while concurrently displaying the representation (e.g., 714) of the user (e.g., 708) and the control user interface object (e.g., 1606a, 1606b, and/or 1608), the computer system (e.g., 101, 700, and/or 1600) displays, via the first display generation component (e.g., 120, 704, 736, and/or 1600a) of the one or more display generation components (e.g., 120, 704, 736, and/or 1600a), a second selectable option (e.g., 1614a-1614c) (e.g., a selectable user interface object, such as a virtual button and/or text) for editing a visual characteristic of the representation (e.g., 714) of the user (e.g., 708) (e.g., editing an accessory in which the representation of the user includes and/or is wearing, such as a prosthetic, an eyepatch, a hearing aid, and/or a wheelchair). In some embodiments, in response to detecting input (e.g., 1650e, 1650f, and/or 1650g) (e.g., user input) corresponding to the second selectable option (e.g., 1614a-1614c) for editing the visual characteristic of the representation (e.g., 714) of the user (e.g., 708), the computer system (e.g., 101, 700, and/or 1600) edits, modifies, and/or adjusts the visual characteristic of the user (e.g., 708) (e.g., changes the appearance of the representation of the user from a first appearance to the second appearance). Displaying an option for editing a visual characteristic of the representation of the user enables visual characteristics of the representation of the user to be edited without requiring additional inputs (e.g., user input) to navigate to a separate editing user interface, thereby reducing the number of inputs needed to edit the eyewear of the representation.

In some embodiments, the visual characteristic of the representation (e.g., 714) of the user (e.g., 708) includes an eyepatch of the representation (e.g., 714) of the user (e.g., 708) (e.g., a type of eyepatch, a color of an eyepatch, a size of an eyepatch, and/or one or more options for whether the representation of the user is wearing an eyepatch over the left eye, the right eye, both the left eye and the right eye, and/or neither the left eye and the right eye). In some embodiments, in response to detecting input (e.g., 1650e, 1650f, and/or 1650g) (e.g., user input) corresponding to the second selectable option (e.g., 1614a-1614c) for editing the visual characteristic of the representation (e.g., 714) of the user (e.g., 708), the computer system (e.g., 101, 700, and/or 1600) edits, modifies, and/or adjusts whether or not the representation (e.g., 714) of the user (e.g., 708) includes and/or is wearing an eyepatch and/or edits, modifies, and/or adjusts an appearance, type, and/or size of the eyepatch. Displaying an option for editing an eyepatch of the representation of the user enables an accessory of the representation of the user to be edited without requiring additional inputs (e.g., user input) to navigate to a separate editing user interface, thereby reducing the number of inputs needed to edit the accessory of the representation.

In some embodiments, the visual characteristic of the representation (e.g., 714) of the user (e.g., 708) includes a prosthetic hand of the representation (e.g., 714) of the user (e.g., 708) (e.g., a type of prosthetic hand, a color of a prosthetic hand, a size of a prosthetic hand, and/or one or more options for whether the representation of the user is wearing and/or includes a prosthetic right hand, a prosthetic left hand, both a prosthetic right hand and a prosthetic left hand, and/or neither a prosthetic right hand and a prosthetic left hand). In some embodiments, in response to detecting input (e.g., 1650e, 1650f, and/or 1650g) (e.g., user input) corresponding to the second selectable option (e.g., 1614a-1614c) for editing the visual characteristic of the representation (e.g., 714) of the user (e.g., 708), the computer system (e.g., 101, 700, and/or 1600) edits, modifies, and/or adjusts whether or not the representation (e.g., 714) of the user (e.g., 708) includes and/or is wearing a prosthetic hand and/or edits, modifies, and/or adjusts an appearance, type, and/or size of the prosthetic hand. Displaying an option for editing a prosthetic hand of the representation of the user enables an accessory of the representation of the user to be edited without requiring additional inputs (e.g., user input) to navigate to a separate editing user interface, thereby reducing the number of inputs needed to edit the accessory of the representation.

In some embodiments, the visual characteristic of the representation (e.g., 714) of the user (e.g., 708) includes a hearing aid of the representation (e.g., 714) of the user (e.g., 708) (e.g., a type of hearing aid, a color of a hearing aid, a size of a hearing aid, and/or one or more options for whether the representation of the user is wearing and/or includes a hearing aid in the right ear, the left ear, both the right ear and the left ear, and/or neither the right ear and the left ear). In some embodiments, in response to detecting input (e.g., 1650e, 1650f, and/or 1650g) (e.g., user input) corresponding to the second selectable option (e.g., 1614a-1614c) for editing the visual characteristic of the representation (e.g., 714) of the user (e.g., 708), the computer system (e.g., 101, 700, and/or 1600) edits, modifies, and/or adjusts whether or not the representation (e.g., 714) of the user (e.g., 708) includes and/or is wearing a hearing aid and/or edits, modifies, and/or adjusts an appearance, type, and/or size of the hearing aid. Displaying an option for editing a hearing aid of the representation of the user enables an accessory of the representation of the user to be edited without requiring additional inputs (e.g., user input) to navigate to a separate editing user interface, thereby reducing the number of inputs needed to edit the accessory of the representation.

In some embodiments, the visual characteristic of the representation (e.g., 714) of the user (e.g., 708) includes a wheelchair of the representation (e.g., 714) of the user (e.g., 708) (e.g., a type of wheelchair, a color of wheelchair, a size of wheelchair, and/or one or more options for whether the representation of the user includes a wheelchair or does not include a wheelchair). In some embodiments, in response to detecting input (e.g., 1650e, 1650f, and/or 1650g) (e.g., user input) corresponding to the second selectable option (e.g., 1614a-1614c) for editing the visual characteristic of the representation (e.g., 714) of the user (e.g., 708), the computer system (e.g., 101, 700, and/or 1600) edits, modifies, and/or adjusts whether or not the representation (e.g., 714) of the user (e.g., 708) includes and/or is positioned on a wheelchair and/or edits, modifies, and/or adjusts an appearance, type, and/or size of the wheelchair. Displaying an option for editing a wheelchair of the representation of the user enables an accessory of the representation of the user to be edited without requiring additional inputs (e.g., user input) to navigate to a separate editing user interface, thereby reducing the number of inputs needed to edit the accessory of the representation.

In some embodiments, while concurrently displaying the representation (e.g., 714) of the user (e.g., 708) and the control user interface object (e.g., 1606a, 1606b, and/or 1608), the computer system (e.g., 101, 700, and/or 1600) displays, via the first display generation component (e.g., 120, 704, 736, and/or 1600a) of the one or more display generation components (e.g., 120, 704, 736, and/or 1600a), a third selectable option (e.g., 786b and/or 1622) (e.g., a selectable user interface object, such as a virtual button and/or text) that, when selected, causes the computer system (e.g., 101, 700, and/or 1600) to initiate (e.g., re-initiate) a process (e.g., a process described with respect to FIGS. 7A-7T and 14A-14D) for capturing information about the one or more physical characteristics of the user (e.g., 708) (e.g., selection of the third selectable option causes the computer system to display a user interface and/or otherwise initiate a process for recapturing information about one or more of the one or more physical characteristics of the user). In some embodiments, an initial capturing of the information about the one or more physical characteristics of the user (e.g., 708) may be inaccurate and/or otherwise incomplete, and thus, providing the user (e.g., 708) an ability to recapture at least a portion of the information about the one or more physical characteristics of the user (e.g., 708) enables the computer system (e.g., 101, 700, and/or 1600) to generate the representation (e.g., 714) to more accurately reflect an actual appearance of the user (e.g., 708). Concurrently displaying an option to recapture information about the user with the representation of the user and the control user interface object enables information about the one or more physical characteristics of the user to be recaptured without requiring additional inputs (e.g., user input) to navigate to a separate user interface, thereby reducing the number of inputs needed to recapture information about the one or more physical characteristics of the user.

In some embodiments, while displaying, via the first display generation component (e.g., 120, 704, 736, and/or 1600a) of the one or more display generation components (e.g., 120, 704, 736, and/or 1600a), a communication user interface (e.g., a user interface that enables a real-time communication session between the computer system and an external computer system to be initiated and/or a user interface associated with an ongoing and/or current real-time communication session between the computer system and an external computer system), the computer system (e.g., 101, 700, and/or 1600) receives a request to adjust the appearance of the representation (e.g., 714) of the user (e.g., 708) (e.g., input (e.g., user input) (e.g., a press gesture, a tap gesture, a touch gesture, a swipe gesture, a slide gesture, an air gesture, and/or a rotational input gesture) corresponding to an editing user interface object). In response to receiving the request to adjust the appearance of the representation (e.g., 714) of the user (e.g., 708), the computer system (e.g., 101, 700, and/or 1600) concurrently displays, via the first display generation component (e.g., 120, 704, 736, and/or 1600a) of the one or more display generation components (e.g., 120, 704, 736, and/or 1600a): the representation (e.g., 714) of the user (e.g., 708) and the control user interface object (e.g., 1606a, 1606b, and/or 1608) for adjusting an appearance of the representation (e.g., 714) of the user (e.g., 708) based on a lighting property (e.g., the computer system is configured to display a user interface that enables the appearance of the representation of the user to be edited and/or modified via the communication user interface so that the user can quickly edit and/or modify the appearance of the representation of the user prior to and/or during a real-time communication session). In some embodiments, the communication user interface includes an editing user interface object that, when selected, enables an appearance of the representation (e.g., 714) of the user (e.g., 708) to be edited and/or modified prior to and/or during a real-time communication session. Enabling a user to access controls for adjusting an appearance of the representation of the user while displaying a communication user interface allows a user to quickly edit the appearance of the representation of the user via the communication user interface without having to navigate to a different application of the computer system, thereby reducing power usage and improving battery life of the computer system by enabling the user to use the computer system more quickly and efficiently.

In some embodiments, aspects/operations of methods 800, 900, 1000, 1100, 1200, 1300, and/or 1500 may be interchanged, substituted, and/or added among these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for generating a representation of a user. In yet another example, users can select a general representation of a user that is not based on data associated with the user. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-212. (canceled)

213. A computer system configured to communicate with one or more display generation components, the computer system comprising:
one or more processors; and
memory storing one or more programs configured to be executed by the one or more processors, the one or more programs including instructions for:
during an enrollment process for generating a representation of a user, wherein the enrollment process includes capturing information about one or more physical characteristics of a user of the computer system, prompting the user to make one or more facial expressions; and
after prompting the user to make the one or more facial expressions:
detecting, via one or more sensors, information about facial features of the user; and
displaying, via a display generation component of the one or more display generation components, a progress indication based on the information about the facial features of the user, wherein displaying the progress indicator includes:
in accordance with a determination that the information about the facial features of the user indicates a first degree of progress toward making the one or more facial expressions, displaying the progress indicator with a first appearance that indicates the first degree of progress; and
in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

214. The computer system of claim 213, wherein the progress indicator is a progress bar.

215. The computer system of claim 214, wherein the progress bar is three dimensional.

216. The computer system of claim 215, wherein one or more first portions of the progress bar associated with making respective facial expressions of the one or more facial expressions extend along a first axis that is based on a viewpoint of the user of the computer system.

217. The computer system of claim 216, wherein displaying the progress indicator includes:
changing an appearance of the progress bar at a first rate at one or more second portions of the progress bar that are between the one or more first portions of the progress bar, and
changing an appearance of the progress bar at a second rate, slower than the first rate, at the one or more first portions.

218. The computer system of claim 213, wherein the first appearance that indicates the first degree of progress includes a first color, and wherein the one or more programs further include instructions for:
while displaying the progress indicator with the first appearance that indicates the first degree of progress, detecting, via the one or more sensors, second information about the facial features of the user; and
in response to detecting the second information about the facial features of the user, displaying, via the display generation component of the one or more display generation components, the progress indication with a third appearance that indicates a third degree of progress toward making the one or more facial expressions, wherein the third appearance includes a second color, different from the first color.

219. The computer system of claim 213, wherein prompting the user to make one or more facial expressions includes outputting audio that prompts the user to make a first facial expression of the one or more facial expressions.

220. The computer system of claim 213, wherein displaying the progress indicator includes:
in accordance with a determination that the information about the facial features of the user satisfies a set of one or more criteria, displaying the progress indicator changing appearance at a first rate, and
in accordance with a determination that the information about the facial features of the user does not satisfy the set of one or more criteria, displaying the progress indicator changing appearance at a second rate, slower than the first rate.

221. The computer system of claim 213, wherein the representation of the user is based on the information about the facial features of the user.

222. The computer system of claim 213, wherein the one or more programs further include instructions for:
after displaying the progress indication based on the information about the facial features of the user for a predetermined amount of time, initiating a next step of the enrollment process without regard to whether or not the information about the facial features of the user corresponds to the one or more facial expressions.

223. The computer system of claim 222, wherein the one or more programs further include instructions for:
after initiating a next step of the enrollment process, displaying, via the display generation component of the one or more display generation components:
the representation of the user; and
a selectable option for capturing second information about the facial features of the user.

224. The computer system of claim 213, wherein the one or more facial expressions include two or more of a closed mouth smile, an open mouth smile, and raised eyebrows.

225. A non-transitory computer-readable storage medium storing one or more programs configured to be executed by one or more processors of a computer system that is in communication with one or more display generation components, the one or more programs including instructions for:
during an enrollment process for generating a representation of a user, wherein the enrollment process includes capturing information about one or more physical characteristics of a user of the computer system, prompting the user to make one or more facial expressions; and
after prompting the user to make the one or more facial expressions:
detecting, via one or more sensors, information about facial features of the user; and
displaying, via a display generation component of the one or more display generation components, a progress indication based on the information about the facial features of the user, wherein displaying the progress indicator includes:
in accordance with a determination that the information about the facial features of the user indicates a first degree of progress toward making the one or more facial expressions, displaying the progress indicator with a first appearance that indicates the first degree of progress; and
in accordance with a determination that the information about the facial features of the user indicates a second degree of progress toward making the one or more facial expressions that is different from the first degree of progress, displaying the progress indicator with a second appearance, different from the first appearance, that indicates the second degree of progress.

226. A method, comprising:
at a computer system that is in communication with one or more display generation components:
during an enrollment process for generating a representation of a user, wherein the enrollment process includes capturing information about one or more physical characteristics of a user of the computer system, prompting the user to make one or more facial expressions; and
after prompting the user to make the one or more facial expressions:
detecting, via one or more sensors, information about facial features of the user; and
displaying, via a display generation component of the one or more display generation components, a progress indication based on the information about the facial features of the user, wherein displaying the progress indicator includes:
in accordance with a determination that the information about the facial features of the user indicates a first degree of progress toward making the one or more facial expressions, displaying the progress indicator with a first appearance that indicates the first degree of progress; and
in accordance with a determination that the information about the facial features of the user indicates a second degree of progress toward making the one or more facial expressions that is different from the first degree of progress, displaying the progress indicator with a second appearance, different from the first appearance, that indicates the second degree of progress.
